(19) United States
(12) Patent Application Publication
(10) Pub. No.: US 2025/0214046 A1
(43) Pub. Date: Jul. 3, 2025

(54) CROSS MIXERS FOR LIPID NANOPARTICLE PRODUCTION, AND METHODS OF OPERATING THE SAME

(71) Applicant: ModernaTX, Inc., Cambridge, MA (US)

(72) Inventors: Benjamin GELDHOF, Cambridge, MA (US); Chang TIAN, Cambridge, MA (US); Michael H. SMITH, Cambridge, MA (US)

(21) Appl. No.: 18/851,121

(22) PCT Filed: Mar. 31, 2023
(86) PCT No.: PCT/US2023/065231

§ 371 Date: Sep. 26, 2024

Related U.S. Application Data
(60) Provisional application No. 63/326,485, filed on Apr. 1, 2022.

(51) Int. Cl. B01F 33/3011; B01F 25/10; B01F 25/23; B01F 33/301

(52) U.S. Cl. CPC B01F 33/3011; B01F 25/10; B01F 25/23; B01F 33/3017

(57) ABSTRACT

The present disclosure provides processes for controlled high-throughput preparation of lipid nanoparticle with defined parameters. A cross mixer can include a central region, a first inlet in fluidic communication with the central region, a second inlet in fluidic communication with the central region, a third inlet in fluidic communication with the central region, and an outlet in fluidic communication with the central region, the outlet oriented at an angle of between about 35° and about 120° from the first inlet and an angle of between about 35° and about 120° from the second inlet.

### CROSS REFERENCE TO RELATED APPLICATIONS

This application claims the benefit of U.S. Provisional Application No. 63/326,485, titled “Cross Mixers for Lipid Nanoparticle Production, and Methods of Operating the Same,” and filed Apr. 1, 2022, the content of which is incorporated herein by reference in its entirety.

### TECHNICAL FIELD

Embodiments described herein relate to systems and methods for producing lipid nanoparticles.

### BACKGROUND

The effective targeted delivery of biologically active substances such as small molecule drugs, proteins, and nucleic acids represents a continuing medical challenge. In particular, the delivery of nucleic acids to cells is made difficult by the relative instability and low cell permeability of such species.

Lipid-containing nanoparticles or lipid nanoparticles, liposomes, and lipoplexes have proven effective as transport vehicles into cells and/or intracellular compartments for biologically active substances such as small molecule drugs, proteins, and nucleic acids. Yet controlled high throughput process for preparing lipid nanoparticles with defined parameters are and needed.

### SUMMARY

The present disclosure provides processes for controlled high-throughput preparation of lipid nanoparticle with defined parameters. In some aspects, a cross mixer can include a central region, a first inlet in fluidic communication with the central region and coupled to a first side of the central region, a second inlet in fluidic communication with the central region and coupled to a second side of the central region, the second side opposite the first side, a third inlet in fluidic communication with the central region and coupled to a third side of the central region, the third side adjacent to the first side and the second side, and an outlet in fluidic communication with the central region and coupled to a fourth side of the central region, the fourth side opposite the third side, the outlet oriented at an angle of between about 35° and about 120° from the first inlet and an angle of between about 35° and about 120° from the second inlet.

In some embodiments, the central region includes a first dimension approximately equal to a first dimension of a cross-sectional area of the first inlet, a second dimension approximately equal to a second dimension of the cross-sectional area of the first inlet, and a third dimension approximately equal to a first dimension of a cross-sectional area of the second inlet.

In some embodiments, the central region includes a convergence chamber. In some embodiments, the convergence chamber has a cylindrical shape. In some embodiments, the first inlet and the second inlet are offset, such that fluids flowing into the convergence chamber create a vertex. In some embodiments, the convergence chamber has a cubic shape. In some embodiments, the convergence chamber has a trapezoidal prism shape. In some embodiments, the convergence chamber has a frustum shape.

In some embodiments, the first inlet has a square cross section. In some embodiments, the square cross section has a cross-sectional dimension of about 1 mm to about 4 mm.

In some embodiments, the outlet is oriented at an angle of about 90° from the first inlet.

In some embodiments, the outlet is oriented at an angle of about 35° to about 45° from the first inlet.

In some embodiments, the third inlet is oriented approximately in-line with the outlet.

In some embodiments, the first inlet includes a first section and a second section, the first section oriented approximately orthogonal to the second section. In some embodiments, the first section is oriented vertically and the second section is oriented horizontally.

In some embodiments, the outlet is oriented within about 5° of parallel to the third inlet.

In some aspects, a method includes feeding a first fluid to a central region of a cross mixer via at least one of a first inlet or a second inlet, the first inlet coupled to a first side of the central region, the second inlet coupled to a second side of the central region, the first side opposite the second side, feeding a second fluid to a third inlet of the cross mixer, the third inlet coupled to a third side of the central region, the third side adjacent to the first side and the second side, mixing the first fluid and the second fluid to form a mixture in a central region fluidically coupled to the first inlet, the second inlet, and the third inlet, and transferring the mixture out of the central region via an outlet of the cross mixer, the outlet coupled to a fourth side of the central region, the fourth side opposite the third side.

In some embodiments, the first fluid includes water. In some embodiments, the second fluid includes LSS. In some embodiments, the water reacts with the LSS to form nanoparticles via nucleation at a sufficient rate, such that the ethanol concentration in the first fluid reduces from at least about 99 wt % to less than about 30 wt % less than about 0.007 seconds after contacting the second fluid. In some embodiments, the ethanol reacts with the LSS at a sufficient rate, such that the ethanol concentration in the first fluid reduces from at least about 99 wt % to less than about 30 wt % less than about 0.003 seconds after contacting the second fluid.

In some embodiments, the central region includes a first dimension approximately equal to a first dimension of a cross-sectional area of the first inlet, a second dimension approximately equal to a second dimension of the cross-sectional area of the first inlet, and a third dimension approximately equal to a first dimension of a cross-sectional area of the second inlet.

In some embodiments, the central region includes a convergence chamber. In some embodiments, the convergence chamber has a cylindrical shape. In some embodiments, the first inlet and the second inlet are offset, such that fluids flowing into the convergence chamber create a vortex.

In some embodiments, the convergence chamber has a cubic shape.

In some embodiments, the convergence chamber has a trapezoidal prism shape.

In some embodiments, the convergence chamber has a frustum shape.

In some aspects a method for preparing LNPs includes mixing a lipid solution with an aqueous buffer solution in a C-Mixer, thereby forming a lipid nanoparticle solution (LNP solution) comprising LNPs, wherein: the lipid solution is fed to an inlet (lipid inlet) of the C-Mixer, the aqueous buffer solution is fed to an inlet (buffer inlet) of the C-Mixer; and/or the LNP solution exits an outlet (LNP outlet) of the C-Mixer.

In some embodiments, the lipid solution is fed to an inlet that is within about 5° of parallel to the outlet.

In some embodiments, the aqueous buffer solution is fed to an inlet that forms an angle with the outlet between about 80° and about 120°.

In some embodiments, the aqueous buffer solution is fed to two inlets that each form an angle with the outlet between about 80° and about 120°.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1A is a simulation showing the variation of local ethanol mass fraction along the trajectory of lipid dissolved in ethanol in a T-Mixer.

FIG. 1B is a simulation showing the variation of local ethanol mass fraction along the trajectory of lipid dissolved in ethanol in a V-Mixer.

FIG. 2A shows different ethanol drop times (EDT) for different flow rates in a 0.5 mm outlet size V-mixer, as a demonstration of decreasing EDT with increasing flow rate/larger Reynolds number.

FIG. 2B shows points on a mesh. The red highlighted points are points where massless tracking particles are injected onto the ethanol inlet.

FIG. 3A is an illustration of a cross mixer with no convergence chamber, according to an embodiment.

FIG. 3B is an illustration of a cross mixer with no convergence chamber and angled inlets, according to an embodiment.

FIG. 3C is an illustration of a cross mixer with a cylindrical convergence chamber, according to an embodiment.

FIG. 3D is an illustration of a cross mixer with a cubic convergence chamber, according to an embodiment.

FIG. 3E is an illustration of a cross mixer with trapezoidal prism convergence chamber, according to an embodiment.

FIG. 3F is an illustration of a cross mixer with a cylindrical convergence chamber, according to an embodiment.

FIG. 3G is an illustration of a cross mixer with a conical or frustum-shaped convergence chamber, according to an embodiment.

FIG. 4A is a simulation showing particle tracks in a cross mixer with no convergence chamber.

FIG. 4B is a simulation showing particle tracks in a cross mixer with no convergence chamber and angled inlets.

FIG. 4C is a simulation showing particle tracks in a cross mixer with a cylindrical convergence chamber.

FIG. 4D is a simulation showing particle tracks in a cross mixer with a cubic convergence chamber.

FIG. 4E is a simulation showing particle tracks in a cross mixer with a trapezoidal convergence chamber.

FIG. 4F is a simulation showing particle tracks in a cross mixer with a cylindrical convergence chamber.

FIG. 4G is a simulation showing particle tracks in a cross mixer with a conical or frustum-shaped convergence chamber.

FIG. 5A is a simulation of contours of mass fractions of ethanol in a cross mixer with no convergence chamber.

FIG. 5B is a simulation of contours of mass fractions of ethanol in a cross mixer with a cubic convergence chamber.

FIG. 6A is a simulation of contours of mass fractions of ethanol in a cross mixer with no convergence chamber.

FIG. 6B is a simulation of contours of static pressure in a cross mixer with no convergence chamber.

FIG. 6C is a simulation showing particle tracks in a cross mixer with no convergence chamber.

FIG. 6D is a simulation showing contours of turbulent kinetic energy in a cross mixer with no convergence chamber.

FIG. 7A is an illustration of a cross mixer with no convergence chamber, according to an embodiment.

FIG. 7B is an illustration of a cross mixer with no convergence chamber, according to an embodiment.

FIG. 7C is an illustration of a cross mixer with a cubic convergence chamber, according to an embodiment.

FIG. 7D is a photograph of a cross mixer with no convergence chamber, according to an embodiment.

FIG. 7E is a photograph of a cross mixer with no convergence chamber, according to an embodiment.

FIG. 7F is a photograph of a cross mixer with a cubic convergence chamber, according to an embodiment.

FIG. 8 is a graph of simulated ethanol drop time for various mixers and flow rates.

FIG. 9A is a graph of measured eLNP particle sizes for various mixers and flow rates.

FIG. 9B is a graph of measured eLNP polydispersity index (PDI) for various mixers and flow rates.

FIG. 10 is a graph of measured eLNP size plotted against simulated ethanol drop time for various mixers.

FIG. 11 is a graph of simulated predicted pressures for various mixers and flow rates.

FIG. 12 is a graph of measured pressures for various mixers and flow rates.

FIG. 13 is an illustration of a cross mixer with a straight inlet, according to an embodiment.

FIG. 14 is an illustration of a cross mixer with a straight inlet, according to an embodiment.

FIG. 15 is an illustration of a cross mixer with a bent inlet, according to an embodiment.

FIG. 16 is an illustration of a cross mixer with a straight inlet, according to an embodiment.

FIG. 17 is an illustration of a cross mixer with a straight inlet and an extended outlet, according to an embodiment.

FIG. 18 is an illustration of a cross mixer with a bent inlet and an extended outlet, according to an embodiment.

FIG. 19 is an illustration of a cross mixer with a straight inlet and an extended outlet, according to an embodiment.

FIG. 20 is an illustration of a cross mixer with a bent inlet and an extended outlet, according to an embodiment.

FIG. 21 is a graph of pressure measured against LSS flow rate across various cross mixers.

FIG. 22A is a graph of pressure as a function of loading lipid rate in various mixers during initial filtration of empty lipids.

FIG. 22B is a graph of pressure as a function of loading lipid rate in various mixers during after 5° C. storage for four weeks.

FIG. 23 shows a T-mixer with a 2 mm outlet diameter and a 9 mm outlet length.

FIG. 24 shows distribution data of the three mixers compared in Table 7.

FIG. 25 is a graph of asymmetric flow field flow fractionation (AF4) data for eLNPs in various mixers.

FIG. 26 shows particle size distribution date for empty LNPs in various mixers, subject to Flow Cam analysis.

FIG. 27 shows flow cytometry data for eLNPs in various mixers. As shown, cross mixers and T-mixers produce a higher proportion of small particles (180-240 nm), as compared to the V-mixer.

FIG. 28 shows capillary zone electrophoresis (CZE) data for eLNPs various mixers.

FIG. 29 shows flow cytometry data for loaded LNPs in various mixers. As shown, the V-mixer includes a higher amounts of small particles than the cross mixers and the T-mixer.

FIGS. 30A-30D show circular dichroism spectroscopy data across various mixers with different sucrose treatment.

### DETAILED DESCRIPTION

### T Mixer and V-Mixer

### T-Mixer

The term “T-Joint Mixer” or “T-Mixer”, as used herein, refers to a mixing device comprising two inlets and an LNP outlet. In some embodiments, the T-Mixer comprises a lipid inlet (via which the stream of the lipid solution enters the T-Mixer), a buffer inlet (via which the aqueous buffer solution enters the T-Mixer), and an LNP outlet (via which the LNP solution exits the T-Mixer). In some embodiments, the two inlets (e.g., the lipid inlet and the buffer) meets at a joint that further connects the LNP outlet. In some embodiments, the stream of the lipid solution and the stream of the aqueous buffer solution meet at the joint between the lipid inlet, the buffer inlet, and the LNP outlet.

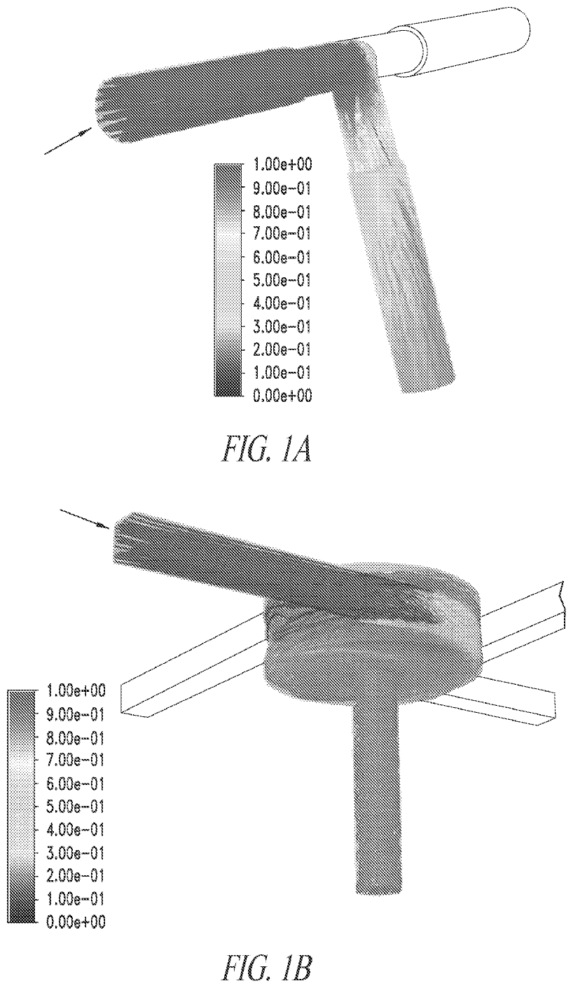

In some embodiments, the T-mixer is substantially the same as the mixers described in in FIG. 1A.

### V-Mixer

The term “Vortex Mixer” or “V-Mixer”, as used herein, refers to a mixing device that is configured to have the lipid solution and the aqueous solution tangentially introduced into a cylindrical mixing chamber. In some embodiments, the V-Mixer comprises two inlets (e.g., two, three, or four inlets) and an LNP outlet. In some embodiments, the V-Mixer comprises a lipid inlet (e.g., one or two lipid inlets), a buffer inlet (e.g., one or two buffer inlets), and an LNP outlet.

In some embodiments, the mixing chamber (e.g., a cylindrical chamber) that connects the inlets and the outlet. In some embodiments, the V-Mixer is configured such that, during mixing, a stream of a transient mixture flows inside the mixing chamber before exiting the mixing chamber vis the LNP outlet. In some embodiments, the mixing is substantially complete before the stream of the transient mixture exits the mixing chamber.

In some embodiments, the V-Mixer is substantially the same as the mixer described in FIG. 1B.

### Cross Mixer

The term “Cross Mixer” or “C-mixer,” as used herein, refers to a mixing device that is configured such that multiple inlets converge upon a central region and exit the central region at an outlet, wherein at least one of the inlets (the “in-line inlet(s)”) is substantially in-line and/or parallel with the outlet. In some embodiments, at least one of the inlets can form an angle with the outlet (“in-line angle”) of less than about 20°, less than about 15°, less than about 10°, less than about 5°, or about 0°. As used herein, the in-line angle is an angle formed between at least one of the inlets and an imaginary line extending from the outlet. In some embodiments, the in-line angle is about 20°, about 19°, about 18°, about 17°, about 16°, about 15°, about 14°, about 13°, about 12°, about 11°, about 10°, about 9°, about 8°, about 7°, about 6°, about 5°, about 4°, about 3°, about 2°, about 1°, or about 0°.

In some embodiments, a line extending through a center of at least one of the inlets can be separated from a line extending through a center of the outlet by less than about 5 mm, less than about 4 mm, less than about 3 mm, less than about 2 mm, less than about 1 mm, less than about 900 μm, less than about 800 μm, less than about 700 μm, less than about 600 μm, less than about 500 μm, less than about 400 μm, less than about 300 μm, less than about 200 μm, or less than about 100 μm. In some embodiments, the cross mixer can include 2, 3, 4, 5, 6, 7, 8, 9, 10, or at least about 10 inlets. In some embodiments, the inlets can be orthogonal to each other. In some embodiments, the inlets can form angles with each other of about 30°, about 35°, about 40°, about 45°, about 50°, about 55°, about 60°, about 65°, about 70°, about 75°, about 80°, about 85°, about 90°, about 95°, about 100°, about 105°, about 110°, about 115°, about 120°, about 125°, about 130°, about 135°, about 140°, about 145°, or about 150°, inclusive of all values and ranges therebetween.

In some embodiments, the mixing device is configured to have a lipid solution and an aqueous solution tangentially introduced into a cylindrical mixing chamber. In some embodiments, the cross mixer comprises a lipid inlet (e.g., one or two lipid inlets), a buffer inlet (e.g., one or two buffer inlets), and an LNP outlet.

In some embodiments, the cross mixer further comprises a mixing chamber (e.g., a cylindrical chamber) that connects the inlets and the outlet. In some embodiments, the cross mixer is configured such that, during mixing, a stream of a transient mixture flows inside the mixing chamber before exiting the mixing chamber via the LNP outlet. In some embodiments, the mixing is substantially complete before the stream of the transient mixture exits the mixing chamber.

In some embodiments, the stream of the lipid solution enters the mixing chamber via the lipid inlet. In some embodiments, the stream of the lipid solution and the stream of the transient mixture meet at an angle less than about 90° (e.g., less than about 85°, less than about 80°, less than about 75°, less than about 70°, less than about 65°, less than about 60°, less than about 55°, less than about 50°, less than about 45°, less than about 40°, less than about 35°, less than about 30°, less than about 25°, less than about 20°, less than about 15°, or less than about 10°).

In some embodiments, the stream of the aqueous buffer solution enters the mixing chamber via the buffer inlet. In some embodiments, the stream of the aqueous buffer solution and the stream of the transient mixture meet at an angle less than about 90° (e.g., less than about 85°, less than about 80°, less than about 75°, less than about 70°, less than about 65°, less than about 60°, less than about 55°, less than about 50°, less than about 45°, less than about 40°, less than about 35°, less than about 30°, less than about 25°, less than about 20°, less than about 15°, or less than about 10°).

### Processes for Preparing LNPs

In some aspects, the present disclosure provides a method for preparing lipid nanoparticles (LNPs), comprising mixing a lipid solution with an aqueous buffer solution in a C-Mixer, thereby forming a lipid nanoparticle solution (LNP solution) comprising LNPs, wherein:
the lipid solution is fed to an inlet (lipid inlet) of the C-Mixer;
the aqueous buffer solution is fed to an inlet (buffer inlet) of the C-Mixer; and/or the LNP solution exits an outlet (LNP outlet) of the C-Mixer.

In some embodiments, wherein:
the lipid solution is fed to a lipid inlet of the C-Mixer at a lipid inlet back pressure of about 100 psi or less;
the aqueous buffer solution is fed to a buffer inlet of the C-Mixer at a buffer inlet back pressure of about 100 psi or less;
the LNP solution exits the LNP outlet of the C-Mixer at a flow rate of about 50 mL/min or greater; and
the LNPs have an average diameter of about 100 nm or less.

In some embodiments, the lipid inlet is an in-line inlet of the C-Mixer.

In some embodiments, the lipid inlet back pressure of the lipid solution in the C-Mixer is lower as compared to the lipid inlet back pressure of a comparable process using a T-Mixer or a V-Mixer.

In some embodiments, the buffer inlet is an in-line inlet of the C-Mixer.

In some embodiments, the buffer inlet back pressure of the lipid solution in the C-Mixer is lower as compared to the buffer inlet back pressure of a comparable process using a T-Mixer or a V-Mixer.

In some embodiments, the diameter of the C-Mixer is greater than the diameter of a T-Mixer or a V-Mixer used in a comparable process.

In some embodiments, the LNP flow rate of the LNP solution exits the C-Mixer is greater than the LNP flow rate of a comparable process using a T-Mixer or a V-Mixer.

In some embodiments, the average diameter of the LNPs is less than the average diameter of the LNPs being prepared by a comparable process using a T-Mixer or a V-Mixer.

Efficient and fast mixing time can be achieved via high turbulence and collision of water and ethanol streams (i.e., not by diffusion-driven mixing) to quickly reduce the ethanol concentration (i.e., a fast EDT). This aids in achieving high supersaturation of lipid and a fast and uniform nucleation rate.

### Lipid Solution

In some embodiments, the processes comprise providing a lipid solution.

In some embodiments, the lipid solution is substantially free of any nucleic acid (e.g., RNA).

In some embodiments, the lipid solution is free of any nucleic acid (e.g., RNA).

In some embodiments, the lipid solution may comprise an ionizable lipid.

In some embodiments, the lipid solution

In some embodiments, the lipid solution further comprises a structural lipid.

In some embodiments, the lipid solution further comprises a phospholipid.

In some embodiments, the lipid solution further comprises a structural lipid and a phospholipid.

In some embodiments, the lipid solution further comprises a PEG lipid.

In some embodiments, the lipid solution further comprises a structural lipid, a phospholipid, and a PEG lipid.

In some embodiments, the lipid solution further comprises an organic solvent.

In some embodiments, the organic solvent is a C₁-C₆ alcohol.

In some embodiments, the C₁-C₆ alcohol is ethanol.

In some embodiments, the lipid solution may comprise the ionizable lipid at a concentration of greater than about 0.01 mg/mL, 0.05 mg/mL, 0.06 mg/mL, 0.07 mg/mL, 0.08 mg/mL, 0.09 mg/mL, 0.1 mg/mL, 0.15 mg/mL, 0.2 mg/mL, 0.3 mg/mL, 0.4 mg/mL, 0.5 mg/mL, 0.6 mg/mL, 0.7 mg/mL, 0.8 mg/mL, 0.9 mg/mL, or 1.0 mg/mL. In some embodiments, the lipid solution may comprise a ionizable lipid at a concentration ranging from about 0.01-1.0 mg/mL, 0.01-0.9 mg/mL, 0.01-0.8 mg/mL, 0.01-0.7 mg/mL, 0.01-0.6 mg/mL, 0.01-0.5 mg/mL, 0.01-0.4 mg/mL, 0.01-0.3 mg/mL, 0.01-0.2 mg/mL, 0.01-0.1 mg/mL, 0.05-1.0 mg/mL, 0.05-0.9 mg/mL, 0.05-0.8 mg/mL, 0.05-0.7 mg/mL, 0.05-0.6 mg/mL, 0.05-0.5 mg/mL, 0.05-0.4 mg/mL, 0.05-0.3 mg/mL, 0.05-0.2 mg/mL, 0.05-0.1 mg/mL, 0.1-1.0 mg/mL, 0.2-0.9 mg/mL, 0.3-0.8 mg/mL, 0.4-0.7 mg/mL, or 0.5-0.6 mg/mL. In some embodiments, the lipid solution may comprise an ionizable lipid at a concentration up to about 5.0 mg/mL, 4.0 mg/mL, 3.0 mg/mL, 2.0 mg/mL, 1.0 mg/mL, 0.09 mg/mL, 0.08 mg/mL, 0.07 mg/mL, 0.06 mg/mL, or 0.05 mg/mL.

In some embodiments, the lipid solution may comprise an ionizable lipid. In some embodiments, the lipid solution may comprise the ionizable lipid at a concentration of greater than about 0.1 mg/mL, 0.5 mg/mL, 0.6 mg/mL, 0.7 mg/mL, 0.8 mg/mL, 0.9 mg/mL, 1.0 mg/mL, 1.5 mg/mL, 2.0 mg/mL, 3.0 mg/mL, 4.0 mg/mL, 5.0 mg/mL, 6.0 mg/mL, 7.0 mg/mL, 8.0 mg/mL, 9.0 mg/mL, 10 mg/mL, 11 mg/mL, 12 mg/mL, 13 mg/mL, 14 mg/mL, 15 mg/mL, 20 mg/mL, 25 mg/mL or 30 mg/mL. In some embodiments, the lipid solution may comprise a ionizable lipid at a concentration ranging from about 0.1-20.0 mg/mL, 0.1-19 mg/mL, 0.1-18 mg/mL, 0.1-17 mg/mL, 0.1-16 mg/mL, 0.1-15 mg/mL, 0.1-14 mg/mL, 01-13 mg/mL, 0.1-12 mg/mL, 0.1-11 mg/mL, 0.5-10.0 mg/mL, 0.5-9 mg/mL, 0.5-8 mg/mL, 0.5-7 mg/mL, 0.5-6 mg/mL, 0.5-5.0 mg/mL, 0.5-4 mg/mL, 0.5-3 mg/mL, 0.5-2 mg/mL, 0.5-1 mg/mL, 1-20 mg/mL, 1-15 mg/mL, 1-12 mg/mL, 1-10 mg/mL, or 1-8 mg/mL. In some embodiments, the lipid solution may comprise an ionizable lipid at a concentration up to about 30 mg/mL, 25, mg/mL, 20 mg/mL, 18 mg/mL, 16 mg/mL, 15 mg/mL, 14 mg/mL, 12 mg/mL, 10 mg/mL, 8 mg/mL, 6 mg/mL, 5.0 mg/mL, 4.0 mg/mL, 3.0 mg/mL, 2.0 mg/mL, 1.0 mg/mL, 0.09 mg/mL, 0.08 mg/mL, 0.07 mg/mL, 0.06 mg/mL, or 0.05 mg/mL.

In some embodiments, the lipid solution comprises an ionizable lipid in an aqueous buffer and/or organic solution.

In some embodiments, the lipid nanoparticle solution further comprises a buffering agent and/or a salt. Exemplary suitable buffering agents include, but are not limited to, ammonium sulfate, sodium bicarbonate, sodium citrate, sodium acetate, potassium phosphate, sodium phosphate, HEPES, and the like. In some embodiments, the lipid solution comprises a buffering agent at a concentration ranging from about 0.1-100 mM, from about 0.5-90 mM, from about 1.0-80 mM, from about 2-70 mM, from about 3-60 mM, from about 4-50 mM, from about 5-40 mM, from about 6-30 mM, from about 7-20 mM, from about 8-15 mM, from about 9-12 mM. In some embodiments, the lipid solution comprises a buffering agent at a concentration of or greater than about 0.1 mM, 0.5 mM, 1 mM, 2 mM, 4 mM, 6 mM, 8 mM, 10 mM, 15 mM, 20 mM, 25 mM, 30 mM, 35 mM, 40 mM, 45 mM, or 50 mM.

Exemplary suitable salts include, but are not limited to, potassium chloride, magnesium chloride, sodium chloride, and the like.

In some embodiments, the lipid solution comprises a salt at a concentration ranging from about 1-500 mM, from about 5-400 mM, from about 10-350 mM, from about 15-300 mM, from about 20-250 mM, from about 30-200 mM, from about 40-190 mM, from about 50-180 mM, from about 50-170 mM, from about 50-160 mM, from about 50-150 mM, or from about 50-100 mM. In some embodiments, the lipid nanoparticle solution comprises a salt at a concentration of or greater than about 1 mM, 5 mM, 10 mM, 20 mM, 30 mM, 40 mM, 50 mM, 60 mM, 70 mM, 80 mM, 90 mM, or 100 mM.

In some embodiments, the lipid solution has a pH ranging from about 4.5 to about 7.0, about 4.6 to about 7.0, about 4.8 to about 7.0, about 5.0 to about 7.0, about 5.5 to about 7.0, about 6.0 to about 7.0, about 6.0 to about 6.9, about 6.0 to about 6.8, about 6.0 to about 6.7, about 6.0 to about 6.6, about 6.0 to about 6.5. In some embodiments, a suitable lipid solution may have a pH of or no greater than 4.5, 4.6, 4.7, 4.8, 4.9, 5.0, 5.2, 5.4, 5.6, 5.8, 6.0, 6.1, 6.2, 6.3, 6.4, 6.5, 6.6, 6.7, 6.8, 6.9, and 7.0.

### Lipid Inlet Back Pressure

In some embodiments, the lipid solution is fed to a lipid inlet of the C-Mixer at a lipid inlet back pressure of about 100 psi or less, about 90 psi or less, about 80 psi or less, about 70 psi or less, about 60 psi or less, about 50 psi or less, about 40 psi or less, about 30 psi or less, about 20 psi or less, or about 10 psi or less.

In some embodiments, the lipid solution is fed to the lipid inlet of the C-Mixer at a lipid inlet back pressure of about 10 psi or greater, about 11 psi or greater, about 12 psi or greater, about 13 psi or greater, about 14 psi or greater, about 15 psi or greater, about 16 psi or greater, about 17 psi or greater, about 18 psi or greater, about 19 psi or greater, about 20 psi or greater, about 21 psi or greater, about 22 psi or greater, about 23 psi or greater, about 24 psi or greater, about 25 psi or greater, about 26 psi or greater, about 27 psi or greater, about 28 psi or greater, about 29 psi or greater, about 30 psi or greater, about 32 psi or greater, about 34 psi or greater, about 36 psi or greater, about 38 psi or greater, about 40 psi or greater, about 42 psi or greater, about 44 psi or greater, about 46 psi or greater, about 48 psi or greater, about 50 psi or greater, about 52 psi or greater, about 54 psi or greater, about 56 psi or greater, or about 58 psi or greater.

In some embodiments, the lipid solution is fed to the lipid inlet of the C-Mixer at a lipid inlet back pressure of about 10 psi or less, about 11 psi or less, about 12 psi or less, about 13 psi or less, about 14 psi or less, about 15 psi or less, about 16 psi or less, about 17 psi or less, about 18 psi or less, about 19 psi or less, about 20 psi or less, about 21 psi or less, about 22 psi or less, about 23 psi or less, about 24 psi or less, about 25 psi or less, about 26 psi or less, about 27 psi or less, about 28 psi or less, about 29 psi or less, about 30 psi or less, about 32 psi or less, about 34 psi or less, about 36 psi or less, about 38 psi or less, about 40 psi or less, about 42 psi or less, about 44 psi or less, about 46 psi or less, about 48 psi or less, about 50 psi or less, about 52 psi or less, about 54 psi or less, about 56 psi or less, about 58 psi or less, or about 60 psi or less.

Combinations of the above-recited ranges for the lipid inlet back pressure are also contemplated (e.g., about 15 psi to about 50 psi, about 15 psi to about 55 psi, about 15 psi to about 60 psi, about 10 psi to about 60 psi, about 15 psi to about 60 psi, or about 20 psi to about 60 psi.)

In some embodiments, the lipid solution is fed to the lipid inlet of the C-Mixer at a lipid inlet back pressure of about 10 psi, about 11 psi, about 12 psi, about 13 psi, about 14 psi, about 15 psi, about 16 psi, about 17 psi, about 18 psi, about 19 psi, about 20 psi, about 21 psi, about 22 psi, about 23 psi, about 24 psi, about 25 psi, about 26 psi, about 27 psi, about 28 psi, about 29 psi, about 30 psi, about 32 psi, about 34 psi, about 36 psi, about 38 psi, about 40 psi, about 42 psi, about 44 psi, about 46 psi, about 48 psi, about 50 psi, about 52 psi, about 54 psi, about 56 psi, or about 58 psi, or about 60 psi.

### Aqueous Buffer Solution

In some embodiments, the aqueous buffer solution comprises a buffering agent.

In some embodiments, the aqueous buffer solution is substantially free of any nucleic acid (e.g., RNA).

In some embodiments, the aqueous buffer solution is free of any nucleic acid (e.g., RNA).

In some embodiments, a suitable solution may further comprise one or more buffering agent and/or a salt. Exemplary suitable buffering agents include, but are not limited to, ammonium sulfate, sodium bicarbonate, sodium citrate, sodium acetate, potassium phosphate, sodium phosphate, HEPES, and the like.

In some embodiments, the aqueous buffer solution comprises a buffering agent at a concentration ranging from about 0.1-100 mM, from about 0.5-90 mM, from about 1.0-80 mM, from about 2-70 mM, from about 3-60 mM, from about 4-50 mM, from about 5-40 mM, from about 6-30 mM, from about 7-20 mM, from about 8-15 mM, from about 9-12 mM.

In some embodiments, the aqueous buffer solution comprises a buffering agent at a concentration of or greater than about 0.1 mM, 0.5 mM, 1 mM, 2 mM, 4 mM, 6 mM, 8 mM, 10 mM, 15 mM, 20 mM, 25 mM, 30 mM, 35 mM, 40 mM, 45 mM, or 50 mM. Exemplary suitable salts include, but are not limited to, potassium chloride, magnesium chloride, sodium chloride, and the like. In some embodiments, the aqueous buffer solution comprises a salt at a concentration ranging from about 1-500 mM, from about 5-400 mM, from about 10-350 mM, from about 15-300 mM, from about 20-250 mM, from about 30-200 mM, from about 40-190 mM, from about 50-180 mM, from about 50-170 mM, from about 50-160 mM, from about 50-150 mM, or from about 50-100 mM.

In some embodiments, the nucleic acid solution comprises a salt at a concentration of or greater than about 1 mM, 5 mM, 10 mM, 20 mM, 30 mM, 40 mM, 50 mM, 60 mM, 70 mM, 80 mM, 90 mM, or 100 mM.

In some embodiments, the aqueous buffer solution has a pH ranging from about 4.5 to about 7.0, about 4.6 to about 7.0, about 4.8 to about 7.0, about 5.0 to about 7.0, about 5.5 to about 7.0, about 6.0 to about 7.0, about 6.0 to about 6.9, about 6.0 to about 6.8, about 6.0 to about 6.7, about 6.0 to about 6.6, about 6.0 to about 6.5. In some embodiments, a suitable aqueous buffer solution may have a pH of or no greater than 4.5, 4.6, 4.7, 4.8, 4.9, 5.0, 5.2, 5.4, 5.6, 5.8, 6.0, 6.1, 6.2, 6.3, 6.4, 6.5, 6.6, 6.7, 6.8, 6.9, and 7.0.

### Buffer Inlet Back Pressure

In some embodiments, the aqueous buffer solution is fed to a buffer inlet of the C-Mixer at a buffer inlet back pressure of about 100 psi or less, about 90 psi or less, about 80 psi or less, about 70 psi or less, about 60 psi or less, about 50 psi or less, about 40 psi or less, about 30 psi or less, about 20 psi or less, or about 10 psi or less.

In some embodiments, the aqueous buffer solution is fed to an buffer inlet of the C-Mixer at a buffer inlet back pressure of about 10 psi or greater, about 11 psi or greater, about 12 psi or greater, about 13 psi or greater, about 14 psi or greater, about 15 psi or greater, about 16 psi or greater, about 17 psi or greater, about 18 psi or greater, about 19 psi or greater, about 20 psi or greater, about 21 psi or greater, about 22 psi or greater, about 23 psi or greater, about 24 psi or greater, about 25 psi or greater, about 26 psi or greater, about 27 psi or greater, about 28 psi or greater, about 29 psi or greater, about 30 psi or greater, about 32 psi or greater, about 34 psi or greater, about 36 psi or greater, about 38 psi or greater, about 40 psi or greater, about 42 psi or greater, about 44 psi or greater, about 46 psi or greater, about 48 psi or greater, about 50 psi or greater, about 52 psi or greater, about 54 psi or greater, about 56 psi or greater, or about 58 psi or greater.

In some embodiments, the aqueous buffer solution is fed to an buffer inlet of the C-Mixer at a buffer inlet back pressure of about 10 psi or less, about 11 psi or less, about 12 psi or less, about 13 psi or less, about 14 psi or less, about 15 psi or less, about 16 psi or less, about 17 psi or less, about 18 psi or less, about 19 psi or less, about 20 psi or less, about 21 psi or less, about 22 psi or less, about 23 psi or less, about 24 psi or less, about 25 psi or less, about 26 psi or less, about 27 psi or less, about 28 psi or less, about 29 psi or less, about 30 psi or less, about 32 psi or less, about 34 psi or less, about 36 psi or less, about 38 psi or less, about 40 psi or less, about 42 psi or less, about 44 psi or less, about 46 psi or less, about 48 psi or less, about 50 psi or less, about 52 psi or less, about 54 psi or less, about 56 psi or less, about 58 psi or less, or about 60 psi or less.

Combinations of the above-recited ranges for the buffer inlet back pressure are also contemplated (e.g., about 15 psi to about 50 psi, about 15 psi to about 55 psi, about 15 psi to about 60 psi, about 10 psi to about 60 psi, about 15 psi to about 60 psi, or about 20 psi to about 60 psi.)

In some embodiments, the aqueous buffer solution is fed to an buffer inlet of the C-Mixer at a buffer inlet back pressure of about 10 psi, about 11 psi, about 12 psi, about 13 psi, about 14 psi, about 15 psi, about 16 psi, about 17 psi, about 18 psi, about 19 psi, about 20 psi, about 21 psi, about 22 psi, about 23 psi, about 24 psi, about 25 psi, about 26 psi, about 27 psi, about 28 psi, about 29 psi, about 30 psi, about 32 psi, about 34 psi, about 36 psi, about 38 psi, about 40 psi, about 42 psi, about 44 psi, about 46 psi, about 48 psi, about 50 psi, about 52 psi, about 54 psi, about 56 psi, or about 58 psi, or about 60 psi.

### Transient Mixture and Organic Solvent Drop Time

In some embodiments, upon mixing, the lipid solution and the aqueous buffer solution form a transient mixture, wherein the concentration of the organic solvent in the transient mixture reduces over an organic solvent drop time, thereby forming the LNP solution.

In some embodiments, the organic solvent drop time is about 0.5 second or less, about 0.45 second or less, about 0.4 second or less, about 0.35 second or less, about 0.3 second or less, about 0.25 second or less, about 0.2 second or less, about 0.15 second or less, about 0.1 second or less, about 0.09 second or less, about 0.08 second or less, about 0.07 second or less, about 0.06 second or less, about 0.05 second or less, about 0.04 second or less, about 0.03 second or less, about 0.02 second or less, or about 0.01 second or less.

In some embodiments, the organic solvent drop time is about 0.45 second or greater, about 0.4 second or greater, about 0.35 second or greater, about 0.3 second or greater, about 0.25 second or greater, about 0.2 second or greater, about 0.15 second or greater, about 0.1 second or greater, about 0.09 second or greater, about 0.08 second or greater, about 0.07 second or greater, about 0.06 second or greater, about 0.05 second or greater, about 0.04 second or greater, about 0.03 second or greater, about 0.02 second or greater, or about 0.005 second or greater.

Combinations of the above-recited ranges for the LNPs average diameter are also contemplated (e.g., about 0.005 second to about 0.4 second, about 0.005 second to about 0.45 second, about 0.005 second to about 0.5 second, about 0.01 second to about 0.5 second, or about 0.02 second to about 0.5 second)

In some embodiments, the organic solvent drop time is about 0.5 second, about 0.45 second, about 0.4 second, about 0.35 second, about 0.3 second, about 0.25 second, about 0.2 second, about 0.15 second, about 0.1 second, about 0.09 second, about 0.08 second, about 0.07 second, about 0.06 second, about 0.05 second, about 0.04 second, about 0.03 second, about 0.02 second, about 0.01 second, or about 0.005 second.

### Diameter of the Mixer

It is understood that the diameter of a mixer, as used herein, refers to the diameter of the outlet of the mixer.

In some embodiments, the C-Mixer has a diameter of about 0.1 mm. In some embodiments, the C-Mixer has a diameter of about 0.3 mm. In some embodiments, the C-Mixer has a diameter of about 0.5 mm. In some embodiments, the C-Mixer has a diameter of about 0.7 mm. In some embodiments, the C-Mixer has a diameter of about 1 mm. In some embodiments, the C-Mixer has a diameter of about 1.5 mm. In some embodiments, the C-Mixer has a diameter of about 2 mm. In some embodiments, the C-Mixer has a diameter of about 2.5 mm. In some embodiments, the C-Mixer has a diameter of about 3 mm. In some embodiments, the C-Mixer has a diameter of about 3.5 mm. In some embodiments, the C-Mixer has a diameter of about 4 mm. In some embodiments, the C-Mixer has a diameter of about 4.5 mm. In some embodiments, the C-Mixer has a diameter of about 5 mm. In some embodiments, the C-Mixer has a diameter of about 6 mm. In some embodiments, the C-Mixer has a diameter of about 7 mm. In some embodiments, the C-Mixer has a diameter of about 8 mm. In some embodiments, the C-Mixer has a diameter of about 9 mm. In some embodiments, the C-Mixer has a diameter of about 10 mm.

### LNP Solution and Flow Rate

In some embodiments, the LNP solution is substantially free of any nucleic acid (e.g., RNA).

In some embodiments, the LNP solution is free of any nucleic acid (e.g., RNA).

In some embodiments, the LNP solution exits the LNP outlet of the C-Mixer at a flow rate of about 50 mL/min or greater, about 550 mL/min or greater, about 60 mL/min or greater, about 650 mL/min or greater, about 70 mL/min or greater, about 750 mL/min or greater, about 80 mL/min or greater, about 850 mL/min or greater, about 90 mL/min or greater, about 950 mL/min or greater, about 100 mL/min or greater, about 110 mL/min or greater, about 120 mL/min or greater, about 130 mL/min or greater, about 140 mL/min or greater, about 150 mL/min or greater, about 200 mL/min or greater, about 250 mL/min or greater, about 300 mL/min or greater, about 350 mL/min or greater, about 400 mL/min or greater, about 450 mL/min or greater, about 950 mL/min or greater, or about 500 mL/min or greater.

In some embodiments, the LNP solution exits the LNP outlet of the C-Mixer at a flow rate of about 500 mL/min or greater, about 550 mL/min or greater, about 600 mL/min or greater, about 650 mL/min or greater, about 700 mL/min or greater, about 750 mL/min or greater, about 800 mL/min or greater, about 850 mL/min or greater, about 900 mL/min or greater, about 950 mL/min or greater, about 1000 mL/min or greater, about 1100 mL/min or greater, about 1200 mL/min or greater, about 1300 mL/min or greater, about 1400 mL/min or greater, about 1500 mL/min or greater, about 2000 mL/min or greater, about 2500 mL/min or greater, about 3000 mL/min or greater, about 3500 mL/min or greater, about 4000 mL/min or greater, about 4500 mL/min or greater, about 950 mL/min or greater, or about 5000 mL/min or greater.

In some embodiments, the LNP solution exits the LNP outlet of the C-Mixer at a flow rate of about 5000 mL/min or less, about 4500 mL/min or less, about 4000 mL/min or less, about 3500 mL/min or less, about 3000 mL/min or less, about 2500 mL/min or less, about 2000 mL/min or less, about 1500 mL/min or less, about 1400 mL/min or less, about 1300 mL/min or less, about 1200 mL/min or less, about 1100 mL/min or less, about 1000 mL/min or less, about 950 mL/min or less, about 900 mL/min or less, about 850 mL/min or less, about 800 mL/min or less, about 750 mL/min or less, about 700 mL/min or less, about 650 mL/min or less, about 600 mL/min or less, or about 550 mL/min or less.

Combinations of the above-recited ranges for the flow rate are also contemplated (e.g., about 500 mL/min to about 900 mL/min, 500 mL/min to about 950 mL/min, 500 mL/min to about 1000 mL/min, 550 mL/min to about 1000 mL/min, 600 mL/min to about 1000 mL/min, or 650 mL/min to about 1000 mL/min.)

In some embodiments, the LNP solution exits the LNP outlet of the C-Mixer at a flow rate of about 500 mL/min, about 520 mL/min, about 540 mL/min, about 560 mL/min, about 580 mL/min, about 600 mL/min, about 620 mL/min, about 640 mL/min, about 660 mL/min, about 680 mL/min, about 700 mL/min, about 720 mL/min, about 740 mL/min, about 760 mL/min, about 780 mL/min, about 800 mL/min, about 820 mL/min, about 840 mL/min, about 860 mL/min, about 880 mL/min, about 900 mL/min, about 920 mL/min, about 940 mL/min, about 960 mL/min, about 980 mL/min, about 1000 mL/min, about 1100 mL/min, about 1200 mL/min, about 1300 mL/min, about 1400 mL/min, about 1500 mL/min, about 2000 mL/min, about 2500 mL/min, about 3000 mL/min, about 3500 mL/min, about 4000 mL/min, about 4500 mL/min, or about 5000 mL/min.

### Mixer Shapes

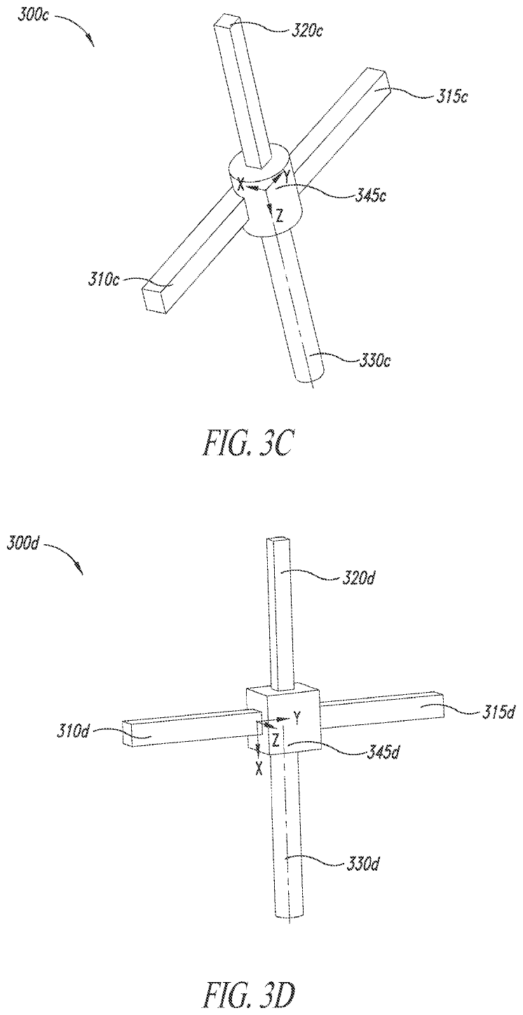

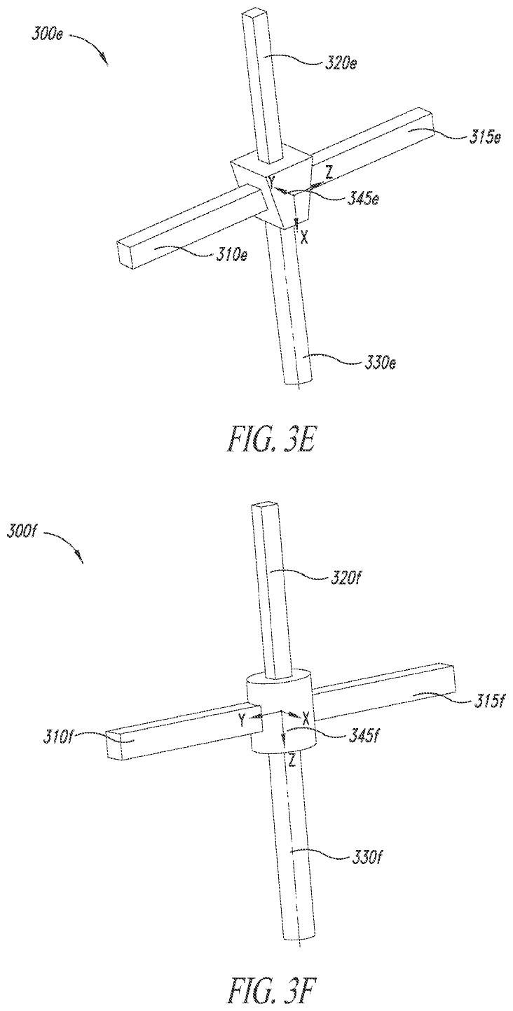

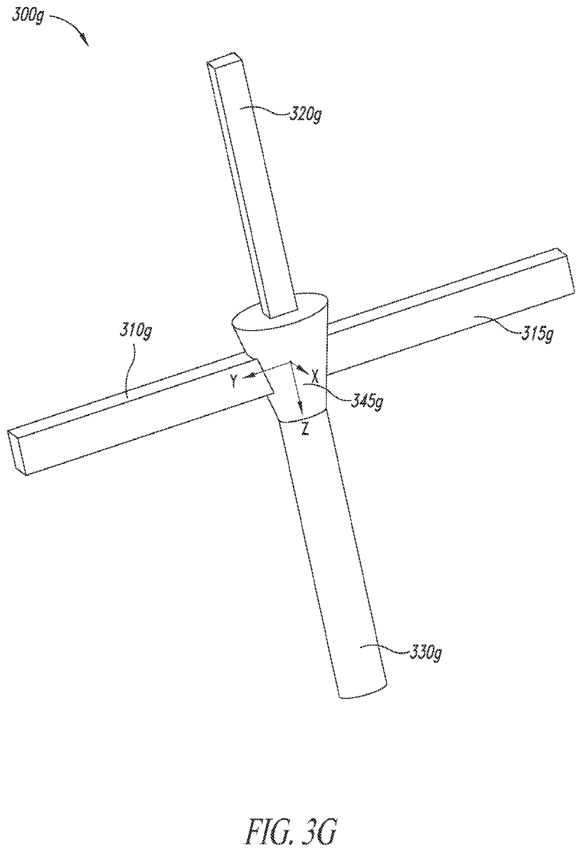

Cross mixers can have many different form factors, each of which can lead to different mixing properties and efficiencies. FIG. 3A is an illustration of a cross mixer 300a with no convergence chamber, according to an embodiment. As shown, the cross mixer 300a includes a first inlet 310a and a second inlet 315a configured to receive a solution, and a third inlet 320a configured to receive an LNP-containing fluid. The cross mixer 300a further includes an outlet 330a and a central region 340a fluidically coupled to the first inlet 310a, the second inlet 315a, the third inlet 320a, and the outlet 330a. As shown, the central region 340a does not include an enlarged portion or a mixing chamber, but rather retains the dimensions of the first inlet 310a, the second inlet 315a, and the third inlet 320a. The lack of a mixing chamber can aid in efficiently mixing the LNPs. In some embodiments, the LNPs can be eLNPs.

As shown, the first inlet 310a, the second inlet 315a, and the third inlet 320a have square cross sections, while the outlet 330a has a circular cross section. In some embodiments, the first inlet 310a, the second inlet 315a, the third inlet 320a, and/or the outlet 330a can have square cross sections, rectangular cross sections, circular cross sections, elliptical cross sections, or any combination thereof (i.e., mix and match cross sectional shapes).

In some embodiments, the cross sections of the first inlet 310a, the second inlet 315a, the third inlet 320a, and the outlet 330a can have cross-sectional dimensions (e.g., a diameter for a circular cross section, a side length for a square/rectangle cross section, or a major/minor axis of an elliptical cross section) of at least about 0.5 mm, at least about 0.6 mm, at least about 0.7 mm, at least about 0.8 mm, at least about 0.9 mm, at least about 1 mm, at least about 1.1 mm, at least about 1.2 mm, at least about 1.3 mm, at least about 1.4 mm, at least about 1.5 mm, at least about 1.6 mm, at least about 1.7 mm, at least about 1.8 mm, at least about 1.9 mm, at least about 2 mm, at least about 2.1 mm, at least about 2.2 mm, at least about 2.3 mm, at least about 2.4 mm, at least about 2.5 mm, at least about 2.6 mm, at least about 2.7 mm, at least about 2.8 mm, at least about 2.9 mm, at least about 3 mm, at least about 3.1 mm, at least about 3.2 mm, at least about 3.3 mm, at least about 3.4 mm, at least about 3.5 mm, at least about 3.6 mm, at least about 3.7 mm, at least about 3.8 mm, at least about 3.9 mm, at least about 4 mm, at least about 4.1 mm, at least about 4.2 mm, at least about 4.3 mm, at least about 4.4 mm, at least about 4.5 mm, at least about 4.6 mm, at least about 4.7 mm, at least about 4.8 mm, or at least about 4.9 mm. In some embodiments, the cross sections of the first inlet 310a, the second inlet 315a, the third inlet 320a, and the outlet 330a can have cross-sectional dimensions of no more than about 5 mm, no more than about 4.9 mm, no more than about 4.8 mm, no more than about 4.7 mm, no more than about 4.6 mm, no more than about 4.5 mm, no more than about 4.4 mm, no more than about 4.3 mm, no more than about 4.2 mm, no more than about 4.1 mm, no more than about 4 mm, no more than about 3.9 mm, no more than about 3.8 mm, no more than about 3.7 mm, no more than about 3.6 mm, no more than about 3.5 mm, no more than about 3.4 mm, no more than about 3.3 mm, no more than about 3.2 mm, no more than about 3.1 mm, no more than about 3 mm, no more than about 2.9 mm, no more than about 2.8 mm, no more than about 2.7 mm, no more than about 2.6 mm, no more than about 2.5 mm, no more than about 2.4 mm, no more than about 2.3 mm, no more than about 2.2 mm, no more than about 2.1 mm, no more than about 2 mm, no more than about 1.9 mm, no more than about 1.8 mm, no more than about 1.7 mm, no more than about 1.6 mm, no more than about 1.5 mm, no more than about 1.4 mm, no more than about 1.3 mm, no more than about 1.2 mm, no more than about 1.1 mm, no more than about 1 mm, no more than about 0.9 mm, no more than about 0.8 mm, no more than about 0.7 mm, or no more than about 0.6 mm.

Without a convergence chamber, the central region 340a has similar dimensions to the first inlet 310a, the second inlet 315a, and the third inlet 320a. In other words, if the central region 340a is considered to be a cubic portion in the center of the cross mixer 300a, the central region 340a has a first and second dimension similar to a first and second dimension of the cross section of the third inlet 320a, and a third dimension similar to a dimension of the cross section of the first inlet 310a and/or the second inlet 315a. As shown, the first inlet 310a, the second inlet 315a, and the third inlet 320a are the same size. In some embodiments, the first inlet 310a, the second inlet 315a, and the third inlet 320a can have varying sizes.

Combinations of the above-referenced cross-sectional dimensions are also possible (e.g., at least about 0.5 mm and no more than about 5 mm or at least about 2 mm and no more than about 4 mm), inclusive of all values and ranges therebetween. In some embodiments, the cross sections of the first inlet 310a, the second inlet 315a, the third inlet 320a, and the outlet 330a can have cross-sectional dimensions of about 0.5 mm, about 0.6 mm, about 0.7 mm, about 0.8 mm, about 0.9 mm, about 1 mm, about 1.1 mm, about 1.2 mm, about 1.3 mm, about 1.4 mm, about 1.5 mm, about 1.6 mm, about 1.7 mm, about 1.8 mm, about 1.9 mm, about 2 mm, about 2.1 mm, about 2.2 mm, about 2.3 mm, about 2.4 mm, about 2.5 mm, about 2.6 mm, about 2.7 mm, about 2.8 mm, about 2.9 mm, about 3 mm, about 3.1 mm, about 3.2 mm, about 3.3 mm, about 3.4 mm, about 3.5 mm, about 3.6 mm, about 3.7 mm, about 3.8 mm, about 3.9 mm, about 4 mm, about 4.1 mm, about 4.2 mm, about 4.3 mm, about 4.4 mm, about 4.5 mm, about 4.6 mm, about 4.7 mm, about 4.8 mm, about 4.9 mm, or about 5 mm.

As shown, the first inlet 310a forms an angle of about 90° with the third inlet 320a, the third inlet 320a forms an angle of about 90° with the second inlet 315a, and the second inlet 315a forms an angle of about 90° with the outlet 320a. In some embodiments, the first inlet 310a can form an angle with the third inlet 320a of at least about 30°, at least about 35°, at least about 40°, at least about 45°, at least about 50°, at least about 55°, at least about 60°, at least about 65°, at least about 70°, at least about 75°, at least about 80°, at least about 85°, at least about 90°, at least about 95°, at least about 100°, at least about 105°, at least about 110°, at least about 115°, at least about 120°, at least about 125°, at least about 130°, at least about 135°, at least about 140°, or at least about 145°. In some embodiments, the first inlet 310a can form an angle with the third inlet 320a of no more than about 150°, no more than about 145°, no more than about 140°, no more than about 135°, no more than about 130°, no more than about 125°, no more than about 120°, no more than about 115°, no more than about 110°, no more than about 105°, no more than about 100°, no more than about 95°, no more than about 90°, no more than about 85°, no more than about 80°, no more than about 75°, no more than about 70°, no more than about 65°, no more than about 60°, no more than about 55°, no more than about 50°, no more than about 45°, no more than about 40°, or no more than about 35°. Combinations of the above-referenced angles between the first inlet 310a and the third inlet 320a are also possible (e.g., at least about 30° and no more than about 150° or at least about 80° and no more than about 120°), inclusive of all values and ranges therebetween. In some embodiments, the first inlet 310a can form an angle with the third inlet 320a of about 30°, about 35°, about 40°, about 45°, about 50°, about 55°, about 60°, about 65°, about 70°, about 75°, about 80°, about 85°, about 90°, about 95°, about 100°, about 105°, about 110°, about 115°, about 120°, about 125°, about 130°, about 135°, about 140°, about 145°, or about 150°.

In some embodiments, the third inlet 320a can form an angle with the second inlet 315a of at least about 30°, at least about 35°, at least about 40°, at least about 45°, at least about 50°, at least about 55°, at least about 60°, at least about 65°, at least about 70°, at least about 75°, at least about 80°, at least about 85°, at least about 90°, at least about 95°, at least about 100°, at least about 105°, at least about 110°, at least about 115°, at least about 120°, at least about 125°, at least about 130°, at least about 135°, at least about 140°, or at least about 145°. In some embodiments, the third inlet 320a can form an angle with the second inlet 315a of no more than about 150°, no more than about 145°, no more than about 140°, no more than about 135°, no more than about 130°, no more than about 125°, no more than about 120°, no more than about 115°, no more than about 110°, no more than about 105°, no more than about 100°, no more than about 95°, no more than about 90°, no more than about 85°, no more than about 80°, no more than about 75°, no more than about 70°, no more than about 65°, no more than about 60°, no more than about 55°, no more than about 50°, no more than about 45°, no more than about 40°, or no more than about 35°. Combinations of the above-referenced angles between the third inlet 320a and the second inlet 315a are also possible (e.g., at least about 30° and no more than about 150° or at least about 80° and no more than about 120°), inclusive of all values and ranges therebetween. In some embodiments, the third inlet 320a can form an angle with the second inlet 315a of about 30°, about 35°, about 40°, about 45°, about 50°, about 55°, about 60°, about 65°, about 70°, about 75°, about 80°, about 85°, about 90°, about 95°, about 100°, about 105°, about 110°, about 115°, about 120°, about 125°, about 130°, about 135°, about 140°, about 145°, or about 150°.

In some embodiments, the second inlet 315a can form an angle with the outlet 330a of at least about 30°, at least about 35°, at least about 40°, at least about 45°, at least about 50°, at least about 55°, at least about 60°, at least about 65°, at least about 70°, at least about 75°, at least about 80°, at least about 85°, at least about 90°, at least about 95°, at least about 100°, at least about 105°, at least about 110°, at least about 115°, at least about 120°, at least about 125°, at least about 130°, at least about 135°, at least about 140°, or at least about 145°. In some embodiments, the second inlet 315a can form an angle with the outlet 330a of no more than about 150°, no more than about 145°, no more than about 140°, no more than about 135°, no more than about 130°, no more than about 125°, no more than about 120°, no more than about 115°, no more than about 110°, no more than about 105°, no more than about 100°, no more than about 95°, no more than about 90°, no more than about 85°, no more than about 80°, no more than about 75°, no more than about 70°, no more than about 65°, no more than about 60°, no more than about 55°, no more than about 50°, no more than about 45°, no more than about 40°, or no more than about 35°. Combinations of the above-referenced angles between the second inlet 315a and the outlet 330a are also possible (e.g., at least about 30° and no more than about 150° or at least about 80° and no more than about 120°), inclusive of all values and ranges therebetween. In some embodiments, the second inlet 315a can form an angle with the outlet 330a of about 30°, about 35°, about 40°, about 45°, about 50°, about 55°, about 60°, about 65°, about 70°, about 75°, about 80°, about 85°, about 90°, about 95°, about 100°, about 105°, about 110°, about 115°, about 120°, about 125°, about 130°, about 135°, about 140°, about 145°, or about 150°.

In some embodiments, the outlet 330a can form an angle with the first inlet 310a of at least about 30°, at least about 35°, at least about 40°, at least about 45°, at least about 50°, at least about 55°, at least about 60°, at least about 65°, at least about 70°, at least about 75°, at least about 80°, at least about 85°, at least about 90°, at least about 95°, at least about 100°, at least about 105°, at least about 110°, at least about 115°, at least about 120°, at least about 125°, at least about 130°, at least about 135°, at least about 140°, or at least about 145°. In some embodiments, the outlet 330a can form an angle with the first inlet 310a of no more than about 150°, no more than about 145°, no more than about 140°, no more than about 135°, no more than about 130°, no more than about 125°, no more than about 120°, no more than about 115°, no more than about 110°, no more than about 105°, no more than about 100°, no more than about 95°, no more than about 90°, no more than about 85°, no more than about 80°, no more than about 75°, no more than about 70°, no more than about 65°, no more than about 60°, no more than about 55°, no more than about 50°, no more than about 45°, no more than about 40°, or no more than about 35°. Combinations of the above-referenced angles between the outlet 330a and the first inlet 310a are also possible (e.g., at least about 30° and no more than about 150° or at least about 80° and no more than about 120°), inclusive of all values and ranges therebetween. In some embodiments, the outlet 330a can form an angle with the first inlet 310a of about 30°, about 35°, about 40°, about 45°, about 50°, about 55°, about 60°, about 65°, about 70°, about 75°, about 80°, about 85°, about 90°, about 95°, about 100°, about 105°, about 110°, about 115°, about 120°, about 125°, about 130°, about 135°, about 140°, about 145°, or about 150°.

As shown, the first inlet 310a, the second inlet 315a, the third inlet 320a, and the outlet 330a are all in-plane. In other words, the first inlet 310a, the second inlet 315a, the third inlet 320a, and the outlet 330a are oriented in the same plane. In some embodiments, one or more of the first inlet 310a, the second inlet 315a, the third inlet 320a, or the outlet 330a can be angled out of plane with the rest of the fluidic pathways. In some embodiments, the first inlet 310a, the second inlet 315a, the third inlet 320a, and/or the outlet 330a can be out-of-plane by about 5°, about 10°, about 15°, about 20°, about 25°, about 30°, about 35°, about 40°, about 45°, about 50°, about 55°, or about 60°, inclusive of all values and ranges therebetween.

In use, a first fluid is fed to the first inlet 310a and/or the second inlet 315a. In some embodiments, the first fluid can include water. In some embodiments, the first fluid can include ethanol. In some embodiments, the first fluid can include an aqueous buffer solution.

A second fluid is fed to the third inlet 320a. In some embodiments, the second fluid can include at least about 90%, at least about 91%, at least about 92%, at least about 93%, at least about 94%, at least about 95%, at least about 96%, at least about 97%, at least about 98%, at least about 99%, at least about 99.1%, at least about 99.2%, at least about 99.3%, at least about 99.4%, at least about 99.5%, at least about 99.6%, at least about 99.7%, at least about 99.8%, at least about 99.9%, at least about 99.91%, at least about 99.92%, at least about 99.93%, at least about 99.94%, at least about 99.95%, at least about 99.96%, at least about 99.97%, at least about 99.98%, or at least about 99.99% by weight of ethanol, inclusive of all values and ranges therebetween. In some embodiments, the second fluid can include LSS. In some embodiments, the second fluid can include LNPs. In some embodiments, the second fluid can include eLNPs. The first fluid and the second fluid form a resultant mixture and a precipitate forms upon mixing in the central region 340a. In some embodiments, the precipitation can occur at a sufficient rate, such that the ethanol concentration in the first fluid reduces from its initial concentration to less than about 30 wt % (i.e., the EDT) less than about 0.15 seconds after contacting the second fluid. In some embodiments, the EDT can be defined as the time between the initial contact between the first fluid and the second fluid and when the resultant mixture has an ethanol content of less than about 95 wt %, less than about 90 wt %, less than about 85 wt %, less than about 80 wt %, less than about 75 wt %, less than about 70 wt %, less than about 65 wt %, less than about 60 wt %, less than about 55 wt %, less than about 50 wt %, less than about 45 wt %, less than about 40 wt %, less than about 35 wt %, less than about 30 wt %, less than about 25 wt %, or less than about 20 wt %. Preferably, the EDT can be defined as the time between the initial contact between the first fluid and the second fluid and when the resultant mixture has an ethanol content of less than about 30 wt %. In some embodiments, the EDT can be less than about 0.15 seconds, less than about 0.14 seconds, less than about 0.13 seconds, less than about 0.12 seconds, less than about 0.11 seconds, less than about 0.1 seconds, less than about 0.09 seconds, less than about 0.08 seconds, less than about 0.07 seconds, less than about 0.06 seconds, less than about 0.05 seconds, less than about 0.04 seconds, less than about 0.03 seconds, less than about 0.02 seconds, less than about 0.01 seconds, less than about 0.009 seconds, less than about 0.008 seconds, less than about 0.007 seconds, less than about 0.006 seconds, less than about 0.005 seconds, less than about 0.004 seconds, less than about 0.003 seconds, less than about 0.002 seconds, or less than about 0.001 seconds, inclusive of all values and ranges therebetween. A low EDT can lead to faster achievement of high supersaturation, a larger nucleation rate, and nanoprecipitation. A higher nucleation rate favors smaller and more nucleation sites over aggregation and growth.

In some embodiments, a third fluid can be fed to the first inlet 310a and/or the second inlet 315a. In some embodiments, the third fluid can be the same or substantially similar to the first fluid. In other words, the first fluid can be fed into the first inlet 310a and the second inlet 315a. In some embodiments, the third fluid can include water. In some embodiments, the third fluid can include an aqueous buffer solution. In some embodiments, the third fluid can include at least about 90%, at least about 91%, at least about 92%, at least about 93%, at least about 94%, at least about 95%, at least about 96%, at least about 97%, at least about 98%, at least about 99%, at least about 99.1%, at least about 99.2%, at least about 99.3%, at least about 99.4%, at least about 99.5%, at least about 99.6%, at least about 99.7%, at least about 99.8%, at least about 99.9%, at least about 99.91%, at least about 99.92%, at least about 99.93%, at least about 99.94%, at least about 99.95%, at least about 99.96%, at least about 99.97%, at least about 99.98%, or at least about 99.99% by weight of water, inclusive of all values and ranges therebetween. In some embodiments, the first fluid can be fed at a pressure of about 10 kPa (gauge), about 15 kPa, about 20 kPa, about 25 kPa, about 30 kPa, about 35 kPa, about 40 kPa, about 45 kPa, or about 50 kPa, inclusive of all values and ranges therebetween. In some embodiments, the third fluid can be fed at a pressure of about 5 kPa, about 10 kPa, about 15 kPa, about 20 kPa, about 25 kPa, about 30 kPa, about 35 kPa, about 40 kPa, or about 45 kPa, inclusive of all values and ranges therebetween.

As used herein, “fluid” (e.g., the first fluid, the second fluid, the third fluid) can refer to a single-component liquid (e.g., pure water, pure ethanol, etc.), a mixture, a solution, a suspension, a colloid, a single-component gas, a gas mixture, a liquid with gas dissolved therein, or any combination thereof.

FIG. 3B is an illustration of a cross mixer 300b with no convergence chamber and angled inlets, according to an embodiment. As shown, the cross mixer 300b includes a first inlet 310b and a second inlet 315b configured to receive a solution, and a third inlet 320b configured to receive an LNP-containing fluid. The cross mixer 300b further includes an outlet 330b and a central region 340b fluidically coupled to the first inlet 310b, the second inlet 315b, the third inlet 320b, and the outlet 330b. As shown, the central region 340a does not include an enlarged portion or a mixing chamber, but rather retains the dimensions of the first inlet 310b, the second inlet 315b, and the third inlet 320b. In some embodiments, the first inlet 310b, the second inlet 315b, the third inlet 320b, the outlet 330b, and the central region 340b can be the same or substantially similar to the first inlet 310a, the second inlet 315a, the third inlet 320a, the outlet 330a, and the central region 340a, as described above with reference to FIG. 3A. Thus, certain aspects of the first inlet 310b, the second inlet 315b, the third inlet 320b, the outlet 330b, and the central region 340b are not described in greater detail herein.

The first inlet 310b and the second inlet 315b are at non-perpendicular angles, compared to the third inlet 320b and the outlet 330b. In some embodiments, this non-perpendicular orientation of the first inlet 310b and the second inlet 315b can aid in generating turbulence in the central region 340b. The turbulence can facilitate mixing. As shown, the first inlet 310b and the second inlet 315b each form an angle of about 30° with respect to the outlet 330b and an angle of about 150° with respect to the third inlet 320b. This can increase the collision angle between water inlets and the ethanol inlet. In some embodiments, the first inlet 310b, the second inlet 315b, the third inlet 320b, and the outlet 330b can form any of the angles described above for the first inlet 310a, the second inlet 315a, the third inlet 320a, and the outlet 330a, as described above with reference to FIG. 3A.

FIG. 3C is an illustration of a cross mixer 300c with a cylindrical convergence chamber, according to an embodiment. As shown, the cross mixer 300c includes a first inlet 310c and a second inlet 315c configured to receive a solution, and a third inlet 320c configured to receive an LNP-containing fluid. The cross mixer 300c further includes an outlet 330c and a convergence chamber 345c fluidically coupled to the first inlet 310c, the second inlet 315c, the third inlet 320c, and the outlet 330c. In some embodiments, the first inlet 310c, the second inlet 315c, the third inlet 320c, and the outlet 330c can be the same or substantially similar to the first inlet 310a, the second inlet 315a, the third inlet 320a, and the outlet 330a, as described above with reference to FIG. 3A. Thus, certain aspects of the first inlet 310c, the second inlet 315c, the third inlet 320c, and the outlet 330c are not described in greater detail herein.

The convergence chamber 345c is an enlarged portion of the cross mixer 300c at an intersection point between the first inlet 310c, the second inlet 315c, the third inlet 320c, and the outlet 330c. As shown, the convergence chamber 345c has a cylindrical shape. As shown, the convergence chamber 345c is oriented such that the diameter of the convergence chamber 345c extends in-plane with the first inlet 310c and the second inlet 315c, and the longitudinal length of the convergence chamber 345c is in-plane with the third inlet 320c and the outlet 330c. In some embodiments, the diameter of the convergence chamber 345c can extend in-plane with the third inlet 320c and the outlet 330c. In some embodiments, the longitudinal length of the convergence chamber 345c can be in-plane with the first inlet 310c and the second inlet 315c.

In some embodiments, the convergence chamber 345c can have a diameter of at least about 2 mm, at least about 2.5 mm, at least about 3 mm, at least about 3.5 mm, at least about 4 mm, at least about 4.5 mm, at least about 5 mm, at least about 5.5 mm, at least about 6 mm, at least about 6.5 mm, at least about 7 mm, at least about 7.5 mm, at least about 8 mm, at least about 8.5 mm, at least about 9 mm, or at least about 9.5 mm. In some embodiments, the convergence chamber 345c can have a diameter of no more than about 10 mm, no more than about 9.5 mm, no more than about 9 mm, no more than about 8.5 mm, no more than about 8 mm, no more than about 7.5 mm, no more than about 7 mm, no more than about 6.5 mm, no more than about 6 mm, no more than about 5.5 mm, no more than about 5 mm, no more than about 4.5 mm, no more than about 4 mm, no more than about 3.5 mm, no more than about 3 mm, or no more than about 2.5 mm. Combinations of the above-referenced diameters of the convergence chamber 345c are also possible (e.g., at least about 2 mm and no more than about 10 mm or at least about 3 mm and no more than about 7 mm), inclusive of all values and ranges therebetween. In some embodiments, the convergence chamber 345c can have a diameter of about 2 mm, about 2.5 mm, about 3 mm, about 3.5 mm, about 4 mm, about 4.5 mm, about 5 mm, about 5.5 mm, about 6 mm, about 6.5 mm, about 7 mm, about 7.5 mm, about 8 mm, about 8.5 mm, about 9 mm, about 9.5 mm, or about 10 mm.

In some embodiments, the convergence chamber 345c can have a longitudinal length of at least about 2 mm, at least about 2.5 mm, at least about 3 mm, at least about 3.5 mm, at least about 4 mm, at least about 4.5 mm, at least about 5 mm, at least about 5.5 mm, at least about 6 mm, at least about 6.5 mm, at least about 7 mm, at least about 7.5 mm, at least about 8 mm, at least about 8.5 mm, at least about 9 mm, or at least about 9.5 mm. In some embodiments, the convergence chamber 345c can have a longitudinal length of no more than about 10 mm, no more than about 9.5 mm, no more than about 9 mm, no more than about 8.5 mm, no more than about 8 mm, no more than about 7.5 mm, no more than about 7 mm, no more than about 6.5 mm, no more than about 6 mm, no more than about 5.5 mm, no more than about 5 mm, no more than about 4.5 mm, no more than about 4 mm, no more than about 3.5 mm, no more than about 3 mm, or no more than about 2.5 mm. Combinations of the above-referenced longitudinal lengths of the convergence chamber 345c are also possible (e.g., at least about 2 mm and no more than about 10 mm or at least about 3 mm and no more than about 7 mm), inclusive of all values and ranges therebetween. In some embodiments, the convergence chamber 345c can have a longitudinal length of about 2 mm, about 2.5 mm, about 3 mm, about 3.5 mm, about 4 mm, about 4.5 mm, about 5 mm, about 5.5 mm, about 6 mm, about 6.5 mm, about 7 mm, about 7.5 mm, about 8 mm, about 8.5 mm, about 9 mm, about 9.5 mm, or about 10 mm.

As shown, the first inlet 310c and the second inlet 315c enter the convergence chamber 345c offset from each other. In other words, a line extending through the first inlet 310c would not extend through the second inlet 315c and vice versa. Orienting the first inlet 310c and the second inlet 315c offset from each other can induce turbulence and cyclone formation in the convergence chamber 345c and promote mixing.

In some embodiments, a center line of the first inlet 310c can be offset from a center line of the second inlet 315c by a distance of at least about 100 μm, at least about 200 μm, at least about 300 μm, at least about 400 μm, at least about 500 μm, at least about 600 μm, at least about 700 μm, at least about 800 μm, at least about 900 μm, at least about 1 mm, at least about 1.5 mm, at least about 2 mm, at least about 2.5 mm, at least about 3 mm, at least about 3.5 mm, at least about 4 mm, or at least about 4.5 mm. In some embodiments, the center line from the first inlet 310c can be offset from the center line of the second inlet 315c by no more than about 5 mm, no more than about 4.5 mm, no more than about 4 mm, no more than about 3.5 mm, no more than about 3 mm, no more than about 2.5 mm, no more than about 2 mm, no more than about 1.5 mm, no more than about 1 mm, no more than about 900 μm, no more than about 800 μm, no more than about 700 μm, no more than about 600 μm, no more than about 500 μm, no more than about 400 μm, no more than about 300 μm, or no more than about 200 μm. Combinations of the above-referenced offset distances are also possible (e.g., at least about 100 μm and no more than about 5 mm or at least about 500 μm and no more than about 3 mm), inclusive of all values and ranges therebetween. In some embodiments, the center line of the first inlet 310c can be offset from the center line of the second inlet 315c by a distance of about 100 μm, about 200 μm, about 300 μm, about 400 μm, about 500 μm, about 600 μm, about 700 μm, about 800 μm, about 900 μm, about 1 mm, about 1.5 mm, about 2 mm, about 2.5 mm, about 3 mm, about 3.5 mm, about 4 mm, about 4.5 mm, or about 5 mm.

FIG. 3D is an illustration of a cross mixer 300d with a cubic convergence chamber, according to an embodiment. As shown, the cross mixer 300d includes a first inlet 310d and a second inlet 315d configured to receive a solution, and a third inlet 320d configured to receive an LNP-containing fluid. The cross mixer 300d further includes an outlet 330d and a convergence chamber 345d fluidically coupled to the first inlet 310d, the second inlet 315d, the third inlet 320d, and the outlet 330d. In some embodiments, the first inlet 310d, the second inlet 315d, the third inlet 320d, and the outlet 330d can be the same or substantially similar to the first inlet 310a, the second inlet 315a, the third inlet 320a, and the outlet 330a, as described above with reference to FIG. 3A. Thus, certain aspects of the first inlet 310d, the second inlet 315d, the third inlet 320d, and the outlet 330d are not described in greater detail herein.

As shown, the convergence chamber 345d has a cubic shape. In other words, the convergence chamber 345d has three dimensions of equal or approximately equal length. In some embodiments, the convergence chamber 345d can be a rectangular prism. In some embodiments, the convergence chamber 345d can have two dimensions of a first length and a third dimension of a second length, the second length greater or less than the first length. In some embodiments, the convergence chamber 345d can have a first dimension of a first length, a second dimension of a second length, and a third dimension of a third length, each of the first length, the second length, and the third length being different values.

In some embodiments, either of the dimensions of the convergence chamber 345d can be at least about 2 mm, at least about 2.5 mm, at least about 3 mm, at least about 3.5 mm, at least about 4 mm, at least about 4.5 mm, at least about 5 mm, at least about 5.5 mm, at least about 6 mm, at least about 6.5 mm, at least about 7 mm, at least about 7.5 mm, at least about 8 mm, at least about 8.5 mm, at least about 9 mm, or at least about 9.5 mm. In some embodiments, either of the dimensions of the convergence chamber 345d can be no more than about 10 mm, no more than about 9.5 mm, no more than about 9 mm, no more than about 8.5 mm, no more than about 8 mm, no more than about 7.5 mm, no more than about 7 mm, no more than about 6.5 mm, no more than about 6 mm, no more than about 5.5 mm, no more than about 5 mm, no more than about 4.5 mm, no more than about 4 mm, no more than about 3.5 mm, no more than about 3 mm, or no more than about 2.5 mm. Combinations of the above-referenced dimensional lengths of the convergence chamber 345d are also possible (e.g., at least about 2 mm and no more than about 10 mm or at least about 3 mm and no more than about 7 mm), inclusive of all values and ranges therebetween. In some embodiments, either of the dimensions of the convergence chamber 345d can be about 2 mm, about 2.5 mm, about 3 mm, about 3.5 mm, about 4 mm, about 4.5 mm, about 5 mm, about 5.5 mm, about 6 mm, about 6.5 mm, about 7 mm, about 7.5 mm, about 8 mm, about 8.5 mm, about 9 mm, about 9.5 mm, or about 10 mm.

FIG. 3E is an illustration of a cross mixer 300e with a trapezoidal prism convergence chamber, according to an embodiment. As shown, the cross mixer 300e includes a first inlet 310e and a second inlet 315e configured to receive a solution, and a third inlet 320e configured to receive an LNP-containing fluid. The cross mixer 300e further includes an outlet 330e and a convergence chamber 345e fluidically coupled to the first inlet 310e, the second inlet 315e, the third inlet 320e, and the outlet 330e. In some embodiments, the first inlet 310e, the second inlet 315e, the third inlet 320e, and the outlet 330e can be the same or substantially similar to the first inlet 310a, the second inlet 315a, the third inlet 320a, and the outlet 330a, as described above with reference to FIG. 3A. Thus, certain aspects of the first inlet 310e, the second inlet 315e, the third inlet 320e, and the outlet 330e are not described in greater detail herein.

As shown, the convergence chamber 345e has a trapezoidal surface with a major side length and a minor side length (the major and minor sides parallel to each other), as well as a trapezoidal height dimension and a depth dimension. In some embodiments, the major side length of the convergence chamber 345e can be at least about 2 mm, at least about 2.5 mm, at least about 3 mm, at least about 3.5 mm, at least about 4 mm, at least about 4.5 mm, at least about 5 mm, at least about 5.5 mm, at least about 6 mm, at least about 6.5 mm, at least about 7 mm, at least about 7.5 mm, at least about 8 mm, at least about 8.5 mm, at least about 9 mm, or at least about 9.5 mm. In some embodiments, the major side length of the convergence chamber 345e can be no more than about 10 mm, no more than about 9.5 mm, no more than about 9 mm, no more than about 8.5 mm, no more than about 8 mm, no more than about 7.5 mm, no more than about 7 mm, no more than about 6.5 mm, no more than about 6 mm, no more than about 5.5 mm, no more than about 5 mm, no more than about 4.5 mm, no more than about 4 mm, no more than about 3.5 mm, no more than about 3 mm, or no more than about 2.5 mm. Combinations of the above-referenced major side lengths of the convergence chamber 345e are also possible (e.g., at least about 2 mm and no more than about 10 mm or at least about 3 mm and no more than about 7 mm), inclusive of all values and ranges therebetween.

In some embodiments, the major side length of the convergence chamber 345e can be about 2 mm, about 2.5 mm, about 3 mm, about 3.5 mm, about 4 mm, about 4.5 mm, about 5 mm, about 5.5 mm, about 6 mm, about 6.5 mm, about 7 mm, about 7.5 mm, about 8 mm, about 8.5 mm, about 9 mm, about 9.5 mm, or about 10 mm.

In some embodiments, the minor side length of the convergence chamber 345e can be at least about 1 mm, at least about 1.5 mm, at least about 2 mm, at least about 2.5 mm, at least about 3 mm, at least about 3.5 mm, at least about 4 mm, at least about 4.5 mm, at least about 5 mm, at least about 5.5 mm, at least about 6 mm, at least about 6.5 mm, at least about 7 mm, or at least about 7.5 mm. In some embodiments, the minor side length of the convergence chamber 345e can be no more than about 8 mm, no more than about 7.5 mm, no more than about 7 mm, no more than about 6.5 mm, no more than about 6 mm, no more than about 5.5 mm, no more than about 5 mm, no more than about 4.5 mm, no more than about 4 mm, no more than about 3.5 mm, no more than about 3 mm, no more than about 2.5 mm, no more than about 2 mm, or no more than about 1.5 mm. Combinations of the above-referenced minor side lengths of the convergence chamber 345e are also possible (e.g., at least about 1 mm and no more than about 8 mm or at least about 2 mm and no more than about 6 mm), inclusive of all values and ranges therebetween. In some embodiments, the minor side length of the convergence chamber 345e can be about 1 mm, about 1.5 mm, about 2 mm, about 2.5 mm, about 3 mm, about 3.5 mm, about 4 mm, about 4.5 mm, about 5 mm, about 5.5 mm, about 6 mm, about 6.5 mm, about 7 mm, about 7.5 mm, or about 8 mm.

In some embodiments, the trapezoid height of the convergence chamber 345e can be at least about 2 mm, at least about 2.5 mm, at least about 3 mm, at least about 3.5 mm, at least about 4 mm, at least about 4.5 mm, at least about 5 mm, at least about 5.5 mm, at least about 6 mm, at least about 6.5 mm, at least about 7 mm, at least about 7.5 mm, at least about 8 mm, at least about 8.5 mm, at least about 9 mm, or at least about 9.5 mm. In some embodiments, the trapezoid height of the convergence chamber 345e can be no more than about 10 mm, no more than about 9.5 mm, no more than about 9 mm, no more than about 8.5 mm, no more than about 8 mm, no more than about 7.5 mm, no more than about 7 mm, no more than about 6.5 mm, no more than about 6 mm, no more than about 5.5 mm, no more than about 5 mm, no more than about 4.5 mm, no more than about 4 mm, no more than about 3.5 mm, no more than about 3 mm, or no more than about 2.5 mm. Combinations of the above-referenced trapezoid heights of the convergence chamber 345e are also possible (e.g., at least about 2 mm and no more than about 10 mm or at least about 3 mm and no more than about 7 mm), inclusive of all values and ranges therebetween. In some embodiments, the trapezoid height of the convergence chamber 345e can be about 2 mm, about 2.5 mm, about 3 mm, about 3.5 mm, about 4 mm, about 4.5 mm, about 5 mm, about 5.5 mm, about 6 mm, about 6.5 mm, about 7 mm, about 7.5 mm, about 8 mm, about 8.5 mm, about 9 mm, about 9.5 mm, or about 10 mm.

In some embodiments, the depth of the convergence chamber 345e can be at least about 2 mm, at least about 2.5 mm, at least about 3 mm, at least about 3.5 mm, at least about 4 mm, at least about 4.5 mm, at least about 5 mm, at least about 5.5 mm, at least about 6 mm, at least about 6.5 mm, at least about 7 mm, at least about 7.5 mm, at least about 8 mm, at least about 8.5 mm, at least about 9 mm, or at least about 9.5 mm. In some embodiments, the depth of the convergence chamber 345e can be no more than about 10 mm, no more than about 9.5 mm, no more than about 9 mm, no more than about 8.5 mm, no more than about 8 mm, no more than about 7.5 mm, no more than about 7 mm, no more than about 6.5 mm, no more than about 6 mm, no more than about 5.5 mm, no more than about 5 mm, no more than about 4.5 mm, no more than about 4 mm, no more than about 3.5 mm, no more than about 3 mm, or no more than about 2.5 mm. Combinations of the above-referenced depths of the convergence chamber 345e are also possible (e.g., at least about 2 mm and no more than about 10 mm or at least about 3 mm and no more than about 7 mm), inclusive of all values and ranges therebetween. In some embodiments, the depth of the convergence chamber 345e can be about 2 mm, about 2.5 mm, about 3 mm, about 3.5 mm, about 4 mm, about 4.5 mm, about 5 mm, about 5.5 mm, about 6 mm, about 6.5 mm, about 7 mm, about 7.5 mm, about 8 mm, about 8.5 mm, about 9 mm, about 9.5 mm, or about 10 mm.

FIG. 3F is an illustration of a cross mixer 300f with a cylindrical convergence chamber, according to an embodiment. As shown, the cross mixer 300f includes a first inlet 310f and a second inlet 315f configured to receive a solution, and a third inlet 320f configured to receive an LNP-containing fluid. The cross mixer 300f further includes an outlet 330f and a convergence chamber 345f fluidically coupled to the first inlet 310f, the second inlet 315f, the third inlet 320f, and the outlet 330f. In some embodiments, the first inlet 310f, the second inlet 315f, the third inlet 320f, the outlet 330f, and the convergence chamber 345f can be the same or substantially similar to the first inlet 310c, the second inlet 315c, the third inlet 320c, the outlet 330c, and the convergence chamber 345c, as described above with reference to FIG. 3C. Thus, certain aspects of the first inlet 310f, the second inlet 315f, the third inlet 320f, the outlet 330f, and the convergence chamber 345f, are not described in greater detail herein. A shown, the first inlet 310f is oriented in-line with the second inlet 315f. In other words, a line extending through the center of the first inlet 310f also extends through the center of the second inlet 315f. The in-line orientation of the first inlet 310f and the second inlet 315f can ease the machining of the cross mixer 300f.

FIG. 3G is an illustration of a cross mixer 300g with a conical or frustum-shaped convergence chamber, according to an embodiment. As shown, the cross mixer 300g includes a first inlet 310g and a second inlet 315g configured to receive a solution, and a third inlet 320g configured to receive an LNP-containing fluid. The cross mixer 300g further includes an outlet 330g and a convergence chamber 345g fluidically coupled to the first inlet 310g, the second inlet 315g, the third inlet 320g, and the outlet 330g. In some embodiments, the first inlet 310g, the second inlet 315g, the third inlet 320g, and the outlet 330g can be the same or substantially similar to the first inlet 310a, the second inlet 315a, the third inlet 320a, and the outlet 330a, as described above with reference to FIG. 3A. Thus, certain aspects of the first inlet 310g, the second inlet 315g, the third inlet 320g, and the outlet 330g are not described in greater detail herein.

As shown, the convergence chamber 345g has a frustum or conical shape. As shown, the convergence chamber 345g has a major diameter, a minor diameter, and a depth dimension. As shown, the depth dimension extends parallel to the third inlet 320g and the outlet 330g. In some embodiments, the depth dimension can extend parallel to the first inlet 310g and the second inlet 315g.

In some embodiments, the major diameter of the convergence chamber 345g can be at least about 2 mm, at least about 2.5 mm, at least about 3 mm, at least about 3.5 mm, at least about 4 mm, at least about 4.5 mm, at least about 5 mm, at least about 5.5 mm, at least about 6 mm, at least about 6.5 mm, at least about 7 mm, at least about 7.5 mm, at least about 8 mm, at least about 8.5 mm, at least about 9 mm, or at least about 9.5 mm. In some embodiments, the major diameter of the convergence chamber 345g can be no more than about 10 mm, no more than about 9.5 mm, no more than about 9 mm, no more than about 8.5 mm, no more than about 8 mm, no more than about 7.5 mm, no more than about 7 mm, no more than about 6.5 mm, no more than about 6 mm, no more than about 5.5 mm, no more than about 5 mm, no more than about 4.5 mm, no more than about 4 mm, no more than about 3.5 mm, no more than about 3 mm, or no more than about 2.5 mm. Combinations of the above-referenced major diameters of the convergence chamber 345g are also possible (e.g., at least about 2 mm and no more than about 10 mm or at least about 3 mm and no more than about 7 mm), inclusive of all values and ranges therebetween. In some embodiments, the major diameter of the convergence chamber 345g can be about 2 mm, about 2.5 mm, about 3 mm, about 3.5 mm, about 4 mm, about 4.5 mm, about 5 mm, about 5.5 mm, about 6 mm, about 6.5 mm, about 7 mm, about 7.5 mm, about 8 mm, about 8.5 mm, about 9 mm, about 9.5 mm, or about 10 mm.

In some embodiments, the minor diameter of the convergence chamber 345g can be at least about 1 mm, at least about 1.5 mm, at least about 2 mm, at least about 2.5 mm, at least about 3 mm, at least about 3.5 mm, at least about 4 mm, at least about 4.5 mm, at least about 5 mm, at least about 5.5 mm, at least about 6 mm, at least about 6.5 mm, at least about 7 mm, at least about 7.5 mm. In some embodiments, the minor diameter of the convergence chamber 345g can be no more than about 8 mm, no more than about 7.5 mm, no more than about 7 mm, no more than about 6.5 mm, no more than about 6 mm, no more than about 5.5 mm, no more than about 5 mm, no more than about 4.5 mm, no more than about 4 mm, no more than about 3.5 mm, no more than about 3 mm, or no more than about 2.5 mm. Combinations of the above-referenced minor diameters of the convergence chamber 345g are also possible (e.g., at least about 1 mm and no more than about 8 mm or at least about 3 mm and no more than about 7 mm), inclusive of all values and ranges therebetween. In some embodiments, the major diameter of the convergence chamber 345g can be about 1 mm, about 1.5 mm, about 2 mm, about 2.5 mm, about 3 mm, about 3.5 mm, about 4 mm, about 4.5 mm, about 5 mm, about 5.5 mm, about 6 mm, about 6.5 mm, about 7 mm, about 7.5 mm, or about 8 mm.

In some embodiments, the depth dimension of the convergence chamber 345g can be at least about 2 mm, at least about 2.5 mm, at least about 3 mm, at least about 3.5 mm, at least about 4 mm, at least about 4.5 mm, at least about 5 mm, at least about 5.5 mm, at least about 6 mm, at least about 6.5 mm, at least about 7 mm, at least about 7.5 mm, at least about 8 mm, at least about 8.5 mm, at least about 9 mm, or at least about 9.5 mm. In some embodiments, the depth dimension of the convergence chamber 345g can be no more than about 10 mm, no more than about 9.5 mm, no more than about 9 mm, no more than about 8.5 mm, no more than about 8 mm, no more than about 7.5 mm, no more than about 7 mm, no more than about 6.5 mm, no more than about 6 mm, no more than about 5.5 mm, no more than about 5 mm, no more than about 4.5 mm, no more than about 4 mm, no more than about 3.5 mm, no more than about 3 mm, or no more than about 2.5 mm. Combinations of the above-referenced depth dimensions of the convergence chamber 345g are also possible (e.g., at least about 2 mm and no more than about 10 mm or at least about 3 mm and no more than about 7 mm), inclusive of all values and ranges therebetween. In some embodiments, the depth dimension of the convergence chamber 345g can be about 2 mm, about 2.5 mm, about 3 mm, about 3.5 mm, about 4 mm, about 4.5 mm, about 5 mm, about 5.5 mm, about 6 mm, about 6.5 mm, about 7 mm, about 7.5 mm, about 8 mm, about 8.5 mm, about 9 mm, about 9.5 mm, or about 10 mm.

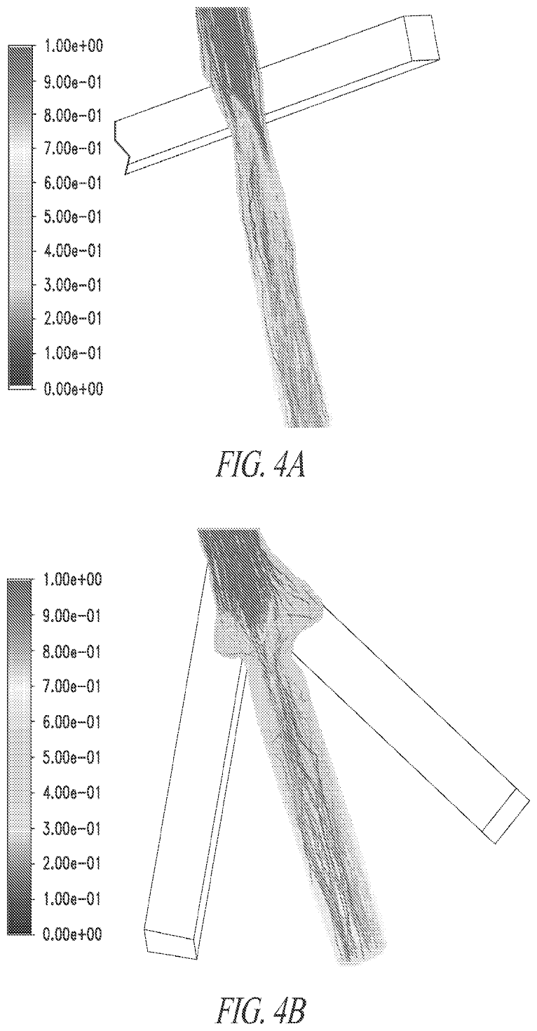

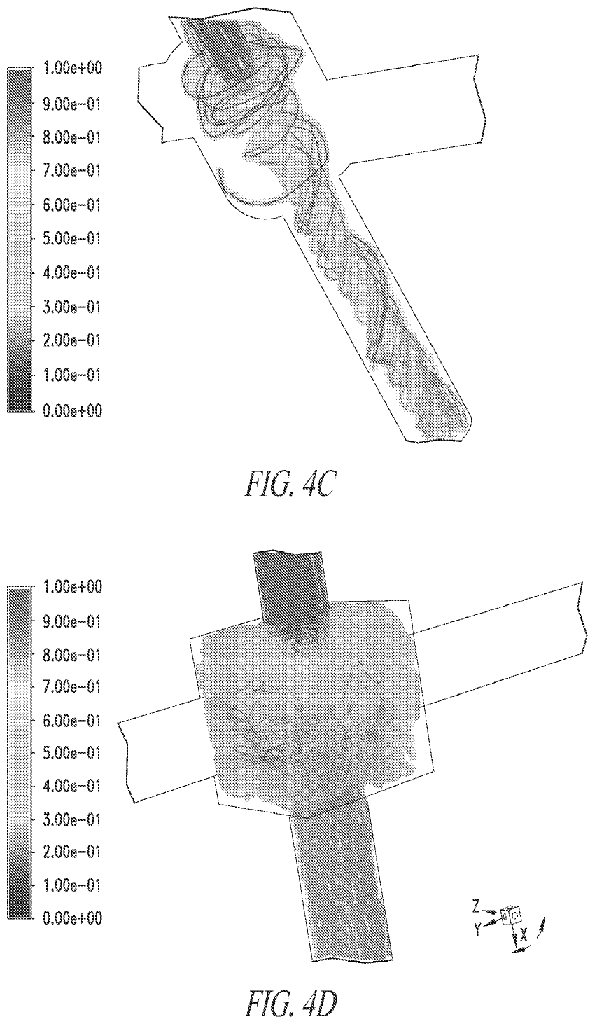

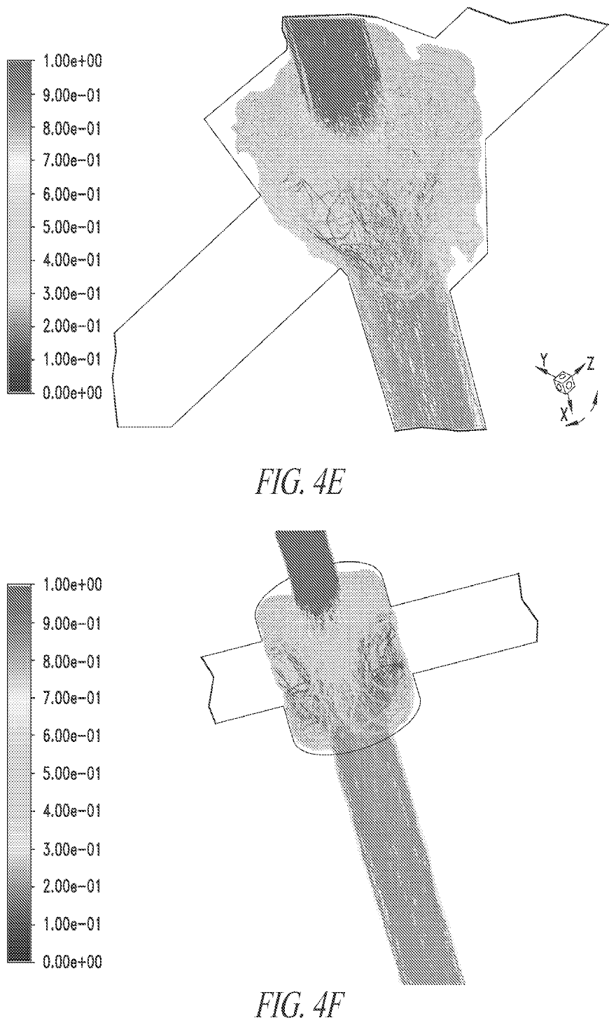

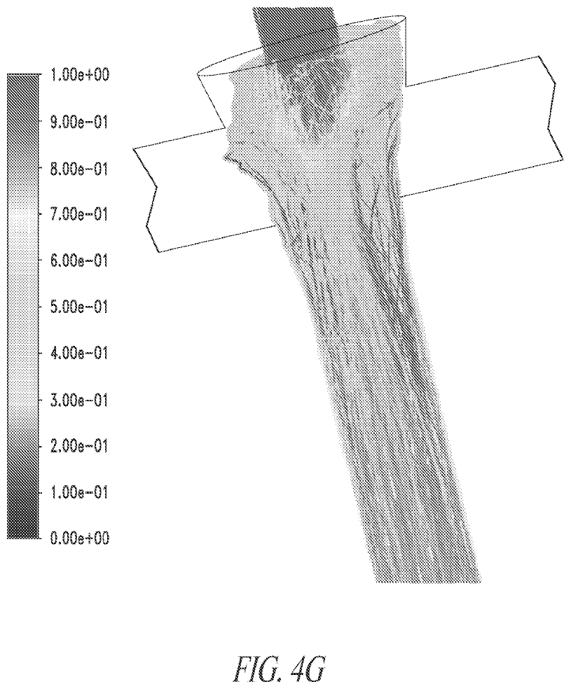

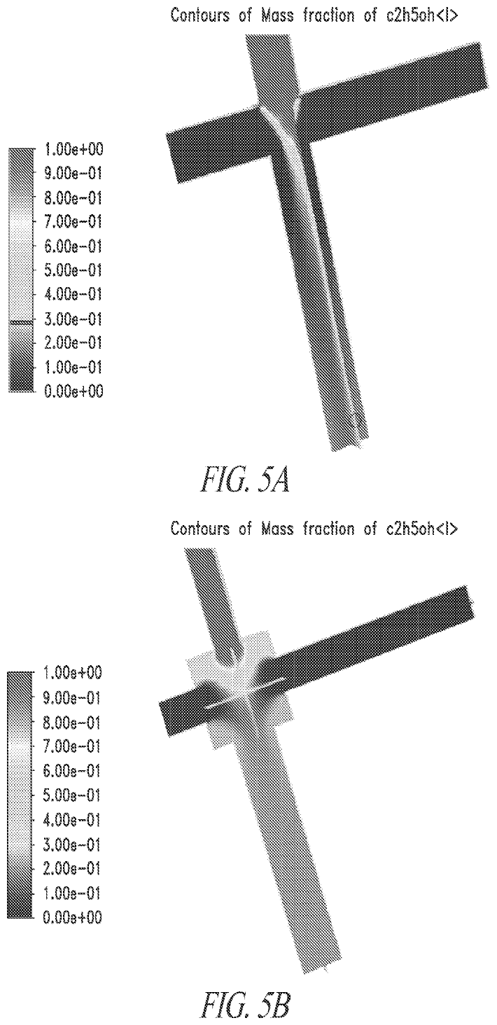

FIG. 4A is a simulation showing particle tracks in a cross mixer with no convergence chamber. In some embodiments, the cross mixer shown in FIG. 4A can be the same or substantially similar to the cross mixer 300a, as described above with reference to FIG. 3A. As shown, the ethanol concentration in most of the particle tracks changes from about 100 wt % to about 70 wt % in the central region, and transitions to 20-30 wt % along the outlet.

FIG. 4B is a simulation showing particle tracks in a cross mixer with no convergence chamber and angled inlets. In some embodiments, the cross mixer shown in FIG. 4B can be the same or substantially similar to the cross mixer 300b, as described above with reference to FIG. 3B. As shown, the ethanol concentration changes in most of the particle tracks from about 100 wt % to about 70 wt % in the central region, and transitions to about 20-30 wt % along the outlet.

FIG. 4C is a simulation showing particle tracks in a cross mixer with a cylindrical convergence chamber. In some embodiments, the cross mixer shown in FIG. 4C can be the same or substantially similar to the cross mixer 300c, as described above with reference to FIG. 3C. As shown, the ethanol concentration changes in most of the particle tracks from about 100 wt % to about 50 wt % in the convergence chamber, and transitions to about 20-30 wt % along the outlet.

FIG. 4D is a simulation showing particle tracks in a cross mixer with a cubic convergence chamber. In some embodiments, the cross mixer shown in FIG. 4D can be the same or substantially similar to the cross mixer 300d, as described above with reference to FIG. 3D. As shown, the ethanol concentration changes in most of the particle tracks from about 100 wt % to about 30 wt % in the convergence chamber, and transitions to about 20 wt % along the outlet.

FIG. 4E is a simulation showing particle tracks in a cross mixer with a trapezoidal convergence chamber. In some embodiments, the cross mixer shown in FIG. 4E can be the same or substantially similar to the cross mixer 300e, as described above with reference to FIG. 3E. As shown, the ethanol concentration changes in most of the particle tracks from about 100 wt % to about 40 wt % in the convergence chamber, and transitions to about 20 wt % along the outlet.

FIG. 4F is a simulation showing particle tracks in a cross mixer with a cylindrical convergence chamber. In some embodiments, the cross mixer shown in FIG. 4F can be the same or substantially similar to the cross mixer 300f, as described above with reference to FIG. 3F. As shown, the ethanol concentration changes in most of the particle tracks from about 100 wt % to about 40 wt % in the convergence chamber, and transitions to about 20 wt % along the outlet.

FIG. 4G is a simulation showing particle tracks in a cross mixer with a conical or frustum-shaped convergence chamber. In some embodiments, the cross mixer shown in FIG. 4G can be the same or substantially similar to the cross mixer 300g, as described above with reference to FIG. 3G. As shown, the ethanol concentration changes in most of the particle tracks from about 100 wt % to about 50 wt % in the convergence chamber, and transitions to about 20-30 wt % along the outlet.

FIG. 5A is a simulation of contours of mass fractions of ethanol in a cross mixer with no convergence chamber. FIG. 5B is a simulation of contours of mass fractions of ethanol in a cross mixer with a cubic convergence chamber. As shown, the ethanol concentration is more uniform in the outlet of the cross mixer with the cubic convergence chamber.

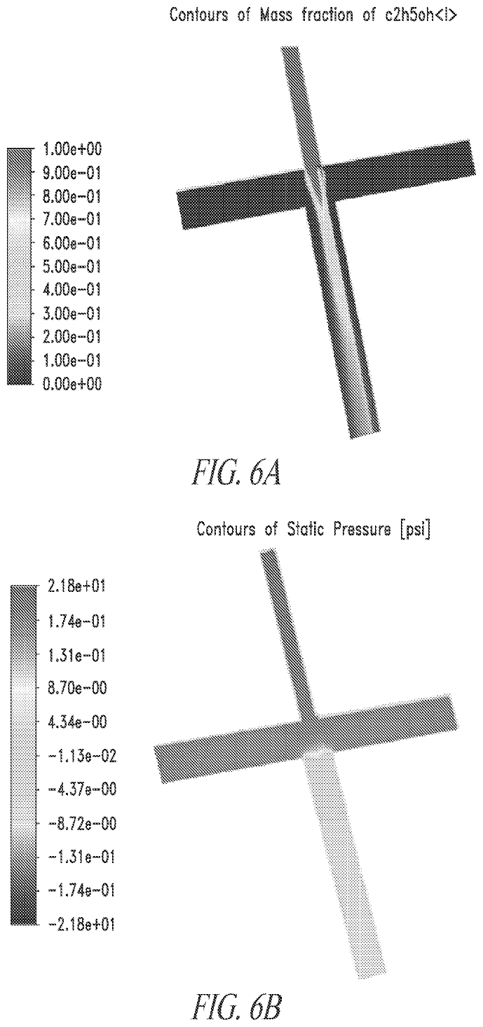

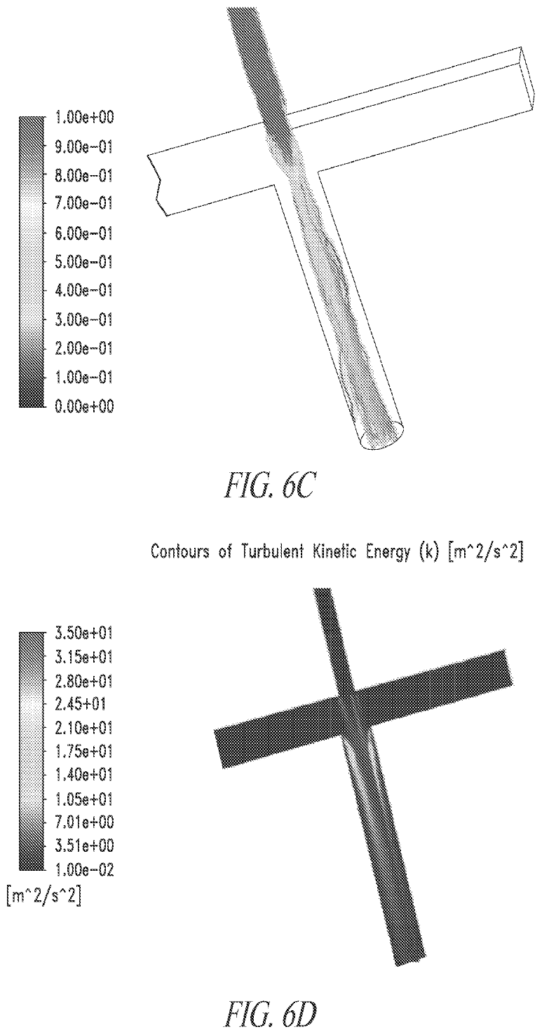

FIG. 6A is a simulation of contours of mass fractions of ethanol in a cross mixer with no convergence chamber. FIG. 6B is a simulation of contours of static pressure in a cross mixer with no convergence chamber. FIG. 6C is a simulation showing particle tracks in a cross mixer with no convergence chamber. FIG. 6D is a simulation showing contours of turbulent kinetic energy in a cross mixer with no convergence chamber. As shown, concentration gradients form in the cross mixer, while pressure lines are clearly delineated.

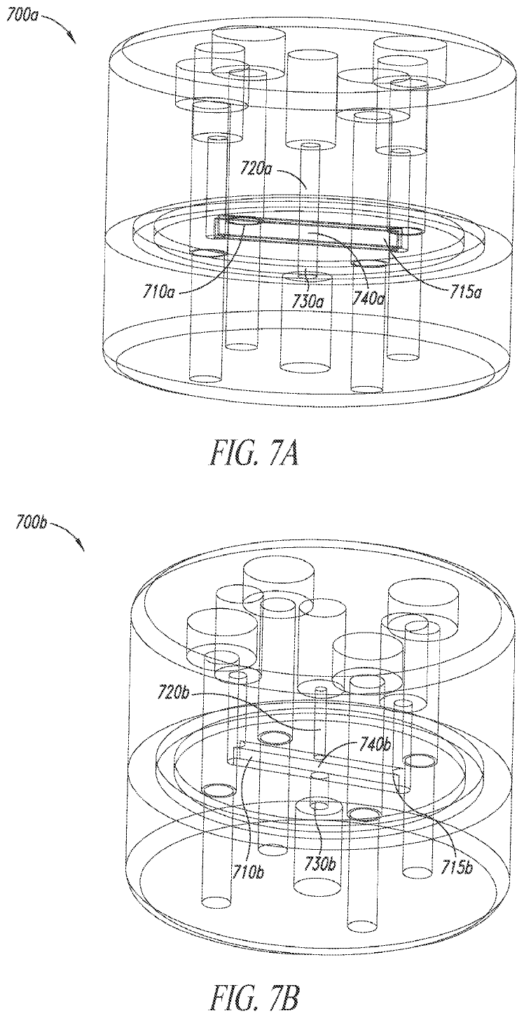

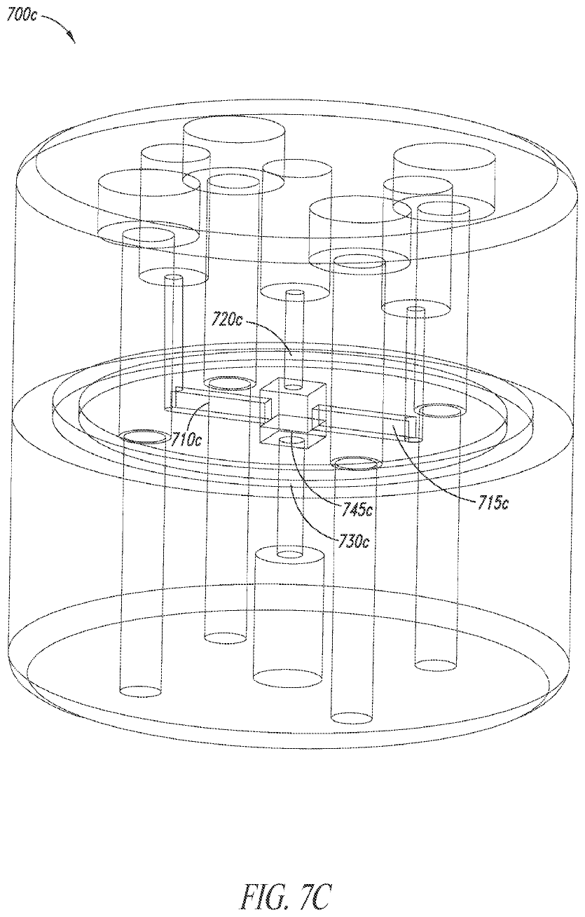

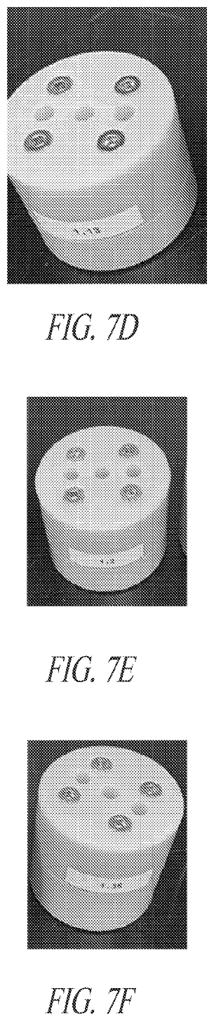

FIG. 7A is an illustration of a cross mixer 700a with no convergence chamber, according to an embodiment. As shown, the cross mixer 700a includes a first inlet 710a and a second inlet 715a configured to receive a solution, and a third inlet 720a configured to receive an LNP-containing fluid. The cross mixer 700a further includes an outlet 730a and a central region 740a fluidically coupled to the first inlet 710a, the second inlet 715a, the third inlet 720a, and the outlet 730a. As shown, the central region 740a does not include an enlarged portion or a mixing chamber, but rather retains the dimensions of the first inlet 710a, the second inlet 715a, and the third inlet 720a. In some embodiments, the first inlet 710a, the second inlet 715a, the third inlet 720a, the outlet 730a, and the central region 740a can be the same or substantially similar to the first inlet 310a, the second inlet 315a, the third inlet 320a, the outlet 330a, and the central region 340a, as described above with reference to FIG. 3A. Thus, certain aspects of the first inlet 710a, the second inlet 715a, the third inlet 720a, the outlet 730a, and the central region 740a are not described in greater detail herein. As shown, the third inlet 720a is cylindrical and has a cross-sectional diameter of about 2 mm. Any of the aforementioned form factors and sizes can be applied to the third inlet 720a.

As shown, the first inlet 710a includes a first section and a second section, the first section perpendicular to the second section. As shown, the first section is oriented vertically, while the second section is oriented horizontally. As shown, the first section forms an angle of about 90° with the second section. In some embodiments, the first section can form an angle of about 60°, about 65°, about 70°, about 75°, about 80°, about 85°, about 90°, about 95°, about 100°, about 105°, about 110°, about 115°, or about 120° with the second section, inclusive of all values and ranges therebetween. As shown, the first section includes an enlarged portion at the top, where fluid can be fed. In some embodiments, the enlarged portion can be fed manually (e.g., from a pipette held by a user). In some embodiments, the enlarged portion can be fed automatically (e.g., from another mixer or from a reactor).

As shown, the second inlet 715a includes a first section and a second section, the first section perpendicular to the second section. As shown, the first section is oriented vertically, while the second section is oriented horizontally. As shown, the first section forms an angle of about 90° with the second section. In some embodiments, the first section can form an angle of about 60°, about 65°, about 70°, about 75°, about 80°, about 85°, about 90°, about 95°, about 100°, about 105°, about 110°, about 115°, or about 120° with the second section, inclusive of all values and ranges therebetween. As shown, the first section includes an enlarged portion at the top, where fluid can be fed. In some embodiments, the enlarged portion can be fed manually (e.g., from a pipette held by a user). In some embodiments, the enlarged portion can be fed automatically (e.g., from another mixer or from a reactor).

FIG. 7B is an illustration of a cross mixer 700b with no convergence chamber, according to an embodiment. As shown, the cross mixer 700b includes a first inlet 710b and a second inlet 715b configured to receive a solution, and a third inlet 720b configured to receive an LNP-containing fluid. The cross mixer 700b further includes an outlet 730b and a central region 740b fluidically coupled to the first inlet 710b, the second inlet 715b, the third inlet 720b, and the outlet 730b. As shown, the central region 740b does not include an enlarged portion or a mixing chamber, but rather retains the dimensions of the first inlet 710b, the second inlet 715b, and the third inlet 720b. In some embodiments, the first inlet 710b, the second inlet 715b, the third inlet 720b, the outlet 730b, and the central region 740b can be the same or substantially similar to the first inlet 710a, the second inlet 715a, the third inlet 720a, the outlet 730a, and the central region 740a, as described above with reference to FIG. 7A. Thus, certain aspects of the first inlet 710b, the second inlet 715b, the third inlet 720b, the outlet 730b, and the central region 740b are not described in greater detail herein. As shown, the third inlet 720b is cylindrical and has a cross-sectional diameter of about 1.2 mm. Any of the aforementioned form factors and sizes can be applied to the third inlet 720b.

FIG. 7C is an illustration of a cross mixer 700c with a cubic convergence chamber, according to an embodiment. As shown, the cross mixer 700c includes a first inlet 710c and a second inlet 715c configured to receive a solution, and a third inlet 720c configured to receive an LNP-containing fluid. The cross mixer 700c further includes an outlet 730c and a convergence chamber 745c fluidically coupled to the first inlet 710c, the second inlet 715c, the third inlet 720c, and the outlet 730c. In some embodiments, the first inlet 710c, the second inlet 715c, the third inlet 720c, and the outlet 730c can be the same or substantially similar to the first inlet 710a, the second inlet 715a, the third inlet 720a, and the outlet 730a, as described above with reference to FIG. 7A. In some embodiments, the convergence chamber 745c can be the same or substantially similar to the convergence chamber 345d, as described above with reference to FIG. 3B. Thus, certain aspects of the first inlet 710c, the second inlet 715c, the third inlet 720c, the outlet 730c, and the convergence chamber 745c are not described in greater detail herein.

FIG. 7D is a photograph of a cross mixer with no convergence chamber, according to an embodiment. FIG. 7E is a photograph of a cross mixer with no convergence chamber, according to an embodiment. FIG. 7F is a photograph of a cross mixer with a cubic convergence chamber, according to an embodiment. FIG. 7D, FIG. 7E, and FIG. 7F each show outside views of the cross mixers.

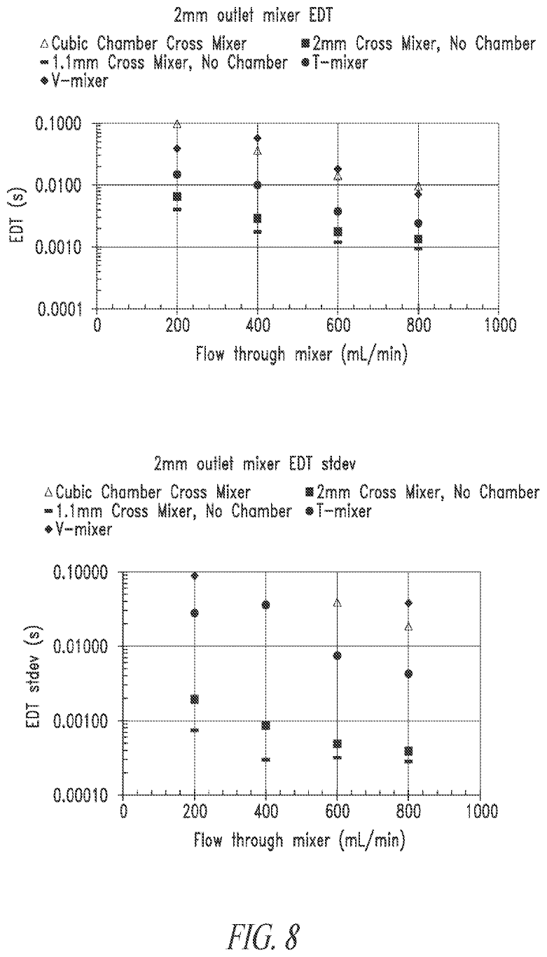

FIG. 8 is a graph of simulated EDTs for various mixers and flow rates. The top plot shows the EDTs while the bottom plot shows standard deviations of the EDTs. Without being bound by any particular theory, the smaller mixing volumes of the cross mixers with no convergence chamber could provide a smaller volume for the LSS and ethanol to mix and form precipitate such that the ethanol is consumed more quickly.

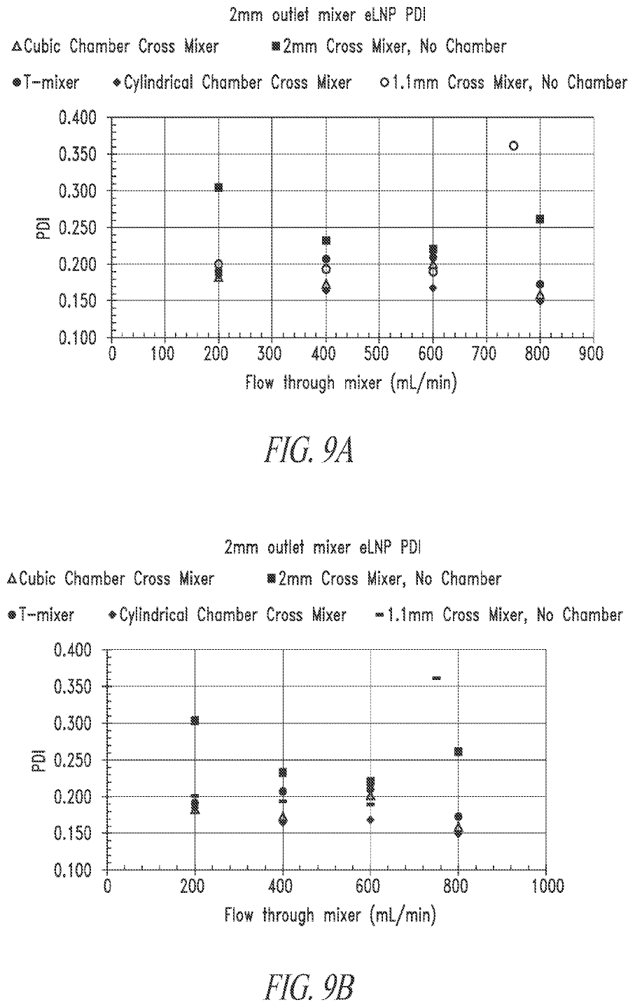

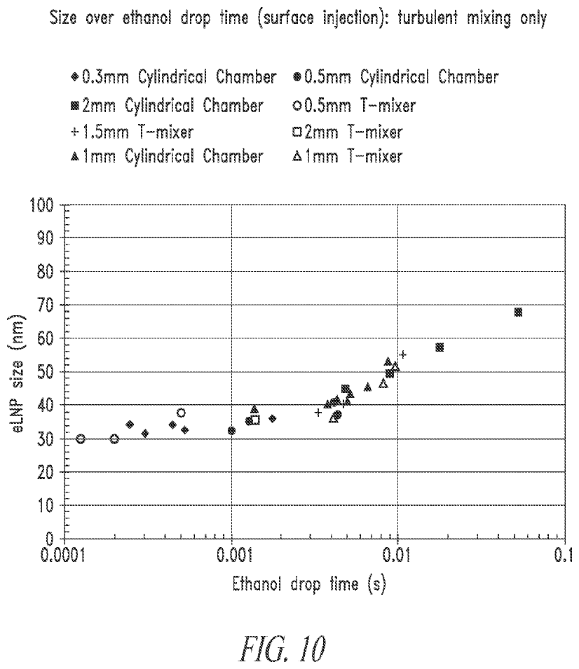

FIG. 9A is a graph of measured eLNP particle sizes for various mixers and flow rates. As shown, eLNP diameters tend to be larger in the outlets of mixers with cubic and cylindrical convergence chambers, smaller in the outlets of T-mixers, and yet smaller in the outlets of the cross mixers with no convergence chambers.

FIG. 9B is a graph of measured eLNP PDI for various mixers and flow rates. As shown, the cross mixer with no convergence chamber and a 2 m LSS tend to have larger PDI than the other mixers.

FIG. 10 is a graph of measured eLNP size plotted against simulated EDTs for various mixers. Mixers simulated include mixers with cylindrical convergence chambers (“V-Mixer”) and T-mixers with various eLNP inlet sizes. In general, T-mixers with smaller inlet diameters yielded lower EDTs and lower eLNP sizes after mixing. Cross mixers with cylindrical convergence chambers generally produced larger eLNP sizes and higher EDTs.

FIG. 11 is a graph of simulated predicted pressures for various mixers and flow rates. In each mixer, higher flow rates lead to larger pressures. The cross mixers without convergence chambers tend to have lower simulated pressures, while the cross mixer with a cylindrical convergence chamber has a larger simulated pressure.

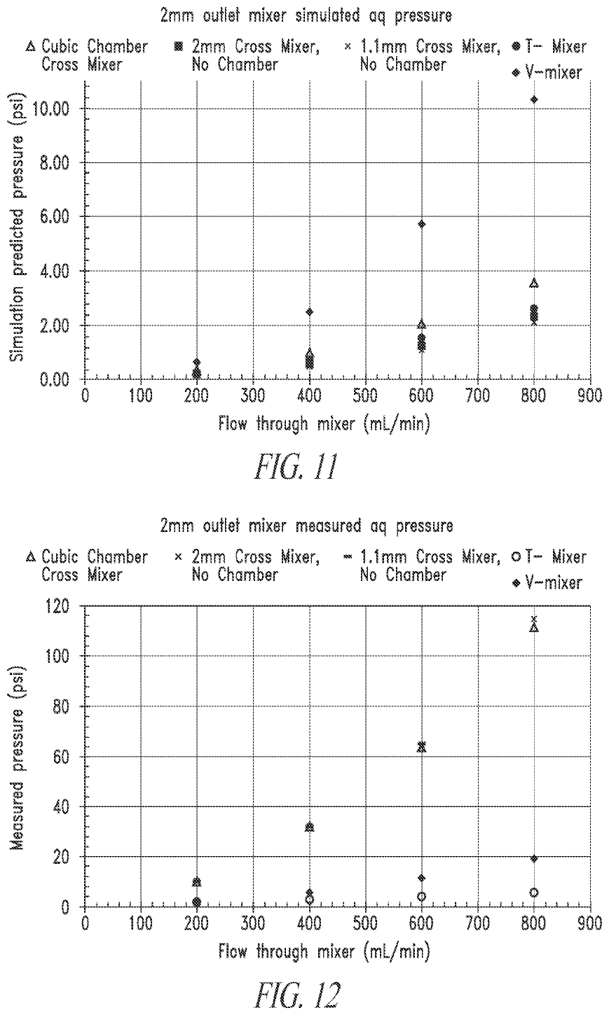

FIG. 12 is a graph of measured pressures for various mixers and flow rates. In each mixer, higher flow rates lead to larger pressures. The T-mixer was measured to have a lower pressure, while cross mixers had higher measured pressures.

FIG. 13 is an illustration of a cross mixer 1300, according to an embodiment. As shown, the cross mixer 1300 includes a common inlet 1305 feeding a first inlet 1310 and a second inlet 1315, and a third inlet 1320, the third inlet 1320 configured to receive an LNP-containing fluid. The cross mixer 1300 further includes an outlet 1330 and a central region 1340 fluidically coupled to the common inlet 1305, the first inlet 1310, the second inlet 1315, the third inlet 1320, and the outlet 1330. In some embodiments, the first inlet 1310, the second inlet 1315, the third inlet 1320, the outlet 1330, and the central region 1340 can be the same or substantially similar to the first inlet 710a, the second inlet 715a, the third inlet 720a, the outlet 730a, and the central region 740a, as described above with reference to FIG. 7A. Thus, certain aspects of the first inlet 1310, the second inlet 1315, the third inlet 1320, the outlet 1330, and the central region 1340 are not described in greater detail herein.

As shown, the common inlet 1305 is fluidically connected to the first inlet 1310 and the second inlet 1315. As shown, the third inlet 1320 includes an expanded region 1322 and a narrow region 1321 downstream of the expanded region 1322. In some embodiments, the narrow region 1321 of the third inlet 1320 can have a length of at least about 500 μm, at least about 1 mm, at least about 2 mm, at least about 3 mm, at least about 4 mm, at least about 5 mm, at least about 6 mm, at least about 7 mm, at least about 8 mm, at least about 9 mm, at least about 1 cm, at least about 2 cm, at least about 3 cm, at least about 4 cm, at least about 5 cm, at least about 6 cm, at least about 7 cm, at least about 8 cm, or at least about 9 cm. In some embodiments, the narrow region 1321 of the third inlet 1320 can have a length of no more than about 10 cm, no more than about 9 cm, no more than about 8 cm, no more than about 7 cm, no more than about 6 cm, no more than about 5 cm, no more than about 4 cm, no more than about 3 cm, no more than about 2 cm, no more than about 1 mm, no more than about 9 mm, no more than about 8 mm, no more than about 7 mm, no more than about 6 mm, no more than about 5 mm, no more than about 4 mm, no more than about 3 mm, no more than about 2 mm, or no more than about 1 mm. Combinations of the above-referenced lengths are also possible (e.g., at least about 500 μm and no more than about 10 cm or at least about 3 mm and no more than about 1 cm), inclusive of all values and ranges therebetween. In some embodiments, the narrow region 1321 of the third inlet 1320 can have a length of about 500 μm, about 1 mm, about 2 mm, about 3 mm, about 4 mm, about 5 mm, about 6 mm, about 7 mm, about 8 mm, about 9 mm, about 1 cm, about 2 cm, about 3 cm, about 4 cm, about 5 cm, about 6 cm, about 7 cm, about 8 cm, about 9 cm, or about 10 cm.

In some embodiments, the narrow region 1321 of the third inlet 1320 can have a diameter of at least about 100 μm, at least about 200 μm, at least about 300 μm, at least about 400 μm, at least about 500 μm, at least about 600 μm, at least about 700 μm, at least about 800 μm, at least about 900 μm, at least about 1 mm, at least about 2 mm, at least about 3 mm, at least about 4 mm, at least about 5 mm, at least about 6 mm, at least about 7 mm, at least about 8 mm, or at least about 9 mm. In some embodiments, the narrow region 1321 of the third inlet 1320 can have a diameter of no more than about 1 cm, no more than about 9 mm, no more than about 8 mm, no more than about 7 mm, no more than about 6 mm, no more than about 5 mm, no more than about 4 mm, no more than about 3 mm, no more than about 2 mm, no more than about 1 mm, no more than about 900 μm, no more than about 800 μm, no more than about 700 μm, no more than about 600 μm, no more than about 500 μm, no more than about 400 μm, no more than about 300 μm, or no more than about 200 μm. Combinations of the above-referenced diameters are also possible (e.g., at least about 100 μm and no more than about 1 cm or at least about 1 mm and no more than about 5 mm), inclusive of all values and ranges therebetween. In some embodiments, the narrow region 1321 of the third inlet 1320 can have a diameter of about 100 μm, about 200 μm, about 300 μm, about 400 μm, about 500 μm, about 600 μm, about 700 μm, about 800 μm, about 900 μm, about 1 mm, about 2 mm, about 3 mm, about 4 mm, about 5 mm, about 6 mm, about 7 mm, about 8 mm, about 9 mm, or about 1 cm.

In some embodiments, the expanded region 1322 of the third inlet 1320 can have a diameter of at least about 500 μm, at least about 600 μm, at least about 700 μm, at least about 800 μm, at least about 900 μm, at least about 1 mm, at least about 2 mm, at least about 3 mm, at least about 4 mm, at least about 5 mm, at least about 6 mm, at least about 7 mm, at least about 8 mm, at least about 9 mm, at least about 1 cm, at least about 2 cm, at least about 3 cm, or at least about 4 cm. In some embodiments, the expanded region 1322 of the third inlet 1320 can have a diameter of no more than about 5 cm, no more than about 4 cm, no more than about 3 cm, no more than about 2 cm, no more than about 1 cm, no more than about 9 mm, no more than about 8 mm, no more than about 7 mm, no more than about 6 mm, no more than about 5 mm, no more than about 4 mm, no more than about 3 mm, no more than about 2 mm, no more than about 1 mm, no more than about 900 μm, no more than about 800 μm, no more than about 700 μm, or no more than about 600 μm. Combinations of the above-referenced diameters are also possible (e.g., at least about 500 μm and no more than about 5 cm or at least about 1 mm and no more than about 8 mm), inclusive of all values and ranges therebetween. In some embodiments, the expanded region 1322 of the third inlet 1320 can have a diameter of about 500 μm, about 600 μm, about 700 μm, about 800 μm, about 900 μm, about 1 mm, about 2 mm, about 3 mm, about 4 mm, about 5 mm, about 6 mm, about 7 mm, about 8 mm, about 9 mm, about 1 cm, about 2 cm, about 3 cm, about 4 cm, or about 5 cm.

In some embodiments, the ratio between the diameter of the expanded region 1322 of the third inlet 1320 and the diameter of the narrow region 1321 of the third inlet 1320 can be at least about 1.1:1, at least about 1.2:1, at least about 1.3:1, at least about 1.4:1, at least about 1.5:1, at least about 1.6:1, at least about 1.7:1, at least about 1.8:1, at least about 1.9:1, at least about 2:1, at least about 3:1, at least about 4:1, at least about 5:1, at least about 6:1, at least about 7:1, at least about 8:1, at least about 9:1, at least about 10:1, at least about 15:1, at least about 20:1, at least about 25:1, at least about 30:1, at least about 35:1, at least about 40:1, or at least about 45:1. In some embodiments, the ratio between the diameter of the expanded region 1322 of the third inlet 1320 and the diameter of the narrow region 1321 of the third inlet 1320 can be no more than about 50:1, no more than about 45:1, no more than about 40:1, no more than about 35:1, no more than about 30:1, no more than about 25:1, no more than about 20:1, no more than about 15:1, no more than about 10:1, no more than about 9:1, no more than about 8:1, no more than about 7:1, no more than about 6:1, no more than about 5:1, no more than about 4:1, no more than about 3:1, no more than about 2:1, no more than about 1.9:1, no more than about 1.8:1, no more than about 1.7:1, no more than about 1.6:1, no more than about 1.5:1, no more than about 1.4:1, no more than about 1.3:1, or no more than about 1.2:1. Combinations of the above-referenced ratios are also possible (e.g., at least about 1.1:1 and no more than about 50:1 or at least about 1.5:1 and no more than about 8:1), inclusive of all values and ranges therebetween. In some embodiments, the ratio between the diameter of the expanded region 1322 of the third inlet 1320 and the diameter of the narrow region 1321 of the third inlet 1320 can be about 1.1:1, about 1.2:1, about 1.3:1, about 1.4:1, about 1.5:1, about 1.6:1, about 1.7:1, about 1.8:1, at least about 1.9:1, at least about 2:1, at least about 3:1, at least about 4:1, at least about 5:1, at least about 6:1, at least about 7:1, at least about 8:1, at least about 9:1, at least about 10:1, at least about 15:1, at least about 20:1, at least about 25:1, at least about 30:1, at least about 35:1, at least about 40:1, about 45:1, or about 50:1.

As shown, the outlet 1330 includes a narrow region 1331 and an expanded region 1332 downstream of the narrow region 1331. As shown, the narrow region 1331 of the outlet 1330 has a length of 4 mm. In some embodiments, the narrow region 1331 of the outlet 1330 can have a length of at least about 1 mm, at least about 2 mm, at least about 3 mm, at least about 4 mm, at least about 5 mm, at least about 6 mm, at least about 7 mm, at least about 8 mm, at least about 9 mm, at least about 1 cm, at least about 2 cm, at least about 3 cm, at least about 4 cm, at least about 5 cm, at least about 6 cm, at least about 7 cm, at least about 8 cm, or at least about 9 cm. In some embodiments, the narrow region 1331 of the outlet 1330 can have a length of no more than about 10 cm, no more than about 9 cm, no more than about 8 cm, no more than about 7 cm, no more than about 6 cm, no more than about 5 cm, no more than about 4 cm, no more than about 3 cm, no more than about 2 cm, no more than about 1 mm, no more than about 9 mm, no more than about 8 mm, no more than about 7 mm, no more than about 6 mm, no more than about 5 mm, no more than about 4 mm, no more than about 3 mm, no more than about 2 mm, or no more than about 1 mm. Combinations of the above-referenced lengths are also possible (e.g., at least about 500 μm and no more than about 10 cm or at least about 3 mm and no more than about 1 cm), inclusive of all values and ranges therebetween. In some embodiments, the narrow region 1331 of the outlet 1330 can have a length of about 500 μm, about 1 mm, about 2 mm, about 3 mm, about 4 mm, about 5 mm, about 6 mm, about 7 mm, about 8 mm, about 9 mm, about 1 cm, about 2 cm, about 3 cm, about 4 cm, about 5 cm, about 6 cm, about 7 cm, about 8 cm, about 9 cm, or about 10 cm.

As shown, the narrow region 1331 of the outlet 1330 has a diameter of 1 mm. In some embodiments, the narrow region 1331 of the outlet 1330 can have a diameter of at least about 500 μm, at least about 600 μm, at least about 700 μm, at least about 800 μm, at least about 900 μm, at least about 1 mm, at least about 2 mm, at least about 3 mm, at least about 4 mm, at least about 5 mm, at least about 6 mm, at least about 7 mm, at least about 8 mm, at least about 9 mm, at least about 1 cm, at least about 1 cm, at least about 1 cm, or at least about 4 cm. In some embodiments, the narrow region 1331 of the outlet 1330 can have a diameter of no more than about 5 cm, no more than about 4 cm, no more than about 3 cm, no more than about 2 cm, no more than about 1 cm, no more than about 9 mm, no more than about 8 mm, no more than about 7 mm, no more than about 6 mm, no more than about 5 mm, no more than about 4 mm, no more than about 3 mm, no more than about 2 mm, no more than about 1 mm, no more than about 900 μm, no more than about 800 μm, no more than about 700 μm, or no more than about 600 μm. Combinations of the above-referenced diameters are also possible (e.g., at least about 500 μm and no more than about 5 cm or at least about 1 mm and no more than about 5 mm), inclusive of all values and ranges therebetween. In some embodiments, the narrow region 1331 of the outlet 1330 can have a diameter of about 500 μm, about 600 μm, about 700 μm, about 800 μm, about 900 μm, about 1 mm, about 2 mm, about 3 mm, about 4 mm, about 5 mm, about 6 mm, about 7 mm, about 8 mm, about 9 mm, about 1 cm, about 2 cm, about 3 cm, about 4 cm, or about 5 cm.

In some embodiments, the expanded region 1332 of the outlet 1330 can have a diameter of at least about 1 mm, at least about 2 mm, at least about 3 mm, at least about 4 mm, at least about 5 mm, at least about 6 mm, at least about 7 mm, at least about 8 mm, at least about 9 mm, at least about 1 cm, at least about 2 cm, at least about 3 cm, at least about 4 cm, at least about 5 cm, at least about 6 cm, at least about 7 cm, at least about 8 cm, or at least about 9 cm. In some embodiments, the expanded region 1332 of the outlet 1330 can have a diameter of no more than about 10 cm, no more than about 9 cm, no more than about 8 cm, no more than about 7 cm, no more than about 6 cm, no more than about 5 cm, no more than about 4 cm, no more than about 3 cm, no more than about 2 cm, no more than about 1 mm, no more than about 9 mm, no more than about 8 mm, no more than about 7 mm, no more than about 6 mm, no more than about 5 mm, no more than about 4 mm, no more than about 3 mm, or no more than about 2 mm. Combinations of the above-referenced diameters are also possible (e.g., at least about 1 mm and no more than about 10 cm or at least about 5 mm and no more than about 5 cm), inclusive of all values and ranges therebetween. In some embodiments, the expanded region 1332 of the outlet 1330 can have a diameter of about 1 mm, about 2 mm, about 3 mm, about 4 mm, about 5 mm, about 6 mm, about 7 mm, about 8 mm, about 9 mm, about 1 cm, about 2 cm, about 3 cm, about 4 cm, about 5 cm, about 6 cm, about 7 cm, about 8 cm, about 9 cm, or about 10 cm.

In some embodiments, the ratio between the diameter of the expanded region 1332 of the outlet 1330 and the diameter of the narrow region 1331 of the outlet 1330 can be at least about 1.1:1, at least about 1.2:1, at least about 1.3:1, at least about 1.4:1, at least about 1.5:1, at least about 1.6:1, at least about 1.7:1, at least about 1.8:1, at least about 1.9:1, at least about 2:1, at least about 3:1, at least about 4:1, at least about 5:1, at least about 6:1, at least about 7:1, at least about 8:1, at least about 9:1, at least about 10:1, at least about 15:1, at least about 20:1, at least about 25:1, at least about 30:1, at least about 35:1, at least about 40:1, or at least about 45:1. In some embodiments, the ratio between the diameter of the expanded region 1332 of the outlet 1330 and the diameter of the narrow region 1331 of the outlet 1330 can be no more than about 50:1, no more than about 45:1, no more than about 40:1, no more than about 35:1, no more than about 30:1, no more than about 25:1, no more than about 20:1, no more than about 15:1, no more than about 10:1, no more than about 9:1, no more than about 8:1, no more than about 7:1, no more than about 6:1, no more than about 5:1, no more than about 4:1, no more than about 3:1, no more than about 2:1, no more than about 1.9:1, no more than about 1.8:1, no more than about 1.7:1, no more than about 1.6:1, no more than about 1.5:1, no more than about 1.4:1, no more than about 1.3:1, or no more than about 1.2:1. Combinations of the above-referenced ratios are also possible (e.g., at least about 1.1:1 and no more than about 50:1 or at least about 1.5:1 and no more than about 8:1), inclusive of all values and ranges therebetween. In some embodiments, the ratio between the diameter of the expanded region 1332 of the outlet 1330 and the diameter of the narrow region 1331 of the outlet 1330 can be about 1.1:1, about 1.2:1, about 1.3:1, about 1.4:1, about 1.5:1, about 1.6:1, about 1.7:1, about 1.8:1, at least about 1.9:1, at least about 2:1, at least about 3:1, at least about 4:1, at least about 5:1, at least about 6:1, at least about 7:1, at least about 8:1, at least about 9:1, at least about 10:1, at least about 15:1, at least about 20:1, at least about 25:1, at least about 30:1, at least about 35:1, at least about 40:1, about 45:1, or about 50:1.

In some embodiments, the length-to-diameter ratio of the narrow region 1321 of the third inlet 1320 can be at least about 1:1, at least about 2:1, at least about 3:1, at least about 4:1, at least about 5:1, at least about 6:1, at least about 7:1, at least about 8:1, at least about 9:1, at least about 10:1, at least about 20:1, at least about 30:1, at least about 40:1, at least about 50:1, at least about 60:1, at least about 70:1, at least about 80:1, or at least about 90:1. In some embodiments, the length-to-diameter ratio of the narrow region 1321 of the third inlet 1320 can be no more than about 100:1, no more than about 90:1, no more than about 80:1, no more than about 70:1, no more than about 60:1, no more than about 50:1, no more than about 40:1, no more than about 30:1, no more than about 20:1, no more than about 10:1, no more than about 9:1, no more than about 8:1, no more than about 7:1, no more than about 6:1, no more than about 5:1, no more than about 4:1, no more than about 3:1, or no more than about 2:1. Combinations of the above-referenced length-to-diameter ratios are also possible (e.g., at least about 1:1 and no more than about 100:1 or at least about 5:1 and no more than about 50:1), inclusive of all values and ranges therebetween. In some embodiments, the length-to-diameter ratio of the narrow region 1321 of the third inlet 1320 can be about 1:1, about 2:1, about 3:1, about 4:1, about 5:1, about 6:1, about 7:1, about 8:1, about 9:1, about 10:1, about 20:1, about 30:1, about 40:1, about 50:1, about 60:1, about 70:1, about 80:1, about 90:1, or about 100:1.

In some embodiments, the length-to-diameter ratio of the narrow region 1331 of the outlet 1330 can be at least about 1:1, at least about 2:1, at least about 3:1, at least about 4:1, at least about 5:1, at least about 6:1, at least about 7:1, at least about 8:1, at least about 9:1, at least about 10:1, at least about 20:1, at least about 30:1, at least about 40:1, at least about 50:1, at least about 60:1, at least about 70:1, at least about 80:1, or at least about 90:1. In some embodiments, the length-to-diameter ratio of the narrow region 1331 of the outlet 1331 can be no more than about 100:1, no more than about 90:1, no more than about 80:1, no more than about 70:1, no more than about 60:1, no more than about 50:1, no more than about 40:1, no more than about 30:1, no more than about 20:1, no more than about 10:1, no more than about 9:1, no more than about 8:1, no more than about 7:1, no more than about 6:1, no more than about 5:1, no more than about 4:1, no more than about 3:1, or no more than about 2:1. Combinations of the above-referenced length-to-diameter ratios are also possible (e.g., at least about 1:1 and no more than about 100:1 or at least about 5:1 and no more than about 50:1), inclusive of all values and ranges therebetween. In some embodiments, the length-to-diameter ratio of the narrow region 1331 of the outlet 1330 can be about 1:1, about 2:1, about 3:1, about 4:1, about 5:1, about 6:1, about 7:1, about 8:1, about 9:1, about 10:1, about 20:1, about 30:1, about 40:1, about 50:1, about 60:1, about 70:1, about 80:1, about 90:1, or about 100:1. In some embodiments, the length-to-diameter ratio of the narrow region 1331 of the outlet 1330 can be between about 6:1 and about 10:1. In some embodiments, the length-to-diameter ratio can be attuned so that so that the reagents have mixed thoroughly finished before leaving the narrow region 1331 of the outlet 1330.

In some embodiments the ratio of the diameter of the narrow region 1321 of the third inlet 1320 to the diameter of the narrow region 1331 of the outlet 1330 can be at least about 0.1:1, at least about 0.2:1, at least about 0.3:1, at least about 0.4:1, at least about 0.5:1, at least about 0.6:1, at least about 0.7:1, at least about 0.8:1, at least about 0.9:1, at least about 1:1, at least about 2:1, at least about 3:1, at least about 4:1, at least about 5:1, at least about 6:1, at least about 7:1, at least about 8:1, or at least about 9:1. In some embodiments, the ratio of the diameter of the narrow region 1321 of the third inlet 1320 to the diameter of the narrow region 1331 of the outlet 1330 can be no more than about 10:1, no more than about 9:1, no more than about 8:1, no more than about 7:1, no more than about 6:1, no more than about 5:1, no more than about 4:1, no more than about 3:1, no more than about 2:1, no more than about 1:1, no more than about 0.9:1, no more than about 0.8:1, no more than about 0.7:1, no more than about 0.6:1, no more than about 0.5:1, no more than about 0.4:1, no more than about 0.3:1, or no more than about 0.2:1 Combinations of the above-referenced ratios are also possible (e.g., at least about 0.1:1 and no more than about 10:1 or at least about 0.5:1 and no more than about 5:1), inclusive of all values and ranges therebetween. In some embodiments, the ratio of the diameter of the narrow region 1321 of the third inlet 1320 to the diameter of the narrow region 1331 of the outlet 1330 can be about 0.1:1, about 0.2:1, about 0.3:1, about 0.4:1, about 0.5:1, about 0.6:1, about 0.7:1, about 0.8:1, about 0.9:1, about 1:1, about 2:1, about 3:1, about 4:1, about 5:1, about 6:1, about 7:1, about 8:1, about 9:1, or about 10:1.

As shown, the common inlet 1305 bends upstream of the location where the common inlet 1305 feeds to the first inlet 1310 and the second inlet 1315. As shown, the bend in the common inlet 1305 is about 90°, when measured from an imaginary straight line extending from the portion of the common inlet 1305 upstream of the bend. In some embodiments, the bend in the common inlet 1305 can be at least about 30°, at least about 40°, at least about 50°, at least about 60°, at least about 70°, at least about 80°, at least about 90°, at least about 100°, at least about 110°, at least about 120°, at least about 130°, or at least about 140°. In some embodiments, the bend in the common inlet 1305 can be no more than about 150°, no more than about 140°, no more than about 130°, no more than about 120°, no more than about 110°, no more than about 100°, no more than about 90°, no more than about 80°, no more than about 70°, no more than about 60°, no more than about 50°, or no more than about 40°. Combinations of the above-referenced angles are also possible (e.g., at least about 30° and no more than about 150° or at least about 60° and no more than about 120°), inclusive of all values and ranges therebetween. In some embodiments, the bend in the common inlet 1305 can be about 30°, about 40°, about 50°, about 60°, about 70°, about 80°, about 90°, about 100°, about 110°, about 120°, about 130°, about 140°, or about 150°.

Table 1 includes EDT of the mixer 1300 at various combined flow rates of both ethanol and water streams through a mixer. The inlet ethanol has a concentration of about 25 vol % and is further diluted by water at an inline dilution step (ILD) to about 10.5 vol % ethanol.

TABLE 1
Average EDT for Cross-mixer with 1 mm LSS
inlet and 4 mm Narrow Region of Outlet

| Flow Rate (ml/min) | EDT (s) | EDT STDEV (s) | EDT STDEV/EDT |
|---|---|---|---|
| 200 | 0.0034 | 0.00215 | 0.63 |
| 400 | 0.0017 | 0.00101 | 0.59 |
| 532 | 0.0013 | 0.00076 | 0.59 |

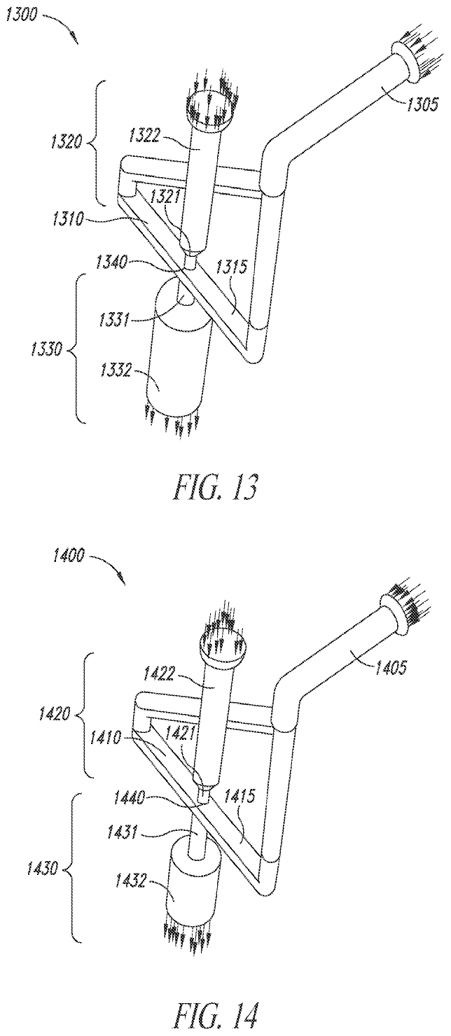

FIG. 14 is an illustration of a cross mixer 1400, according to an embodiment. As shown, the cross mixer 1400 includes a common inlet 1405 feeding a first inlet 1410 and a second inlet 1415, and a third inlet 1420, the third inlet 1420 configured to receive an LNP-containing fluid. The cross mixer 1400 further includes an outlet 1430 and a central region 1440 fluidically coupled to the common inlet 1405, the first inlet 1410, the second inlet 1415, the third inlet 1420, and the outlet 1430. In some embodiments, the common inlet 1405, the first inlet 1410, the second inlet 1415, the third inlet 1420, the outlet 1430, and the central region 1440 can be the same or substantially similar to the common inlet 1305, the first inlet 1310, the second inlet 1315, the third inlet 1320, the outlet 1330, and the central region 1340, as described above with reference to FIG. 13. Thus, certain aspects of the common inlet 1405, first inlet 1410, the second inlet 1415, the third inlet 1420, the outlet 1430, and the central region 1440 are not described in greater detail herein.

As shown, the third inlet 1420 includes a narrow portion 1421 and an expanded portion 1422 upstream of the narrow portion 1421. As shown, the outlet 1430 includes a narrow region 1431 and an expanded region 1432 downstream of the narrow region 1431. As shown, the narrow region 1431 has a length of 12 mm. In some embodiments, the narrow region 1431 of the outlet 1430 can have any of the lengths of the narrow region 1331 of the outlet 1330, as described above with reference to FIG. 13. Table 2 includes EDT of the mixer 1600 at various LSS flow rates.

TABLE 2
Average EDT for Cross-mixer with 1 mm LSS
inlet and 4 mm Narrow Region of Outlet

| Flow Rate (ml/min) | EDT (s) | EDT STDEV (s) | EDT STDEV/EDT |
|---|---|---|---|
| 200 | 0.0055 | 0.00482 | 0.87 |
| 400 | 0.0021 | 0.00154 | 0.74 |
| 532 | 0.0015 | 0.0015 | 0.73 |

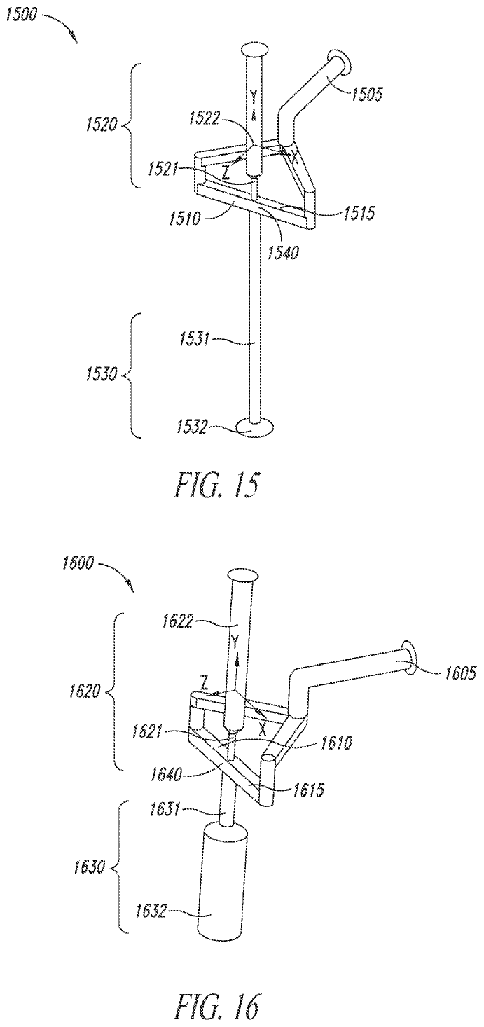

FIG. 15 is an illustration of a cross mixer 1500, according to an embodiment. As shown, the cross mixer 1500 includes a common inlet 1505 feeding a first inlet 1510 and a second inlet 1515, and a third inlet 1520, the third inlet 1520 configured to receive an LNP-containing fluid. The cross mixer 1500 further includes an outlet 1530 and a central region 1540 fluidically coupled to the common inlet 1505, the first inlet 1510, the second inlet 1515, the third inlet 1520, and the outlet 1530. In some embodiments, the common inlet 1505, the first inlet 1510, the second inlet 1515, the third inlet 1520, the outlet 1530, and the central region 1540 can be the same or substantially similar to the common inlet 1305, the first inlet 1310, the second inlet 1315, the third inlet 1320, the outlet 1330, and the central region 1340, as described above with reference to FIG. 13. Thus, certain aspects of the common inlet 1505, the first inlet 1510, the second inlet 1515, the third inlet 1520, the outlet 1530, and the central region 1540 are not described in greater detail herein.

As shown, the third inlet 1520 includes a narrow portion 1521 and an expanded portion 1522 upstream of the narrow portion 1521. As shown, the outlet 1530 includes a narrow region 1531 and an expanded region 1532 downstream of the narrow region 1531. As shown, the narrow region 1531 has a length of 40 mm. In some embodiments, the narrow region 1531 of the outlet 1530 can have any of the lengths of the narrow region 1331 of the outlet 1330, as described above with reference to FIG. 13.

FIG. 16 is an illustration of a cross mixer 1600, according to an embodiment. As shown, the cross mixer 1600 includes a common inlet 1605 feeding a first inlet 1610 and a second inlet 1615, and a third inlet 1620, the third inlet 1620 configured to receive an LNP-containing fluid. The cross mixer 1600 further includes an outlet 1630 and a central region 1640 fluidically coupled to the common inlet 1605, the first inlet 1610, the second inlet 1615, the third inlet 1620, and the outlet 1630. In some embodiments, the common inlet 1605, the first inlet 1610, the second inlet 1615, the third inlet 1620, the outlet 1630, and the central region 1640 can be the same or substantially similar to the common inlet 1305, the first inlet 1310, the second inlet 1315, the third inlet 1320, the outlet 1330, and the central region 1340, as described above with reference to FIG. 13. Thus, certain aspects of the common inlet 1605, the first inlet 1610, the second inlet 1615, the third inlet 1620, the outlet 1630, and the central region 1640 are not described in greater detail herein.

As shown, the third inlet 1620 includes a narrow portion 1621 and an expanded portion 1622 upstream of the narrow portion 1621. As shown, the outlet 1630 includes a narrow region 1631 and an expanded region 1632 downstream of the narrow region 1631. As shown, the narrow region 1631 has a length of 8 mm. In some embodiments, the narrow region 1631 of the outlet 1630 can have any of the lengths of the narrow region 1331 of the outlet 1330, as described above with reference to FIG. 13. Table 3 includes EDT of the mixer 1600 at various LSS flow rates.

TABLE 3
Average EDT for Cross-mixer with 1 mm LSS
inlet and 4 mm Narrow Region of Outlet

| Flow Rate (ml/min) | EDT (s) | EDT STDEV (s) | EDT STDEV/EDT |
|---|---|---|---|
| 200 | 0.0044 | 0.00333 | 0.76 |
| 400 | 0.0019 | 0.00138 | 0.71 |
| 532 | 0.0015 | 0.00105 | 0.71 |

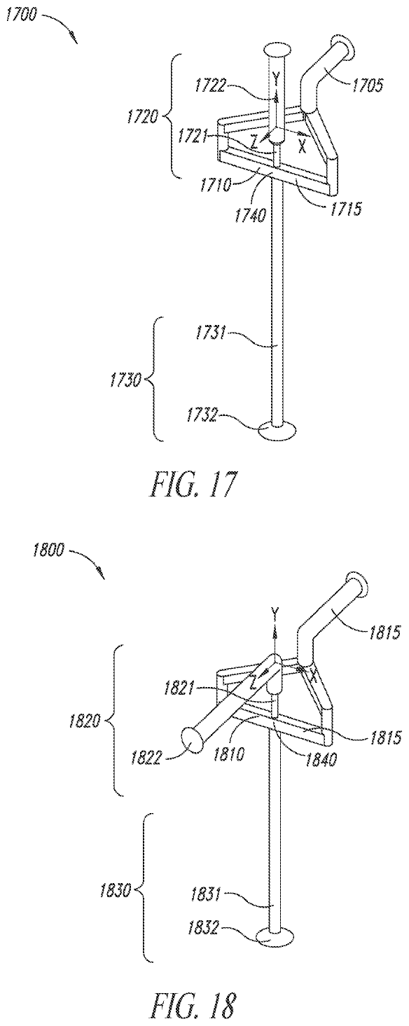

FIG. 17 is an illustration of a cross mixer 1700, according to an embodiment. As shown, the cross mixer 1700 includes a common inlet 1705 feeding a first inlet 1710 and a second inlet 1715, and a third inlet 1720, the third inlet 1720 configured to receive an LNP-containing fluid. The cross mixer 1700 further includes an outlet 1730 and a central region 1740 fluidically coupled to the common inlet 1705, the first inlet 1710, the second inlet 1715, the third inlet 1720, and the outlet 1730. In some embodiments, the common inlet 1705, the first inlet 1710, the second inlet 1715, the third inlet 1720, the outlet 1730, and the central region 1740 can be the same or substantially similar to the common inlet 1305, the first inlet 1310, the second inlet 1315, the third inlet 1320, the outlet 1330, and the central region 1340, as described above with reference to FIG. 13. Thus, certain aspects of the common inlet 1705, the first inlet 1710, the second inlet 1715, the third inlet 1720, the outlet 1730, and the central region 1740 are not described in greater detail herein.

As shown, the third inlet 1720 includes a narrow portion 1721 and an expanded portion 1722 upstream of the narrow portion 1721. As shown, the outlet 1730 includes a narrow region 1731 and an expanded region 1732 downstream of the narrow region 1731. As shown, the narrow region 1731 has a length of 60 mm. In some embodiments, the narrow region 1731 of the outlet 1730 can have any of the lengths of the narrow region 1331 of the outlet 1330, as described above with reference to FIG. 13.

FIG. 18 is an illustration of a cross mixer 1800, according to an embodiment. As shown, the cross mixer 1800 includes a common inlet 1805 feeding a first inlet 1810 and a second inlet 1815, and a third inlet 1820, the third inlet 1820 configured to receive an LNP-containing fluid. The cross mixer 1800 further includes an outlet 1830 and a central region 1840 fluidically coupled to the common inlet 1805, the first inlet 1810, the second inlet 1815, the third inlet 1820, and the outlet 1830. In some embodiments, the first inlet 1810, the second inlet 1815, the third inlet 1820, the outlet 1830, and the central region 1840 can be the same or substantially similar to the common inlet 1305, the first inlet 1310, the second inlet 1315, the third inlet 1320, the outlet 1330, and the central region 1340, as described above with reference to FIG. 13. Thus, certain aspects of the common inlet 1805, the first inlet 1810, the second inlet 1815, the third inlet 1820, the outlet 1830, and the central region 1840 are not described in greater detail herein.

As shown, the third inlet 1820 includes a narrow portion 1821 and an expanded portion 1822 upstream of the narrow portion 1821. As shown, the outlet 1830 includes a narrow region 1831 and an expanded region 1832 downstream of the narrow region 1831. As shown, the narrow region 1831 has a length of 40 mm. In some embodiments, the narrow region 1831 of the outlet 1830 can have any of the lengths of the narrow region 1331 of the outlet 1330, as described above with reference to FIG. 13. As shown, the third inlet 1820 includes a bend measuring about 90°. In some embodiments, the bend in the third inlet 1820 can be at least about 30°, at least about 40°, at least about 50°, at least about 60°, at least about 70°, at least about 80°, at least about 90°, at least about 100°, at least about 110°, at least about 120°, at least about 130°, or at least about 140°. In some embodiments, the bend in the third inlet 1820 can be no more than about 150°, no more than about 140°, no more than about 130°, no more than about 120°, no more than about 110°, no more than about 100°, no more than about 90°, no more than about 80°, no more than about 70°, no more than about 60°, no more than about 50°, or no more than about 40°. Combinations of the above-referenced angles are also possible (e.g., at least about 30° and no more than about 150° or at least about 60° and no more than about 120°), inclusive of all values and ranges therebetween. In some embodiments, the bend in the third inlet 1820 can be about 30°, about 40°, about 50°, about 60°, about 70°, about 80°, about 90°, about 100°, about 110°, about 120°, about 130°, about 140°, or about 150°.

As shown, the third inlet 1820 includes one bend. In some embodiments, the third inlet can include about 2, about 3, about 4, about 5, about 6, about 7, about 8, about 9, or about 10 bends, inclusive of all values and ranges therebetween. Any of the bends can have any of the any of the angles described above.

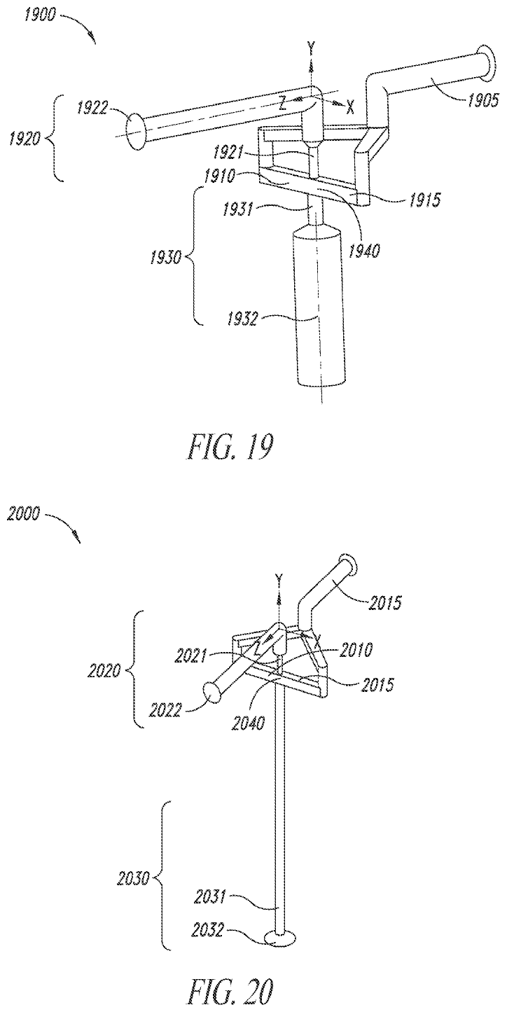

FIG. 19 is an illustration of a cross mixer 1900, according to an embodiment. As shown, the cross mixer 1900 includes a common inlet 1905 feeding a first inlet 1910 and a second inlet 1915, and a third inlet 1920, the third inlet 1920 configured to receive an LNP-containing fluid. The cross mixer 1900 further includes an outlet 1930 and a central region 1940 fluidically coupled to the common inlet 1905, the first inlet 1910, the second inlet 1915, the third inlet 1920, and the outlet 1930. In some embodiments, the common inlet 1905, the first inlet 1910, the second inlet 1915, the third inlet 1920, the outlet 1930, and the central region 1940 can be the same or substantially similar to the first inlet 1805, the first inlet 1810, the second inlet 1815, the third inlet 1820, the outlet 1830, and the central region 1840, as described above with reference to FIG. 18. Thus, certain aspects of the common inlet 1905, the first inlet 1910, the second inlet 1915, the third inlet 1920, the outlet 1930, and the central region 1940 are not described in greater detail herein.

As shown, the third inlet 1920 includes a narrow portion 1921 and an expanded portion 1922 upstream of the narrow portion 1921. As shown, the outlet 1930 includes a narrow region 1931 and an expanded region 1932 downstream of the narrow region 1931. As shown, the narrow region 1931 has a length of 4 mm. In some embodiments, the narrow region 1931 of the outlet 1930 can have any of the lengths of the narrow region 1331 of the outlet 1330, as described above with reference to FIG. 13. As shown, the third inlet 1920 includes a narrow region 1921 and an expanded region 1922 upstream of the narrow region 1921. As shown, the narrow region 1921 of the third inlet 1920 has a diameter of 1 mm. In some embodiments, the narrow region 1921 of the third inlet 1920 can have any of the diameters of the narrow region 1321 of the third inlet 1320, as described above with reference to FIG. 13. Table 4 includes EDT of the mixer 1900 at various LSS flow rates. As shown, the EDT of the mixer 1900 is lower than the EDT of the mixer 1300 without a bend in the third inlet 1320.

TABLE 4
Average EDT for Cross-mixer with 1 mm LSS inlet, bend
in LSS inlet and 4 mm Narrow Region of Outlet

| Flow Rate (ml/min) | EDT (s) | EDT STDEV (s) | EDT STDEV/EDT |
|---|---|---|---|
| 200 | 0.0029 | 0.00159 | 0.55 |
| 400 | 0.0014 | 0.00073 | 0.53 |
| 532 | 0.0011 | 0.00058 | 0.55 |

FIG. 20 is an illustration of a cross mixer 2000, according to an embodiment. As shown, the cross mixer 2000 includes a common inlet 2005 feeding a first inlet 2010 and a second inlet 2015, and a third inlet 2020, the third inlet 2020 configured to receive an LNP-containing fluid. As shown, the third inlet 2020 includes a narrow region 2021 and an expanded region 2022 upstream of the narrow region 2021. The cross mixer 2000 further includes an outlet 2030 and a central region 2040 fluidically coupled to the common inlet 2005, the first inlet 2010, the second inlet 2015, the third inlet 2020, and the outlet 2030. In some embodiments, the common inlet 2005, the first inlet 2010, the second inlet 2015, the third inlet 2020, the outlet 2030, and the central region 2040 can be the same or substantially similar to the first inlet 1805, the first inlet 1810, the second inlet 1815, the third inlet 1820, the outlet 1830, and the central region 1840, as described above with reference to FIG. 18. Thus, certain aspects of the common inlet 2005, the first inlet 2010, the second inlet 2015, the third inlet 2020, the outlet 2030, and the central region 2040 are not described in greater detail herein.

As shown, the third inlet 2020 includes a narrow portion 2021 and an expanded portion 2022 upstream of the narrow portion 2021. As shown, the outlet 2030 includes a narrow region 2031 and an expanded region 2032 downstream of the narrow region 2031. As shown, the narrow region 2031 has a length of 60 mm. In some embodiments, the narrow region 2031 of the outlet 2030 can have any of the lengths of the narrow region 1331 of the outlet 1330, as described above with reference to FIG. 13.

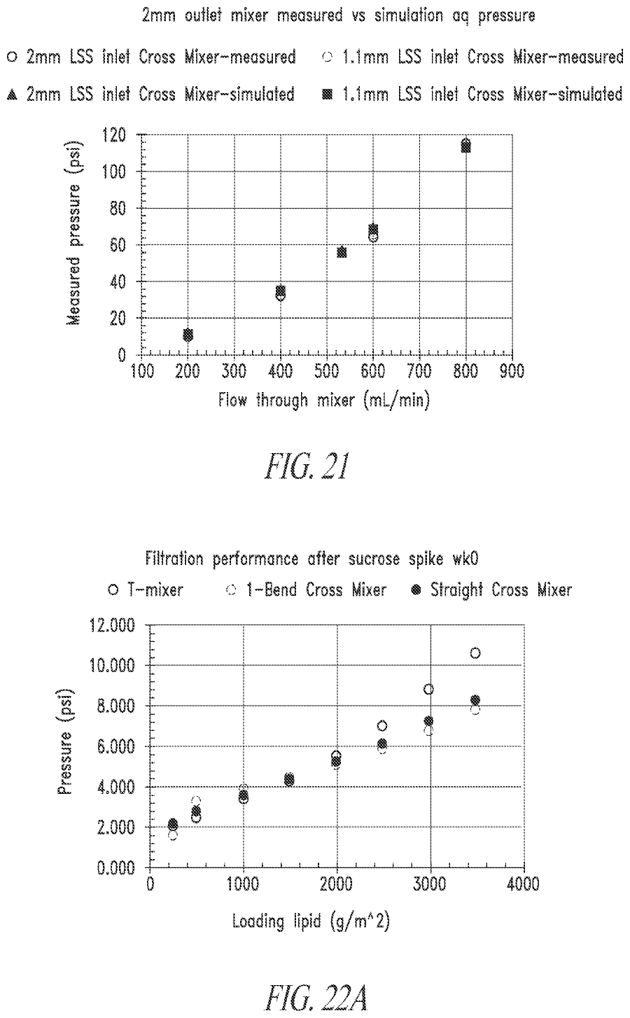

FIG. 21 is a graph of pressure measured against LSS flow rate across various cross mixers. As shown, the measured results are similar to the simulated results, and there are minimal differences between the 1.1 mm inlet and the 2 mm inlet. As shown in FIG. 21, the mixer with a 1.1 mm inlet has similar back pressure compared to the 2 mm inlet cross mixer. In other words, the 1.1 mm inlet cross mixer produces smaller LNPs without sacrificing back pressure.

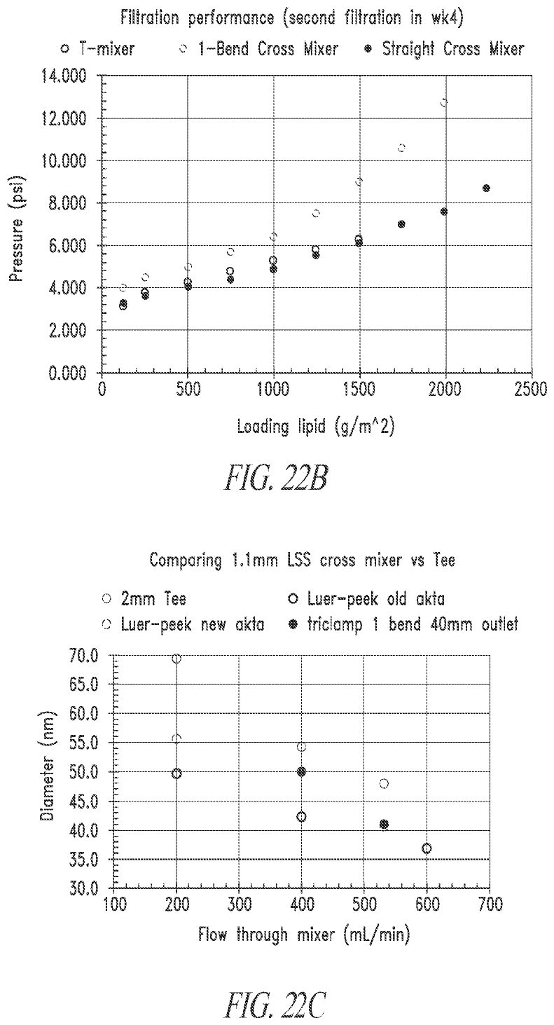

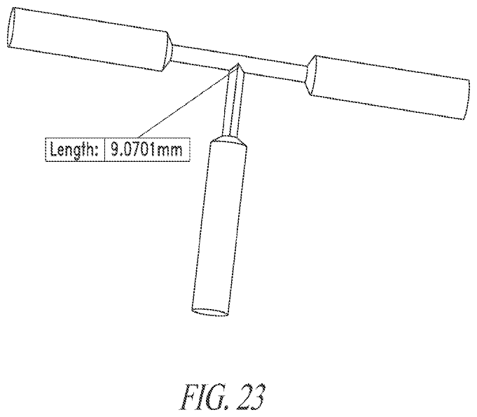

FIG. 22A is a graph of pressure as a function of loading lipid rate in various mixers during initial filtration of empty lipids. Table 5 shows LNP size and PDI data during initial filtration.

TABLE 5
LNP size during initial filtration

| | Size Before | | Size Post | |
|---|---|---|---|---|
| | Filtration | | Filtration | |
| Mixer | (nm) | PDI | (nm) | PDI |
| T-Mixer | 39.4 | 0.167 | 38.0 | 0.180 |
| One-Bend Cross | 39.9 | 0.198 | 38.5 | 0.169 |
| Mixer | | | | |
| Straight Cross | 38.9 | 0.198 | 38.4 | 0.163 |
| Mixer | | | | |

FIG. 22B is a graph of pressure as a function of loading lipid rate in various mixers during after 5° C. storage for four weeks. Table 6 shows LNP size and PDI data after 5° C. for four weeks.

TABLE 6
LNP size after four weeks of filtration

| | Size Before | | Size Post | |
|---|---|---|---|---|
| | Filtration | | Filtration | |
| Mixer | (nm) | PDI | (nm) | PDI |
| T-Mixer | 45.8 | 0.176 | 44.2 | 0.203 |
| One-Bend | 44.4 | 0.217 | 43.7 | 0.232 |
| Cross Mixer | | | | |
| Straight | 45.1 | 0.231 | 43.4 | 0.262 |
| Cross Mixer | | | | |

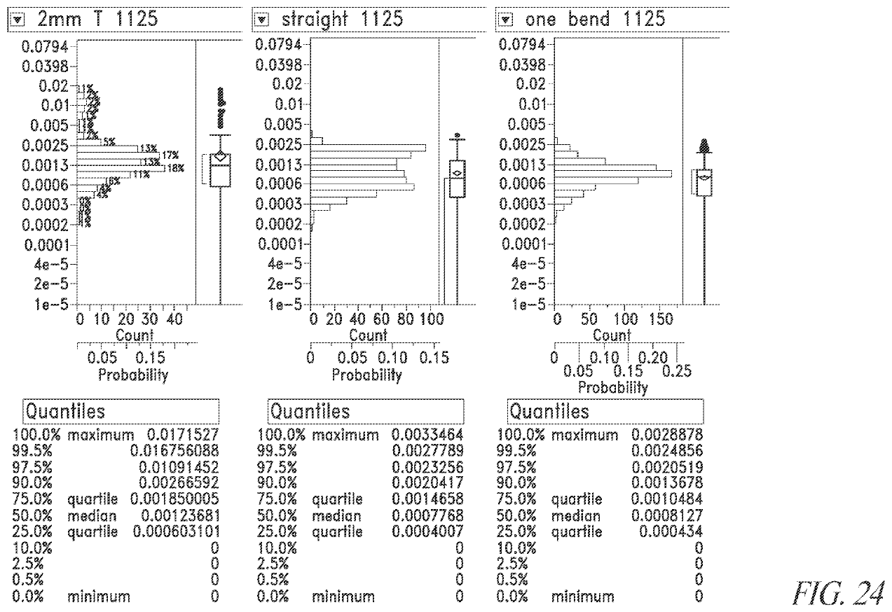

As shown, cross mixers and T-mixers produce LNPs of similar filtration performance. Lower pressures lead to less membrane clogging and less aggregate formation over time. The T-mixer with a bend in the LSS inlet shows a pressure increase after four weeks of storage. Currently at day 1, the quality (i.e., size, size distribution, subvisible, circular dichroism (CD) and loading performance) of eLNPs made using T-mixers and different cross mixers is very similar. There is some variation of filtration performance at day 1, with cross mixers showing slightly better results. On day 28, the one-bend cross mixer eLNP produced diminished filtration performance in its second filtration compared to the T-mixer and the straight cross mixer. Overall, no significant difference in filtration was observed. Cross mixers more quickly reach plateau size with less flow rate needed compared to T-mixers, but at scale-b, cross mixers and T-mixers produce eLNPs of similar size and quality. FIG. 23 shows a T-mixer with a 2 mm outlet diameter and a 9 mm outlet length. Table 7 shows EDT measurements for various mixers with a flow rate of 1,125 mL/min of water and ethanol combined. More specifically, the data is shown with respect to the T-mixer shown in FIG. 23 compared to the cross mixers shown in FIG. 15 and FIG. 18. FIG. 24 shows distribution data of the three mixers compared in Table 7. As shown, the cross mixers have much faster EDTs than the T-mixer.

TABLE 7
EDT measurements for various T-mixers

| | | | | | Ethanol | Water |
|---|---|---|---|---|---|---|
| | | | EDT | EDT | Inlet | Inlet |
| | Flow Rate | EDT | STDEV | STDEV/ | Pressure | Pressure |
| Mixer | (mL/min) | (ms) | (ms) | EDT | (psi) | (psi) |
| 2 mm T- | 1125 | 1.7 | 2.5 | 1.46 | 4.04 | 4.99 |
| Mixer | | | | | | |
| (FIG. 23) | | | | | | |
| 2 mm | 1125 | 0.9 | 0.7 | 0.78 | 8.51 | 8.90 |
| Straight | | | | | | |
| Inlet | | | | | | |
| Cross | | | | | | |
| Mixer | | | | | | |
| (FIG. 15) | | | | | | |
| 2 mm One | 1125 | 0.8 | 0.6 | 0.74 | 8.61 | 8.92 |
| Bend Inlet | | | | | | |
| Cross- | | | | | | |
| Mixer | | | | | | |
| (FIG. 18) | | | | | | |

Table 8 shows experimental data for various mixers. Mixing experiments were done using a VM pump system. Real operating pressures were close to simulation predictions. The T-mixer had the lowest pressure, while for cross mixers, the pressure increased with increasing outlet channel length, but the overall pressure was still low. Sizes of particles after nanoprecipitation were similar, with the size of the eLNP from the short outlet cross mixer a bit larger than particles from the other cross mixers.

Table 9 compares dynamic light scattering (DLS) measurements to determine LNP sizes over various processing steps with different mixers. As shown, no major size variation was observed during the TFF step.

Table 10 shows comparisons of particle sizes before and after neutralization.

As shown, cross mixers produce slightly smaller LNPs compared to T-mixers, but the difference between the two is not significant. Mixers without bends produce the smallest LNPs. In-line dilution (ILD) refers to the aqueous buffer flow rate used to dilute the 25 vol % ethanol stream entering the mixer (to about 10.4 vol %) to prevent LNP size maturation in a 25 vol % ethanol environment. Encapsulation efficiency of mRNA (RG EE %) is measured via Robogreen assay. As shown, the encapsulation of mRNA is almost perfect.

Table 11 shows comparisons of LNP sizes in various mixers at various flow rates and pressures. As shown, higher flow rates lead to smaller particle sizes.

TABLE 8
Experimental Data for Various Mixers

| | Mixer | Outlet | | | | | | | | |
|---|---|---|---|---|---|---|---|---|---|---|
| | Outlet | Narrow | | | In-line | | LSS pressure | Aq pressure | size after | |
| | Cross | Channel | Ethanol | | dilution | | nano- | nano- | nano- | |
| Mixer | Section | Length | Flow | Water Flow | (ILD) | Residence | precipitation | precipitation | precipitation | |
| Type | Size (mm) | (mm) | (mL/min) | (mL/min) | (mL/min) | Time (s) | (psi) | (psi) | (nm) | PDI |
| T-Mixer | 2 | N/A | 281 | 844 | 1575 | 5 | 3.6 | 4.7 | 39.4 | 0.184 |
| One Bend | 2 | 40 | 281 | 844 | 1575 | 5 | 7.2 | 8.9 | 38.7 | 0.227 |
| LSS Inlet | | | | | | | | | | |
| Cross Mixer | | | | | | | | | | |
| Straight | 2 | 40 | 281 | 844 | 1575 | 5 | 6.9 | 8.2 | 37.3 | 0.206 |
| LSS Inlet | | | | | | | | | | |
| Cross Mixer | | | | | | | | | | |
| One Bend | 2 | 23 | 281 | 844 | 1575 | 5 | 5.5 | 6.7 | 39.5 | 0.182 |
| LSS Inlet | | | | | | | | | | |
| Cross Mixer | | | | | | | | | | |
| One Bend | 2 | 60 | 281 | 844 | 1575 | 5 | 8.4 | 9.8 | 37.8 | 0.171 |
| LSS Inlet | | | | | | | | | | |
| Cross Mixer | | | | | | | | | | |

TABLE 9
DLS Sizes Over Processing Steps

| | | | | | UF2 Next | | Sucrose | |
|---|---|---|---|---|---|---|---|---|
| | UF1 Size | | DF Size | | Day Size | | Spike Post | |
| Mixer Type | (nm) | PDI | (nm) | PDI | (nm) | PDI | Filtration | PDI |
| T-Mixer | 41.3 | 0.154 | 37.7 | 0.155 | 38.4 | 0.169 | 38.0 | 0.180 |
| One Bend | 39.8 | 0.195 | 37.4 | 0.192 | 38.8 | 0.168 | 38.5 | 0.169 |
| LSS Inlet | | | | | | | | |
| Cross Mixer, | | | | | | | | |
| 40 mm long | | | | | | | | |
| Outlet | | | | | | | | |
| Straight | 38.2 | 0.182 | 36.2 | 0.226 | 36.8 | 0.190 | 38.4 | 0.63 |
| LSS Inlet | | | | | | | | |
| Cross Mixer, | | | | | | | | |
| 40 mm Long | | | | | | | | |
| Outlet | | | | | | | | |

TABLE 10
Comparing fLNPs: DLS and Flow Cytometry

| | Size of | | | | | | | | |
|---|---|---|---|---|---|---|---|---|---|
| | Empty | PDI of | Size Before | | | | | | |
| Mixer | Particles | Empty | Neutralization | PDI Before | pH After | Size After | PDI After | Final | RG |
| Type | (nm) | Particles | (nm) | Neutralization | Neutralization | Neutralization | Neutralization | pH | EE % |
| 2 mm T- | 38.0 | 0.180 | 110.4 | 0.228 | 5.312 | 105.1 | 0.177 | 7.728 | 97.1 |
| mixer | | | | | | | | | |
| 2 mm | 38.5 | 0.169 | 109.5 | 0.216 | 5.322 | 102.8 | 0.191 | 7.679 | 97.2 |
| One Bend | | | | | | | | | |
| Cross | | | | | | | | | |
| 2 mm | 38.4 | 0.163 | 110.6 | 0.232 | 5.301 | 104.5 | 0.176 | 7.738 | 97.5 |
| Straight | | | | | | | | | |
| Cross | | | | | | | | | |
| 2 mm | 43.7 | 0.121 | 142.1 | 0.264 | 5.302 | 133.4 | 0.215 | 7.824 | 94.6 |
| Poseidon | | | | | | | | | |

TABLE 11
Comparing fLNPs: DLS and Flow Cytometry

| | Outlet | 400 mL/ | | 532 mL/ | Water | |
|---|---|---|---|---|---|---|
| LSS Inlet | Length | min size | | min size | pressure | |
| Orientation | (mm) | (nm) | PDI | (nm) | (psi) | PDI |
| Straight | 23 | 57.9 | 0.210 | 42.3 | 2.9 | 0.188 |
| Straight | 40 | 54.2 | 0.239 | 43.7 | 4.35 | 0.216 |
| Straight | 60 | 52.3 | 0.211 | 42.7 | 4.35 | 0.198 |
| 1 bend | 23 | 55.5 | 0.226 | 45.9 | 2.9 | 0.197 |
| 1 bend | 40 | 50.1 | 0.219 | 41.1 | 2.9 | 0.206 |
| 1 bend | 60 | 51.5 | 0.185 | 42.3 | 2.9 | 0.194 |
| 2 bends | 23 | 53.2 | 0.188 | 48.8 | 2.9 | 0.227 |
| 2 bends | 40 | 53.5 | 0.243 | 43.5 | 2.9 | 0.238 |
| 2 bends | 60 | 52.5 | 0.212 | 43.0 | 4.35 | 0.210 |

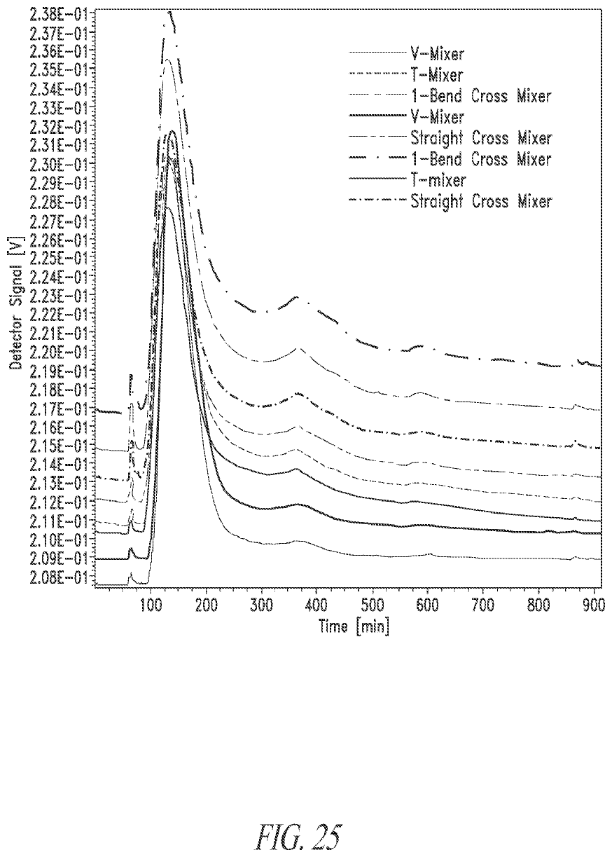

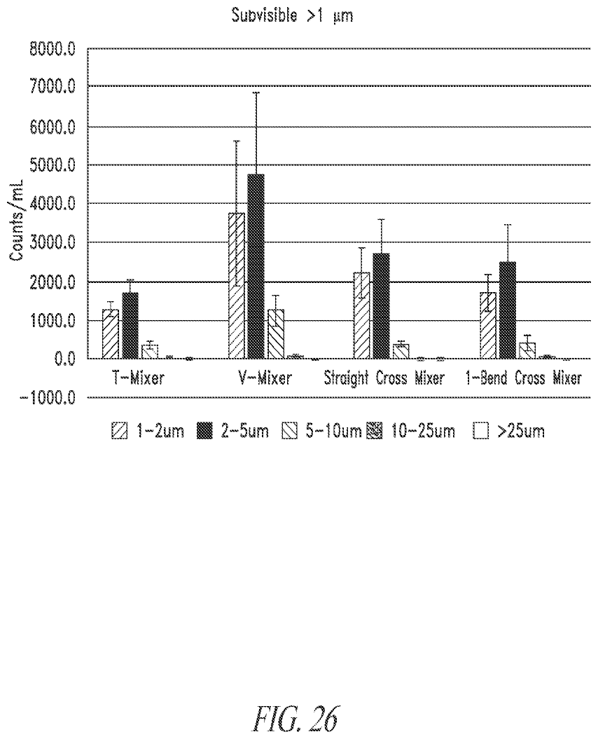

FIG. 25 is a graph of asymmetric flow field flow fractionation (AF4) data for eLNPs in various mixers. As shown, the 1-bend cross mixer produces the strongest signal, followed by the straight cross mixer, the T-mixer, and then the V-mixer. FIG. 26 shows particle size distribution date for eLNPs in various mixers, subject to Flow Cam analysis. As shown, the cross mixers produce the highest percentages of small particles, followed by the T-mixer, and then the V-mixer, which has a high percentage of particles in the 5 μm to 10 μm range.

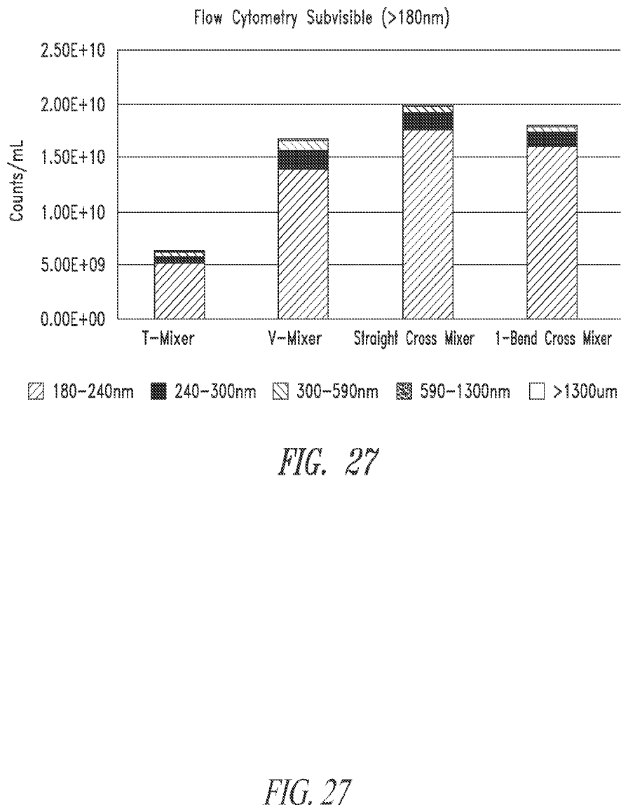

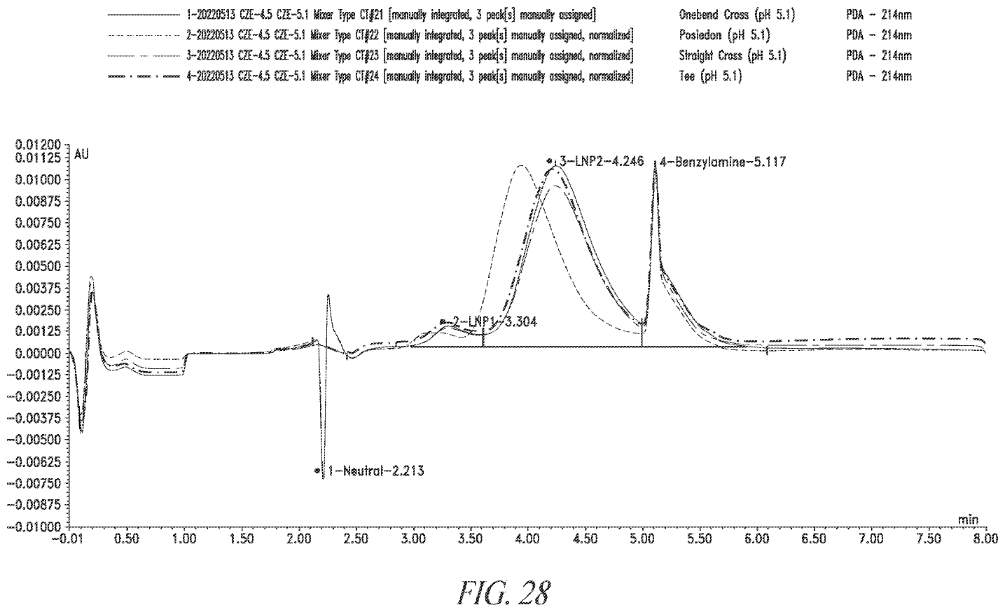

FIG. 27 shows flow cytometry data for eLNPs in various mixers. As shown, cross mixers and T-mixers produce a higher proportion of small particles (180-240 nm), as compared to the V-mixer. FIG. 28 shows capillary zone electrophoresis (CZE) data for eLNPs various mixers. The black data set represents a one-bend cross mixer, the blue data set represents a V-mixer, the pink data represents a straight cross mixer, and the red data represents a T-mixer. As shown, the T-mixer and the cross mixers show improved migration time as compared to the V-mixer.

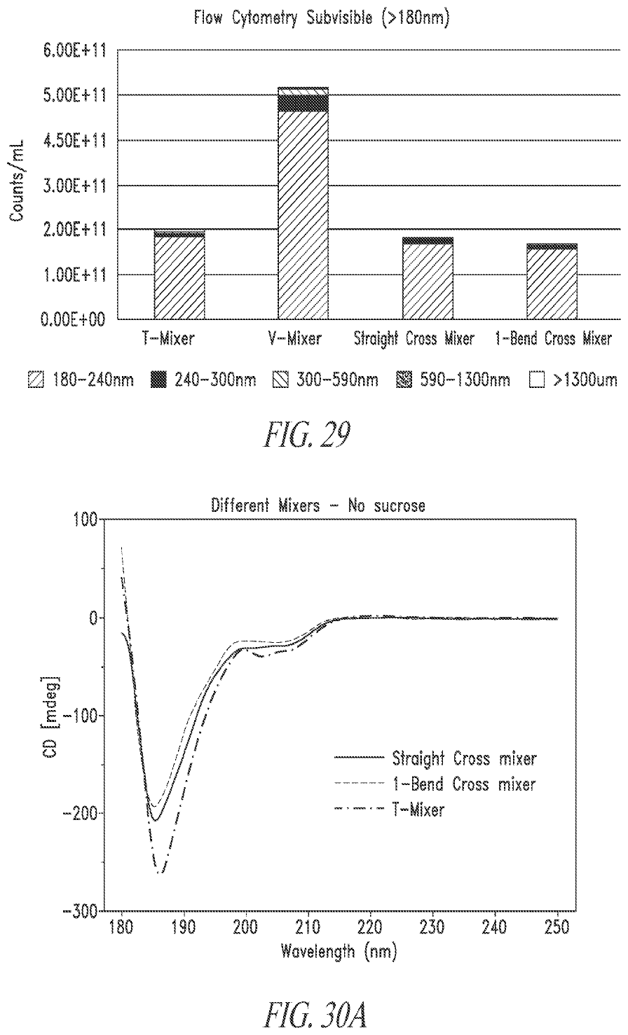

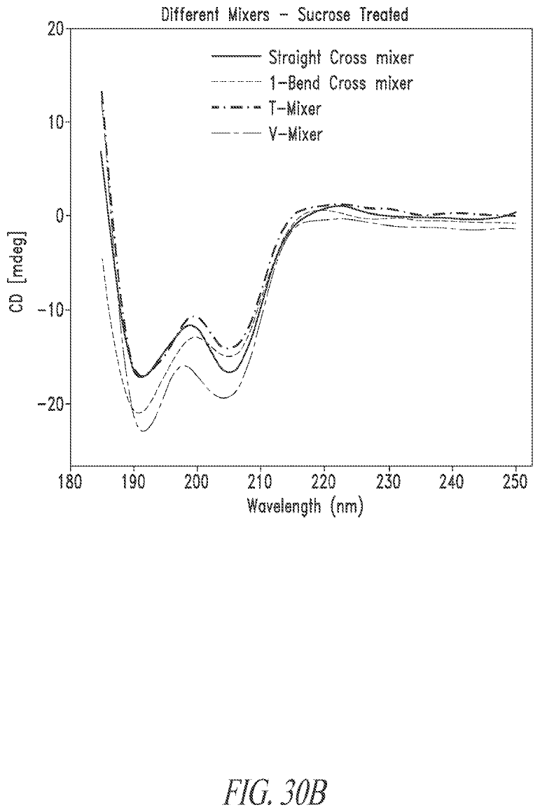

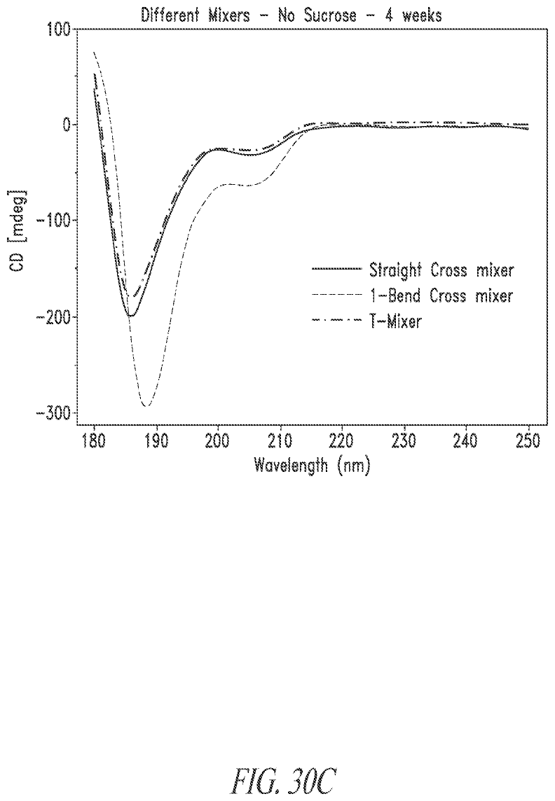

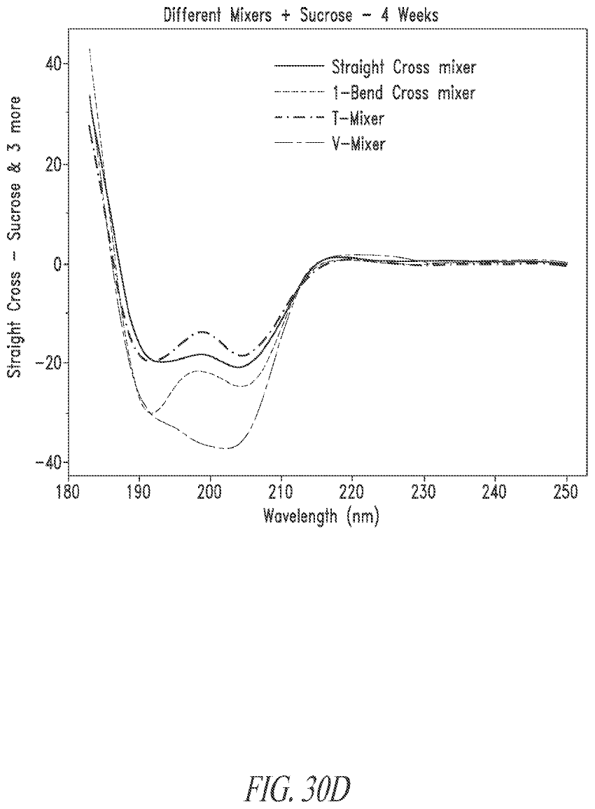

FIG. 29 shows flow cytometry data for fLNPs in various mixers. As shown, the V-mixer includes a higher amounts of small particles than the cross mixers and the T-mixer. FIGS. 30A-30D show CD data across various mixers with different sucrose treatment. FIG. 30A shows initial data with no sucrose. FIG. 30B shows initial data with sucrose treatment. FIG. 30C shows samples after 4 weeks of incubation at 5° C. and no sucrose treatment. FIG. 30D shows samples after 4 weeks of incubation at 5° C. with sucrose treatment. As shown, the straight cross mixer shows more cholesterol crystallization. The V-mixer has the largest change and the most cholesterol.

### LNPs

In some embodiments, the LNPs are substantially free of any nucleic acid (e.g., RNA).

In some embodiments, the LNPs are free of any nucleic acid (e.g., RNA).

In some embodiments, the LNPs have an average diameter of about 100 nm or less, about 95 nm or less, about 90 nm or less, about 85 nm or less, about 80 nm or less, about 75 nm or less, about 70 nm or less, about 65 nm or less, about 60 nm or less, about 55 nm or less, about 50 nm or less, about 45 nm or less, about 40 nm or less, about 35 nm or less, about 30 nm or less, about 25 nm or less, about 20 nm or less, or about 15 nm or less.

In some embodiments, the LNPs have an average diameter of about 10 nm or greater, about 15 nm or greater, about 20 nm or greater, about 25 nm or greater, about 30 nm or greater, about 35 nm or greater, about 40 nm or greater, about 45 nm or greater, about 50 nm or greater, about 55 nm or greater, about 65 nm or greater, about 70 nm or greater, about 75 nm or greater, about 80 nm or greater, about 85 nm or greater, about 90 nm or greater, or about 95 nm or greater.

Combinations of the above-recited ranges for the LNPs average diameter are also contemplated (e.g., about 10 nm to about 90 nm, about 10 nm to about 95 nm, about 10 nm to about 100 nm, about 15 nm to about 100 nm, about 20 nm to about 100 nm, or about 25 nm to about 100 nm.)

In some embodiments, the LNPs have an average diameter of about 10±5 nm, about 15±5 nm, about 20±5 nm, about 25±5 nm, about 30±5 nm, about 35±5 nm, about 40±5 nm, about 45±5 nm, about 50±5 nm, about 55±5 nm, about 60=5 nm, about 65±5 nm, about 70±5 nm, about 75±5 nm, about 80±5 nm, about 85±5 nm, about 90±5 nm, about 95±5 nm, or about 100±5 nm.

In some aspects, the present disclosure provides a lipid nanoparticle solution (LNP solution) being prepared by a process described herein.

In some aspects, the present disclosure provides a lipid nanoparticle (LNP) being prepared by a process described herein.

### Ionizable Lipids

The present disclosure provides ionizable lipids. In some embodiments, the ionizable lipids include a central amine moiety and at least one biodegradable group. In some embodiments, the ionizable lipid is an amino lipid. The lipids described herein may be advantageously used in lipid nanoparticles and lipid nanoparticle formulations for the delivery of therapeutic and/or prophylactics, such as a nucleic acid, to mammalian cells or organs.

In some aspects, the ionizable lipids of the present disclosure may be one or more of compounds of Formula (IL-1):

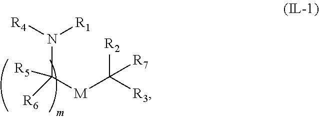

or their N-oxides, or salts or isomers thereof, wherein:
R¹ is selected from the group consisting of C₅₋₃₀ alkyl, C₅₋₂₀ alkenyl, —R*YR″, —YR″, and —R″M′R′;
R² and R³ are independently selected from the group consisting of H, C₁₋₁₄ alkyl, C₂₋₁₄ alkenyl, —R*YR″, —YR″, and —R*OR″, or R² and R³, together with the atom to which they are attached, form a heterocycle or carbocycle;
R⁴ is selected from the group consisting of hydrogen, a C₃₋₆ carbocycle, —(CH₂)ₙQ, —(CH₂)ₙCHQR, —(CH₂)ₒC(R¹⁰)₂(CH₂)ₙ₋ₒQ, —CHQR, —CQ(R)₂, and unsubstituted C₁₋₆ alkyl, where Q is selected from a carbocycle, heterocycle, —OR, —O(CH₂)ₙN(R)₂, —C(O)OR, —OC(O)R, —CX₃, —CX₂H, —CXH₂, —CN, —N(R)₂, —C(O)N(R)₂, —N(R)C(O)R, —N(R)S(O)₂R, —N(R)C(O)N(R)₂, —N(R)C(S)N(R)₂, —N(R)R⁸, —N(R)S(O)₂R⁸, —O(CH₂)ₙOR, —N(R)C(═NR⁹)N(R)₂, —N(R)C(═CHR⁹)N(R)₂, —OC(O)N(R)₂, —N(R)C(O)OR, —N(OR)C(O)R, —N(OR)S(O)₂R, —N(OR)C(O)OR, —N(OR)C(O)N(R)₂, —N(OR)C(S)N(R)₂, —N(OR)C(═NR⁹)N(R)₂, —N(OR)C(═CHR⁹)N(R)₂, —C(═NR⁹)N(R)₂, —C(═NR⁹)R, —C(O)N(R)OR, and —C(R)N(R)₂C(O)OR, each o is independently selected from 1, 2, 3, and 4, and each n is independently selected from 1, 2, 3, 4, and 5;
each R⁵ is independently selected from the group consisting of OH, C₁₋₃ alkyl, C₂₋₃ alkenyl, and H;
each R⁶ is independently selected from the group consisting of OH, C₁₋₃ alkyl, C₂₋₃ alkenyl, and H;
M and M′ are independently selected from —C(O)O—, —OC(O)—, —OC(O)-M″-C(O)O—, —C(O) N(R′)—, —N(R′)C(O)—, —C(O)—, —C(S)—, —C(S)S—, —SC(S)—, —CH(OH)—, —P(O)(OR′)O—, —S(O)₂—, —S—S—, an aryl group, and a heteroaryl group, in which M″ is a bond, C₁₋₁₃ alkyl or C₂₋₁₃ alkenyl;
R⁷ is selected from the group consisting of C₁₋₃ alkyl, C₂₋₃ alkenyl, and H;
R⁸ is selected from the group consisting of C₃₋₆ carbocycle and heterocycle; R′ is selected from the group consisting of H, CN, NO₂, C₁₋₆ alkyl, —OR, —S(O)₂R, —S(O)₂N(R)₂, C₂₋₆ alkenyl, C₃₋₆ carbocycle and heterocycle;
R¹⁰ is selected from the group consisting of H, OH, C₁₋₃ alkyl, and C₂₋₃ alkenyl;
each R is independently selected from the group consisting of C₁₋₃ alkyl, C₂₋₃ alkenyl, (CH₂)_{q}OR*, and H, and each q is independently selected from 1, 2, and 3;
each R′ is independently selected from the group consisting of C₁₋₁₈ alkyl, C₂₋₁₈ alkenyl, —R*YR″, —YR″, and H;
each R″ is independently selected from the group consisting of C₃₋₁₅ alkyl and C₃₋₁₅ alkenyl;
each R* is independently selected from the group consisting of C₁₋₁₂ alkyl and

C₂₋₁₂ alkenyl;
each Y is independently a C₃₋₆ carbocycle;
each X is independently selected from the group consisting of F, Cl, Br, and I; and
m is selected from 5, 6, 7, 8, 9, 10, 11, 12, and 13; and wherein when R⁴ is —(CH₂)ₙQ, —(CH₂)ₙCHQR, —CHQR, or —CQ(R)₂, then (i) Q is not —N(R)₂ when n is 1, 2, 3, 4 or 5, or (ii) Q is not 5, 6, or 7-membered heterocycloalkyl when n is 1 or 2.

In some aspects, the ionizable lipids of the present disclosure may be one or more of compounds of Formula (IL-X):

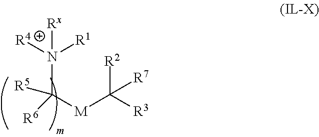

### or its N-oxide,

or a salt or isomer thereof, wherein
or a salt or isomer thereof, wherein
R¹ is selected from the group consisting of C₅₋₃₀ alkyl, C₅₋₂₀ alkenyl, —R*YR″, —YR″, and —R″M′R′;
R² and R³ are independently selected from the group consisting of H, C₁₋₁₄ alkyl, C₂₋₁₄ alkenyl, —R*YR″, —YR″, and —R*OR″, or R² and R³, together with the atom to which they are attached, form a heterocycle or carbocycle;
R⁴ is selected from the group consisting of hydrogen, a C₃₋₆ carbocycle, —(CH₂)ₙQ, —(CH₂)ₙCHQR, —(CH₂)ₒC(R¹⁰)₂(CH₂)ₙ₋ₒQ, —CHQR, —CQ(R)₂, and unsubstituted C₁₋₆ alkyl, where Q is selected from a carbocycle, heterocycle, —OR, —O(CH₂)ₙN(R)₂, —C(O)OR, —OC(O)R, —CX₃, —CX₂H, —CXH₂, —CN, —N(R)₂, —C(O)N(R)₂, —N(R)C(O)R, —N(R)S(O)₂R, —N(R)C(O)N(R)₂, —N(R)C(S)N(R)₂, N(R)R⁸, —N(R)S(O)₂R⁸, —O(CH₂)ₙOR, —N(R)C(═NR⁹)N(R)₂, —N(R)C(═CHR⁹)N(R)₂, —OC(O)N(R)₂, —N(R)C(O)OR, —N(OR)C(O)R, —N(OR)S(O)₂R, —N(OR)C(O)OR, —N(OR)C(O)N(R)₂, —N(OR)C(S)N(R)₂, —N(OR)C(═NR⁹)N(R)₂, —N(OR)C(═CHR⁹)N(R)₂, —C(═NR⁹)N(R)₂, —C(═NR⁹)R, —C(O)N(R)OR, and —C(R)N(R)₂C(O)OR, each o is independently selected from 1, 2, 3, and 4, and each n is independently selected from 1, 2, 3, 4, and 5;
R^{x} is selected from the group consisting of C₁₋₆ alkyl, C₂₋₆ alkenyl, —(CH₂)ᵥOH, and —(CH₂)ᵥN(R)₂,
wherein v is selected from 1, 2, 3, 4, 5, and 6;
each R⁵ is independently selected from the group consisting of OH, C₁₋₃ alkyl, C₂₋₃ alkenyl, and H;
each R⁶ is independently selected from the group consisting of OH, C₁₋₃ alkyl, C₂₋₃ alkenyl, and H;
M and M′ are independently selected from —C(O)O—, —OC(O)—, —OC(O)-M″-C(O)O—, —C(O) N(R′)—, —N(R′)C(O)—, —C(O)—, —C(S)—, —C(S)S—, —SC(S)—, —CH(OH)—, —P(O)(OR′)O—, —S(O)₂—, —S—S—, an aryl group, and a heteroaryl group, in which M″ is a bond, C₁₋₁₃ alkyl or C₂₋₁₃ alkenyl;
R⁷ is selected from the group consisting of C₁₋₃ alkyl, C₂₋₃ alkenyl, and H; R⁸ is selected from the group consisting of C₃₋₆ carbocycle and heterocycle;
R⁹ is selected from the group consisting of H, CN, NO₂, C₁₋₆ alkyl, —OR, —S(O)₂R, —S(O)₂N(R)₂, C₂₋₆ alkenyl, C₃₋₆ carbocycle and heterocycle;
R¹⁰ is selected from the group consisting of H, OH, C₁₋₃ alkyl, and C₂₋₃ alkenyl;
each R is independently selected from the group consisting of C₁₋₃ alkyl, C₂₋₃ alkenyl, (CH₂)_{q}OR*, and H, and each q is independently selected from 1, 2, and 3;
each R′ is independently selected from the group consisting of C₁₋₁₈ alkyl, C₂₋₁₈ alkenyl, —R*YR″, —YR″, and H;
each R″ is independently selected from the group consisting of C₃₋₁₅ alkyl and C₃₋₁₅ alkenyl;
each R* is independently selected from the group consisting of C₁₋₁₂ alkyl and C₂₋₁₂ alkenyl;
each Y is independently a C₃₋₆ carbocycle;
each X is independently selected from the group consisting of F, Cl, Br, and I; and
m is selected from 5, 6, 7, 8, 9, 10, 11, 12, and 13.

In some embodiments, a subset of compounds of Formula (IL-I) includes those of Formula (IL-IA):

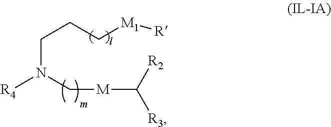

or its N-oxide, or a salt or isomer thereof, wherein l is selected from 1, 2, 3, 4, and 5; m is selected from 5, 6, 7, 8, and 9; M₁ is a bond or M′; R⁴ is hydrogen, unsubstituted C₁₋₃ alkyl, —(CH₂)ₒC(R¹⁰)₂(CH₂)ₙ₋ₒQ, or —(CH₂)ₙQ, in which Q is OH, —NHC(S)N(R)₂, —NHC(O)N(R)₂, —N(R)C(O)R, —N(R)S(O)₂R, —N(R)R⁸, —NHC(═NR⁹)N(R)₂, —NHC(═CHR⁹)N(R)₂, —OC(O)N(R)₂, —N(R)C(O)OR, heteroaryl or heterocycloalkyl; M and M′ are independently selected from —C(O)O—, —OC(O)—, —OC(O)-M″-C(O)O—, —C(O) N(R′)—, —P(O)(OR′)O—, —S—S—, an aryl group, and a heteroaryl group; and R² and R³ are independently selected from the group consisting of H, C₁₋₁₄ alkyl, and C₂₋₁₄ alkenyl. For example, m is 5, 7, or 9. For example, Q is OH, —NHC(S)N(R)₂, or —NHC(O)N(R)₂. For example, Q is —N(R)C(O)R, or —N(R)S(O)₂R.

In some embodiments, a subset of compounds of Formula (I) includes those of Formula (IL-IB):

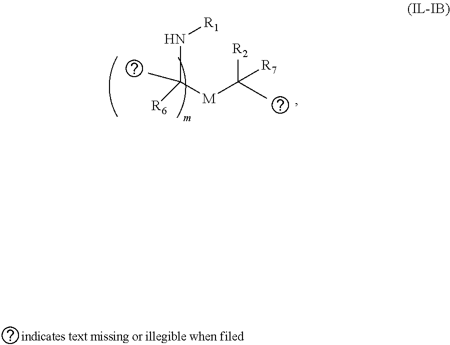

or its N-oxide, or a salt or isomer thereof, in which all variables are as defined herein. In some embodiments, m is selected from 5, 6, 7, 8, and 9; R₄ is hydrogen, unsubstituted C₁₋₃ alkyl, or —(CH₂)ₙQ, in which Q is —OH, —NHC(S)N(R)₂, —NHC(O)N(R)₂, —N(R)C(O)R, —N(R)S(O)₂R, —N(R)R₈, —NHC(═NR₉)N(R)₂, —NHC(═CHR₉)N(R)₂, —OC(O)N(R)₂, —N(R)C(O)OR, heteroaryl or heterocycloalkyl; M and M′ are independently selected from —C(O)O—, —OC(O)—, —OC(O)-M″-C(O)O—, —C(O) N(R′)—, —P(O)(OR′)O—, —S—S—, an aryl group, and a heteroaryl group, and R₂ and R₃ are independently selected from the group consisting of H, C₁₋₁₄ alkyl, and C₂₋₁₄ alkenyl. In some embodiments, m is 5, 7, or 9. In some embodiments, Q is OH, —NHC(S)N(R)₂, or —NHC(O)N(R)₂. In some embodiments, Q is —N(R)C(O)R, or —N(R)S(O)₂R.

In some embodiments, a subset of compounds of Formula (IL-I) includes those of Formula (IL-II):

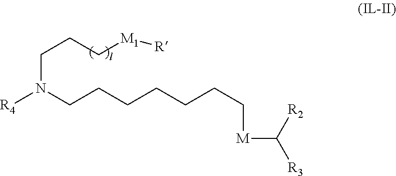

or its N-oxide, or a slat or isomer thereof, wherein l is selected from 1, 2, 3, 4 and 5; M1 is a bond or M′; R₄ is hydrogen, unsubstituted C₁₋₃ alkyl, or —(CH₂)ₙQ, in which n is 2, 3, or 4, and Q is —OH, —NHC(S)N(R)₂, —NHC(O)N(R)₂, —N(R)C(O)R, —N(R)S(O)₂R, —N(R)R₈, —NHC(═NR₉)N(R)₂, —NHC(═CHR₉)N(R)₂, —OC(O)N(R)₂, —N(R)C(O)OR, heteroaryl or heterocycloalkyl; M and M′ are independently selected from —C(O)O—, —OC(O)—, —OC(O)-M″—C(O)O—, —C(O) N(R′)—, —P(O)(OR′)O—, —S—S—, an aryl group, and a heteroaryl group; and R₂ and R₃ are independently selected from the group consisting of H, C₁₋₁₄ alkyl, and C₂₋₁₄ alkenyl.

In some aspects, the ionizable lipids of the present disclosure may be one or more of compounds of Formula (IL-VI):

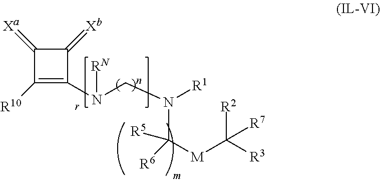

### or its N-oxide,

or a salt or isomer thereof, wherein
R¹ is selected from the group consisting of C₅₋₃₀ alkyl, C₅₋₂₀ alkenyl, —R*YR″, —YR″, and —R″M′R′;
R² and R³ are independently selected from the group consisting of H, C₁₋₁₄ alkyl, C₂₋₁₄ alkenyl, —R*YR″, —YR″, and —R*OR″, or R² and R³, together with the atom to which they are attached, form a heterocycle or carbocycle;
each R⁵ is independently selected from the group consisting of OH, C₁₋₃ alkyl, C₂₋₃ alkenyl, and H;
each R⁶ is independently selected from the group consisting of OH, C₁₋₃ alkyl, C₂₋₃ alkenyl, and H;
M and M′ are independently selected from —C(O)O—, —OC(O)—, —OC(O)-M″-C(O)O—, —C(O) N(R′)—, —N(R′)C(O)—, —C(O)—, —C(S)—, —C(S)S—, —SC(S)—, —CH(OH)—, —P(O)(OR′)O—, —S(O)₂—, —S—S—, an aryl group, and a heteroaryl group, in which M″ is a bond, C₁₋₁₃ alkyl or C₂₋₁₃ alkenyl;
R⁷ is selected from the group consisting of C₁₋₃ alkyl, C₂₋₃ alkenyl, and H;
each R is independently selected from the group consisting of H, C₁₋₃ alkyl, and C₂₋₃ alkenyl;
R^{N} is H, or C₁₋₃ alkyl;
each R′ is independently selected from the group consisting of C₁₋₁₈ alkyl, C₂₋₁₈ alkenyl, —R*YR″, —YR″, and H;
each R″ is independently selected from the group consisting of C₃₋₁₅ alkyl and C₃₋₁₅ alkenyl;
each R* is independently selected from the group consisting of C₁₋₁₂ alkyl and C₂₋₁₂ alkenyl;
each Y is independently a C₃₋₆ carbocycle;
each X is independently selected from the group consisting of F, Cl, Br, and I;
X^{a} and X^{b} are each independently O or S;
R¹⁰ is selected from the group consisting of H, halo, —OH, R, —N(R)₂, —CN, —N₃, —C(O)OH, —C(O)OR, —OC(O)R, —OR, —SR, —S(O)R, —S(O)OR, —S(O)₂OR, —NO₂, —S(O)₂N(R)₂, —N(R)S(O)₂R, —NH(CH₂)ₜ₁N(R)₂, —NH(CH₂)ₚ₁O(CH₂)_{q1}N(R)₂, —NH(CH₂)ₛ₁OR, —N((CH₂)ₛ₁OR)₂, a carbocycle, a heterocycle, aryl and heteroaryl;
m is selected from 5, 6, 7, 8, 9, 10, 11, 12, and 13;
n is selected from 1, 2, 3, 4, 5, 6, 7, 8, 9, and 10;
r is 0 or 1;
t¹ is selected from 1, 2, 3, 4, and 5;
p¹ is selected from 1, 2, 3, 4, and 5;
q¹ is selected from 1, 2, 3, 4, and 5; and
s¹ is selected from 1, 2, 3, 4, and 5.

In some embodiments, a subset of compounds of Formula (IL-VI) includes those of Formula (IL-VI-a):

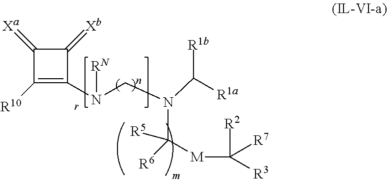

or its N-oxide, or a salt or isomer thereof, wherein
R^{1a} and R^{1b} are independently selected from the group consisting of C₁₋₁₄ alkyl and C₂₋₁₄ alkenyl; and
R² and R³ are independently selected from the group consisting of C₁₋₁₄ alkyl, C₂₋₁₄ alkenyl, —R*YR″, —YR″, and —R*OR″, or R² and R³, together with the atom to which they are attached, form a heterocycle or carbocycle.

In another embodiment, a subset of compounds of Formula (IL-VI) includes those of Formula (IL-VII):

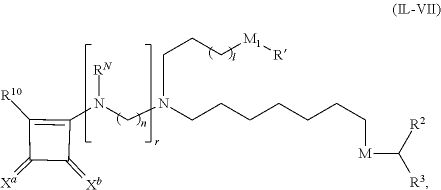

or its N-oxide, or a salt or isomer thereof, wherein
l is selected from 1, 2, 3, 4, and 5;
M₁ is a bond or M′; and
R² and R³ are independently selected from the group consisting of H, C₁₋₁₄ alkyl, and C₂₋₁₄ alkenyl.

In another embodiment, a subset of compounds of Formula (IL-VI) includes those of Formula (IL-VIII):

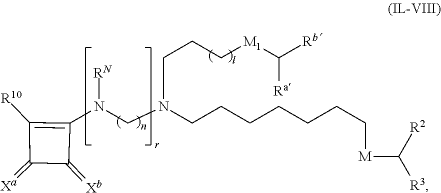

or its N-oxide, or a salt or isomer thereof, wherein
l is selected from 1, 2, 3, 4, and 5;
M₁ is a bond or M′; and
R^{a′} and R^{b′} are independently selected from the group consisting of C₁₋₁₄ alkyl and C₂₋₁₄ alkenyl; and
R² and R³ are independently selected from the group consisting of C₁₋₁₄ alkyl, and C₂₋₁₄ alkenyl.

The compounds of any one of formula (IL-I), (IL-IA), (IL-VI), (IL-VI-a), (IL-VII) or (IL-VIII) include one or more of the following features when applicable.

In some embodiments, M₁ is M′.

In some embodiments, M and M′ are independently —C(O)O— or —OC(O)—.

In some embodiments, at least one of M and M′ is —C(O)O— or —OC(O)—.

In some embodiments, at least one of M and M′ is —OC(O)—.

In some embodiments, M is —OC(O)— and M′ is —C(O)O—. In some embodiments, M is —C(O)O— and M′ is —OC(O)—. In some embodiments, M and M′ are each —OC(O)—. In some embodiments, M and M′ are each —C(O)O—.

In some embodiments, at least one of M and M′ is —OC(O)-M″-C(O)O—.

In some embodiments, M and M′ are independently —S—S—.

In some embodiments, at least one of M and M′ is —S—S—.

In some embodiments, one of M and M′ is —C(O)O— or —OC(O)— and the other is —S—S—. For example, M is —C(O)O— or —OC(O)— and M′ is —S—S— or M′ is —C(O)O—, or —OC(O)— and M is —S—S—.

In some embodiments, one of M and M′ is —OC(O)-M″-C(O)O—, in which M″ is a bond, C₁₋₁₃ alkyl or C₂₋₁₃ alkenyl. In other embodiments, M″ is C₁₋₆ alkyl or C₂₋₆ alkenyl. In some embodiments, M″ is C₁₋₄ alkyl or C₂₋₄ alkenyl. For example, in some embodiments, M″ is C₁ alkyl. For example, in some embodiments, M″ is C₂ alkyl. For example, in some embodiments, M″ is C₃ alkyl. For example, in some embodiments, M″ is C₄ alkyl. For example, in some embodiments, M″ is C₂ alkenyl. For example, in some embodiments, M″ is C₃ alkenyl. For example, in some embodiments, M″ is C₄ alkenyl.

In some embodiments, 1 is 1, 3, or 5.

In some embodiments, R⁴ is hydrogen.

In some embodiments, R⁴ is not hydrogen.

In some embodiments, R⁴ is unsubstituted methyl or —(CH₂)ₙQ, in which Q is OH, —NHC(S)N(R)₂, —NHC(O)N(R)₂, —N(R)C(O)R, or —N(R)S(O)₂R.

In some embodiments, Q is OH.

In some embodiments, Q is —NHC(S)N(R)₂.

In some embodiments, Q is —NHC(O)N(R)₂.

In some embodiments, Q is —N(R)C(O) R.

In some embodiments, Q is —N(R)S(O)₂R.

In some embodiments, Q is —O(CH₂)ₙN(R)₂.

In some embodiments, Q is —O(CH₂)ₙOR.

In some embodiments, Q is —N(R)R⁸.

In some embodiments, Q is —NHC(═NR⁹)N(R)₂.

In some embodiments, Q is —NHC(═CHR⁹)N(R)₂.

In some embodiments, Q is —OC(O)N(R)₂.

In some embodiments, Q is —N(R)C(O)OR.

In some embodiments, n is 2.

In some embodiments, n is 3.

In some embodiments, n is 4.

In some embodiments, M₁ is absent.

In some embodiments, at least one R⁵ is hydroxyl. For example, one R⁵ is hydroxyl.

In some embodiments, at least one R⁶ is hydroxyl. For example, one R⁶ is hydroxyl.

In some embodiments one of R⁵ and R⁶ is hydroxyl. For example, one R⁵ is hydroxyl and each R⁶ is hydrogen. For example, one R⁶ is hydroxyl and each R⁵ is hydrogen.

In some embodiments, R^{x} is C₁₋₆ alkyl. In some embodiments, R^{x} is C₁₋₃ alkyl. For example, R^{x} is methyl. For example, R^{x} is ethyl. For example, R^{x} is propyl.

In some embodiments, R^{x} is —(CH₂)ᵥOH and, v is 1, 2 or 3. For example, R^{x} is methanoyl. For example, R^{x} is ethanoyl. For example, R^{x} is propanoyl.

In some embodiments, R^{x} is —(CH₂)ᵥN(R)₂, v is 1, 2 or 3 and each R is H or methyl. For example, R^{x} is methanamino, methylmethanamino, or dimethylmethanamino. For example, R^{x} is aminomethanyl, methylaminomethanyl, or dimethylaminomethanyl. For example, R^{x} is aminoethanyl, methylaminoethanyl, or dimethylaminoethanyl. For example, R^{x} is aminopropanyl, methylaminopropanyl, or dimethylaminopropanyl.

In some embodiments, R′ is C₁₋₁₈ alkyl, C₂₋₁₈ alkenyl, —R*YR″, or —YR″.

In some embodiments, R² and R³ are independently C₃₋₁₄ alkyl or C₃₋₁₄ alkenyl.

In some embodiments, R^{1b} is C₁₋₁₄ alkyl. In some embodiments, R^{1b} is C₂₋₁₄ alkyl. In some embodiments, R^{1b} is C₃₋₁₄ alkyl. In some embodiments, R^{1b} is C₁₋₈ alkyl. In some embodiments, R^{1b} is C₁₋₅ alkyl. In some embodiments, R^{1b} is C₁₋₃ alkyl. In some embodiments, R^{1b} is selected from C₁ alkyl, C₂ alkyl, C₃ alkyl, C₄ alkyl, and C₅ alkyl. For example, in some embodiments, R^{1b} is C₁ alkyl. For example, in some embodiments, R^{1b} is C₂ alkyl. For example, in some embodiments, R^{1b} is C₃ alkyl. For example, in some embodiments, R^{1b} is C₄ alkyl. For example, in some embodiments, R^{1b} is C₅ alkyl.

In some embodiments, R¹ is different from —(CHR⁵R⁶)ₘ-M-CR²R³R⁷

In some embodiments, —CHR^{1a}R^{1b}— is different from —(CHR⁵R⁶)ₘ-M-CR²R³R⁷.

In some embodiments, R⁷ is H. In some embodiments, R⁷ is selected from C₁₋₃ alkyl. For example, in some embodiments, R⁷ is C₁ alkyl. For example, in some embodiments, R⁷ is C₂ alkyl. For example, in some embodiments, R⁷ is C₃ alkyl. In some embodiments, R⁷ is selected from C₄ alkyl, C₄ alkenyl, C₅ alkyl, C₅ alkenyl, C₆ alkyl, C₆ alkenyl, C₇ alkyl, C₇ alkenyl, C₉ alkyl, C₉ alkenyl, C₁₁ alkyl, C₁₁ alkenyl, C₁₇ alkyl, C₁₇ alkenyl, C₁₈ alkyl, and C₁₈ alkenyl.

In some embodiments, Rb′ is C1-14 alkyl. In some embodiments, R^{b′} is C₂₋₁₄ alkyl. In some embodiments, R^{b′} is C₃₋₁₄ alkyl. In some embodiments, R^{b′} is C₁₋₈ alkyl. In some embodiments, R^{b′} is C₁₋₅ alkyl. In some embodiments, R^{b′} is C₁₋₃ alkyl. In some embodiments, R^{b′} is selected from C₁ alkyl, C₂ alkyl, C₃ alkyl, C₄ alkyl and C₅ alkyl. For example, in some embodiments, R^{b′} is C₁ alkyl. For example, in some embodiments, R^{b′} is C₂ alkyl. For example, some embodiments, R^{b′} is C₃ alkyl. For example, some embodiments, R^{b′} is C₄ alkyl.

In one embodiment, the compounds of Formula (IL-I) are of Formula (IL-IIa):

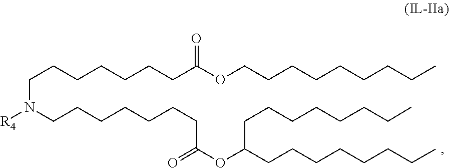

or their N-oxides, or salts or isomers thereof, wherein R⁴ is as described herein.

In another embodiment, the compounds of Formula (IL-I) are of Formula (IL-IIb):

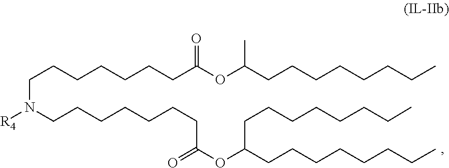

or their N-oxides, or salts or isomers thereof, wherein R⁴ is as described herein.

In another embodiment, the compounds of Formula (IL-I) are of Formula (IL-IIc) or (IL-IIe):

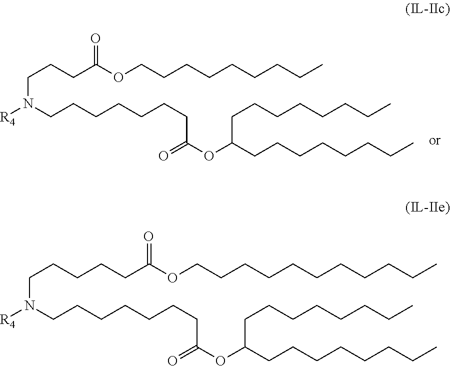

or their N-oxides, or salts or isomers thereof, wherein R⁴ is as described herein.

In another embodiment, the compounds of Formula (IL-I) are of Formula (IL-IIf):

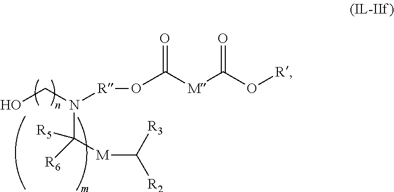

or their N-oxides, or salts or isomers thereof, wherein M is —C(O)O— or —OC(O)—, M″ is C₁₋₆ alkyl or C₂₋₆ alkenyl, R² and R³ are independently selected from the group consisting of C₅₋₁₄ alkyl and C₅₋₁₄ alkenyl, and n is selected from 2, 3, and 4.

In a further embodiment, the compounds of Formula (IL-I) are of Formula (IL-IId):

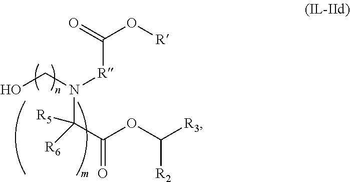

or their N-oxides, or salts or isomers thereof, wherein n is 2, 3, or 4; and m, R′, R″, and R² through R⁶ are as described herein. In some embodiments, each of R² and R³ may be independently selected from the group consisting of C₅₋₁₄ alky and C₅₋₁₄ alkenyl.

In a further embodiment, the compounds of Formula (IL-I) are of Formula (IL-IIg):

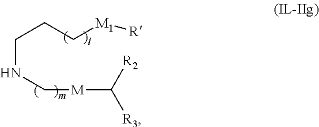

or their N-oxides, or salts or isomers thereof, wherein l is selected from 1, 2, 3, 4, and 5; m is selected from 5, 6, 7, 8, and 9; M₁ is a bond or M′; M and M′ are independently selected from —C(O)O—, —OC(O)—, —OC(O)-M″-C(O)O—, —C(O) N(R′)—, —P(O)(OR′)O—, —S—S—, an aryl group, and a heteroaryl group; and R² and R³ are independently selected from the group consisting of H, C₁₋₁₄ alkyl, and C₂₋₁₄ alkenyl. In some embodiments, M″ is C₁₋₆ alkyl (e.g., C₁₋₄ alkyl) or C₂₋₆ alkenyl (e.g., C₂₋₄ alkenyl). In some embodiments, R² and R³ are independently selected from the group consisting of C₅₋₁₄ alkyl and C₅₋₁₄ alkenyl.

In another embodiment, a subset of compounds of Formula (IL-VI) includes those of Formula (IL-VIIa):

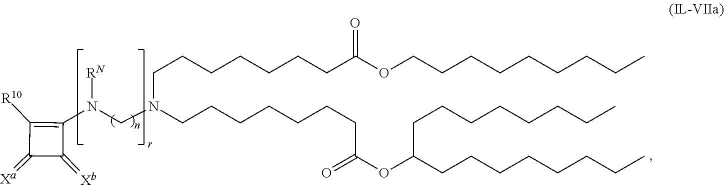

or its N-oxide, or a salt or isomer thereof.

In another embodiment, a subset of compounds of Formula (VI) includes those of Formula (IL-VIIIa):

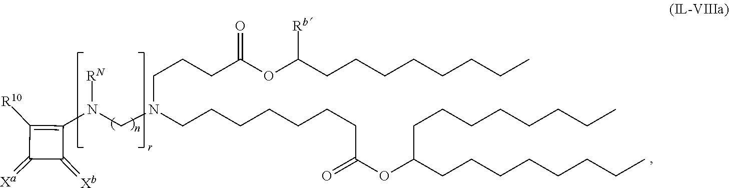

or its N-oxide, or a salt or isomer thereof.

In another embodiment, a subset of compounds of Formula (IL-VI) includes those of Formula (IL-VIIIb):

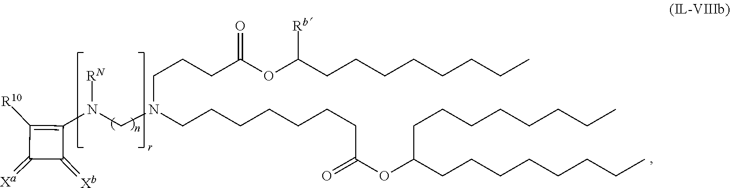

or its N-oxide, or a salt or isomer thereof.

In another embodiment, a subset of compounds of Formula (IL-VI) includes those of Formula (IL-VIIb-1):

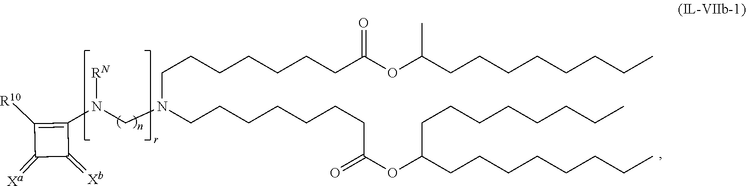

or its N-oxide, or a salt or isomer thereof.

In another embodiment, a subset of compounds of Formula (IL-VI) includes those of Formula (IL-VIIb-2):

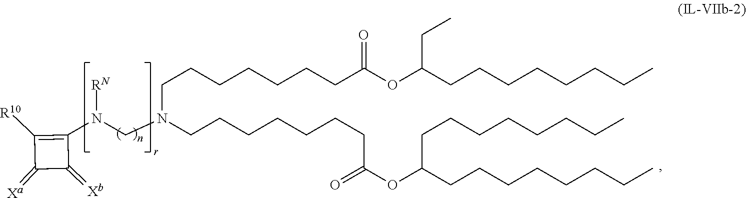

or its N-oxide, or a salt or isomer thereof.

In another embodiment, a subset of compounds of Formula (IL-VI) includes those of Formula (IL-VIIb-3):

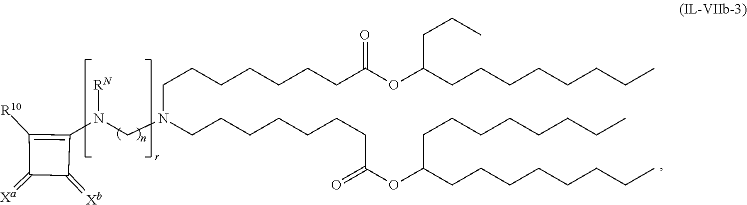

or its N-oxide, or a salt or isomer thereof.

In another embodiment, a subset of compounds of Formula (IL-VI) includes those of Formula (IL-VIIc):

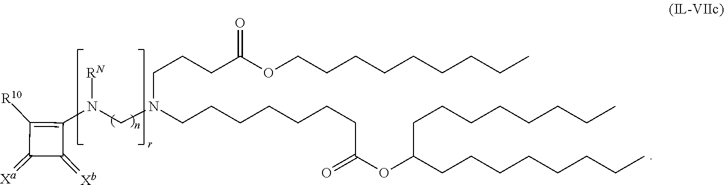

In another embodiment, a subset of compounds of Formula (IL-VI) includes those of Formula (IL-VIId):

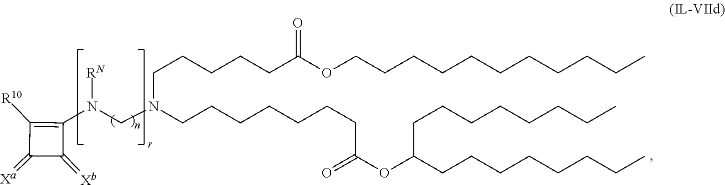

or its N-oxide, or a salt or isomer thereof.

In another embodiment, a subset of compounds of Formula (IL-VI) includes those of Formula (IL-VIIIc):

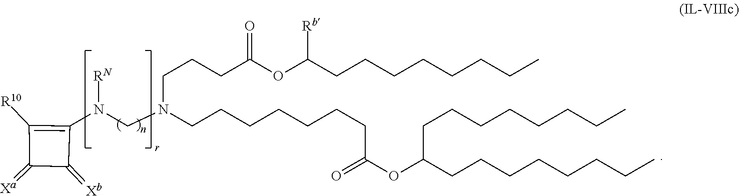

In another embodiment, a subset of compounds of Formula (IL-VI) includes those of Formula (IL-VIIId):

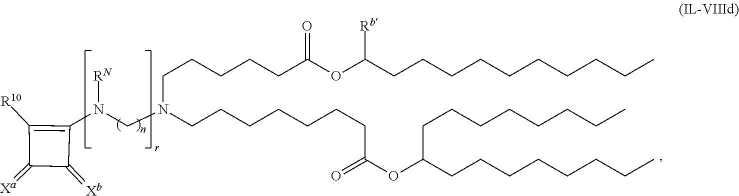

or its N-oxide, or a salt or isomer thereof.

The compounds of any one of formulae (IL-I), (IL-IA), (IL-IB), (IL-II), (IL-IIa), (IL-IIb), (IL-IIc), (IL-IId), (IL-IIe), (IL-IIf), (IL-IIg), (IL-III), (IL-VI), (IL-VI-a), (IL-VII), (IL-VIII), (IL-VIIa), (IL-VIIIa), (IL-VIIIb), (IL-VIIb-1), (IL-VIIb-2), (IL-VIIb-3), (IL-VIIc), (IL-VIId), (IL-VIIIc), or (IL-VIIId) include one or more of the following features when applicable.

In some embodiments, the ionizable lipids are one or more of the compounds described in PCT Application Nos. PCT/US2020/051613, PCT/US2020/051613, and PCT/US2020/051629, and in PCT Publication Nos. WO 2017/049245, WO 2018/170306, WO 2018/170336, WO 2020/061367.

In some embodiments, the ionizable lipids are selected from Compounds 1-280 described in U.S. Application No. 62/475,166.

In some embodiments, the ionizable lipid is

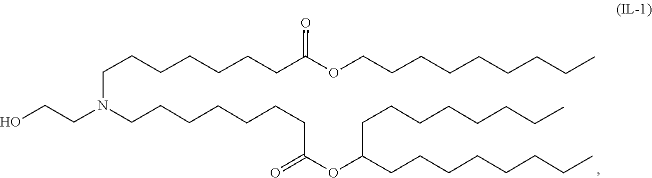 [SMILES: CCCCCCCCCOC(=O)CCCCCCCN(CCO)CCCCCCCC(=O)OC(CCCCCCCC)CCCCCCCC]

or a salt thereof.

In some embodiments, the ionizable lipid is (IL-1).

In some embodiments, the ionizable lipid is

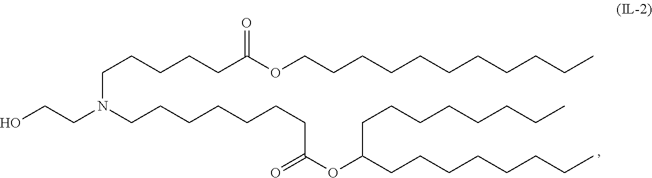 [SMILES: CCCCCCCCCCCOC(=O)CCCCCN(CCO)CCCCCCCC(=O)OC(CCCCCCCC)CCCCCCCC]

or a salt thereof.

In some embodiments, the ionizable lipid is IL-2.

In some embodiments, the ionizable lipid is

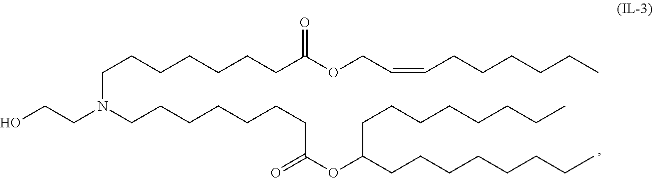 [SMILES: CCCCCC/C=C\COC(=O)CCCCCCCN(CCO)CCCCCCCC(=O)OC(CCCCCCCC)CCCCCCCC]

or a salt thereof.

In some embodiments, the ionizable lipid is IL-3.

In some embodiments, the ionizable lipid is

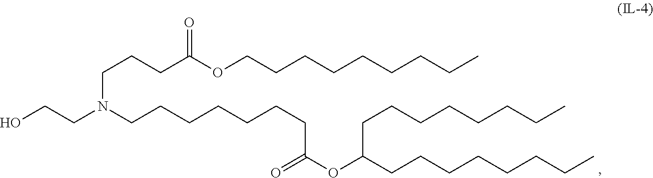 [SMILES: CCCCCCCCCOC(=O)CCCN(CCO)CCCCCCCC(=O)OC(CCCCCCCC)CCCCCCCC]

or a salt thereof.

In some embodiments, the ionizable lipid is IL-4.

In some embodiments, the ionizable lipid is

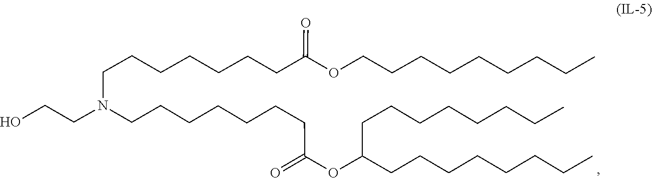 [SMILES: CCCCCCCCCOC(=O)CCCCCCCN(CCO)CCCCCCCC(=O)OC(CCCCCCCC)CCCCCCCC]

or a salt thereof.

In some embodiments, the ionizable lipid is IL-5.

In some embodiments, the ionizable lipid is

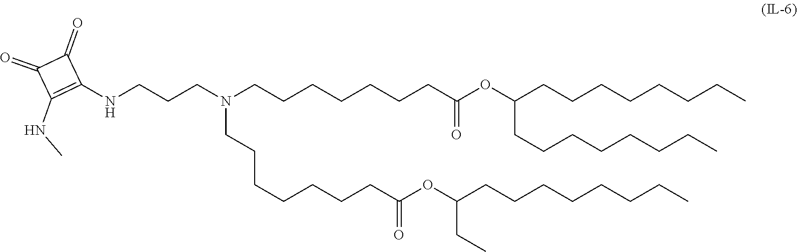 [SMILES: CCCCCCCCC(CC)OC(=O)CCCCCCCN(CCCCCCCC(=O)OC(CCCCCCCC)CCCCCCCC)CCCNc1c(NC)c(=O)c1=O]

or a salt thereof.

In some embodiments, the ionizable lipid is IL-6.

In some embodiments, the ionizable lipid is

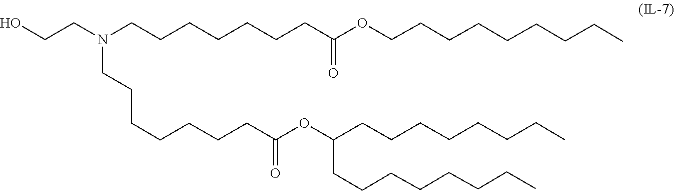 [SMILES: CCCCCCCCCOC(=O)CCCCCCCN(CCO)CCCCCCCC(=O)OC(CCCCCCCC)CCCCCCCC]

or a salt thereof.

In some embodiments, the ionizable lipid is IL-7.

In some embodiments, the ionizable lipid is

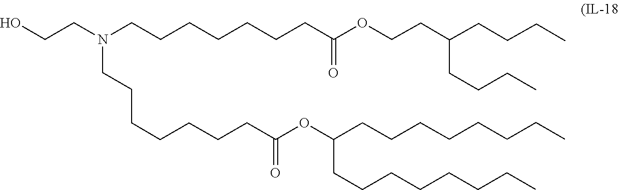 [SMILES: CCCCCCCCC(CCCCCCCC)OC(=O)CCCCCCCN(CCO)CCCCCCCC(=O)OCCC(CCCC)CCCC]

or a salt thereof.

In some embodiments, the ionizable lipid is IL-8.

In some embodiments, the ionizable lipid is

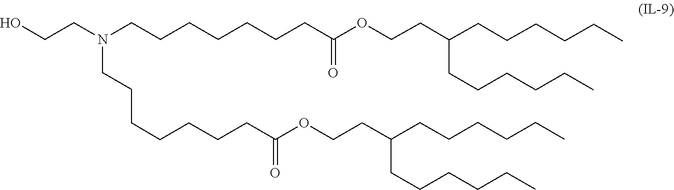 [SMILES: CCCCCCC(CCCCCC)CCOC(=O)CCCCCCCN(CCO)CCCCCCCC(=O)OCCC(CCCCCC)CCCCCC]

or a salt thereof.

In some embodiments, the ionizable lipid is IL-9.

In some embodiments, the ionizable lipid is

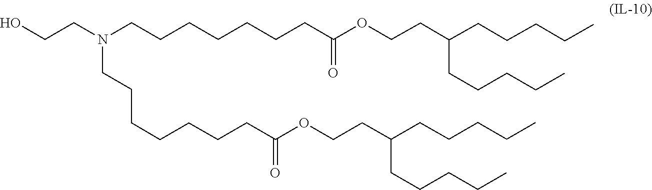 [SMILES: CCCCCC(CCCCC)CCOC(=O)CCCCCCCN(CCO)CCCCCCCC(=O)OCCC(CCCCC)CCCCC]

or a salt thereof.

In some embodiments, the ionizable lipid is IL-10.

In some embodiments, the ionizable lipid is

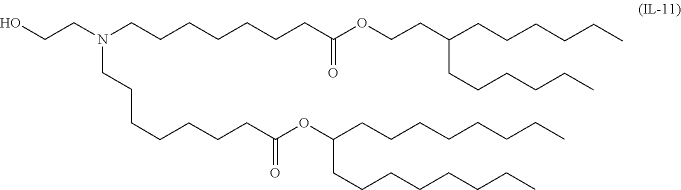 [SMILES: CCCCCCCCC(CCCCCCCC)OC(=O)CCCCCCCN(CCO)CCCCCCCC(=O)OCCC(CCCCCC)CCCCCC]

or a salt thereof.

In some embodiments, the ionizable lipid is IL-11.

In some embodiments, the ionizable lipid is

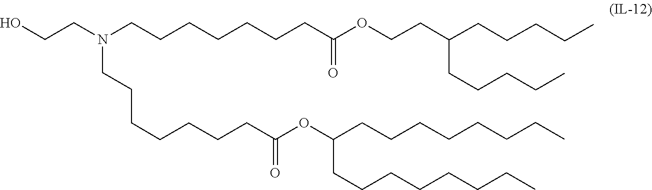 [SMILES: CCCCCCCCC(CCCCCCCC)OC(=O)CCCCCCCN(CCO)CCCCCCCC(=O)OCCC(CCCCC)CCCCC]

or a salt thereof.

In some embodiments, the ionizable lipid is IL-12.

In some embodiments, the ionizable lipid is

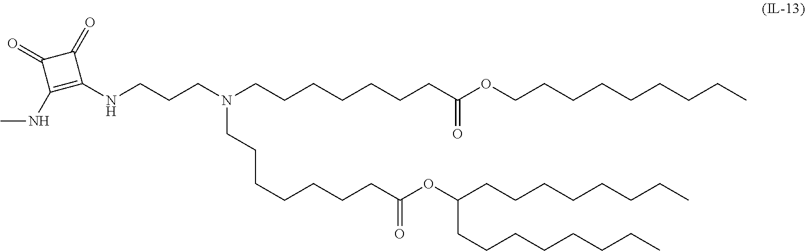 [SMILES: CCCCCCCCCOC(=O)CCCCCCCN(CCCCCCCC(=O)OC(CCCCCCCC)CCCCCCCC)CCCNc1c(NC)c(=O)c1=O]

or a salt thereof.

In some embodiments, the ionizable lipid is IL-13.

In some embodiments, the ionizable lipid is

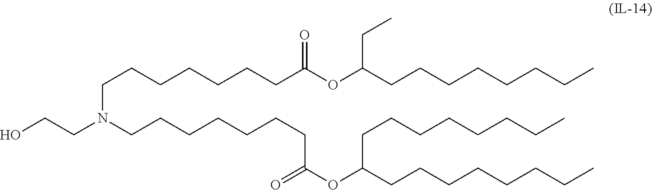 [SMILES: CCCCCCCCC(CC)OC(=O)CCCCCCCN(CCO)CCCCCCCC(=O)OC(CCCCCCCC)CCCCCCCC]

or a salt thereof.

In some embodiments, the ionizable lipid is IL-14.

In some embodiments, the ionizable lipid is

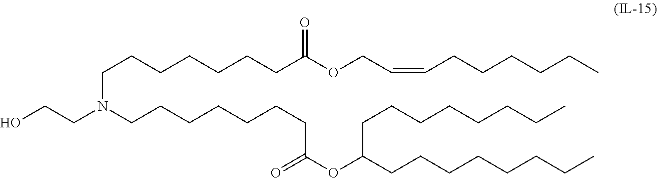 [SMILES: CCCCCC/C=C\COC(=O)CCCCCCCN(CCO)CCCCCCCC(=O)OC(CCCCCCCC)CCCCCCCC]

or a salt thereof.

In some embodiments, the ionizable lipid is IL-15.

In some embodiments, the ionizable lipid is

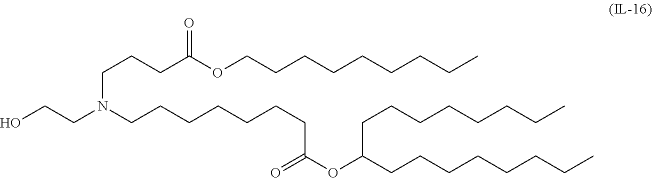 [SMILES: CCCCCCCCCOC(=O)CCCN(CCO)CCCCCCCC(=O)OC(CCCCCCCC)CCCCCCCC]

or a salt thereof.

In some embodiments, the ionizable lipid is IL-16.

In some embodiments, the ionizable lipid is

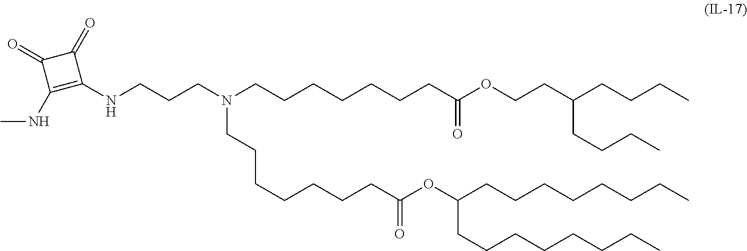 [SMILES: CCCCCCCCC(CCCCCCCC)OC(=O)CCCCCCCN(CCCCCCCC(=O)OCCC(CCCC)CCCC)CCCNc1c(NC)c(=O)c1=O]

or a salt thereof.

In some embodiments, the ionizable lipid is IL-17.

In some embodiments, the ionizable lipid is

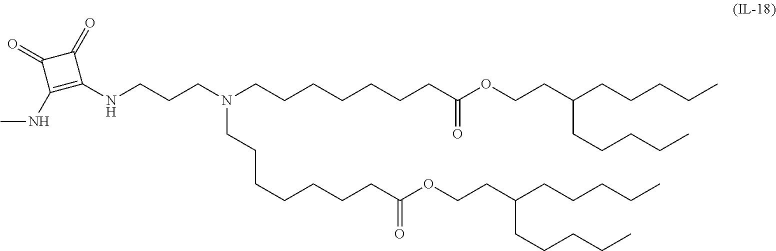 [SMILES: CCCCCC(CCCCC)CCOC(=O)CCCCCCCN(CCCCCCCC(=O)OCCC(CCCCC)CCCCC)CCCNc1c(NC)c(=O)c1=O]

or a salt thereof.

In some embodiments, the ionizable lipid is IL-18.

In some embodiments, the ionizable lipid is

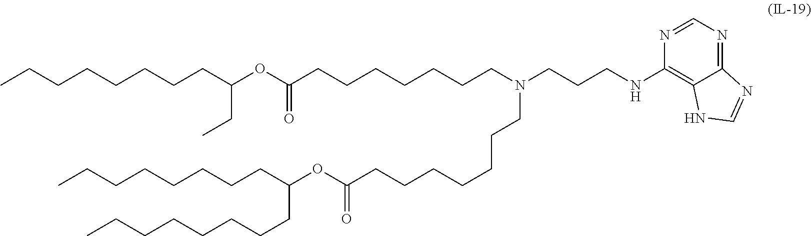 [SMILES: CCCCCCCCC(CC)OC(=O)CCCCCCCN(CCCCCCCC(=O)OC(CCCCCCCC)CCCCCCCC)CCCNc1ncnc2nc[nH]c12]

or a salt thereof.

In some embodiments, the ionizable lipid is IL-19.

In some aspects, the ionizable lipids of the present disclosure may be one or more of compounds of formula (IL-VIVa):

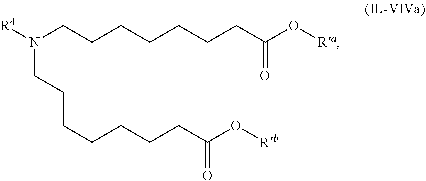

or its N-oxide, or a salt or isomer thereof,
wherein R′^{a} is R′^{branched} or R′^{cyclic}, wherein
R′^{branched} is

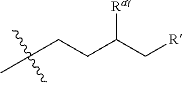

and R′^{cyclic} is

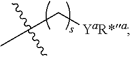

and
R′^{b} is:

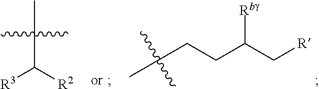

wherein [symbol] denotes a point of attachment;
wherein R^{aγ} and R^{bγ} are each independently a C₂₋₁₂ alkyl or C₂₋₁₂ alkenyl;
   R² and R³ are each independently selected from the group consisting of C₁₋₁₄ alkyl and C₂₋₁₄ alkenyl;
   R⁴ is —(CH₂)₂OH;
   each R′ independently is a C₁₋₁₂ alkyl or C₂₋₁₂ alkenyl;
   Y^{a} is a C₃₋₆ carbocycle;
   R*″^{a} is selected from the group consisting of C₁₋₁₅ alkyl and C₂₋₁₅ alkenyl; and
   s is 2 or 3.

In some aspects, the ionizable lipids of the present disclosure may be one or more of compounds of formula (IL-VIVb):

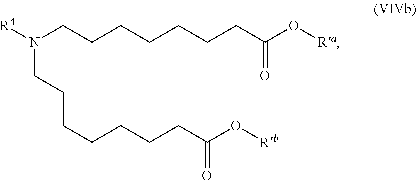

or its N-oxide, or a salt or isomer thereof,
wherein R′^{a} is R′^{branched} or R′^{cyclic}, wherein
R′^{branched} is

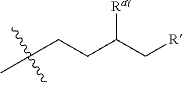

and R′^{cyclic} is

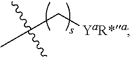

and
R′^{b} is:

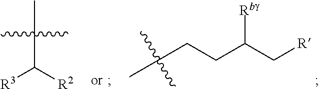

wherein [symbol] denotes a point of attachment;
   wherein R^{aγ} and R^{bγ} are each independently a C₂₋₁₂ alkyl or C₂₋₁₂ alkenyl;
   R² and R³ are each independently selected from the group consisting of C₁₋₁₄ alkyl and C₂₋₁₄ alkenyl;
   R⁴ is

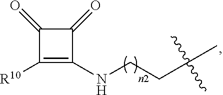

wherein [symbol] denotes a point of attachment;
R¹⁰ is N(R)₂; each R is independently selected from the group consisting of C₁₋₆ alkyl, C₂₋₃ alkenyl, and H; and n2 is selected from the group consisting of 1, 2, 3, 4, 5, 6, 7, 8, 9, and 10;
each R′ independently is a C₁₋₁₂ alkyl or C₂₋₁₂ alkenyl;
Y^{a} is a C₃₋₆ carbocycle;
R*″^{a} is selected from the group consisting of C₁₋₁₅ alkyl and C₂₋₁₅ alkenyl; and
s is 2 or 3.

In some embodiments, the ionizable lipid is selected from:

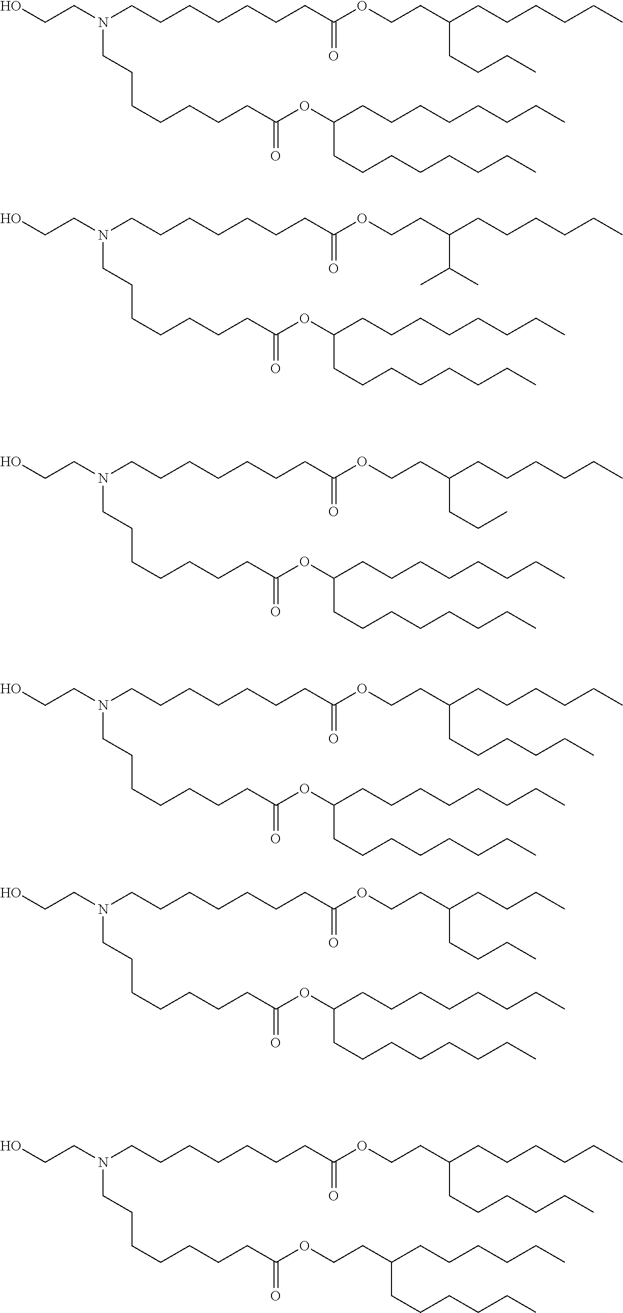

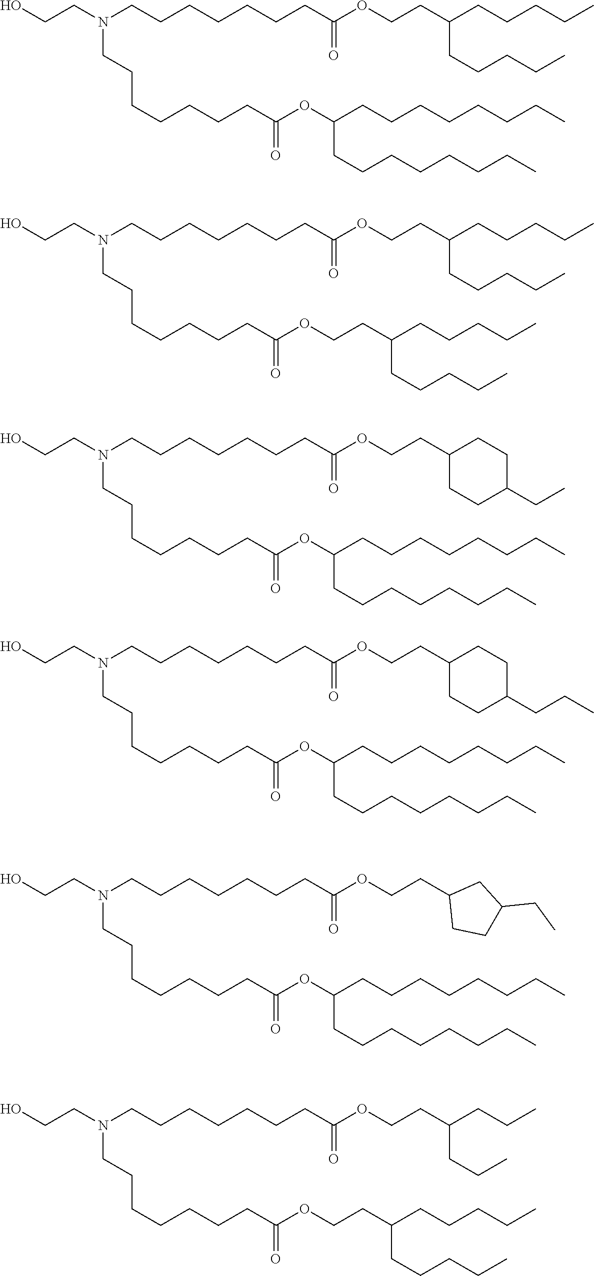

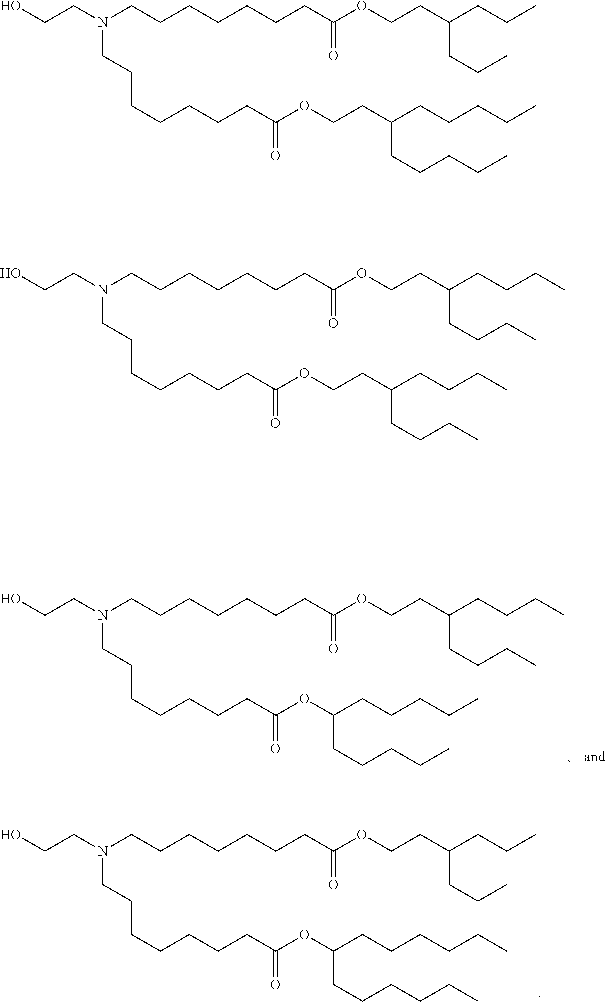 [SMILES: CCCCCC(CCCCC)CCOC(=O)CCCCCCCN(CCO)CCCCCCCC(=O)OCCC(CCC)CCC ; CCCCC(CCCC)CCOC(=O)CCCCCCCN(CCO)CCCCCCCC(=O)OCCC(CCCC)CCCC ; CCCCCC(CCCCC)OC(=O)CCCCCCCN(CCO)CCCCCCCC(=O)OCCC(CCCC)CCCC ; CCCCCCC(CCCCCC)OC(=O)CCCCCCCN(CCO)CCCCCCCC(=O)OCCC(CCC)CCC]

In some aspects, the ionizable lipids of the present disclosure may be one or more of compounds of formula (IL-III):

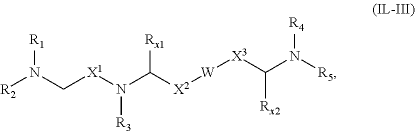

or salts or isomers thereof, wherein,
W is

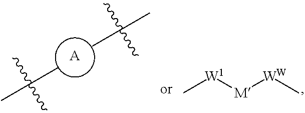

ring A is

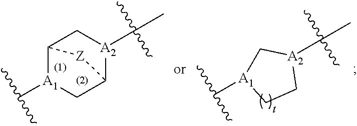

t is 1 or 2;
A₁ and A₂ are each independently selected from CH or N;
Z is CH₂ or absent wherein when Z is CH₂, the dashed lines (1) and (2) each represent a single bond; and when Z is absent, the dashed lines (1) and (2) are both absent;
R₁, R₂, R₃, R₄, and R₅ are independently selected from the group consisting of C₅₋₂₀ alkyl, C₅₋₂₀ alkenyl, —R″MR′, —R*YR″, —YR″, and —R*OR″;
R_{X1} and R_{X2} are each independently H or C₁₋₃ alkyl;
each M is independently selected from the group consisting of —C(O)O—, —OC(O)—, —OC(O)O—, —C(O) N(R′)—, —N(R′)C(O)—, —C(O)—, —C(S)—, —C(S)S—, —SC(S)—, —CH(OH)—, —P(O)(OR′)O—, —S(O)₂—, —C(O)S—, —SC(O)—, an aryl group, and a heteroaryl group;
M* is C₁-C₆ alkyl,
W¹ and W² are each independently selected from the group consisting of —O— and —N(R₆)—;
each R₆ is independently selected from the group consisting of H and C₁₋₅ alkyl;
X¹, X², and X³ are independently selected from the group consisting of a bond, —CH₂—, —(CH₂)₂—, —CHR—, —CHY—, —C(O)—, —C(O)O—, —OC(O)—, —(CH₂)ₙ—C(O)—, —C(O)—(CH₂)ₙ—, —(CH₂)ₙ—C(O)O—, —OC(O)—(CH₂)ₙ—, —(CH₂)ₙ—OC(O)—, —C(O)O—(CH₂)ₙ—, —CH(OH)—, —C(S)—, and —CH(SH)—, each Y is independently a C₃₋₆ carbocycle;
each R* is independently selected from the group consisting of C₁₋₁₂ alkyl and C₂₋₁₂ alkenyl;
each R is independently selected from the group consisting of C₁₋₃ alkyl and a C₃₋₆ carbocycle;
each R′ is independently selected from the group consisting of C₁₋₁₂ alkyl, C₂₋₁₂ alkenyl, and H;
each R″ is independently selected from the group consisting of C₃₋₁₂ alkyl, C₃₋₁₂ alkenyl and —R*MR′; and
n is an integer from 1-6;
wherein when ring A is

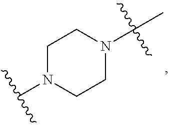 [SMILES: *N1CCN(*)CC1]

then
i) at least one of X¹, X², and X³ is not —CH₂—; and/or
ii) at least one of R₁, R₂, R₃, R₄, and R₅ is —R″MR′.

In some embodiments, the compound is of any of formulae (IL-IIIa1)-(IL-IIIa8):

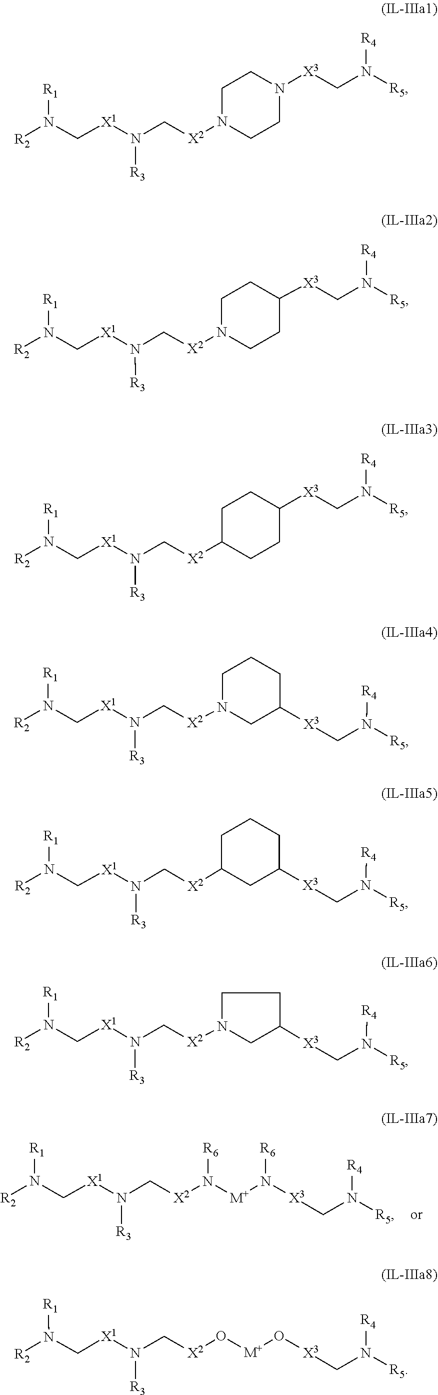

In some embodiments, the ionizable lipids are one or more of the compounds described in PCT Publication Nos. WO 2017/112865, WO 2018/232120.

In some embodiments, the ionizable lipids are selected from Compound 1-156 described in PCT Publication No. WO 2018/232120.

In some embodiments, the ionizable lipids are selected from Compounds 1-16, 42-66, 68-76, and 78-156 described in PCT Publication Nos. WO 2017/112865.

In some embodiments, the ionizable lipid is

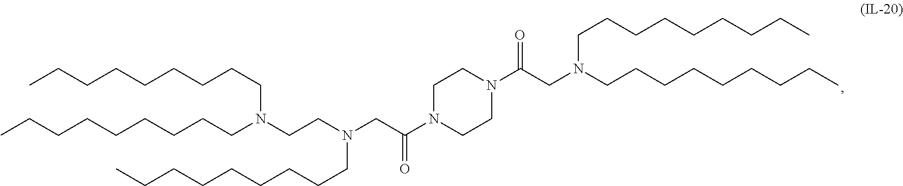 [SMILES: CCCCCCCCCN(CCCCCCCCC)CCN(CCCCCCCCC)CC(=O)N1CCN(C(=O)CN(CCCCCCCCC)CCCCCCCCC)CC1]

or a salt thereof.

In some embodiments, the ionizable lipid is IL-20.

In some embodiments, the ionizable lipid is

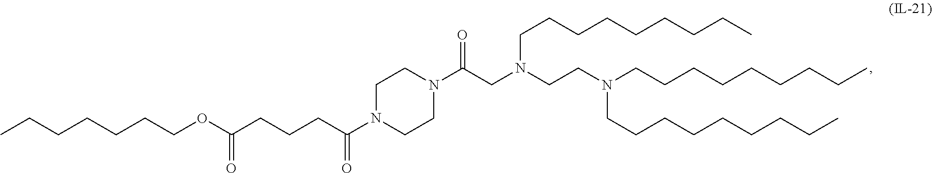 [SMILES: CCCCCCCCCN(CCCCCCCCC)CCN(CCCCCCCCC)CC(=O)N1CCN(C(=O)CCCC(=O)OCCCCCCC)CC1]

or a salt thereof.

In some embodiments, the ionizable lipid is IL-21.

The central amine moiety of a lipid according to Formula (IL-1), (IL-IA), (IL-IB), (IL-II), (IL-IIa), (IL-IIb), (IL-IIc), (IL-IId), (IL-IIe), (IL-IIf), (IL-IIg), (IL-III), (IL-IIIa1), (IL-IIIa2), (IL-IIIa3), (IL-IIIa4), (IL-IIIa5), (IL-IIIa6), (IL-IIIa7), or (IL-IIIa8) may be protonated at a physiological pH. Thus, a lipid may have a positive or partial positive charge at physiological pH. Such lipids may be referred to as cationic or ionizable (amino) lipids. Lipids may also be zwitterionic, i.e., neutral molecules having both a positive and a negative charge.

In some embodiments, the ionizable lipid is selected from the group consisting of 3-(didodecylamino)-N1,N1,4-tridodecyl-1-piperazineethanamine (KL10), N1-[2-(didodecylamino)ethyl]-N1,N4,N4-tridodecyl-1,4-piperazinediethanamine (KL22), 14,25-ditridecyl-15,18,21,24-tetraaza-octatriacontane (KL25), 1,2-dilinoleyloxy-N,N-dimethylaminopropane (DLin-DMA), 2,2-dilinoleyl-4-dimethylaminomethyl-[1,3]-dioxolane (DLin-K-DMA), heptatriaconta-6,9,28,31-tetraen-19-yl 4-(dimethylamino) butanoate (DLin-MC3-DMA), 2,2-dilinoleyl-4-(2-dimethylaminoethyl)-[1,3]-dioxolane (DLin-KC2-DMA), 1,2-dioleyloxy-N,N-dimethylaminopropane (DODMA), 2-({8-[(3B)-cholest-5-en-3-yloxy]octyl}oxy)-N,N-dimethyl-3-[(9Z,12Z)-octadeca-9,12-dien-1-yloxy]propan-1-amine (Octyl-CLinDMA), (2R)-2-({8-[(3B)-cholest-5-en-3-yloxy]octyl}oxy)-N,N-dimethyl-3-[(9Z,12Z)-octadeca-9,12-dien-1-yloxy]propan-1-amine (Octyl-CLinDMA (2R)), and (2S)-2-({8-[(3B)-cholest-5-en-3-yloxy]octyl}oxy)-N,N-dimethyl-3-[(9Z,12Z)-octadeca-9,12-dien-1-yloxy]propan-1-amine (Octyl-CLinDMA (2S)).

### Polyethylene Glycol (PEG) Lipids

As used herein, the term “PEG lipid” refers to polyethylene glycol (PEG)-modified lipids. Non-limiting examples of PEG lipids include PEG-modified phosphatidylethanolamine and phosphatidic acid, PEG-ceramide conjugates (e.g., PEG-CerC14 or PEG-CerC20), PEG-modified dialkylamines and PEG-modified 1,2-diacyloxypropan-3-amines. Such lipids are also referred to as PEGylated lipids. In some embodiments, a PEG lipid can be PEG-c-DOMG, PEG-DMG, PEG-DLPE, PEG-DMPE, PEG-DPPC, or a PEG-DSPE lipid.

In some embodiments, the PEG lipid includes, but are not limited to, 1,2-dimyristoyl-sn-glycerol methoxypolyethylene glycol (PEG-DMG), 1,2-distearoyl-sn-glycero-3-phosphoethanolamine-N-[amino (polyethylene glycol)] (PEG-DSPE), PEG-disteryl glycerol (PEG-DSG), PEG-dipalmetoleyl, PEG-dioleyl, PEG-distearyl, PEG-diacylglycamide (PEG-DAG), PEG-dipalmitoyl phosphatidylethanolamine (PEG-DPPE), or PEG-1,2-dimyristyloxlpropyl-3-amine (PEG-c-DMA).

In one embodiment, the PEG lipid is selected from the group consisting of a PEG-modified phosphatidylethanolamine, a PEG-modified phosphatidic acid, a PEG-modified ceramide, a PEG-modified dialkylamine, a PEG-modified diacylglycerol, a PEG-modified dialkylglycerol, and mixtures thereof.

In some embodiments, the lipid moiety of the PEG lipids includes those having lengths of from about C₁₄ to about C₂₂, In some embodiments, the lipid moiety of the PEG lipids includes those having lengths of from about C₁₄ to about C₁₆. In some embodiments, a PEG moiety, for example an mPEG-NH₂, has a size of about 1000, 2000, 5000, 10,000, 15,000 or 20,000 daltons. In one embodiment, the PEG lipid is PEG₂ₖ-DMG.

In one embodiment, the lipid nanoparticles described herein can comprise a PEG lipid which is a non-diffusible PEG. Non-limiting examples of non-diffusible PEGs include PEG-DSG and PEG-DSPE.

PEG lipids are known in the art, such as those described in U.S. Pat. No. 8,158,601 and International Publ. No. WO 2015/130584 A2, which are incorporated herein by reference in their entireties.

In general, some of the other lipid components (e.g., PEG lipids) of various formulae, described herein may be synthesized as described International Patent Application No. PCT/US2016/000129, filed Dec. 10, 2016, entitled “Compositions and Methods for Delivery of Therapeutic Agents,” which is incorporated by reference in its entirety.

The lipid component of a lipid nanoparticle or lipid nanoparticle formulation may include one or more molecules comprising polyethylene glycol, such as PEG or PEG-modified lipids. Such species may be alternately referred to as PEGylated lipids. A PEG lipid is a lipid modified with polyethylene glycol. A PEG lipid may be selected from the non-limiting group including PEG-modified phosphatidylethanolamines, PEG-modified phosphatidic acids, PEG-modified ceramides, PEG-modified dialkylamines, PEG-modified diacylglycerols, PEG-modified dialkylglycerols, and mixtures thereof. In some embodiments, a PEG lipid may be PEG-c-DOMG, PEG-DMG, PEG-DLPE, PEG-DMPE, PEG-DPPC, or a PEG-DSPE lipid.

In some embodiments, the PEG-modified lipids are a modified form of PEG DMG. PEG-DMG has the following structure:

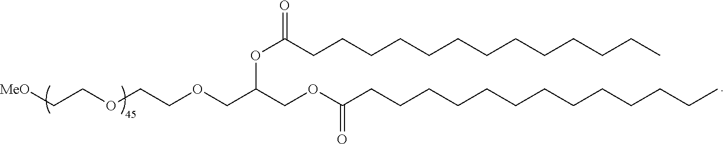

In one embodiment, PEG lipids useful in the present invention can be PEGylated lipids described in International Publication No. WO2012099755, which is herein incorporated by reference in its entirety. Any of these exemplary PEG lipids described herein may be modified to comprise a hydroxyl group on the PEG chain. In some embodiments, the PEG lipid is a PEG-OH lipid. As generally defined herein, a “PEG-OH lipid” (also referred to herein as “hydroxy-PEGylated lipid”) is a PEGylated lipid having one or more hydroxyl (—OH) groups on the lipid. In some embodiments, the PEG-OH lipid includes one or more hydroxyl groups on the PEG chain. In some embodiments, a PEG-OH or hydroxy-PEGylated lipid comprises an —OH group at the terminus of the PEG chain. Each possibility represents a separate embodiment of the present invention.

In some embodiments, a PEG lipid useful in the present invention is a compound of Formula (PL-I). Provided herein are compounds of Formula (PL-I):

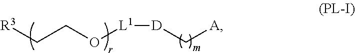

or salts thereof, wherein:
R³ is —OR^{O};
R^{O} is hydrogen, optionally substituted alkyl, or an oxygen protecting group;
r is an integer between 1 and 100, inclusive;
L¹ is optionally substituted C₁₋₁₀ alkylene, wherein at least one methylene of the optionally substituted C₁₋₁₀ alkylene is independently replaced with optionally substituted carbocyclylene, optionally substituted heterocyclylene, optionally substituted arylene, optionally substituted heteroarylene, O, N(R^{N}), S, C(O), C(O)N(R^{N}), NR^{N}C(O), C(O)O, —OC(O), OC(O)O, OC(O)N(R^{N}), NR^{N}C(O)O, or NR^{N}C(O)N(R^{N});
D is a moiety obtained by click chemistry or a moiety cleavable under physiological conditions;
m is 0, 1, 2, 3, 4, 5, 6, 7, 8, 9, or 10;
A is of the formula:

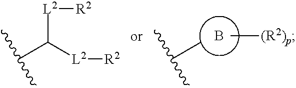

each instance of of L² is independently a bond or optionally substituted C₁₋₆ alkylene, wherein one methylene unit of the optionally substituted C₁₋₆ alkylene is optionally replaced with O, N(R^{N}), S, C(O), C(O)N(R^{N}), NR^{N}C(O), C(O)O, OC(O), OC(O)O, OC(O)N(R^{N}), —NR^{N}C(O)O, or NR^{N}C(O)N(R^{N});
each instance of R² is independently optionally substituted C₁₋₃₀ alkyl, optionally substituted C₁₋₃₀ alkenyl, or optionally substituted C₁₋₃₀ alkynyl; optionally wherein one or more methylene units of R² are independently replaced with optionally substituted carbocyclylene, optionally substituted heterocyclylene, optionally substituted arylene, optionally substituted heteroarylene, N(R^{N}), O, S, C(O), C(O)N(R^{N}), NR^{N}C(O), —NR^{N}C(O)N(R^{N}), C(O)O, OC(O), OC(O)O, OC(O)N(R^{N}), NR^{N}C(O)O, C(O)S, SC(O), —C(═NR^{N}), C(═NR^{N})N(R^{N}), NR^{N}C(═NR^{N}), NR^{N}C(═NR^{N})N(R^{N}), C(S), C(S)N(R^{N}), NR^{N}C(S), NR^{N}C(S)N(R^{N}), S(O), OS(O), S(O)O, OS(O)O, OS(O)₂, S(O)₂O, OS(O)₂O, N(R^{N})S(O), —S(O)N(R^{N}), N(R^{N})S(O)N(R^{N}), OS(O)N(R^{N}), N(R^{N})S(O)O, S(O)₂, N(R^{N})S(O)₂, S(O)₂N(R^{N}), N(R^{N})S(O)₂N(R^{N}), OS(O)₂N(R^{N}), or N(R^{N})S(O)₂O;
each instance of R^{N} is independently hydrogen, optionally substituted alkyl, or a nitrogen protecting group;
Ring B is optionally substituted carbocyclyl, optionally substituted heterocyclyl, optionally substituted aryl, or optionally substituted heteroaryl; and
p is 1 or 2.

In some embodiments, the compound of Formula (PL-I) is a PEG-OH lipid (i.e., R³ is —OR^{O}, and R^{O} is hydrogen). In some embodiments, the compound of Formula (PL-I) is of Formula (PL-I-OH):

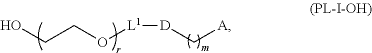

or a salt thereof.

In some embodiments, a PEG lipid useful in the present invention is a PEGylated fatty acid. In some embodiments, a PEG lipid useful in the present invention is a compound of Formula (PL-II). Provided herein are compounds of Formula (PL-II):

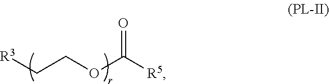

or a salt thereof, wherein:
R³ is —OR^{O};
R^{O} is hydrogen, optionally substituted alkyl or an oxygen protecting group;
r is an integer between 1 and 100, inclusive;
R⁵ is optionally substituted C₁₀₋₄₀ alkyl, optionally substituted C₁₀₋₄₀ alkenyl, or optionally substituted C₁₀₋₄₀ alkynyl; and optionally one or more methylene groups of R⁵ are replaced with optionally substituted carbocyclylene, optionally substituted heterocyclylene, optionally substituted arylene, optionally substituted heteroarylene, N(R^{N}), O, S, C(O), —C(O)N(R^{N}), NR^{N}C(O), NR^{N}C(O)N(R^{N}), C(O)O, OC(O), OC(O)O, OC(O)N(R^{N}), NR^{N}C(O)O, C(O)S, SC(O), C(═NR^{N}), C(═NR^{N})N(R^{N}), NR^{N}C(═NR^{N}), NR^{N}C(═NR^{N})N(R^{N}), C(S), —C(S)N(R^{N}), NR^{N}C(S), NR^{N}C(S)N(R^{N}), S(O), OS(O), S(O)O, OS(O)O, OS(O)₂, S(O)₂O, —OS(O)₂O, N(R^{N})S(O), S(O)N(R^{N}), N(R^{N})S(O)N(R^{N}), OS(O)N(R^{N}), N(R^{N})S(O)O, S(O)₂, —N(R^{N})S(O)₂, S(O)>N(R^{N}), N(R^{N})S(O)₂N(R^{N}), OS(O)₂N(R^{N}), or N(R^{N})S(O)₂O; and
each instance of R^{N} is independently hydrogen, optionally substituted alkyl, or a nitrogen protecting group.

In some embodiments, the compound of Formula (PL-II) is of Formula (PL-II-OH):

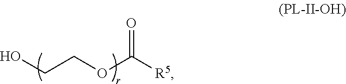

or a salt thereof, wherein:
r is an integer between 1 and 100;
R⁵ is optionally substituted C₁₀₋₄₀ alkyl, optionally substituted C₁₀₋₄₀ alkenyl, or optionally substituted C₁₀₋₄₀ alkynyl; and optionally one or more methylene groups of R⁵ are replaced with optionally substituted carbocyclylene, optionally substituted heterocyclylene, optionally substituted arylene, optionally substituted heteroarylene, N(R^{N}), O, S, C(O), —C(O)N(R^{N}), NR^{N}C(O), NR^{N}C(O)N(R^{N}), C(O)O, OC(O), OC(O)O, OC(O)N(R^{N}), NR^{N}C(O)O, C(O)S, SC(O), C(═NR^{N}), C(—NR^{N})N(R^{N}), NR^{N}C(═NR^{N}), NR^{N}C(═NR^{N})N(R^{N}), C(S), —C(S)N(R^{N}), NR^{N}C(S), NR^{N}C(S)N(R^{N}), S(O), OS(O), S(O)O, OS(O)O, OS(O)₂, S(O)₂O, —OS(O)₂O, N(R^{N})S(O), S(O)N(R^{N}), N(R^{N})S(O)N(R^{N}), OS(O)N(R^{N}), N(R^{N})S(O)O, S(O)₂, —N(R^{N})S(O)₂, S(O)₂N(R^{N}), N(R^{N})S(O)₂N(R^{N}), OS(O)₂N(R^{N}), or N(R^{N})S(O)₂O; and
each instance of R^{N} is independently hydrogen, optionally substituted alkyl, or a nitrogen protecting group.

In some embodiments, r is an integer between 10 to 80, between 20 to 70, between 30 to 60, or between 40 to 50.

In some embodiments, r is 45.

In some embodiments, R⁵ is C₁₇ alkyl.

In yet other embodiments the compound of Formula (PL-II) is:

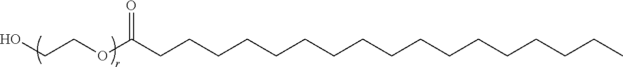

or a salt thereof.

In one embodiment, the compound of Formula (PL-II) is

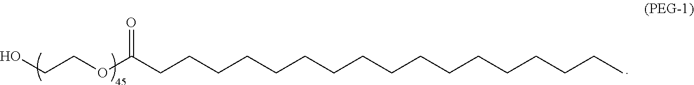

In some aspects, the lipid composition of the pharmaceutical compositions described herein does not comprise a PEG lipid.

In some embodiments, the PEG lipids may be one or more of the PEG lipids described in U.S. Application No. 62/520,530.

In some embodiments, the PEG lipid is a compound of Formula (PL-III):

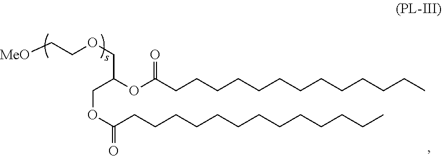

or a salt or isomer thereof, wherein s is an integer between 1 and 100.

In some embodiments, the PEG lipid is a compound of the following formula:

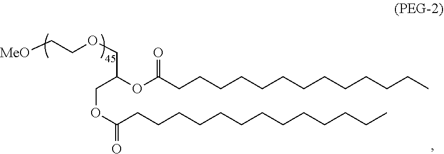

or a salt or isomer thereof.

### Structural Lipids

As used herein, the term “structural lipid” refers to sterols and also to lipids containing sterol moieties.

Incorporation of structural lipids in the lipid nanoparticle may help mitigate aggregation of other lipids in the particle. Structural lipids can be selected from the group including but not limited to, cholesterol, fecosterol, sitosterol, ergosterol, campesterol, stigmasterol, brassicasterol, tomatidine, tomatine, ursolic acid, alpha-tocopherol, hopanoids, phytosterols, steroids, and mixtures thereof. In some embodiments, the structural lipid is a mixture of two or more components each independently selected from cholesterol, fecosterol, sitosterol, ergosterol, campesterol, stigmasterol, brassicasterol, tomatidine, tomatine, ursolic acid, alpha-tocopherol, hopanoids, phytosterols, and steroids. In some embodiments, the structural lipid is a sterol. In some embodiments, the structural lipid is a mixture of two or more sterols. As defined herein, “sterols” are a subgroup of steroids consisting of steroid alcohols. In some embodiments, the structural lipid is a steroid. In some embodiments, the structural lipid is cholesterol. In some embodiments, the structural lipid is an analog of cholesterol. In some embodiments, the structural lipid is alpha-tocopherol.

In some embodiments, the structural lipids may be one or more structural lipids described in U.S. Application No. 62/520,530.

As defined herein, “sterols” are a subgroup of steroids consisting of steroid alcohols. In some embodiments, the structural lipid is a steroid. In some embodiments, the structural lipid is cholesterol. In some embodiments, the structural lipid is an analog of cholesterol. In some embodiments, the structural lipid is alpha-tocopherol.

In some embodiments, the structural lipid is

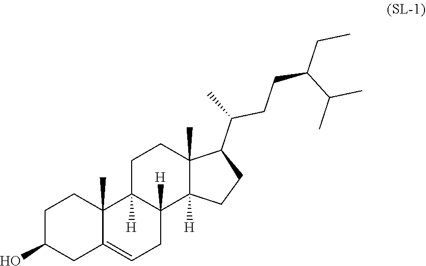

or a salt thereof.

In some embodiments, the structural lipid is SL-1.

In some embodiments, the structural lipid is

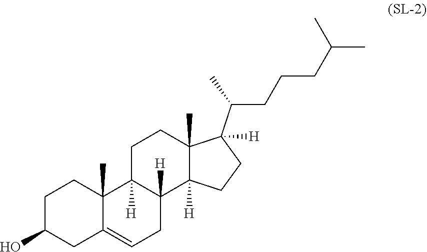

or a salt thereof.

In some embodiments, the structural lipid (e.g., SL-2) is present at a concentration ranging from about 15 mol % to about 70 mol %, from about 20 mol % to about 60 mol %, from about 25 mol % to about 50 mol %, from about 30 mol % to about 45 mol %, from about 35 mol % to about 40 mol %, or from about 36 mol % to about 38 mol %.

In some embodiments, the structural lipid (e.g., SL-2) is present at a concentration of about 36.6±25 mol %, about 36.6±20 mol %, about 36.6±15 mol %, about 36.6±10 mol %, about 36.6±9 mol %, about 36.6±8 mol %, about 36.6±7 mol %, about 36.6±6 mol %, about 36.6±5 mol %, about 36.6±4 mol %, about 36.6±3 mol %, about 36.6±2 mol %, about 36.6±1 mol %, about 36.6±0.8 mol %, about 36.6±0.6 mol %, about 36.6±0.5 mol %, about 36.6=0.4 mol %, about 36.6±0.3 mol %, about 36.6±0.2 mol %, or about 36.6±0.1 mol % (e.g., about 36.6 mol %).

### Encapsulation Agent

In some embodiments of the present disclosure, the encapsulation agent is a compound of Formula (EA-I):

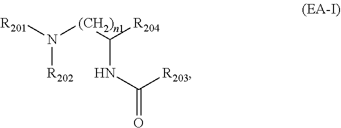

or salts or isomers thereof, wherein
R₂₀₁ and R₂₀₂ are each independently selected from the group consisting of H, C₁-C₆ alkyl, C₂-C₆ alkenyl, and (C═NH)N(R₁₀₁)₂ wherein each R₁₀₁ is independently selected from the group consisting of H, C₁-C₆ alkyl, and C₂-C₆ alkenyl;
R₂₀₃ is selected from the group consisting of C₁-C₂₀ alkyl and C₂-C₂₀ alkenyl;
R₂₀₄ is selected from the group consisting of H, C₁-C₂₀ alkyl, C₂-C₂₀ alkenyl, C(O)(OC₁-C₂₀ alkyl), C(O)(OC₂-C₂₀ alkenyl), C(O) (NHC₁-C₂₀ alkyl), and C(O) (NHC₂-C₂₀ alkenyl);
n1 is selected from 1, 2, 3, 4, 5, 6, 7, 8, 9, and 10.

In some embodiments, R₂₀₁ and R₂₀₂ are each independently selected from the group consisting of H and CH₃.

In some embodiments, R₂₀₁ and R₂₀₂ are each independently selected from the group consisting of (C═NH)NH₂ and (C═NH)N(CH₃)₂

In some embodiments, R₂₀₃ is selected from the group consisting of C₁-C₂₀ alkyl, C₈-C₁₈ alkyl, and C₁₂-C₁₆ alkyl.

In some embodiments, R₂₀₄ is selected from the group consisting of H, C₁-C₂₀ alkyl, C₂-C₂₀ alkenyl, C(O)(OC₁-C₂₀ alkyl), C(O)(OC₂-C₂₀ alkenyl), C(O) (NHC₁-C₂₀ alkyl), and C(O) (NHC₂-C₂₀ alkenyl); C₈-C₁₈ alkyl, C₈-C₁₈ alkenyl, C(O)(OC₈-C₁₈ alkyl), C(O)(OC₈-C₁₈ alkenyl), C(O) (NHC₈-C₁₈ alkyl), and C(O) (NHC₈-C₁₈ alkenyl); and C₁₂-C₁₆ alkyl, C₁₂-C₁₆ alkenyl, C(O)(OC₁₂-C₁₆ alkyl), C(O)(OC₁₂-C₁₆ alkenyl), C(O) (NHC₁₂-C₁₆ alkyl), and C(O) (NHC₁₂-C₁₆ alkenyl);
In some embodiments, n1 is selected from 1, 2, 3, 4, 5, 6, 7, 8, 9, and 10; n1 is selected from 1, 2, 3, 4, 5, and 6; n1 is selected from 2, 3, and 4.

In some embodiments, n1 is 3.

In some embodiments of the present disclosure, the encapsulation agent is a compound of Formula (EA-II):

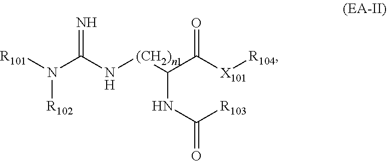

or salts or isomers thereof, wherein
X¹⁰¹ is a bond, NH, or O;
R₁₀₁ and R¹⁰² are each independently selected from the group consisting of H, C₁-C₆ alkyl, and C₂-C₆ alkenyl;
R¹⁰³ and R¹⁰⁴ are each independently selected from the group consisting of C₁-C₂₀ alkyl and C₂-C₂₀ alkenyl; and
n1 is selected from 1, 2, 3, 4, 5, 6, 7, 8, 9, and 10.

In some embodiments, X¹⁰¹ is a bond.

In some embodiments, X¹⁰¹ is NH.

In some embodiments, X¹⁰¹ is O.

In some embodiments, R₁₀₁ and R¹⁰² are each independently selected from the group consisting of H and CH₃.

In some embodiments, R¹⁰³ is selected from the group consisting of C₁-C₂₀ alkyl, C₈-C₁₈ alkyl, and C₁₂-C₁₆ alkyl.

In some embodiments, R¹⁰⁴ is selected from the group consisting of C₁-C₂₀ alkyl, C₈-C₁₈ alkyl, and C₁₂-C₁₆ alkyl.

In some embodiments, n1 is selected from 1, 2, 3, 4, 5, 6, 7, 8, 9, and 10; n1 is selected from 1, 2, 3, 4, 5, and 6; n1 is selected from 2, 3, and 4.

In some embodiments, n1 is 3.

Exemplary encapsulation agents include, but are not limited to, ethyl lauroyl arginate, ethyl myristoyl arginate, ethyl palmitoyl arginate, ethyl cholesterol-arginate, ethyl oleic arginate, ethyl capric arginate, and ethyl carprylic arginate.

In some embodiments, the encapsulation agent is ethyl lauroyl arginate,

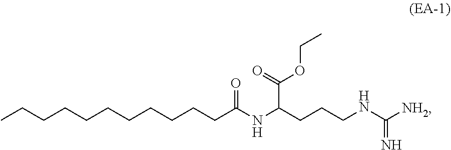 [SMILES: CCCCCCCCCCCC(=O)NC(CCCNC(=N)N)C(=O)OCC]

or a salt or isomer thereof.

In some embodiments, the encapsulation agent is at least one compound selected from the group consisting of:

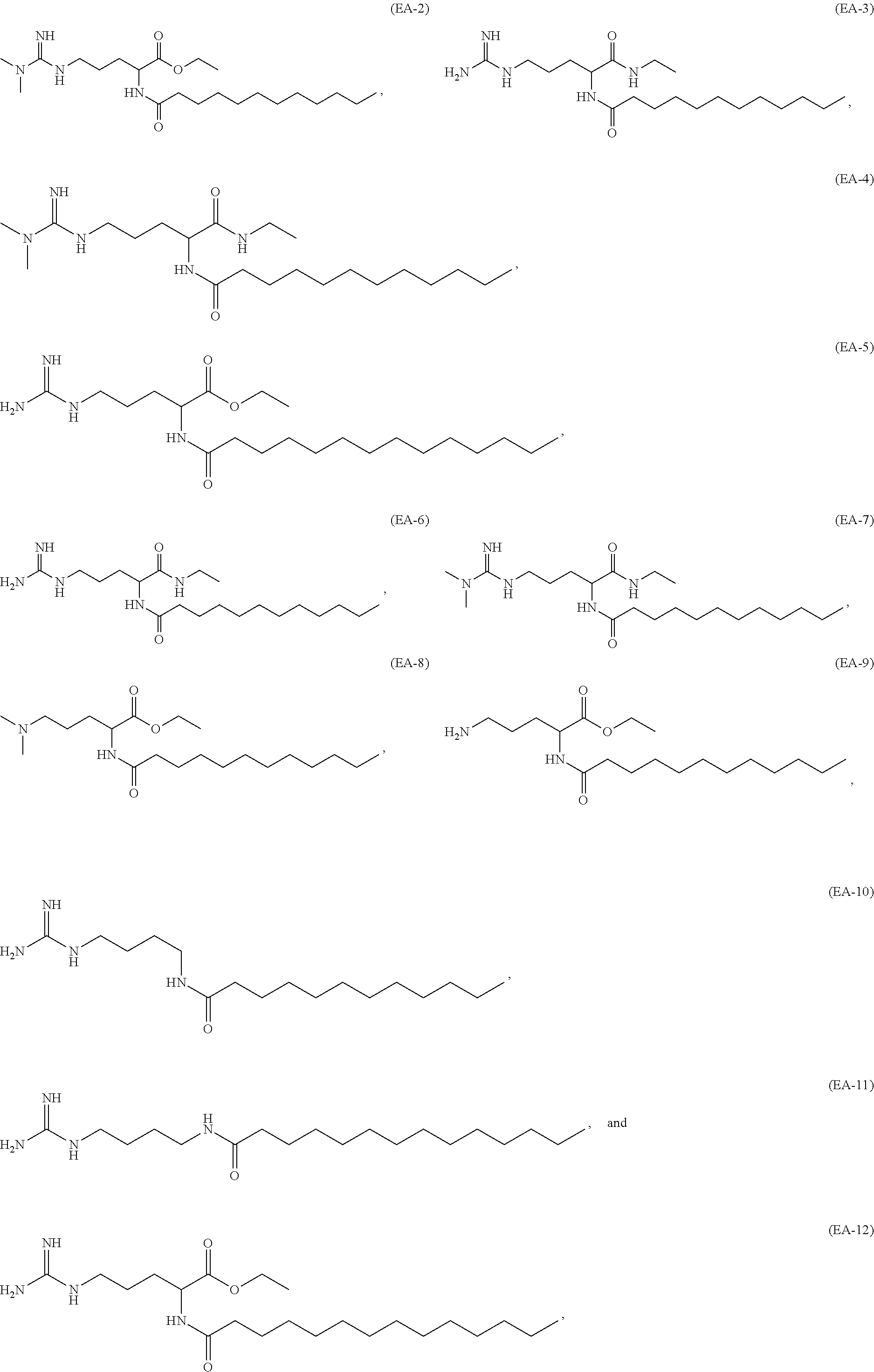

or salts and isomers thereof, such as, for example free bases, TFA salts, and/or HCl salts.

### Phospholipids

Phospholipids may assemble into one or more lipid bilayers. In general, phospholipids comprise a phospholipid moiety and one or more fatty acid moieties.

A phospholipid moiety can be selected, for example, from the non-limiting group consisting of phosphatidyl choline, phosphatidyl ethanolamine, phosphatidyl glycerol, phosphatidyl serine, phosphatidic acid, 2-lysophosphatidyl choline, and a sphingomyelin.

A fatty acid moiety can be selected, for example, from the non-limiting group consisting of lauric acid, myristic acid, myristoleic acid, palmitic acid, palmitoleic acid, stearic acid, oleic acid, linoleic acid, alpha-linolenic acid, erucic acid, phytanoic acid, arachidic acid, arachidonic acid, eicosapentaenoic acid, behenic acid, docosapentaenoic acid, and docosahexaenoic acid.

Particular phospholipids can facilitate fusion to a membrane. In some embodiments, a cationic phospholipid can interact with one or more negatively charged phospholipids of a membrane (e.g., a cellular or intracellular membrane). Fusion of a phospholipid to a membrane can allow one or more elements (e.g., a therapeutic agent) of a lipid-containing composition (e.g., LNPs) to pass through the membrane permitting, e.g., delivery of the one or more elements to a target tissue.

Non-natural phospholipid species including natural species with modifications and substitutions including branching, oxidation, cyclization, and alkynes are also contemplated. In some embodiments, a phospholipid can be functionalized with or cross-linked to one or more alkynes (e.g., an alkenyl group in which one or more double bonds is replaced with a triple bond). Under appropriate reaction conditions, an alkyne group can undergo a copper-catalyzed cycloaddition upon exposure to an azide. Such reactions can be useful in functionalizing a lipid bilayer of a nanoparticle composition to facilitate membrane permeation or cellular recognition or in conjugating a nanoparticle composition to a useful component such as a targeting or imaging moiety (e.g., a dye).

Phospholipids include, but are not limited to, glycerophospholipids such as phosphatidylcholines, phosphatidylethanolamines, phosphatidylserines, phosphatidylinositols, phosphatidyglycerols, and phosphatidic acids. Phospholipids also include phosphosphingolipid, such as sphingomyelin.

In some embodiments, a phospholipid useful or potentially useful in the present invention is an analog or variant of DSPC. In some embodiments, a phospholipid useful or potentially useful in the present invention is a compound of Formula (PL-I):

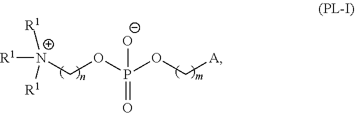

or a salt thereof, wherein:
each R¹ is independently optionally substituted alkyl; or optionally two R¹ are joined together with the intervening atoms to form optionally substituted monocyclic carbocyclyl or optionally substituted monocyclic heterocyclyl; or optionally three R¹ are joined together with the intervening atoms to form optionally substituted bicyclic carbocyclyl or optionally substitute bicyclic heterocyclyl;
n is 1, 2, 3, 4, 5, 6, 7, 8, 9, or 10;
m is 0, 1, 2, 3, 4, 5, 6, 7, 8, 9, or 10;
A is of the formula:

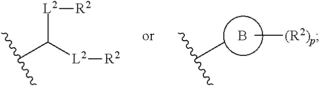

each instance of L² is independently a bond or optionally substituted C₁₋₆ alkylene, wherein one methylene unit of the optionally substituted C₁₋₆ alkylene is optionally replaced with —O—, —N(R^{N})—, —S—, —C(O)—, —C(O)N(R^{N})—, —NR^{N}C(O)—, —C(O)O—, —OC(O)—, —OC(O)O—, —OC(O)N(R^{N})—, —NR^{N}C(O)O—, or —NR^{N}C(O)N(R^{N})—;
each instance of R² is independently optionally substituted C₁₋₃₀ alkyl, optionally substituted C₁₋₃₀ alkenyl, or optionally substituted C₁₋₃₀ alkynyl; optionally wherein one or more methylene units of R² are independently replaced with optionally substituted carbocyclylene, optionally substituted heterocyclylene, optionally substituted arylene, optionally substituted heteroarylene, —N(R^{N})—, —O—, —S—, —C(O)—, —C(O)N(R^{N})—, —NR^{N}C(O)—, —NR^{N}C(O)N(R^{N})—, —C(O)O—, —OC(O)—, —OC(O)O—, —OC(O)N(R^{N})—, —NR^{N}C(O)O—, —C(O)S—, —SC(O)—, —C(═NR^{N})—, —C(═NR^{N})N(R^{N})—, —NR^{N}C(═NR^{N})—, —NR^{N}C(—NR^{N})N(R^{N})—, —C(S)—, —C(S)N(R^{N})—, —NR^{N}C(S)—, —NR^{N}C(S)N(R^{N})—, —S(O)—, —OS(O)—, —S(O)O—, —OS(O)O—, —OS(O)₂—, —S(O)₂O—, —OS(O)₂O—, —N(R^{N})S(O)—, —S(O)N(R^{N})—, —N(R^{N})S(O)N(R^{N})—, —OS(O)N(R^{N})—, —N(R^{N})S(O)O—, —S(O)₂—, —N(R^{N})S(O)₂—, —S(O)₂N(R^{N})—, —N(R^{N})S(O)₂N(R^{N})—, —OS(O)₂N(R^{N})—, or —N(R^{N})S(O)₂O—;
each instance of R^{N} is independently hydrogen, optionally substituted alkyl, or a nitrogen protecting group;
Ring B is optionally substituted carbocyclyl, optionally substituted heterocyclyl, optionally substituted aryl, or optionally substituted heteroaryl; and
p is 1 or 2;
provided that the compound is not of the formula:

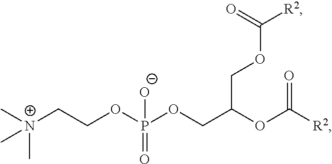

wherein each instance of R² is independently unsubstituted alkyl, unsubstituted alkenyl, or unsubstituted alkynyl.

In some embodiments, the phospholipids may be one or more of the phospholipids described in U.S. Application No. 62/520,530.

In some embodiments, the phospholipids may be selected from the non-limiting group consisting of 1,2-distearoyl-sn-glycero-3-phosphocholine (DSPC), 1,2-dioleoyl-sn-glycero-3-phosphoethanolamine (DOPE), 1,2-dilinoleoyl-sn-glycero-3-phosphocholine (DLPC), 1,2-dimyristoyl-sn-glycero-phosphocholine (DMPC), 1,2-dioleoyl-sn-glycero-3-phosphocholine (DOPC), 1,2-dipalmitoyl-sn-glycero-3-phosphocholine (DPPC), 1,2-diundecanoyl-sn-glycero-phosphocholine (DUPC), 1-palmitoyl-2-oleoyl-sn-glycero-3-phosphocholine (POPC), 1,2-di-O-octadecenyl-sn-glycero-3-phosphocholine (18:0 Diether PC), 1-oleoyl-2-cholesterylhemisuccinoyl-sn-glycero-3-phosphocholine (OChemsPC), 1-hexadecyl-sn-glycero-3-phosphocholine (C16 Lyso PC), 1,2-dilinolenoyl-sn-glycero-3-phosphocholine, 1,2-diarachidonoyl-sn-glycero-3-phosphocholine, 1,2-didocosahexaenoyl-sn-glycero-3-phosphocholine, 1,2-diphytanoyl-sn-glycero-3-phosphoethanolamine (ME 16.0 PE), 1,2-distearoyl-sn-glycero-3-phosphoethanolamine, 1,2-dilinoleoyl-sn-glycero-3-phosphoethanolamine, 1,2-dilinolenoyl-sn-glycero-3-phosphoethanolamine, 1,2-diarachidonoyl-sn-glycero-3-phosphoethanolamine, 1,2-didocosahexaenoyl-sn-glycero-3-phosphoethanolamine, 1,2-dioleoyl-sn-glycero-3-phospho-rac-(1-glycerol) sodium salt (DOPG), and sphingomyelin. In some embodiments, a LNP includes DSPC. In some embodiments, a LNP includes DOPE. In some embodiments, a LNP includes both DSPC and DOPE.

### i) Phospholipid Head Modifications

In some embodiments, a phospholipid useful or potentially useful in the present invention comprises a modified phospholipid head (e.g., a modified choline group). In some embodiments, a phospholipid with a modified head is DSPC, or analog thereof, with a modified quaternary amine. In some embodiments, in embodiments of Formula (PL-I), at least one of R¹ is not methyl. In some embodiments, at least one of R¹ is not hydrogen or methyl. In some embodiments, the compound of Formula (PL-I) is one of the following formulae:

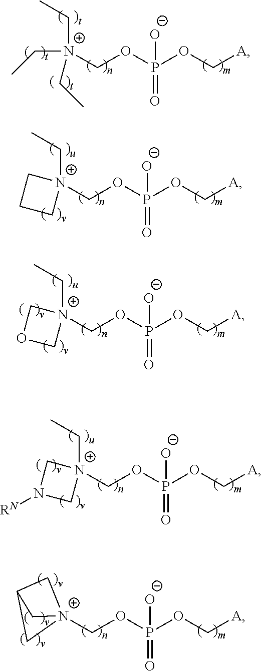

or a salt thereof, wherein:
each t is independently 1, 2, 3, 4, 5, 6, 7, 8, 9, or 10;
each u is independently 0, 1, 2, 3, 4, 5, 6, 7, 8, 9, or 10; and
each v is independently 1, 2, or 3.

In some embodiments, a compound of Formula (PL-I) is of Formula (PL-I-a):

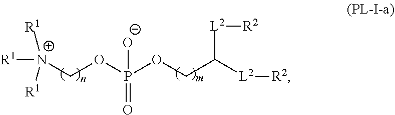

or a salt thereof.

In some embodiments, a phospholipid useful or potentially useful in the present invention comprises a cyclic moiety in place of the glyceride moiety. In some embodiments, a phospholipid useful in the present invention is DSPC, or analog thereof, with a cyclic moiety in place of the glyceride moiety. In some embodiments, the compound of Formula (PL-I) is of Formula (PL-I-b):

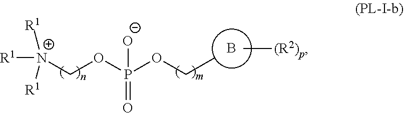

or a salt thereof.

### ii) Phospholipid Tail Modifications

In some embodiments, a phospholipid useful or potentially useful in the present invention comprises a modified tail. In some embodiments, a phospholipid useful or potentially useful in the present invention is DSPC, or analog thereof, with a modified tail. As described herein, a “modified tail” may be a tail with shorter or longer aliphatic chains, aliphatic chains with branching introduced, aliphatic chains with substituents introduced, aliphatic chains wherein one or more methylenes are replaced by cyclic or heteroatom groups, or any combination thereof. In some embodiments, In some embodiments, the compound of (PL-I) is of Formula (PL-I-a), or a salt thereof, wherein at least one instance of R² is each instance of R² is optionally substituted C₁₋₃₀ alkyl, wherein one or more methylene units of R² are independently replaced with optionally substituted carbocyclylene, optionally substituted heterocyclylene, optionally substituted arylene, optionally substituted heteroarylene, —N(R^{N})—, —O—, —S—, —C(O)—, —C(O)N(R^{N})—, —NR^{N}C(O)—, —NR^{N}C(O)N(R^{N})—, —C(O)O—, —OC(O)—, —OC(O)O—, —OC(O)N(R^{N})—, —NR^{N}C(O)O—, —C(O)S—, —SC(O)—, —C(═NR^{N})—, —C(═NR^{N})N(R^{N})—, —NR^{N}C(═NR^{N})—, —NR^{N}C(═NR^{N})N(R^{N})—, —C(S)—, —C(S)N(R^{N})—, —NR^{N}C(S)—, —NR^{N}C(S)N(R^{N})—, —S(O)—, —OS(O)—, —S(O)O—, —OS(O)O—, —OS(O)₂—, —S(O)₂O—, —OS(O)₂O—, —N(R^{N})S(O)—, —S(O)N(R^{N})—, —N(R^{N})S(O)N(R^{N})—, —OS(O)N(R^{N})—, —N(R^{N})S(O)O—, —S(O)₂—, —N(R^{N})S(O)₂—, —S(O)₂N(R^{N})—, —N(R^{N})S(O)₂N(R^{N})—, —OS(O)₂N(R^{N})—, or —N(R^{N})S(O)₂O—.

In some embodiments, the compound of Formula (PL-I) is of Formula (PL-I-c):

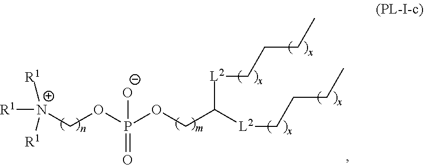

or a salt thereof, wherein:
each x is independently an integer between 0-30, inclusive; and
each instance is G is independently selected from the group consisting of optionally substituted carbocyclylene, optionally substituted heterocyclylene, optionally substituted arylene, optionally substituted heteroarylene, —N(R^{N})—, —O—, —S—, —C(O)—, —C(O)N(R^{N})—, —NR^{N}C(O)—, —NR^{N}C(O)N(R^{N})—, —C(O)O—, —OC(O)—, —OC(O)O—, —OC(O)N(R^{N})—, —NR^{N}C(O)O—, —C(O)S—, —SC(O)—, —C(═NR^{N})—, —C(═NR^{N})N(R^{N})—, —NR^{N}C(═NR^{N})—, —NR^{N}C(—NR^{N})N(R^{N})—, —C(S)—, —C(S)N(R^{N})—, —NR^{N}C(S)—, —NR^{N}C(S)N(R^{N})—, —S(O)—, —OS(O)—, —S(O)O—, —OS(O)O—, —OS(O)₂—, —S(O)₂O—, —OS(O)₂O—, —N(R^{N})S(O)—, —S(O)N(R^{N})—, —N(R^{N})S(O)N(R^{N})—, —OS(O)N(R^{N})—, —N(R^{N})S(O)O—, —S(O)₂—, —N(R^{N})S(O)₂—, —S(O)₂N(R^{N})—, —N(R^{N})S(O)₂N(R^{N})—, —OS(O)₂N(R^{N})—, or —N(R^{N})S(O)₂O—. Each possibility represents a separate embodiment of the present invention.

In some embodiments, a phospholipid useful or potentially useful in the present invention comprises a modified phosphocholine moiety, wherein the alkyl chain linking the quaternary amine to the phosphoryl group is not ethylene (e.g., n is not 2). Therefore, in some embodiments, a phospholipid useful or potentially useful in the present invention is a compound of Formula (PL-I), wherein n is 1, 3, 4, 5, 6, 7, 8, 9, or 10. In some embodiments, a compound of Formula (PL-I) is of one of the following formulae:

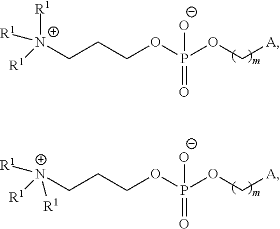

or a salt thereof.

### Alternative Lipids

In some embodiments, an alternative lipid is used in place of a phospholipid of the present disclosure. Non-limiting examples of such alternative lipids include the following:

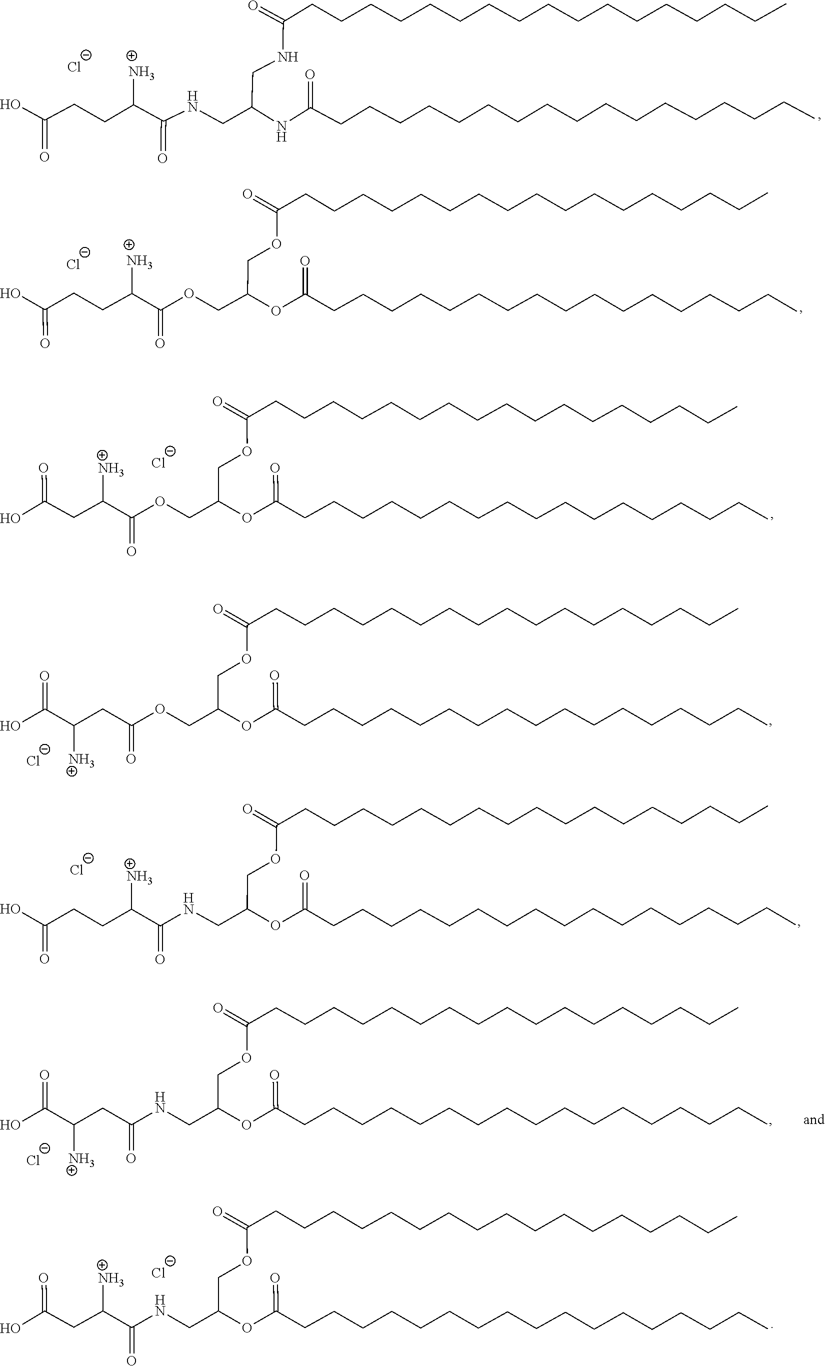

### Adjuvants

In some embodiments, a LNP that includes one or more lipids described herein may further include one or more adjuvants, e.g., Glucopyranosyl Lipid Adjuvant (GLA), CpG oligodeoxynucleotides (e.g., Class A or B), poly(I: C), aluminum hydroxide, and Pam3CSK4.

### Therapeutic Agents

Lipid nanoparticles (e.g., empty LNPs or loaded LNPs) may include one or more therapeutic and/or prophylactics. The disclosure features methods of delivering a therapeutic and/or prophylactic to a mammalian cell or organ, producing a polypeptide of interest in a mammalian cell, and treating a disease or disorder in a mammal in need thereof comprising administering to a mammal and/or contacting a mammalian cell with a lipid nanoparticle (e.g., an empty LNP or a loaded LNP) including a therapeutic and/or prophylactic.

Therapeutic and/or prophylactics include biologically active substances and are alternately referred to as “active agents.” A therapeutic and/or prophylactic may be a substance that, once delivered to a cell or organ, brings about a desirable change in the cell, organ, or other bodily tissue or system. Such species may be useful in the treatment of one or more diseases, disorders, or conditions. In some embodiments, a therapeutic and/or prophylactic is a small molecule drug useful in the treatment of a particular disease, disorder, or condition.

In some embodiments, a therapeutic and/or prophylactic is a vaccine, a compound (e.g., a polynucleotide or nucleic acid molecule that encodes a protein or polypeptide or peptide or a protein or polypeptide or protein) that elicits an immune response, and/or another therapeutic and/or prophylactic. Vaccines include compounds and preparations that are capable of providing immunity against one or more conditions related to infectious diseases and can include mRNAs encoding infectious disease derived antigens and/or epitopes. Vaccines also include compounds and preparations that direct an immune response against cancer cells and can include mRNAs encoding tumor cell derived antigens, epitopes, and/or neoepitopes. In some embodiments, a vaccine and/or a compound capable of eliciting an immune response is administered intramuscularly via a composition of the disclosure.

In other embodiments, a therapeutic and/or prophylactic is a protein, for example a protein needed to augment or replace a naturally-occurring protein of interest. Such proteins or polypeptides may be naturally occurring, or may be modified using methods known in the art, e.g., modified so as to increase half life. Exemplary proteins are intracellular, transmembrane, or secreted proteins, peptides or polypeptides.

### Polynucleotides and Nucleic Acids

In some embodiments, the therapeutic agent is an agent that enhances (i.e., increases, stimulates, upregulates) protein expression. Non-limiting examples of types of therapeutic agents that can be used for enhancing protein expression include RNAs, mRNAs, dsRNAs, CRISPR/Cas9 technology, ssDNAs and DNAs (e.g., expression vectors). The agent that upregulates protein expression may upregulate expression of a naturally occurring or non-naturally occurring protein (e.g., a chimeric protein that has been modified to improve half life, or one that comprises desirable amino acid changes). Exemplary proteins include intracellular, transmembrane, or secreted proteins, peptides, or polypeptides.

In some embodiments, the therapeutic agent is a DNA therapeutic agent. The DNA molecule can be a double-stranded DNA, a single-stranded DNA (ssDNA), or a molecule that is a partially double-stranded DNA, i.e., has a portion that is double-stranded and a portion that is single-stranded. In some cases the DNA molecule is triple-stranded or is partially triple-stranded, i.e., has a portion that is triple stranded and a portion that is double stranded. The DNA molecule can be a circular DNA molecule or a linear DNA molecule.

A DNA therapeutic agent can be a DNA molecule that is capable of transferring a gene into a cell, e.g., a DNA molecule that encodes and can express a transcript. In other embodiments, the DNA molecule is a synthetic molecule, e.g., a synthetic DNA molecule produced in vitro. In some embodiments, the DNA molecule is a recombinant molecule. Non-limiting exemplary DNA therapeutic agents include plasmid expression vectors and viral expression vectors.

The DNA therapeutic agents described herein, e.g., DNA vectors, can include a variety of different features. The DNA therapeutic agents described herein, e.g., DNA vectors, can include a non-coding DNA sequence. For example, a DNA sequence can include at least one regulatory element for a gene, e.g., a promoter, enhancer, termination element, polyadenylation signal element, splicing signal element, and the like. In some embodiments, the non-coding DNA sequence is an intron. In some embodiments, the non-coding DNA sequence is a transposon. In some embodiments, a DNA sequence described herein can have a non-coding DNA sequence that is operatively linked to a gene that is transcriptionally active. In other embodiments, a DNA sequence described herein can have a non-coding DNA sequence that is not linked to a gene, i.e., the non-coding DNA does not regulate a gene on the DNA sequence.

In some embodiments, in the loaded LNP of the disclosure, the one or more therapeutic and/or prophylactic agents is a nucleic acid. In some embodiments, the one or more therapeutic and/or prophylactic agents is selected from the group consisting of a ribonucleic acid (RNA) and a deoxyribonucleic acid (DNA).

For example, in some embodiments, when the therapeutic and/or prophylactic agents is a DNA, the DNA is selected from the group consisting of a double-stranded DNA, a single-stranded DNA (ssDNA), a partially double-stranded DNA, a triple stranded DNA, and a partially triple-stranded DNA. In some embodiments, the DNA is selected from the group consisting of a circular DNA, a linear DNA, and mixtures thereof.

In some embodiments, in the loaded LNP of the disclosure, the one or more therapeutic and/or prophylactic agents is selected from the group consisting of a plasmid expression vector, a viral expression vector, and mixtures thereof.

For example, in some embodiments, when the therapeutic and/or prophylactic agents is a RNA, the RNA is selected from the group consisting of a single-stranded RNA, a double-stranded RNA (dsRNA), a partially double-stranded RNA, and mixtures thereof. In some embodiments, the RNA is selected from the group consisting of a circular RNA, a linear RNA, and mixtures thereof.

For example, in some embodiments, when the therapeutic and/or prophylactic agents is a RNA, the RNA is selected from the group consisting of a short interfering RNA (siRNA), an asymmetrical interfering RNA (aiRNA), a RNA interference (RNAi) molecule, a microRNA (miRNA), an antagomir, an antisense RNA, a ribozyme, a Dicer-substrate RNA (dsRNA), a small hairpin RNA (shRNA), a messenger RNA (mRNA), locked nucleic acids (LNAs) and CRISPR/Cas9 technology, and mixtures thereof.

For example, in some embodiments, when the therapeutic and/or prophylactic agents is a RNA, the RNA is selected from the group consisting of a small interfering RNA (siRNA), an asymmetrical interfering RNA (aiRNA), a microRNA (miRNA), a Dicer-substrate RNA (dsRNA), a small hairpin RNA (shRNA), a messenger RNA (mRNA), and mixtures thereof.

In some embodiments, the one or more therapeutic and/or prophylactic agents is an mRNA. In some embodiments, the one or more therapeutic and/or prophylactic agents is a modified mRNA (mmRNA).

In some embodiments, the one or more therapeutic and/or prophylactic agents is an mRNA that incorporates a micro-RNA binding site (miR binding site). Further, in some embodiments, an mRNA includes one or more of stem loop, chain terminating nucleoside, polyA sequence, polyadenylation signal, and/or 5′ cap structure.

An mRNA may be a naturally or non-naturally occurring mRNA. An mRNA may include one or more modified nucleobases, nucleosides, or nucleotides, as described below, in which case it may be referred to as a “modified mRNA” or “mmRNA.” As described herein “nucleoside” is defined as a compound containing a sugar molecule (e.g., a pentose or ribose) or derivative thereof in combination with an organic base (e.g., a purine or pyrimidine) or a derivative thereof (also referred to herein as “nucleobase”). As described herein, “nucleotide” is defined as a nucleoside including a phosphate group.

An mRNA may include a 5′ untranslated region (5′-UTR), a 3′ untranslated region (3′-UTR), and/or a coding region (e.g., an open reading frame). An mRNA may include any suitable number of base pairs, including tens (e.g., 10, 20, 30, 40, 50, 60, 70, 80, 90 or 100), hundreds (e.g., 200, 300, 400, 500, 600, 700, 800, or 900) or thousands (e.g., 1000, 2000, 3000, 4000, 5000, 6000, 7000, 8000, 9000, 10,000) of base pairs. Any number (e.g., all, some, or none) of nucleobases, nucleosides, or nucleotides may be an analog of a canonical species, substituted, modified, or otherwise non-naturally occurring. In some embodiments, all of a particular nucleobase type may be modified. In some embodiments, all uracils or uridines are modified. When all nucleobases, nucleosides, or nucleotides are modified, e.g., all uracils or uridines, the mRNA can be referred to as “fully modified”, e.g., for uracil or uridine.

In some embodiments, an mRNA as described herein may include a 5′ cap structure, a chain terminating nucleotide, optionally a Kozak sequence (also known as a Kozak consensus sequence), a stem loop, a polyA sequence, and/or a polyadenylation signal.

A 5′ cap structure or cap species is a compound including two nucleoside moieties joined by a linker and may be selected from a naturally occurring cap, a non-naturally occurring cap or cap analog, or an anti-reverse cap analog (ARCA). A cap species may include one or more modified nucleosides and/or linker moieties. For example, a natural mRNA cap may include a guanine nucleotide and a guanine (G) nucleotide methylated at the 7 position joined by a triphosphate linkage at their 5′ positions, e.g., m7G (5′)ppp(5′) G, commonly written as m7GpppG. A cap species may also be an anti-reverse cap analog. A non-limiting list of possible cap species includes m7GpppG, m7Gpppm7G, m73′dGpppG, m27,03′GpppG, m27,03′GppppG, m27,02′GppppG, m7Gpppm7G, m73′dGpppG, m27,03′GpppG, m27,03′GppppG, and m27,02′GppppG.

An mRNA may include a chain terminating nucleoside. For example, a chain terminating nucleoside may include those nucleosides deoxygenated at the 2′ and/or 3′ positions of their sugar group. Such species may include 3′ deoxyadenosine (cordycepin), 3′ deoxyuridine, 3′ deoxycytosine, 3′ deoxyguanosine, 3′ deoxythymine, and 2′,3′ dideoxynucleosides, such as 2′,3′ dideoxyadenosine, 2′,3′ dideoxyuridine, 2′,3′ dideoxycytosine, 2′,3′ dideoxyguanosine, and 2′,3′ dideoxythymine. In some embodiments, incorporation of a chain terminating nucleotide into an mRNA, for example at 3′-terminus, may result in stabilization of the mRNA.

An mRNA may include a stem loop, such as a histone stem loop. A stem loop may include 2, 3, 4, 5, 6, 7, 8, or more nucleotide base pairs. For example, a stem loop may include 4, 5, 6, 7, or 8 nucleotide base pairs. A stem loop may be located in any region of an mRNA. For example, a stem loop may be located in, before, or after an untranslated region (a 5′ untranslated region or a 3′ untranslated region), a coding region, or a polyA sequence or tail. In some embodiments, a stem loop may affect one or more function(s) of an mRNA, such as initiation of translation, translation efficiency, and/or transcriptional termination.

An mRNA may include a polyA sequence and/or polyadenylation signal. A polyA sequence may be comprised entirely or mostly of adenine nucleotides or analogs or derivatives thereof. A poly A sequence may also comprise stabilizing nucleotides or analogs. For example, a poly A sequence can include deoxythymidine, e.g., inverted (or reverse linkage) deoxythymidine (dT), as a stabilizing nucleotide or analog. Details on using inverted dT and other stabilizing poly A sequence modifications can be found, for example, in WO2017/049275 A2, the content of which is incorporated herein by reference. A polyA sequence may be a tail located adjacent to a 3′ untranslated region of an mRNA. In some embodiments, a polyA sequence may affect the nuclear export, translation, and/or stability of an mRNA.

An mRNA may include a microRNA binding site. MicroRNA binding sites (or miR binding sites) can be used to regulate mRNA expression in various tissues or cell types. In exemplary embodiments, miR binding sites are engineered into 3′ UTR sequences of an mRNA to regulate, e.g., enhance degradation of mRNA in cells or tissues expressing the cognate miR. Such regulation is useful to regulate or control “off-target” expression ir mRNAs, i.e., expression in undesired cells or tissues in vivo. Details on using mir binding sites can be found, for example, in WO 2017/062513 A2, the content of which is incorporated herein by reference.

In some embodiments, an mRNA is a bicistronic mRNA comprising a first coding region and a second coding region with an intervening sequence comprising an internal ribosome entry site (IRES) sequence that allows for internal translation initiation between the first and second coding regions, or with an intervening sequence encoding a self-cleaving peptide, such as a 2A peptide. IRES sequences and 2A peptides are typically used to enhance expression of multiple proteins from the same vector. A variety of IRES sequences are known and available in the art and may be used, including, e.g., the encephalomyocarditis virus IRES.

In some embodiments, an mRNA of the disclosure comprises one or more modified nucleobases, nucleosides, or nucleotides (termed “modified mRNAs” or “mmRNAs”). In some embodiments, modified mRNAs may have useful properties, including enhanced stability, intracellular retention, enhanced translation, and/or the lack of a substantial induction of the innate immune response of a cell into which the mRNA is introduced, as compared to a reference unmodified mRNA. Therefore, use of modified mRNAs may enhance the efficiency of protein production, intracellular retention of nucleic acids, as well as possess reduced immunogenicity.

In some embodiments, an mRNA includes one or more (e.g., 1, 2, 3 or 4) different modified nucleobases, nucleosides, or nucleotides. In some embodiments, an mRNA includes one or more (e.g., 1, 2, 3, 4, 5, 6, 7, 8, 9, 10, 20, 30, 40, 50, 60, 70, 80, 90, 100, or more) different modified nucleobases, nucleosides, or nucleotides. In some embodiments, the modified mRNA may have reduced degradation in a cell into which the mRNA is introduced, relative to a corresponding unmodified mRNA.

In some embodiments, the modified nucleobase is a modified uracil. Exemplary nucleobases and nucleosides having a modified uracil include pseudouridine (w), pyridin-4-one ribonucleoside, 5-aza-uridine, 6-aza-uridine, 2-thio-5-aza-uridine, 2-thio-uridine (s2U), 4-thio-uridine (s4U), 4-thio-pseudouridine, 2-thio-pseudouridine, 5-hydroxy-uridine (ho5U), 5-aminoallyl-uridine, 5-halo-uridine (e.g., 5-iodo-uridineor 5-bromo-uridine), 3-methyl-uridine (m3U), 5-methoxy-uridine (mo5U), uridine 5-oxyacetic acid (cmo5U), uridine 5-oxyacetic acid methyl ester (mcmo5U), 5-carboxymethyl-uridine (cm5U), 1-carboxymethyl-pseudouridine, 5-carboxyhydroxymethyl-uridine (chm5U), 5-carboxyhydroxymethyl-uridine methyl ester (mchm5U), 5-methoxycarbonylmethyl-uridine (mcm5U), 5-methoxycarbonylmethyl-2-thio-uridine (mcm5s2U), 5-aminomethyl-2-thio-uridine (nm5s2U), 5-methylaminomethyl-uridine (mnm5U), 5-methylaminomethyl-2-thio-uridine (mnm5s2U), 5-methylaminomethyl-2-seleno-uridine (mnm5se2U), 5-carbamoylmethyl-uridine (ncm5U), 5-carboxymethylaminomethyl-uridine (cmnm5U), 5-carboxymethylaminomethyl-2-thio-uridine (cmnm5s2U), 5-propynyl-uridine, 1-propynyl-pseudouridine, 5-taurinomethyl-uridine (Tm5U), 1-taurinomethyl-pseudouridine, 5-taurinomethyl-2-thio-uridine (m5s2U), 1 taurinomethyl-4-thio-pseudouridine, 5-methyl-uridine (m5U, i.e., having the nucleobase deoxythymine), 1-methyl-pseudouridine (m1ψ), 5-methyl-2-thio-uridine (m5s2U), 1-methyl-4-thio-pseudouridine (mls4ψ), 4-thio-1-methyl-pseudouridine, 3-methyl-pseudouridine (m3ψ), 2-thio-1-methyl-pseudouridine, 1-methyl-1-deaza-pseudouridine, 2-thio-1-methyl-1-deaza-pseudouridine, dihydrouridine (D), dihydropseudouridine, 5,6-dihydrouridine, 5-methyl-dihydrouridine (m5D), 2-thio-dihydrouridine, 2-thio-dihydropseudouridine, 2-methoxy-uridine, 2-methoxy-4-thio-uridine, 4-methoxy-pseudouridine, 4-methoxy-2-thio-pseudouridine, N1-methyl-pseudouridine, 3-(3-amino-3-carboxypropyl) uridine (acp3U), 1-methyl-3-(3-amino-3-carboxypropyl) pseudouridine (acp3 ψ), 5-(isopentenylaminomethyl) uridine (inm5U), 5-(isopentenylaminomethyl)-2-thio-uridine (inm5s2U), α-thio-uridine, 2′-O-methyl-uridine (Um), 5,2′-O-dimethyl-uridine (m5Um), 2′-O-methyl-pseudouridine (wm), 2-thio-2′-O-methyl-uridine (s2Um), 5-methoxycarbonylmethyl-2′-O-methyl-uridine (mcm5Um), 5-carbamoylmethyl-2′-O-methyl-uridine (ncm5Um), 5-carboxymethylaminomethyl-2′-O-methyl-uridine (cmnm5Um), 3,2′-O-dimethyl-uridine (m3Um), and 5-(isopentenylaminomethyl)-2′-O-methyl-uridine (inm5Um), 1-thio-uridine, deoxythymidine, 2′-F-ara-uridine, 2′-F-uridine, 2′-OH-ara-uridine, 5-(2-carbomethoxyvinyl) uridine, and 5-[3-(1-E-propenylamino)]uridine.

In some embodiments, the modified nucleobase is a modified cytosine. Exemplary nucleobases and nucleosides having a modified cytosine include 5-aza-cytidine, 6-aza-cytidine, pseudoisocytidine, 3-methyl-cytidine (m3C), N4-acetyl-cytidine (ac4C), 5-formyl-cytidine (f5C), N4-methyl-cytidine (m4C), 5-methyl-cytidine (m5C), 5-halo-cytidine (e.g., 5-iodo-cytidine), 5-hydroxymethyl-cytidine (hm5C), 1-methyl-pseudoisocytidine, pyrrolo-cytidine, pyrrolo-pseudoisocytidine, 2-thio-cytidine (s2C), 2-thio-5-methyl-cytidine, 4-thio-pseudoisocytidine, 4-thio-1-methyl-pseudoisocytidine, 4-thio-1-methyl-1-deaza-pseudoisocytidine, 1-methyl-1-deaza-pseudoisocytidine, zebularine, 5-aza-zebularine, 5-methyl-zebularine, 5-aza-2-thio-zebularine, 2-thio-zebularine, 2-methoxy-cytidine, 2-methoxy-5-methyl-cytidine, 4-methoxy-pseudoisocytidine, 4-methoxy-1-methyl-pseudoisocytidine, lysidine (k2C), α-thio-cytidine, 2′-O-methyl-cytidine (Cm), 5,2′-O-dimethyl-cytidine (m5Cm), N4-acetyl-2′-O-methyl-cytidine (ac4Cm), N4,2′-O-dimethyl-cytidine (m4Cm), 5-formyl-2′-O-methyl-cytidine (f5Cm), N4,N4,2′-O-trimethyl-cytidine (m42Cm), 1-thio-cytidine, 2′-F-ara-cytidine, 2′-F-cytidine, and 2′-OH-ara-cytidine.

In some embodiments, the modified nucleobase is a modified adenine. Exemplary nucleobases and nucleosides having a modified adenine include α-thio-adenosine, 2-amino-purine, 2, 6-diaminopurine, 2-amino-6-halo-purine (e.g., 2-amino-6-chloro-purine), 6-halo-purine (e.g., 6-chloro-purine), 2-amino-6-methyl-purine, 8-azido-adenosine, 7-deaza-adenine, 7-deaza-8-aza-adenine, 7-deaza-2-amino-purine, 7-deaza-8-aza-2-amino-purine, 7-deaza-2,6-diaminopurine, 7-deaza-8-aza-2,6-diaminopurine, 1-methyl-adenosine (m1A), 2-methyl-adenine (m2A), N6-methyl-adenosine (m6A), 2-methylthio-N6-methyl-adenosine (ms2m6A), N6-isopentenyl-adenosine (16A), 2-methylthio-N6-isopentenyl-adenosine (ms216A), N6-(cis-hydroxyisopentenyl) adenosine (io6A), 2-methylthio-N6-(cis-hydroxyisopentenyl) adenosine (ms2io6A), N6-glycinylcarbamoyl-adenosine (g6A), N6-threonylcarbamoyl-adenosine (t6A), N6-methyl-N6-threonylcarbamoyl-adenosine (m6t6A), 2-methylthio-N6-threonylcarbamoyl-adenosine (ms2g6A), N6,N6-dimethyl-adenosine (m62A), N6-hydroxynorvalylcarbamoyl-adenosine (hn6A), 2-methylthio-N6-hydroxynorvalylcarbamoyl-adenosine (ms2hn6A), N6-acetyl-adenosine (ac6A), 7-methyl-adenine, 2-methylthio-adenine, 2-methoxy-adenine, α-thio-adenosine, 2′-O-methyl-adenosine (Am), N6,2′-O-dimethyl-adenosine (m6Am), N6,N6,2′-O-trimethyl-adenosine (m62Am), 1,2′-O-dimethyl-adenosine (m1Am), 2′-O-ribosyladenosine (phosphate) (Ar(p)), 2-amino-N6-methyl-purine, 1-thio-adenosine, 8-azido-adenosine, 2′-F-ara-adenosine, 2′-F-adenosine, 2′-OH-ara-adenosine, and N6-(19-amino-pentaoxanonadecyl)-adenosine.

In some embodiments, the modified nucleobase is a modified guanine. Exemplary nucleobases and nucleosides having a modified guanine include α-thio-guanosine, inosine (I), 1-methyl-inosine (m1I), wyosine (imG), methylwyosine (mimG), 4-demethyl-wyosine (imG-14), isowyosine (imG2), wybutosine (yW), peroxywybutosine (02yW), hydroxywybutosine (OhyW), undermodified hydroxywybutosine (OhyW*), 7-deaza-guanosine, queuosine (Q), epoxyqueuosine (oQ), galactosyl-queuosine (galQ), mannosyl-queuosine (manQ), 7-cyano-7-deaza-guanosine (preQ0), 7-aminomethyl-7-deaza-guanosine (preQ1), archaeosine (G+), 7-deaza-8-aza-guanosine, 6-thio-guanosine, 6-thio-7-deaza-guanosine, 6-thio-7-deaza-8-aza-guanosine, 7-methyl-guanosine (m7G), 6-thio-7-methyl-guanosine, 7-methyl-inosine, 6-methoxy-guanosine, 1-methyl-guanosine (m1G), N2-methyl-guanosine (m2G), N2,N2-dimethyl-guanosine (m22G), N2,7-dimethyl-guanosine (m2,7G), N2, N2,7-dimethyl-guanosine (m2,2,7G), 8-oxo-guanosine, 7-methyl-8-oxo-guanosine, 1-methyl-6-thio-guanosine, N2-methyl-6-thio-guanosine, N2,N2-dimethyl-6-thio-guanosine, α-thio-guanosine, 2′-O-methyl-guanosine (Gm), N2-methyl-2′-O-methyl-guanosine (m2Gm), N2,N2-dimethyl-2′-O-methyl-guanosine (m22Gm), 1-methyl-2′-O-methyl-guanosine (m1Gm), N2,7-dimethyl-2′-O-methyl-guanosine (m2,7Gm), 2′-O-methyl-inosine (Im), 1,2′-O-dimethyl-inosine (m1Im), 2′-O-ribosylguanosine (phosphate) (Gr(p)), 1-thio-guanosine, 06-methyl-guanosine, 2′-F-ara-guanosine, and 2′-F-guanosine.

In some embodiments, an mRNA of the disclosure includes a combination of one or more of the aforementioned modified nucleobases (e.g., a combination of 2, 3 or 4 of the aforementioned modified nucleobases.)

In some embodiments, the modified nucleobase is pseudouridine (w), N1-methylpseudouridine (mlv), 2-thiouridine, 4′-thiouridine, 5-methylcytosine, 2-thio-1-methyl-1-deaza-pseudouridine, 2-thio-1-methyl-pseudouridine, 2-thio-5-aza-uridine, 2-thio-dihydropseudouridine, 2-thio-dihydrouridine, 2-thio-pseudouridine, 4-methoxy-2-thio-pseudouridine, 4-methoxy-pseudouridine, 4-thio-1-methyl-pseudouridine, 4-thio-pseudouridine, 5-aza-uridine, dihydropseudouridine, 5-methoxyuridine, or 2′-O-methyl uridine. In some embodiments, an mRNA of the disclosure includes a combination of one or more of the aforementioned modified nucleobases (e.g., a combination of 2, 3 or 4 of the aforementioned modified nucleobases.) In some embodiments, the modified nucleobase is N1-methylpseudouridine (m1ψ) and the mRNA of the disclosure is fully modified with N1-methylpseudouridine (m1ψ). In some embodiments, N1-methylpseudouridine (m1ψ) represents from 75-100% of the uracils in the mRNA. In some embodiments, N1-methylpseudouridine (m1ψ) represents 100% of the uracils in the mRNA.

In some embodiments, the modified nucleobase is a modified cytosine. Exemplary nucleobases and nucleosides having a modified cytosine include N4-acetyl-cytidine (ac4C), 5-methyl-cytidine (m5C), 5-halo-cytidine (e.g., 5-iodo-cytidine), 5-hydroxymethyl-cytidine (hm5C), 1-methyl-pseudoisocytidine, 2-thio-cytidine (s2C), 2-thio-5-methyl-cytidine. In some embodiments, an mRNA of the disclosure includes a combination of one or more of the aforementioned modified nucleobases (e.g., a combination of 2, 3 or 4 of the aforementioned modified nucleobases.)

In some embodiments, the modified nucleobase is a modified adenine. Exemplary nucleobases and nucleosides having a modified adenine include 7-deaza-adenine, 1-methyl-adenosine (m1A), 2-methyl-adenine (m2A), N6-methyl-adenosine (m6A). In some embodiments, an mRNA of the disclosure includes a combination of one or more of the aforementioned modified nucleobases (e.g., a combination of 2, 3 or 4 of the aforementioned modified nucleobases.)

In some embodiments, the modified nucleobase is a modified guanine. Exemplary nucleobases and nucleosides having a modified guanine include inosine (I), 1-methyl-inosine (m1I), wyosine (imG), methylwyosine (mimG), 7-deaza-guanosine, 7-cyano-7-deaza-guanosine (preQ0), 7-aminomethyl-7-deaza-guanosine (preQ1), 7-methyl-guanosine (m7G), 1-methyl-guanosine (m1G), 8-oxo-guanosine, 7-methyl-8-oxo-guanosine. In some embodiments, an mRNA of the disclosure includes a combination of one or more of the aforementioned modified nucleobases (e.g., a combination of 2, 3 or 4 of the aforementioned modified nucleobases.)

In some embodiments, the modified nucleobase is 1-methyl-pseudouridine (m1ψ), 5-methoxy-uridine (mo5U), 5-methyl-cytidine (m5C), pseudouridine (v), α-thio-guanosine, or α-thio-adenosine. In some embodiments, an mRNA of the disclosure includes a combination of one or more of the aforementioned modified nucleobases (e.g., a combination of 2, 3 or 4 of the aforementioned modified nucleobases.)

In some embodiments, the mRNA comprises pseudouridine (w). In some embodiments, the mRNA comprises pseudouridine (w) and 5-methyl-cytidine (m5C). In some embodiments, the mRNA comprises 1-methyl-pseudouridine (mlv). In some embodiments, the mRNA comprises 1-methyl-pseudouridine (m1ψ) and 5-methyl-cytidine (m5C). In some embodiments, the mRNA comprises 2-thiouridine (s2U). In some embodiments, the mRNA comprises 2-thiouridine and 5-methyl-cytidine (m5C). In some embodiments, the mRNA comprises 5-methoxy-uridine (mo5U). In some embodiments, the mRNA comprises 5-methoxy-uridine (mo5U) and 5-methyl-cytidine (m5C). In some embodiments, the mRNA comprises 2′-O-methyl uridine. In some embodiments, the mRNA comprises 2′-O-methyl uridine and 5-methyl-cytidine (m5C). In some embodiments, the mRNA comprises comprises N6-methyl-adenosine (m6A). In some embodiments, the mRNA comprises N6-methyl-adenosine (m6A) and 5-methyl-cytidine (m5C).

In some embodiments, an mRNA of the disclosure is uniformly modified (i.e., fully modified, modified through-out the entire sequence) for a particular modification. For example, an mRNA can be uniformly modified with N1-methylpseudouridine (m1ψ) or 5-methyl-cytidine (m5C), meaning that all uridines or all cytosine nucleosides in the mRNA sequence are replaced with N1-methylpseudouridine (m1ψ) or 5-methyl-cytidine (m5C). Similarly, mRNAs of the disclosure can be uniformly modified for any type of nucleoside residue present in the sequence by replacement with a modified residue such as those set forth above.

In some embodiments, an mRNA of the disclosure may be modified in a coding region (e.g., an open reading frame encoding a polypeptide). In other embodiments, an mRNA may be modified in regions besides a coding region. For example, in some embodiments, a 5′-UTR and/or a 3′-UTR are provided, wherein either or both may independently contain one or more different nucleoside modifications. In such embodiments, nucleoside modifications may also be present in the coding region.

The mmRNAs of the disclosure can include a combination of modifications to the sugar, the nucleobase, and/or the internucleoside linkage. These combinations can include any one or more modifications described herein.

Where a single modification is listed, the listed nucleoside or nucleotide represents 100 percent of that A, U, G or C nucleotide or nucleoside having been modified. Where percentages are listed, these represent the percentage of that particular A, U, G or C nucleobase triphosphate of the total amount of A, U, G, or C triphosphate present. For example, the combination: 25% 5-Aminoallyl-CTP+75% CTP/25% 5-Methoxy-UTP+75% UTP refers to a polynucleotide where 25% of the cytosine triphosphates are 5-Aminoallyl-CTP while 75% of the cytosines are CTP; whereas 25% of the uracils are 5-methoxy UTP while 75% of the uracils are UTP. Where no modified UTP is listed then the naturally occurring ATP, UTP, GTP and/or CTP is used at 100% of the sites of those nucleotides found in the polynucleotide. In this example all of the GTP and ATP nucleotides are left unmodified.

The mRNAs of the present disclosure, or regions thereof, may be codon optimized. Codon optimization methods are known in the art and may be useful for a variety of purposes: matching codon frequencies in host organisms to ensure proper folding, bias GC content to increase mRNA stability or reduce secondary structures, minimize tandem repeat codons or base runs that may impair gene construction or expression, customize transcriptional and translational control regions, insert or remove proteins trafficking sequences, remove/add post translation modification sites in encoded proteins (e.g., glycosylation sites), add, remove or shuffle protein domains, insert or delete restriction sites, modify ribosome binding sites and mRNA degradation sites, adjust translation rates to allow the various domains of the protein to fold properly, or to reduce or eliminate problem secondary structures within the polynucleotide. Codon optimization tools, algorithms and services are known in the art; non-limiting examples include services from GeneArt (Life Technologies), DNA2.0 (Menlo Park, CA) and/or proprietary methods. In some embodiments, the mRNA sequence is optimized using optimization algorithms, e.g., to optimize expression in mammalian cells or enhance mRNA stability.

In some embodiments, the present disclosure includes polynucleotides having at least 80%, at least 85%, at least 90%, at least 95%, at least 98%, or at least 99% sequence identity to any of the polynucleotide sequences described herein.

mRNAs of the present disclosure may be produced by means available in the art, including but not limited to in vitro transcription (IVT) and synthetic methods. Enzymatic (IVT), solid-phase, liquid-phase, combined synthetic methods, small region synthesis, and ligation methods may be utilized. In some embodiments, mRNAs are made using IVT enzymatic synthesis methods. Accordingly, the present disclosure also includes polynucleotides, e.g., DNA, constructs and vectors that may be used to in vitro transcribe an mRNA described herein.

Non-natural modified nucleobases may be introduced into polynucleotides, e.g., mRNA, during synthesis or post-synthesis. In some embodiments, modifications may be on internucleoside linkages, purine or pyrimidine bases, or sugar. In particular embodiments, the modification may be introduced at the terminal of a polynucleotide chain or anywhere else in the polynucleotide chain; with chemical synthesis or with a polymerase enzyme.

Either enzymatic or chemical ligation methods may be used to conjugate polynucleotides or their regions with different functional moieties, such as targeting or delivery agents, fluorescent labels, liquids, nanoparticles, etc. Therapeutic Agents for Reducing Protein Expression

In some embodiments, the therapeutic agent is a therapeutic agent that reduces (i.e., decreases, inhibits, downregulates) protein expression. Non-limiting examples of types of therapeutic agents that can be used for reducing protein expression include mRNAs that incorporate a micro-RNA binding site(s) (miR binding site), microRNAs (miRNAs), antagomirs, small (short) interfering RNAs (siRNAs) (including shortmers and dicer-substrate RNAs), RNA interference (RNAi) molecules, antisense RNAs, ribozymes, small hairpin RNAs (shRNAs), locked nucleic acids (LNAs) and CRISPR/Cas9 technology.

### Pharmaceutical Compositions

Formulations comprising lipid nanoparticles may be formulated in whole or in part as pharmaceutical compositions. Pharmaceutical compositions may include one or more lipid nanoparticles. In some embodiments, a pharmaceutical composition may include one or more lipid nanoparticles including one or more different therapeutics and/or prophylactics. Pharmaceutical compositions may further include one or more pharmaceutically acceptable excipients or accessory ingredients such as those described herein. General guidelines for the formulation and manufacture of pharmaceutical compositions and agents are available, for example, in Remington's The Science and Practice of Pharmacy, 21^{st} Edition, A. R. Gennaro; Lippincott, Williams & Wilkins, Baltimore, MD, 2006. Conventional excipients and accessory ingredients may be used in any pharmaceutical composition, except insofar as any conventional excipient or accessory ingredient may be incompatible with one or more components of a LNP in the formulation of the disclosure. An excipient or accessory ingredient may be incompatible with a component of a LNP of the formulation if its combination with the component or LNP may result in any undesirable biological effect or otherwise deleterious effect.

In some embodiments, one or more excipients or accessory ingredients may make up greater than 50% of the total mass or volume of a pharmaceutical composition including a LNP. In some embodiments, the one or more excipients or accessory ingredients may make up 50%, 60%, 70%, 80%, 90%, or more of a pharmaceutical convention. In some embodiments, a pharmaceutically acceptable excipient is at least 95%, at least 96%, at least 97%, at least 98%, at least 99%, or 100% pure. In some embodiments, an excipient is approved for use in humans and for veterinary use. In some embodiments, an excipient is approved by United States Food and Drug Administration. In some embodiments, an excipient is pharmaceutical grade. In some embodiments, an excipient meets the standards of the United States Pharmacopoeia (USP), the European Pharmacopoeia (EP), the British Pharmacopoeia, and/or the International Pharmacopoeia.

Relative amounts of the one or more lipid nanoparticles, the one or more pharmaceutically acceptable excipients, and/or any additional ingredients in a pharmaceutical composition in accordance with the present disclosure will vary, depending upon the identity, size, and/or condition of the subject treated and further depending upon the route by which the composition is to be administered. By way of example, a pharmaceutical composition comprises between 0.1% and 100% (wt/wt) of one or more lipid nanoparticles. As another example, a pharmaceutical composition comprises between 0.1% and 15% (wt/vol) of one or more amphiphilic polymers (e.g., 0.5%, 1%, 2.5%, 5%, 10%, or 12.5% w/v).

In some embodiments, the lipid nanoparticles and/or pharmaceutical compositions of the disclosure are refrigerated or frozen for storage and/or shipment (e.g., being stored at a temperature of 4° C. or lower, such as a temperature between about −150° C. and about 0° C. or between about −80° C. and about −20° C. (e.g., about −5° C., −10° C., −15° C., −20° C., −25° C., −30° C., −40° C., −50° C., −60° C., −70° C., −80° C., −90° C., −130° C. or −150° C.). For example, the pharmaceutical composition comprising one or more lipid nanoparticles is a solution or solid (e.g., via lyophilization) that is refrigerated for storage and/or shipment at, for example, about −20° C., −30° C., −40° C., −50° C., −60° C., −70° C., or −80° C. In some embodiments, the disclosure also relates to a method of increasing stability of the lipid nanoparticles and by storing the lipid nanoparticles and/or pharmaceutical compositions thereof at a temperature of 4° C. or lower, such as a temperature between about −150° C. and about 0° C. or between about −80° C. and about −20° C., e.g., about −5° C., −10° C., −15° C., −20° C., −25° C., −30° C., −40° C., −50° C., −60° C., −70° C., −80° C., −90° C., −130° C. or −150° C.).

Lipid nanoparticles and/or pharmaceutical compositions including one or more lipid nanoparticles may be administered to any patient or subject, including those patients or subjects that may benefit from a therapeutic effect provided by the delivery of a therapeutic and/or prophylactic to one or more particular cells, tissues, organs, or systems or groups thereof, such as the renal system. Although the descriptions provided herein of lipid nanoparticles and pharmaceutical compositions including lipid nanoparticles are principally directed to compositions which are suitable for administration to humans, it will be understood by the skilled artisan that such compositions are generally suitable for administration to any other mammal. Modification of compositions suitable for administration to humans in order to render the compositions suitable for administration to various animals is well understood, and the ordinarily skilled veterinary pharmacologist can design and/or perform such modification with merely ordinary, if any, experimentation. Subjects to which administration of the compositions is contemplated include, but are not limited to, humans, other primates, and other mammals, including commercially relevant mammals such as cattle, pigs, hoses, sheep, cats, dogs, mice, and/or rats.

A pharmaceutical composition including one or more lipid nanoparticles may be prepared by any method known or hereafter developed in the art of pharmacology. In general, such preparatory methods include bringing the active ingredient into association with an excipient and/or one or more other accessory ingredients, and then, if desirable or necessary, dividing, shaping, and/or packaging the product into a desired single- or multi-dose unit.

A pharmaceutical composition in accordance with the present disclosure may be prepared, packaged, and/or sold in bulk, as a single unit dose, and/or as a plurality of single unit doses. As used herein, a “unit dose” is discrete amount of the pharmaceutical composition comprising a predetermined amount of the active ingredient (e.g., lipid nanoparticle). The amount of the active ingredient is generally equal to the dosage of the active ingredient which would be administered to a subject and/or a convenient fraction of such a dosage such as, for example, one-half or one-third of such a dosage.

Pharmaceutical compositions may be prepared in a variety of forms suitable for a variety of routes and methods of administration. In some embodiments, pharmaceutical compositions may be prepared in liquid dosage forms (e.g., emulsions, microemulsions, nanoemulsions, solutions, suspensions, syrups, and elixirs), injectable forms, solid dosage forms (e.g., capsules, tablets, pills, powders, and granules), dosage forms for topical and/or transdermal administration (e.g., ointments, pastes, creams, lotions, gels, powders, solutions, sprays, inhalants, and patches), suspensions, powders, and other forms.

Liquid dosage forms for oral and parenteral administration include, but are not limited to, pharmaceutically acceptable emulsions, microemulsions, nanoemulsions, solutions, suspensions, syrups, and/or elixirs. In addition to active ingredients, liquid dosage forms comprise inert diluents commonly used in the art such as, for example, water or other solvents, solubilizing agents and emulsifiers such as ethyl alcohol, isopropyl alcohol, ethyl carbonate, ethyl acetate, benzyl alcohol, benzyl benzoate, propylene glycol, 1,3-butylene glycol, dimethylformamide, oils (in particular, cottonseed, groundnut, corn, germ, olive, castor, and sesame oils), glycerol, tetrahydrofurfuryl alcohol, polyethylene glycols and fatty acid esters of sorbitan, and mixtures thereof. Besides inert diluents, oral compositions can include additional therapeutics and/or prophylactics, additional agents such as wetting agents, emulsifying and suspending agents, sweetening, flavoring, and/or perfuming agents. In some embodiments for parenteral administration, compositions are mixed with solubilizing agents such as Cremophor®, alcohols, oils, modified oils, glycols, polysorbates, cyclodextrins, polymers, and/or combinations thereof.

Injectable preparations, for example, sterile injectable aqueous or oleaginous suspensions may be formulated according to the known art using suitable dispersing agents, wetting agents, and/or suspending agents. Sterile injectable preparations may be sterile injectable solutions, suspensions, and/or emulsions in nontoxic parenterally acceptable diluents and/or solvents, for example, as a solution in 1,3-butanediol. Among the acceptable vehicles and solvents that may be employed are water, Ringer's solution, U.S.P., and isotonic sodium chloride solution. Sterile, fixed oils are conventionally employed as a solvent or suspending medium. For this purpose any bland fixed oil can be employed including synthetic mono- or diglycerides. Fatty acids such as oleic acid can be used in the preparation of injectables.

Injectable formulations can be sterilized, for example, by filtration through a bacterial-retaining filter, and/or by incorporating sterilizing agents in the form of sterile solid compositions which can be dissolved or dispersed in sterile water or other sterile injectable medium prior to use.

In order to prolong the effect of an active ingredient, it is often desirable to slow the absorption of the active ingredient from subcutaneous or intramuscular injection. This may be accomplished by the use of a liquid suspension of crystalline or amorphous material with poor water solubility. The rate of absorption of the drug then depends upon its rate of dissolution which, in turn, may depend upon crystal size and crystalline form. Alternatively, delayed absorption of a parenterally administered drug form is accomplished by dissolving or suspending the drug in an oil vehicle. Injectable depot forms are made by forming microencapsulated matrices of the drug in biodegradable polymers such as polylactide-polyglycolide. Depending upon the ratio of drug to polymer and the nature of the particular polymer employed, the rate of drug release can be controlled. Examples of other biodegradable polymers include poly(orthoesters) and poly(anhydrides). Depot injectable formulations are prepared by entrapping the drug in liposomes or microemulsions which are compatible with body tissues.

Compositions for rectal or vaginal administration are typically suppositories which can be prepared by mixing compositions with suitable non-irritating excipients such as cocoa butter, polyethylene glycol or a suppository wax which are solid at ambient temperature but liquid at body temperature and therefore melt in the rectum or vaginal cavity and release the active ingredient.

Solid dosage forms for oral administration include capsules, tablets, pills, films, powders, and granules. In such solid dosage forms, an active ingredient is mixed with at least one inert, pharmaceutically acceptable excipient such as sodium citrate or dicalcium phosphate and/or fillers or extenders (e.g., starches, lactose, sucrose, glucose, mannitol, and silicic acid), binders (e.g., carboxymethylcellulose, alginates, gelatin, polyvinylpyrrolidone, sucrose, and acacia), humectants (e.g., glycerol), disintegrating agents (e.g., agar, calcium carbonate, potato or tapioca starch, alginic acid, certain silicates, and sodium carbonate), solution retarding agents (e.g., paraffin), absorption accelerators (e.g., quaternary ammonium compounds), wetting agents (e.g., cetyl alcohol and glycerol monostearate), absorbents (e.g., kaolin and bentonite clay, silicates), and lubricants (e.g., talc, calcium stearate, magnesium stearate, solid polyethylene glycols, sodium lauryl sulfate), and mixtures thereof. In the case of capsules, tablets and pills, the dosage form may comprise buffering agents.

Solid compositions of a similar type may be employed as fillers in soft and hard-filled gelatin capsules using such excipients as lactose or milk sugar as well as high molecular weight polyethylene glycols and the like. Solid dosage forms of tablets, dragees, capsules, pills, and granules can be prepared with coatings and shells such as enteric coatings and other coatings well known in the pharmaceutical formulating art. They may optionally comprise opacifying agents and can be of a composition that they release the active ingredient(s) only. In some embodiments, the solid compositions may optionally comprise opacifying agents and can be of a composition that they release the active ingredient(s) in a certain part of the intestinal tract, optionally, in a delayed manner. Examples of embedding compositions which can be used include polymeric substances and waxes. Solid compositions of a similar type may be employed as fillers in soft and hard-filled gelatin capsules using such excipients as lactose or milk sugar as well as high molecular weight polyethylene glycols and the like.

Dosage forms for topical and/or transdermal administration of a composition may include ointments, pastes, creams, lotions, gels, powders, solutions, sprays, inhalants, and/or patches. Generally, an active ingredient is admixed under sterile conditions with a pharmaceutically acceptable excipient and/or any needed preservatives and/or buffers as may be required. Additionally, the present disclosure contemplates the use of transdermal patches, which often have the added advantage of providing controlled delivery of a compound to the body. Such dosage forms may be prepared, for example, by dissolving and/or dispensing the compound in the proper medium. Alternatively or additionally, rate may be controlled by either providing a rate controlling membrane and/or by dispersing the compound in a polymer matrix and/or gel.

Suitable devices for use in delivering intradermal pharmaceutical compositions described herein include short needle devices such as those described in U.S. Pat. Nos. 4,886,499; 5,190,521; 5,328,483; 5,527,288; 4,270,537; 5,015,235; 5,141,496; and 5,417,662. Intradermal compositions may be administered by devices which limit the effective penetration length of a needle into the skin, such as those described in PCT publication WO 99/34850 and functional equivalents thereof. Jet injection devices which deliver liquid compositions to the dermis via a liquid jet injector and/or via a needle which pierces the stratum corneum and produces a jet which reaches the dermis are suitable. Jet injection devices are described, for example, in U.S. Pat. Nos. 5,480,381; 5,599,302; 5,334,144; 5,993,412; 5,649,912; 5,569,189; 5,704,911; 5,383,851; 5,893,397; 5,466,220; 5,339,163; 5,312,335; 5,503,627; 5,064,413; 5,520,639; 4,596,556; 4,790,824; 4,941,880; 4,940,460; and PCT publications WO 97/37705 and WO 97/13537. Ballistic powder/particle delivery devices which use compressed gas to accelerate vaccine in powder form through the outer layers of the skin to the dermis are suitable. Alternatively or additionally, conventional syringes may be used in the classical mantoux method of intradermal administration.

Formulations suitable for topical administration include, but are not limited to, liquid and/or semi liquid preparations such as liniments, lotions, oil in water and/or water in oil emulsions such as creams, ointments and/or pastes, and/or solutions and/or suspensions.

Topically-administrable formulations may, for example, comprise from about 1% to about 10% (wt/wt) active ingredient, although the concentration of active ingredient may be as high as the solubility limit of the active ingredient in the solvent. Formulations for topical administration may further comprise one or more of the additional ingredients described herein.

A pharmaceutical composition may be prepared, packaged, and/or sold in a formulation suitable for pulmonary administration via the buccal cavity. Such a formulation may comprise dry particles which comprise the active ingredient. Such compositions are conveniently in the form of dry powders for administration using a device comprising a dry powder reservoir to which a stream of propellant may be directed to disperse the powder and/or using a self-propelling solvent/powder dispensing container such as a device comprising the active ingredient dissolved and/or suspended in a low-boiling propellant in a sealed container. Dry powder compositions may include a solid fine powder diluent such as sugar and are conveniently provided in a unit dose form.

Low boiling propellants generally include liquid propellants having a boiling point of below 65° F. at atmospheric pressure. Generally the propellant may constitute 50% to 99.9% (wt/wt) of the composition, and active ingredient may constitute 0.1% to 20% (wt/wt) of the composition. A propellant may further comprise additional ingredients such as a liquid non-ionic and/or solid anionic surfactant and/or a solid diluent (which may have a particle size of the same order as particles comprising the active ingredient).

Pharmaceutical compositions formulated for pulmonary delivery may provide an active ingredient in the form of droplets of a solution and/or suspension. Such formulations may be prepared, packaged, and/or sold as aqueous and/or dilute alcoholic solutions and/or suspensions, optionally sterile, comprising active ingredient, and may conveniently be administered using any nebulization and/or atomization device. Such formulations may further comprise one or more additional ingredients including, but not limited to, a flavoring agent such as saccharin sodium, a volatile oil, a buffering agent, a surface active agent, and/or a preservative such as methylhydroxybenzoate. Droplets provided by this route of administration may have an average diameter in the range from about 1 nm to about 200 nm.

Formulations described herein as being useful for pulmonary delivery are useful for intranasal delivery of a pharmaceutical composition. Another formulation suitable for intranasal administration is a coarse powder comprising the active ingredient and having an average particle from about 0.2 μm to 500 μm. Such a formulation is administered in the manner in which snuff is taken, i.e. by rapid inhalation through the nasal passage from a container of the powder held close to the nose.

Formulations suitable for nasal administration may, for example, comprise from about as little as 0.1% (wt/wt) and as much as 100% (wt/wt) of active ingredient, and may comprise one or more of the additional ingredients described herein. A pharmaceutical composition may be prepared, packaged, and/or sold in a formulation suitable for buccal administration. Such formulations may, for example, be in the form of tablets and/or lozenges made using conventional methods, and may, for example, 0.1% to 20% (wt/wt) active ingredient, the balance comprising an orally dissolvable and/or degradable composition and, optionally, one or more of the additional ingredients described herein. Alternately, formulations suitable for buccal administration may comprise a powder and/or an aerosolized and/or atomized solution and/or suspension comprising active ingredient. Such powdered, aerosolized, and/or aerosolized formulations, when dispersed, may have an average particle and/or droplet size in the range from about 0.1 nm to about 200 nm, and may further comprise one or more of any additional ingredients described herein.

A pharmaceutical composition may be prepared, packaged, and/or sold in a formulation suitable for ophthalmic administration. Such formulations may, for example, be in the form of eye drops including, for example, a 0.1/1.0% (wt/wt) solution and/or suspension of the active ingredient in an aqueous or oily liquid excipient. Such drops may further comprise buffering agents, salts, and/or one or more other of any additional ingredients described herein. Other ophthalmically-administrable formulations which are useful include those which comprise the active ingredient in microcrystalline form and/or in a liposomal preparation. Ear drops and/or eye drops are contemplated as being within the scope of this present disclosure.

Those skilled in the art will recognize, or be able to ascertain using no more than routine experimentation, many equivalents to the specific embodiments in accordance with the disclosure described herein. The scope of the present disclosure is not intended to be limited to the above Description, but rather is as set forth in the appended claims.

In the claims, articles such as “a,” “an,” and “the” may mean one or more than one unless indicated to the contrary or otherwise evident from the context. Claims or descriptions that include “or” between one or more members of a group are considered satisfied if one, more than one, or all of the group members are present in, employed in, or otherwise relevant to a given product or process unless indicated to the contrary or otherwise evident from the context. The disclosure includes embodiments in which exactly one member of the group is present in, employed in, or otherwise relevant to a given product or process. The disclosure includes embodiments in which more than one, or all, of the group members are present in, employed in, or otherwise relevant to a given product or process.

It is also noted that the term “comprising” is intended to be open and permits but does not require the inclusion of additional elements or steps. When the term “comprising” is used herein, the terms “consisting essentially of” and “consisting of” are thus also encompassed and disclosed. Throughout the description, where compositions are described as having, including, or comprising specific components, it is contemplated that compositions also consist essentially of, or consist of, the recited components. Similarly, where methods or processes are described as having, including, or comprising specific process steps, the processes also consist essentially of, or consist of, the recited processing steps. Further, it should be understood that the order of steps or order for performing certain actions is immaterial so long as the invention remains operable. Moreover, two or more steps or actions can be conducted simultaneously.

Where ranges are given, endpoints are included. Furthermore, it is to be understood that unless otherwise indicated or otherwise evident from the context and understanding of one of ordinary skill in the art, values that are expressed as ranges can assume any specific value or sub-range within the stated ranges in different embodiments of the disclosure, to the tenth of the unit of the lower limit of the range, unless the context clearly dictates otherwise.

In addition, it is to be understood that any particular embodiment of the present disclosure that falls within the prior art may be explicitly excluded from any one or more of the claims. Since such embodiments are deemed to be known to one of ordinary skill in the art, they may be excluded even if the exclusion is not set forth explicitly herein.

All cited sources, for example, references, publications, patent applications, databases, database entries, and art cited herein, are incorporated into this application by reference, even if not expressly stated in the citation. In case of conflicting statements of a cited source and the instant application, the statement in the instant application shall control.

The disclosure having been described, the following examples are offered by way of illustration and not limitation.

### Definitions

As used herein, the term “alkyl” or “alkyl group” means a linear or branched, saturated hydrocarbon including one or more carbon atoms (e.g., one, two, three, four, five, six, seven, eight, nine, ten, eleven, twelve, thirteen, fourteen, fifteen, sixteen, seventeen, eighteen, nineteen, twenty, or more carbon atoms), which is optionally substituted. The notation “C₁₋₁₄ alkyl” means an optionally substituted linear or branched, saturated hydrocarbon including 1-14 carbon atoms. Alkyl groups may be optionally substituted.

As used herein, the term “alkenyl” or “alkenyl group” means a linear or branched hydrocarbon including two or more carbon atoms (e.g., two, three, four, five, six, seven, eight, nine, ten, eleven, twelve, thirteen, fourteen, fifteen, sixteen, seventeen, eighteen, nineteen, twenty, or more carbon atoms) and at least one double bond, which is optionally substituted. The notation “C₂₋₁₄ alkenyl” means an optionally substituted linear or branched hydrocarbon including 2-14 carbon atoms and at least one carbon-carbon double bond. An alkenyl group may include one, two, three, four, or more carbon-carbon double bonds. In some embodiments, C₁₈ alkenyl may include one or more double bonds. A C₁₈ alkenyl group including two double bonds may be a linoleyl group. Alkenyl groups may be optionally substituted.

As used herein, the term “carbocycle” or “carbocyclic group” means an optionally substituted mono- or multi-cyclic system including one or more rings of carbon atoms. Rings may be three, four, five, six, seven, eight, nine, ten, eleven, twelve, thirteen, fourteen, fifteen, sixteen, seventeen, eighteen, nineteen, or twenty membered rings. The notation “C₃₋₆ carbocycle” means a carbocycle including a single ring having 3-6 carbon atoms. Carbocycles may include one or more carbon-carbon double or triple bonds and may be non-aromatic or aromatic (e.g., cycloalkyl or aryl groups). Examples of carbocycles include cyclopropyl, cyclopentyl, cyclohexyl, phenyl, naphthyl, and 1,2-dihydronaphthyl groups. The term “cycloalkyl” as used herein means a non-aromatic carbocycle and may or may not include any double or triple bond. Unless otherwise specified, carbocycles described herein may be unsubstituted or substituted carbocycle groups, i.e., optionally substituted carbocycles.

As used herein, the term “heterocycle” or “heterocyclic group” means an optionally substituted mono- or multi-cyclic system including one or more rings, where at least one ring includes at least one heteroatom. Heteroatoms may be, for example, nitrogen, oxygen, or sulfur atoms. Rings may be three, four, five, six, seven, eight, nine, ten, eleven, twelve, thirteen, or fourteen membered rings. Heterocycles may include one or more double or triple bonds and may be non-aromatic or aromatic (e.g., heterocycloalkyl or heteroaryl groups). Examples of heterocycles include imidazolyl, imidazolidinyl, oxazolyl, oxazolidinyl, thiazolyl, thiazolidinyl, pyrazolidinyl, pyrazolyl, isoxazolidinyl, isoxazolyl, isothiazolidinyl, isothiazolyl, morpholinyl, pyrrolyl, pyrrolidinyl, furyl, tetrahydrofuryl, thiophenyl, pyridinyl, piperidinyl, quinolyl, and isoquinolyl groups. The term “heterocycloalkyl” as used herein means a non-aromatic heterocycle and may or may not include any double or triple bond.

Unless otherwise specified, heterocycles described herein may be unsubstituted or substituted heterocycle groups, i.e., optionally substituted heterocycles.

As used herein, a “biodegradable group” is a group that may facilitate faster metabolism of a lipid in a mammalian entity. A biodegradable group may be selected from the group consisting of, but is not limited to, —C(O)O—, —OC(O)—, —C(O) N(R′)—, —N(R′)C(O)—, —C(O)—, —C(S)—, —C(S)S—, —SC(S)—, —CH(OH)—, —P(O)(OR′)O—, —S(O)₂—, an aryl group, and a heteroaryl group. As used herein, an “aryl group” is an optionally substituted carbocyclic group including one or more aromatic rings. Examples of aryl groups include phenyl and naphthyl groups. As used herein, a “heteroaryl group” is an optionally substituted heterocyclic group including one or more aromatic rings. Examples of heteroaryl groups include pyrrolyl, furyl, thiophenyl, imidazolyl, oxazolyl, and thiazolyl. Both aryl and heteroaryl groups may be optionally substituted. In some embodiments, M and M′ can be selected from the non-limiting group consisting of optionally substituted phenyl, oxazole, and thiazole. In the formulas herein, M and M′ can be independently selected from the list of biodegradable groups above. Unless otherwise specified, aryl or heteroaryl groups described herein may be unsubstituted or substituted groups, i.e., optionally substituted aryl or heteroaryl groups.

Alkyl, alkenyl, and cyclyl (e.g., carbocyclyl and heterocyclyl) groups may be optionally substituted unless otherwise specified. Optional substituents may be selected from the group consisting of, but are not limited to, a halogen atom (e.g., a chloride, bromide, fluoride, or iodide group), a carboxylic acid (e.g., —C(O)OH), an alcohol (e.g., a hydroxyl, —OH), an ester (e.g., —C(O)OR or —OC(O) R), an aldehyde (e.g., —C(O) H), a carbonyl (e.g., —C(O)R, alternatively represented by C═O), an acyl halide (e.g., —C(O) X, in which X is a halide selected from bromide, fluoride, chloride, and iodide), a carbonate (e.g., —OC(O)OR), an alkoxy (e.g., —OR), an acetal (e.g., —C(OR)₂R″ “, in which each OR are alkoxy groups that can be the same or different and R“ ” is an alkyl or alkenyl group), a phosphate (e.g., P(O)₄³⁻), a thiol (e.g., —SH), a sulfoxide (e.g., —S(O) R), a sulfinic acid (e.g., —S(O)OH), a sulfonic acid (e.g., —S(O)₂OH), a thial (e.g., —C(S) H), a sulfate (e.g., S(O)₄²⁻), a sulfonyl (e.g., —S(O)₂—), an amide (e.g., —C(O) NR², or —N(R)C(O) R), an azido (e.g., —N3), a nitro (e.g., —NO₂), a cyano (e.g., —CN), an isocyano (e.g., —NC), an acyloxy (e.g., —OC(O) R), an amino (e.g., —NR², —NRH, or —NH₂), a carbamoyl (e.g., —OC(O) NR², —OC(O) NRH, or —OC(O) NH₂), a sulfonamide (e.g., —S(O)₂NR², —S(O)₂NRH, —S(O)₂NH₂, —N(R)S(O)₂R, —N(H)S(O)₂R, —N(R)S(O)₂H, or —N(H)S(O)₂H), an alkyl group, an alkenyl group, and a cyclyl (e.g., carbocyclyl or heterocyclyl) group. In any of the preceding, R is an alkyl or alkenyl group, as defined herein. In some embodiments, the substituent groups themselves may be further substituted with, for example, one, two, three, four, five, or six substituents as defined herein. In some embodiments, a C₁₋₆ alkyl group may be further substituted with one, two, three, four, five, or six substituents as described herein.

As used herein, the terms “approximately” and “about,” as applied to one or more values of interest, refer to a value that is similar to a stated reference value. In some embodiments, the term “approximately” or “about” refers to a range of values that fall within 25%, 20%, 19%, 18%, 17%, 16%, 15%, 14%, 13%, 12%, 11%, 10%, 9%, 8%, 7%, 6%, 5%, 4%, 3%, 2%, 1%, or less in either direction (greater than or less than) of the stated reference value unless otherwise stated or otherwise evident from the context (except where such number would exceed 100% of a possible value). In some embodiments, when used in the context of an amount of a given compound in a lipid component of a LNP, “about” may mean+/−10% of the recited value. For instance, a LNP including a lipid component having about 40% of a given compound may include 30-50% of the compound.

As used herein, the term “compound,” is meant to include all isomers and isotopes of the structure depicted. “Isotopes” refers to atoms having the same atomic number but different mass numbers resulting from a different number of neutrons in the nuclei. In some embodiments, isotopes of hydrogen include tritium and deuterium. Further, a compound, salt, or complex of the present disclosure can be prepared in combination with solvent or water molecules to form solvates and hydrates by routine methods.

As used herein, the term “upon” intends to refer to the time point being after an action happens. For example, “upon administration” refers to the time point being after the action of administration.

As used herein, the term “contacting” means establishing a physical connection between two or more entities. In some embodiments, contacting a mammalian cell with a LNP means that the mammalian cell and a nanoparticle are made to share a physical connection. Methods of contacting cells with external entities both in vivo and ex vivo are well known in the biological arts. In some embodiments, contacting a LNP and a mammalian cell disposed within a mammal may be performed by varied routes of administration (e.g., intravenous, intramuscular, intradermal, and subcutaneous) and may involve varied amounts of lipid nanoparticles. Moreover, more than one mammalian cell may be contacted by a LNP.

As used herein, the term “comparable method” refers to a method with comparable parameters or steps, as of the method being compared (e.g., the producing the LNP formulation of the present disclosure). In some embodiments, the “comparable method” is a method with one or more of steps i), ia), iaa), ib), ii), iia), iib), iic), iid), and iie) of the method being compared. In some embodiments, the “comparable method” is a method without one or more of steps i), ia), iaa), ib), ii), iia), iib), iic), iid), and iie) of the method being compared. In some embodiments, the “comparable method” is a method without one or more of steps ia) and ib) of the method being compared. In some embodiments, the “comparable method” is a method employing a water-soluble salt of a nucleic acid. In some embodiments, the “comparable method” is a method employing an organic solution that does not comprise an organic solvent-soluble nucleic acid. In some embodiments, the “comparable method” is a method comprising processing the lipid nanoparticle prior to administering the lipid nanoparticle formulation.

As used herein, the term “delivering” means providing an entity to a destination. In some embodiments, delivering a therapeutic and/or prophylactic to a subject may involve administering a LNP including the therapeutic and/or prophylactic to the subject (e.g., by an intravenous, intramuscular, intradermal, or subcutaneous route). Administration of a LNP to a mammal or mammalian cell may involve contacting one or more cells with the lipid nanoparticle.

As used herein, the term “enhanced delivery” means delivery of more (e.g., at least 1.5 fold more, at least 2-fold more, at least 3-fold more, at least 4-fold more, at least 5-fold more, at least 6-fold more, at least 7-fold more, at least 8-fold more, at least 9-fold more, at least 10-fold more) of a therapeutic and/or prophylactic by a nanoparticle to a target tissue of interest (e.g., mammalian liver) compared to the level of delivery of a therapeutic and/or prophylactic by a control nanoparticle to a target tissue of interest (e.g., MC3, KC2, or DLinDMA). The level of delivery of a nanoparticle to a particular tissue may be measured by comparing the amount of protein produced in a tissue to the weight of said tissue, comparing the amount of therapeutic and/or prophylactic in a tissue to the weight of said tissue, comparing the amount of protein produced in a tissue to the amount of total protein in said tissue, or comparing the amount of therapeutic and/or prophylactic in a tissue to the amount of total therapeutic and/or prophylactic in said tissue. It will be understood that the enhanced delivery of a nanoparticle to a target tissue need not be determined in a subject being treated, it may be determined in a surrogate such as an animal model (e.g., a rat model).

As used herein, the term “specific delivery,” “specifically deliver,” or “specifically delivering” means delivery of more (e.g., at least 1.5 fold more, at least 2-fold more, at least 3-fold more, at least 4-fold more, at least 5-fold more, at least 6-fold more, at least 7-fold more, at least 8-fold more, at least 9-fold more, at least 10-fold more) of a therapeutic and/or prophylactic by a nanoparticle to a target tissue of interest (e.g., mammalian liver) compared to an off-target tissue (e.g., mammalian spleen). The level of delivery of a nanoparticle to a particular tissue may be measured by comparing the amount of protein produced in a tissue to the weight of said tissue, comparing the amount of therapeutic and/or prophylactic in a tissue to the weight of said tissue, comparing the amount of protein produced in a tissue to the amount of total protein in said tissue, or comparing the amount of therapeutic and/or prophylactic in a tissue to the amount of total therapeutic and/or prophylactic in said tissue. In some embodiments, for renovascular targeting, a therapeutic and/or prophylactic is specifically provided to a mammalian kidney as compared to the liver and spleen if 1.5, 2-fold, 3-fold, 5-fold, 10-fold, 15-fold, or 20-fold more therapeutic and/or prophylactic per 1 g of tissue is delivered to a kidney compared to that delivered to the liver or spleen following systemic administration of the therapeutic and/or prophylactic. It will be understood that the ability of a nanoparticle to specifically deliver to a target tissue need not be determined in a subject being treated, it may be determined in a surrogate such as an animal model (e.g., a rat model).

As used herein, “encapsulation efficiency” refers to the amount of a therapeutic and/or prophylactic that becomes part of a LNP, relative to the initial total amount of therapeutic and/or prophylactic used in the preparation of a LNP. In some embodiments, if 97 mg of therapeutic and/or prophylactic are encapsulated in a LNP out of a total 100 mg of therapeutic and/or prophylactic initially provided to the composition, the encapsulation efficiency may be given as 97%.

As used herein, “encapsulation”, “encapsulated”, “loaded”, and “associated” may refer to complete, substantial, or partial enclosure, confinement, surrounding, or encasement. As used herein, “encapsulation” or “association” may refer to the process of confining an individual nucleic acid molecule within a nanoparticle and/or establishing a physiochemical relationship between an individual nucleic acid molecule and a nanoparticle. As used herein, an “empty nanoparticle” may refer to a nanoparticle that is substantially free of a therapeutic or prophylactic agent. As used herein, an “empty nanoparticle” may refer to a nanoparticle that is substantially free of a nucleic acid. As used herein, an “empty nanoparticle” may refer to a nanoparticle that consists substantially of only lipid components.

As used herein, “expression” of a nucleic acid sequence refers to translation of an mRNA into a polypeptide or protein and/or post-translational modification of a polypeptide or protein.

As used herein, the term “in vitro” refers to events that occur in an artificial environment, e.g., in a test tube or reaction vessel, in cell culture, in a Petri dish, etc., rather than within an organism (e.g., animal, plant, or microbe).

As used herein, the term “in vivo” refers to events that occur within an organism (e.g., animal, plant, or microbe or cell or tissue thereof).

As used herein, the term “ex vivo” refers to events that occur outside of an organism (e.g., animal, plant, or microbe or cell or tissue thereof). Ex vivo events may take place in an environment minimally altered from a natural (e.g., in vivo) environment.

As used herein, the term “isomer” means any geometric isomer, tautomer, zwitterion, stereoisomer, enantiomer, or diastereomer of a compound. Compounds may include one or more chiral centers and/or double bonds and may thus exist as stereoisomers, such as double-bond isomers (i.e., geometric E/Z isomers) or diastereomers (e.g., enantiomers (i.e., (+) or (−)) or cis/trans isomers). The present disclosure encompasses any and all isomers of the compounds described herein, including stereomerically pure forms (e.g., geometrically pure, enantiomerically pure, or diastereomerically pure) and enantiomeric and stereoisomeric mixtures, e.g., racemates. Enantiomeric and stereomeric mixtures of compounds and means of resolving them into their component enantiomers or stereoisomers are well-known.

As used herein, a “lipid component” is that component of a lipid nanoparticle that includes one or more lipids. In some embodiments, the lipid component may include one or more cationic/ionizable, PEGylated, structural, or other lipids, such as phospholipids.

As used herein, a “linker” is a moiety connecting two moieties, for example, the connection between two nucleosides of a cap species. A linker may include one or more groups including but not limited to phosphate groups (e.g., phosphates, boranophosphates, thiophosphates, selenophosphates, and phosphonates), alkyl groups, amidates, or glycerols. In some embodiments, two nucleosides of a cap analog may be linked at their 5′ positions by a triphosphate group or by a chain including two phosphate moieties and a boranophosphate moiety.

As used herein, “methods of administration” may include intravenous, intramuscular, intradermal, subcutaneous, or other methods of delivering a composition to a subject. A method of administration may be selected to target delivery (e.g., to specifically deliver) to a specific region or system of a body.

As used herein, “modified” means non-natural. In some embodiments, an RNA may be a modified RNA. That is, an RNA may include one or more nucleobases, nucleosides, nucleotides, or linkers that are non-naturally occurring. A “modified” species may also be referred to herein as an “altered” species. Species may be modified or altered chemically, structurally, or functionally. In some embodiments, a modified nucleobase species may include one or more substitutions that are not naturally occurring.

As used herein, the “N:P ratio” is the molar ratio of ionizable (in the physiological pH range) nitrogen atoms in a lipid to phosphate groups in an RNA, e.g., in a LNP including a lipid component and an RNA.

As used herein, a “lipid nanoparticle” is a composition comprising one or more lipids. Lipid nanoparticles are typically sized on the order of micrometers or smaller and may include a lipid bilayer. Lipid nanoparticles, as used herein, unless otherwise specified, encompass lipid nanoparticles (LNPs), liposomes (e.g., lipid vesicles), and lipoplexes. In some embodiments, a LNP may be a liposome having a lipid bilayer with a diameter of 500 nm or less.

As used herein, “naturally occurring” means existing in nature without artificial aid.

As used herein, “patient” refers to a subject who may seek or be in need of treatment, requires treatment, is receiving treatment, will receive treatment, or a subject who is under care by a trained professional for a particular disease or condition.

As used herein, a “PEG lipid” or “PEGylated lipid” refers to a lipid comprising a polyethylene glycol component.

As used herein, a “polymeric lipid” refers to a lipid comprising repeating subunits in its chemical structure. In some embodiments, the polymeric lipid is a lipid comprising a polymer component. In some embodiments, the polymeric lipid is a PEG lipid. In some embodiments, the polymeric lipid is not a PEG lipid. In some embodiments, the polymeric lipid is Brij or OH-PEG-stearate.

The phrase “pharmaceutically acceptable” is used herein to refer to those compounds, materials, composition, and/or dosage forms which are, within the scope of sound medical judgment, suitable for use in contact with the tissues of human beings and animals without excessive toxicity, irritation, allergic response, or other problems or complication, commensurate with a reasonable benefit/risk ratio.

The phrase “pharmaceutically acceptable excipient,” as used herein, refers to any ingredient other than the compounds described herein (for example, a vehicle capable of suspending, complexing, or dissolving the active compound) and having the properties of being substantially nontoxic and non-inflammatory in a patient. Excipients may include, for example: anti-adherents, antioxidants, binders, coatings, compression aids, disintegrants, dyes (colors), emollients, emulsifiers, fillers (diluents), film formers or coatings, flavors, fragrances, glidants (flow enhancers), lubricants, preservatives, printing inks, sorbents, suspending or dispersing agents, sweeteners, and waters of hydration. Exemplary excipients include, but are not limited to: butylated hydroxytoluene (BHT), calcium carbonate, calcium phosphate (dibasic), calcium stearate, croscarmellose, crosslinked polyvinyl pyrrolidone, citric acid, crospovidone, cysteine, ethylcellulose, gelatin, hydroxypropyl cellulose, hydroxypropyl methylcellulose, lactose, magnesium stearate, maltitol, mannitol, methionine, methylcellulose, methyl paraben, microcrystalline cellulose, polyethylene glycol, polyvinyl pyrrolidone, povidone, pregelatinized starch, propyl paraben, retinyl palmitate, shellac, silicon dioxide, sodium carboxymethyl cellulose, sodium citrate, sodium starch glycolate, sorbitol, starch (corn), stearic acid, sucrose, talc, titanium dioxide, vitamin A, vitamin E (alpha-tocopherol), vitamin C, xylitol, and other species disclosed herein.

Compositions may also include salts of one or more compounds. Salts may be pharmaceutically acceptable salts. As used herein, “pharmaceutically acceptable salts” refers to derivatives of the disclosed compounds wherein the parent compound is altered by converting an existing acid or base moiety to its salt form (e.g., by reacting a free base group with a suitable organic acid). Examples of pharmaceutically acceptable salts include, but are not limited to, mineral or organic acid salts of basic residues such as amines; alkali or organic salts of acidic residues such as carboxylic acids; and the like. Representative acid addition salts include acetate, adipate, alginate, ascorbate, aspartate, benzenesulfonate, benzoate, bisulfate, borate, butyrate, camphorate, camphorsulfonate, citrate, cyclopentanepropionate, digluconate, dodecylsulfate, ethanesulfonate, fumarate, glucoheptonate, glycerophosphate, hemisulfate, heptonate, hexanoate, hydrobromide, hydrochloride, hydroiodide, 2-hydroxy-ethanesulfonate, lactobionate, lactate, laurate, lauryl sulfate, malate, maleate, malonate, methanesulfonate, 2-naphthalenesulfonate, nicotinate, nitrate, oleate, oxalate, palmitate, pamoate, pectinate, persulfate, 3-phenylpropionate, phosphate, picrate, pivalate, propionate, stearate, succinate, sulfate, tartrate, thiocyanate, toluenesulfonate, undecanoate, valerate salts, and the like. Representative alkali or alkaline earth metal salts include sodium, lithium, potassium, calcium, magnesium, and the like, as well as nontoxic ammonium, quaternary ammonium, and amine cations, including, but not limited to ammonium, tetramethylammonium, tetraethylammonium, methylamine, dimethylamine, trimethylamine, triethylamine, ethylamine, and the like. The pharmaceutically acceptable salts of the present disclosure include the conventional non-toxic salts of the parent compound formed, for example, from non-toxic inorganic or organic acids. The pharmaceutically acceptable salts of the present disclosure can be synthesized from the parent compound which contains a basic or acidic moiety by conventional chemical methods. Generally, such salts can be prepared by reacting the free acid or base forms of these compounds with a stoichiometric amount of the appropriate base or acid in water or in an organic solvent, or in a mixture of the two. In some embodiments, the nonaqueous media are ether, ethyl acetate, ethanol, isopropanol, or acetonitrile. Lists of suitable salts are found in Remington's Pharmaceutical Sciences, 17th ed., Mack Publishing Company, Easton, Pa., 1985, p. 1418, Pharmaceutical Salts: Properties, Selection, and Use, P. H. Stahl and C. G. Wermuth (eds.), Wiley-VCH, 2008, and Berge et al., Journal of Pharmaceutical Science, 66, 1-19 (1977), each of which is incorporated herein by reference in its entirety.

As used herein, a “phospholipid” is a lipid that includes a phosphate moiety and one or more carbon chains, such as unsaturated fatty acid chains. A phospholipid may include one or more multiple (e.g., double or triple) bonds (e.g., one or more unsaturations). A phospholipid or an analog or derivative thereof may include choline. A phospholipid or an analog or derivative thereof may not include choline. Particular phospholipids may facilitate fusion to a membrane. In some embodiments, a cationic phospholipid may interact with one or more negatively charged phospholipids of a membrane (e.g., a cellular or intracellular membrane). Fusion of a phospholipid to a membrane may allow one or more elements of a lipid-containing composition to pass through the membrane permitting, e.g., delivery of the one or more elements to a cell.

As used herein, the “polydispersity index” is a ratio that describes the homogeneity of the particle size distribution of a system. A small value, e.g., less than 0.3, indicates a narrow particle size distribution.

As used herein, an amphiphilic “polymer” is an amphiphilic compound that comprises an oligomer or a polymer. In some embodiments, an amphiphilic polymer can comprise an oligomer fragment, such as two or more PEG monomer units. In some embodiments, an amphiphilic polymer described herein can be PS 20.

As used herein, the term “polypeptide” or “polypeptide of interest” refers to a polymer of amino acid residues typically joined by peptide bonds that can be produced naturally (e.g., isolated or purified) or synthetically.

As used herein, an “RNA” refers to a ribonucleic acid that may be naturally or non-naturally occurring. In some embodiments, an RNA may include modified and/or non-naturally occurring components such as one or more nucleobases, nucleosides, nucleotides, or linkers. An RNA may include a cap structure, a chain terminating nucleoside, a stem loop, a polyA sequence, and/or a polyadenylation signal. An RNA may have a nucleotide sequence encoding a polypeptide of interest. In some embodiments, an RNA may be a messenger RNA (mRNA). Translation of an mRNA encoding a particular polypeptide, for example, in vivo translation of an mRNA inside a mammalian cell, may produce the encoded polypeptide. RNAs may be selected from the non-liming group consisting of small interfering RNA (siRNA), asymmetrical interfering RNA (aiRNA), microRNA (miRNA), Dicer-substrate RNA (dsRNA), small hairpin RNA (shRNA), mRNA, long non-coding RNA (lncRNA) and mixtures thereof.

As used herein, a “single unit dose” is a dose of any therapeutic administered in one dose/at one time/single route/single point of contact, i.e., single administration event.

As used herein, a “split dose” is the division of a single unit dose or total daily dose into two or more doses.

As used herein, a “total daily dose” is an amount given or prescribed in a 24 hour period. It may be administered as a single unit dose.

As used herein, the term “subject” refers to any organism to which a composition or formulation in accordance with the disclosure may be administered, e.g., for experimental, diagnostic, prophylactic, and/or therapeutic purposes. Typical subjects include animals (e.g., mammals such as mice, rats, rabbits, non-human primates, and humans) and/or plants.

As used herein, “Tₓ” refers to the amount of time lasted for the nucleic acid integrity (e.g., mRNA integrity) of a LNP, LNP solution, lyophilized LNP composition, or LNP formulation to degrade to about X of the initial integrity of the nucleic acid (e.g., mRNA) used for the preparation of the LNP, LNP solution, lyophilized LNP composition, or LNP formulation. For example, “T80%” refers to the amount of time lasted for the nucleic acid integrity (e.g., mRNA integrity) of a LNP, LNP solution, lyophilized LNP composition, or LNP formulation to degrade to about 80% of the initial integrity of the nucleic acid (e.g., mRNA) used for the preparation of the LNP, LNP solution, lyophilized LNP composition, or LNP formulation. For another example, “T_{1/2}” refers to the amount of time lasted for the nucleic acid integrity (e.g., mRNA integrity) of a LNP, LNP solution, lyophilized LNP composition, or LNP formulation to degrade to about ½ of the initial integrity of the nucleic acid (e.g., mRNA) used for the preparation of the LNP, LNP solution, lyophilized LNP composition, or LNP formulation.

As used herein, “targeted cells” refers to any one or more cells of interest. The cells may be found in vitro, in vivo, in situ, or in the tissue or organ of an organism. The organism may be an animal. In some embodiments, the organism is a mammal. In some embodiments, the organism is a human. In some embodiments, the organism is a patient.

As used herein, “target tissue” refers to any one or more tissue types of interest in which the delivery of a therapeutic and/or prophylactic would result in a desired biological and/or pharmacological effect. Examples of target tissues of interest include specific tissues, organs, and systems or groups thereof. In particular applications, a target tissue may be a kidney, a lung, a spleen, vascular endothelium in vessels (e.g., intra-coronary or intra-femoral), or tumor tissue (e.g., via intratumoral injection). An “off-target tissue” refers to any one or more tissue types in which the expression of the encoded protein does not result in a desired biological and/or pharmacological effect. In particular applications, off-target tissues may include the liver and the spleen.

The term “therapeutic agent” or “prophylactic agent” refers to any agent that, when administered to a subject, has a therapeutic, diagnostic, and/or prophylactic effect and/or elicits a desired biological and/or pharmacological effect. Therapeutic agents are also referred to as “actives” or “active agents.” Such agents include, but are not limited to, cytotoxins, radioactive ions, chemotherapeutic agents, small molecule drugs, proteins, and nucleic acids.

As used herein, the term “therapeutically effective amount” means an amount of an agent to be delivered (e.g., nucleic acid, drug, composition, therapeutic agent, diagnostic agent, prophylactic agent, etc.) that is sufficient, when administered to a subject suffering from or susceptible to an infection, disease, disorder, and/or condition, to treat, improve symptoms of, diagnose, prevent, and/or delay the onset of the infection, disease, disorder, and/or condition.

As used herein, the term “transfection” refers to the introduction of a species (e.g., an RNA) into a cell. Transfection may occur, for example, in vitro, ex vivo, or in vivo.

As used herein, the term “treating” refers to partially or completely alleviating, ameliorating, improving, relieving, delaying onset of, inhibiting progression of, reducing severity of, and/or reducing incidence of one or more symptoms or features of a particular infection, disease, disorder, and/or condition. In some embodiments, “treating” cancer may refer to inhibiting survival, growth, and/or spread of a tumor. Treatment may be administered to a subject who does not exhibit signs of a disease, disorder, and/or condition and/or to a subject who exhibits only early signs of a disease, disorder, and/or condition for the purpose of decreasing the risk of developing pathology associated with the disease, disorder, and/or condition.

As used herein, the term “zeta potential” refers to the electrokinetic potential of a lipid, e.g., in a particle composition.

As used herein, the term “polydispersity”, “polydispersity index”, or “PDI” refers to a measurement of the distribution of molecular mass in a given sample. The polydispersity is calculated as M_{w}/Mₙ, in which M_{w} is the mass-average molar mass (or molecular weight) and Mₙ is the number-average molar mass (or molecular weight).

The term, “empty lipid nanoparticle” or “empty LNP”, as used herein, refers to a lipid nanoparticle which is substantially free of therapeutic or prophylactic agent. In some embodiments, therapeutic or prophylactic agent is nucleic acid (e.g., mRNA). In some embodiments, the empty LNP is substantially free of nucleic acid (e.g., mRNA). In some embodiments, the empty LNP comprises an ionizable lipid, a phospholipid, a structural lipid, and a PEG lipid. In some embodiments, the empty LNP comprises substantially less nucleic acid (e.g., RNA) as compared to the loaded LNP. In some embodiments, the empty LNP comprises less than about 5% w/w, less than about 4% w/w, less than 3% w/w, less than 2% w/w, less than 1% w/w, less than 0.5% w/w, less than 0.4% w/w, less than 0.3% w/w, less than 0.2% w/w, or less than 0.1% w/w of nucleic acid (e.g., RNA). In some embodiments, the empty LNP is free of nucleic acid (e.g., mRNA). In some embodiments, the empty LNP is further substantially free of nucleic acid (e.g., mRNA) associated with the surface of the LNP or conjugated to the exterior of the LNP.

The term, “loaded lipid nanoparticle” or “loaded LNP”, as used herein, refers to a lipid nanoparticle comprising a substantial amount of therapeutic or prophylactic agent. In some embodiments, therapeutic or prophylactic agent is nucleic acid (e.g., mRNA). In some embodiments, the loaded LNP comprises a substantial amount of nucleic acid (e.g., mRNA). In some embodiments, the empty LNP comprises an ionizable lipid, a phospholipid, a structural lipid, and a PEG lipid. In some embodiments, the empty LNP comprises a substantial amount of nucleic acid (e.g., mRNA) that is at least partially in the interior of the LNP. In some embodiments, the empty LNP comprises a substantial amount of nucleic acid (e.g., mRNA) that is associated with the surface of the LNP or conjugated to the exterior of the LNP.

It is understood that some properties of LNPs disclosed herein may be characterized by capillary zone electrophoresis (CZE). Capillary zone electrophoresis (CZE) refers to a separation technique which uses high voltage across a capillary to separate charged species based on their electrophoretic mobility. In some embodiments, the CZE is conducted with an acetate buffer (e.g., 50 mM sodium acetate at pH 5). In some embodiments, the CZE is conducted with a reverse voltage of about 10 kV across a 75 μm capillary of 20 cm effective length. In some embodiments, the capillary is coated with polyethyleneimine.

The term “mobility peak”, as used herein, refers to a peak representing the distribution of a substance (e.g., a population of LNPs) as measured by CZE. In some embodiments, the intensity of the mobility peak is detected by scattered light. It is understood that the intensity of the peak may indicate the amount of the portion of the substance at the position of the peak. In some embodiments, the position of the peak is calculated against a neutral reference standard (e.g., DMSO) being characterized by a mobility peak at 0, and a charged reference standard (e.g., benzylamine) being characterized by a mobility peak at 1.0. In some embodiments, a population of LNPs may exhibit more than one peaks as measured by CZE, and unless indicated otherwise, the mobility peak refers to the peak having the greatest peak area among the more than one peaks.

The term “spread”, as used herein, refers to the width at half height of a peak (e.g., a mobility peak).

It is understood that, unless specified otherwise, the term “substantial portion”, as used herein, refers to a portion of at least about 50%. In some embodiments, the substantial portion is at least about 60%, at least about 70%, at least about 75%, at least about 80%, at least about 85%, at least about 88%, at least about 90%, at least about 91%, at least about 92%, at least about 93%, at least about 94%, at least about 95%, at least about 96%, at least about 97%, at least about 98%, or at least about 99%.

It is understood that some properties of LNPs disclosed herein may be characterized by asymmetric flow field flow fractionation (AF4). AF4 refers to a one phase separation that uses a perpendicular flow against a membrane (cross-flow) in conjunction with a channel flow parallel to the membrane to fractionate samples based on their diffusion behavior. The channel flow gives a parabolic profile and the perpendicular flow drives macromolecules toward the boundary layer of the membrane. Diffusion related to Brownian motions moves smaller particles with higher diffusion rates higher in the channel where longitudinal flow is faster, eluting smaller particles more quickly. In some embodiments, this technique is coupled to a separation to convolute the polydispersity of LNPs.

The term “size-heterogeneity mode peak” or “Rg mode peak”, as used herein, refers to a peak representing the distribution of a substance (e.g., a population of LNPs) as measured by AF4. In some embodiments, the intensity of the mobility peak is detected by scattered light, UV, or RI. It is understood that the intensity of the peak may indicate the amount of the portion of the substance at the position of the peak. In some embodiments, a population of LNPs may exhibit more than one peaks as measured by AF4 and unless indicated otherwise, the size-heterogeneity mode peak refers to the peak having the greatest peak area among the more than one peaks.

The term “distribution percentage”, as used herein, refers to the percentage of the peak area of a referenced peak over the total peak area of all peaks in a spectrum or diagram. For example, the distribution percentage of a mobility peak refers the percentage of the peak area of the mobility peak over the total peak area of all peaks of a substance (e.g., a population of LNPs) as measured by CZE. For another example, the distribution percentage of a size-heterogeneity mode peak refers to the percentage of the peak are of the size-heterogeneity mode peak over the total peak area of all peaks of a substance (e.g., a population of LNPs) as measured by AF4.

The term “radius of gyration”, as used herein, refers to the radial distance to a point which would have a moment of inertia the same as the body's actual distribution of mass, if the total mass of the body were concentrated there. In some embodiments, the radius of gyration is measured by AF4.

The term “free of”, as used herein, means not comprising the referenced component. For example, when a population, solution, or formulation is described as being “free of PEG lipid”, the population, solution, or formulation does not comprise PEG lipid (e.g., does not comprise a PEG lipid described herein (e.g., does not comprise PEG-DMG)).

### EXAMPLES

In order that the invention described herein may be more fully understood, the following examples are set forth. The examples described in this application are offered to illustrate the compounds, pharmaceutical compositions, and methods provided herein and are not to be construed in any way as limiting their scope.

### Example 1. Comparison of Exemplary Mixers

V-mixers of different geometry design and outlet sizes were used to compare their mixing performance. Computational fluid dynamics (CFD) simulations were performed to calculate the average EDT during mixing for different mixer geometries and flow rates. EDT is a characteristic time for the nucleation and growth event, and a short EDT corresponds to a larger nucleation rate. Hence, smaller sizes of eLNPs are made, with a defined lipid composition and concentration level. Based on extensive studies of EDT, EDT standard deviation and inlet pressure, a comparison of V-mixers, T-mixers, and C-mixers was established at different production levels. The comparison can be used as a prediction guidance for the choice of mixers and flow rates, once eLNPs of certain sizes and production rates are requested.

V-mixers, T-mixers, and C-mixers of different outlet dimensions were divided into individual meshing to get the numerical solution of the Navier-Stokes equation at locations within the fluid mixing domain. A system converged at steady state gives the pressure and ethanol content contour within the mixer.

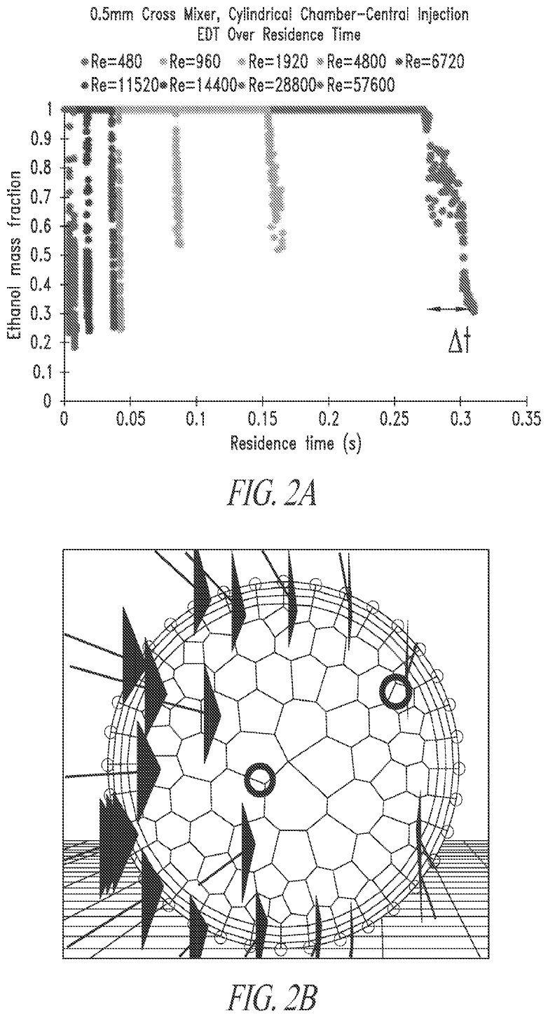

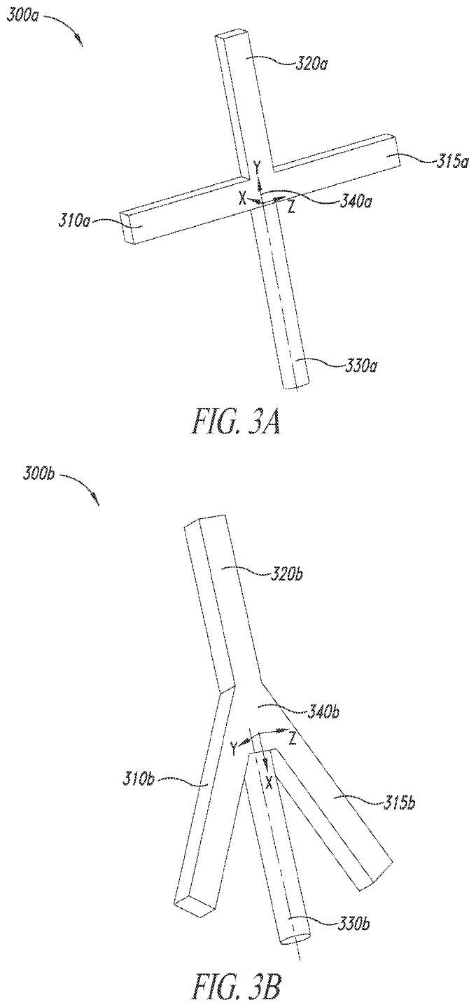

As shown in FIG. 1A-1B and FIGS. 2A-2B, after calculation iterations, the simulation converged at the steady state. Massless particles were then injected across the ethanol inlet and pushed forwards with the ethanol flow. The local fraction of ethanol was monitored against an increase of residence time. For lipid dissolved in ethanol stream, the local ethanol mass concentration started at 100%, began to drop in the mixing domain and left the mixing chamber at 20.4% at the outlet (25% volume ethanol). “Ethanol drop time” or Δt, is defined as the average time differences between where the local ethanol mass fraction is 99.9% (mixing starts) and 30.0% (defined here as the close to the end of mixing), as experienced by all particles.

The five mixers involved in this experiment are 2 mm outlet V-mixer, 2 mm outlet T-mixer, 2 mm outlet C-mixer with a 4 mm dimension cubic chamber, 2 mm outlet C-mixer without a chamber and with 2 mm water and ethanol inlet, and 2 mm outlet C-mixer without a chamber and with 1.1 mm ethanol inlet and 2 mm water inlets. Gear pumps were used to supply total flow rates of 200, 400, 600 and 800 mL/min total (25% vol ethanol) through the five mixers, outlet streams of the mixers were further diluted to 10.6% vol ethanol by the same aqueous buffer, supplied by another peristaltic pump. The sizes of LNPs were measured and compared. Pressures were measured for the accumulated pressure (mixer and tubing pressure) and the aqueous and ethanol supply pumps.

### EQUIVALENTS

The details of one or more embodiments of the invention are set forth in the accompanying description above. Although any methods and materials similar or equivalent to those described herein can be used in the practice or testing of the present disclosure, the preferred methods and materials are now described. Other features, objects, and advantages of the disclosure will be apparent from the description and from the claims. In the specification and the appended claims, the singular forms include plural referents unless the context clearly dictates otherwise. Unless defined otherwise, all technical and scientific terms used herein have the same meaning as commonly understood by one of ordinary skill in the art to which this disclosure belongs. All patents and publications cited in this specification are incorporated by reference.

The foregoing description has been presented only for the purposes of illustration and is not intended to limit the invention to the precise form disclosed, but by the claims appended hereto.

We claim:

1. A cross mixer, comprising:
a central region;
a first inlet in fluidic communication with the central region and coupled to a first side of the central region;
a second inlet in fluidic communication with the central region and coupled to a second side of the central region, the second side opposite the first side;
a third inlet in fluidic communication with the central region and coupled to a third side of the central region, the third side adjacent to the first side and the second side; and
an outlet in fluidic communication with the central region and coupled to a fourth side of the central region, the fourth side opposite the third side, the outlet oriented at an angle of between about 35° and about 120° from the first inlet and an angle of between about 35° and about 120° from the second inlet.

2. The cross mixer of claim 1, wherein the central region includes a first dimension approximately equal to a first dimension of a cross-sectional area of the first inlet, a second dimension approximately equal to a second dimension of the cross-sectional area of the first inlet, and a third dimension approximately equal to a first dimension of a cross-sectional area of the second inlet.

3. The cross mixer of claim 1, wherein the central region includes a convergence chamber.

4. The cross mixer of claim 3, wherein the convergence chamber has a cylindrical shape.

5. The cross mixer of claim 4, wherein the first inlet and the second inlet are offset, such that fluids flowing into the convergence chamber create a vertex.

6. The cross mixer of claim 3, wherein the convergence chamber has a cubic shape.

7. The cross mixer of claim 3, wherein the convergence chamber has a trapezoidal prism shape.

8. The cross mixer of claim 3, wherein the convergence chamber has a frustum shape.

9. The cross mixer of claim 1, wherein the first inlet has a square cross section.

10. The cross mixer of claim 9, wherein the square cross section has a cross-sectional dimension of about 1 mm to about 4 mm.

11. The cross mixer of claim 1, wherein the first inlet has a circular cross section.

12. The cross mixer of claim 11, wherein the circular cross section has a cross-sectional diameter of about 1 mm to about 4 mm.

13. The cross mixer of claim 1, wherein the outlet is oriented at an angle of about 90° from the first inlet.

14. The cross mixer of claim 1, wherein the outlet is oriented at an angle of about 35° to about 45° from the first inlet.

15. The cross mixer of claim 1, wherein the third inlet is oriented approximately in-line with the outlet.

16. The cross mixer of claim 1, wherein the first inlet includes a first section and a second section, the first section oriented approximately orthogonal to the second section.

17. The cross mixer of claim 16, wherein the first section is oriented vertically and the second section is oriented horizontally.

18. The cross mixer of claim 1, wherein the outlet is oriented within about 5° of parallel to the third inlet.

19. The cross mixer of claim 1, wherein the third inlet includes a bend having an angle between about 80° and about 100°.

20. The cross mixer of claim 1, wherein the outlet includes a narrow region and an expanded region, the expanded region further from the central region than the narrow region.

21. The cross mixer of claim 20, wherein the narrow region has a length between about 2 mm and about 10 mm.

22. The cross mixer of claim 20, wherein the narrow region has a length of at least about 40 mm.

23. The cross mixer of claim 20, wherein the expanded region has a diameter larger than the narrow region by a factor of between about 1.5:1 and about 5:1.

24. The cross mixer of claim 20, wherein the narrow region of the outlet has a length-to-diameter ratio between about 5:1 and about 15:1.

25. The cross mixer of claim 20, wherein the third inlet includes a narrow region and an expanded region, the expanded region further from the central region than the narrow region.

26. The cross mixer of claim 25, wherein the narrow region of the outlet has a first diameter and the narrow region of the third inlet has a second diameter, the ratio between the first diameter and the second diameter between about 0.5:1 and about 5:1.

27. The cross mixer of claim 20, wherein the narrow region has a length-to-diameter region of between about 2:1 and about 20:1.

28. A method, comprising:
feeding a first fluid to a central region of a cross mixer via at least one of a first inlet or a second inlet, the first inlet coupled to a first side of the central region, the second inlet coupled to a second side of the central region, the first side opposite the second side;
feeding a second fluid to a third inlet of the cross mixer, the third inlet coupled to a third side of the central region, the third side adjacent to the first side and the second side;
mixing the first fluid and the second fluid to form a mixture in a central region fluidically coupled to the first inlet, the second inlet, and the third inlet; and
transferring the mixture out of the central region via an outlet of the cross mixer, the outlet coupled to a fourth side of the central region, the fourth side opposite the third side.

29. The method of claim 28, wherein the first fluid includes water.

30. The method of claim 29, wherein the second fluid includes LSS.

31. The method of claim 30, wherein the water reacts with the LSS to form nanoparticles via nucleation at a sufficient rate, such that the ethanol concentration in the first fluid reduces from at least about 99 wt % to less than about 30 wt % less than about 0.007 seconds after contacting the second fluid.

32. The method of claim 31, wherein the ethanol reacts with the LSS at a sufficient rate, such that the ethanol concentration in the first fluid reduces from at least about 99 wt % to less than about 30 wt % less than about 0.003 seconds after contacting the second fluid.

33. The method of claim 28, wherein the central region includes a first dimension approximately equal to a first dimension of a cross-sectional area of the first inlet, a second dimension approximately equal to a second dimension of the cross-sectional area of the first inlet, and a third dimension approximately equal to a first dimension of a cross-sectional area of the second inlet.

34. The method of claim 28, wherein the central region includes a convergence chamber.

35. The method of claim 34, wherein the convergence chamber has a cylindrical shape.

36. The method of claim 35, wherein the first inlet and the second inlet are offset, such that fluids flowing into the convergence chamber create a vortex.

37. The method of claim 34, wherein the convergence chamber has a cubic shape.

38. The method of claim 34, wherein the convergence chamber has a trapezoidal prism shape.

39. The method of claim 34, wherein the convergence chamber has a frustum shape.

40. The method of claim 34, wherein feeding the second fluid to the third inlet includes flowing the second fluid through a first flow path and flowing the second fluid through a second flow path, the second flow path oriented between about 80° and about 100° from the first flow path.

41. A method for preparing LNPs, the method comprising:
mixing a lipid solution with an aqueous buffer solution in a C-Mixer, thereby forming a lipid nanoparticle solution (LNP solution) comprising LNPs, wherein:
the lipid solution is fed to an inlet (lipid inlet) of the C-Mixer;
the aqueous buffer solution is fed to an inlet (buffer inlet) of the C-Mixer; and/or
the LNP solution exits an outlet (LNP outlet) of the C-Mixer.

42. The method of claim 41, wherein the lipid solution is fed to an inlet that is within about 5° of parallel to the outlet.

43. The method of claim 41, wherein the aqueous buffer solution is fed to an inlet that forms an angle with the outlet between about 80° and about 120°.

44. The method of claim 41, wherein the aqueous buffer solution is fed to two inlets that each form an angle with the outlet between about 80° and about 120°.
